(19) United States
(12) Patent Application Publication
(10) Pub. No.: US 2003/0046401 A1
(43) Pub. Date: Mar. 6, 2003

(54) Dynamically determing appropriate computer user interfaces

(76) Inventors: Kenneth H. Abbott, Kirkland, WA (US); James O. Robarts, Redmond, WA (US); Lisa L. Davis, Seattle, WA (US)

Correspondence Address: PERKINS COIE LLP, PATENT-SEA, P.O. BOX 1247, SEATTLE, WA, 98111-1247, US

(21) Appl. No.: 09/981,320

(22) Filed: Oct. 16, 2001

Related U.S. Application Data
(60) Provisional application No. 60/240,671, filed on Oct. 16, 2000.
(60) Provisional application No. 60/240,682, filed on Oct. 16, 2000.
(60) Provisional application No. 60/240,687, filed on Oct. 16, 2000.
(60) Provisional application No. 60/240,689, filed on Oct. 16, 2000.
(60) Provisional application No. 60/240,694, filed on Oct. 16, 2000.
(60) Provisional application No. 60/311,181, filed on Aug. 9, 2001.
(60) Provisional application No. 60/311,148, filed on Aug. 9, 2001.
(60) Provisional application No. 60/311,151, filed on Aug. 9, 2001.
(60) Provisional application No. 60/311,190, filed on Aug. 9, 2001.
(60) Provisional application No. 60/311,236, filed on Aug. 9, 2001.
(60) Provisional application No. 60/323,032, filed on Sep. 14, 2001.

(51) Int. Cl. G06F 15/16; G09G 5/00

(52) U.S. Cl. 709/228; 709/227; 345/762

(57) ABSTRACT

A method, system, and computer-readable medium are described for dynamically determining an appropriate user interface (“UI”) to be provided to a user. In some situations, the determining is to dynamically modify a UI being provided to a user of a wearable computing device so that the current UI is appropriate for a current context of the user. In order to dynamically determine an appropriate UI, various types of UI needs may be characterized (e.g., based on a current user's situation, a current task being performed, current I/O devices that are available, etc.) in order to determine characteristics of a UI that is currently optimal or appropriate, various existing UI designs or templates may be characterized in order to identify situations for which they are optimal or appropriate, and one of the existing UIs that is most appropriate may then be selected based on the current UI needs.

### CROSS REFERENCE TO RELATED APPLICATIONS

This application claims the benefit of U.S. Provisional Application No. 60/240,671 (Attorney Docket Nos. TG1003 and 294438006US00), filed Oct. 16, 2000; of U.S. Provisional Application No. 60/240,682 (Attorney Docket Nos. TG1004 and 294438006US01), filed Oct. 16, 2000; of U.S. Provisional Application No. 60/240,687 (Attorney Docket Nos. TG1005 and 294438006US02), filed Oct. 16, 2000; of U.S. Provisional Application No. 60/240,689 (Attorney Docket Nos. TG1001 and 294438006US03), filed Oct. 16, 2000; of U.S. Provisional Application No. 60/240,694 (Attorney Docket Nos. TG1013 and 294438006US04), filed Oct. 16, 2000; of U.S. Provisional Application No. 60/311,181 (Attorney Docket Nos. 145 and 294438006US06), filed Aug. 9, 2001; of U.S. Provisional Application No. 60/311,148 (Attorney Docket Nos. 146 and 294438006US07), filed Aug. 9, 2001; of U.S. Provisional Application No. 60/311,151 (Attorney Docket Nos. 147 and 294438006US08), filed Aug. 9, 2001; of U.S. Provisional Application No. 60/311,190 (Attorney Docket Nos. 149 and 294438006US09), filed Aug. 9, 2001; of U.S. Provisional Application No. 60/311,236 (Attorney Docket Nos. 150 and 294438006US10), filed Aug. 9, 2001; and of U.S. Provisional Application No. 60/323,032 (Attorney Docket Nos. 135 and 294438006US05), filed Sep. 14, 2001, each of which are hereby incorporated by reference in their entirety.

### TECHNICAL FIELD

The following disclosure relates generally to computer user interfaces, and more particularly to various techniques for dynamically determining an appropriate user interface, such as based on a current context of a user of a wearable computer.

### BACKGROUND

Current user interfaces (UIs) often use a windows, icons, menus, and pointers (WIMP) interface. While WIMP interfaces have proved useful for some users of stationary desktop computers, a WIMP interface is not typically appropriate for other users (e.g., users that are non-stationary and/or users of other types of computing devices). One reason that WIMP interfaces are inappropriate in other situations is that they make several inappropriate assumptions about the user's situation, including: (a) that the user's computing device has a significant amount of screen real estate available for the UI; (b) that interaction, not digital information, is the user's primary task (e.g., that the user is willing to track a pointer's movement, hunt down a menu item or button, find an icon, and/or immediately receive and respond to information being presented); and (c) that the user can and should explicitly specify how and when to change the interface (e.g., to adapt to changes in the user's environment).

Moreover, what limited controls are available to the user in a WIMP interface (e.g., manually changing the entire computer display's brightness or audio volume) are typically complicated (e.g., system controls are not integrated in the control mechanisms of the computing system—instead, users must go through multiple layers of system software), inflexible (e.g., user preferences do not apply to different input and output (I/O) devices), non-automated (e.g., UIs do not typically respond to context changes without direct user intervention), not user-extensible (e.g., new devices cannot be integrated into existing preferences), not user-programmable (e.g., users cannot modify underlying logic used), and difficult to share (e.g., there is a lack of integration, which means preference for logic used cannot be conveniently stored and exported to other computers), as well as suffering from various other problems.

A computing system and/or an executing software application that were able to dynamically modify a UI during execution so as to appropriately reflect current conditions would provide a variety of benefits. However, to perform such dynamic modification of a UI, whether by choosing between existing options and/or by creating a custom UI, such a system and/or software may need to be able to determine and respond to a variety of complex current UI needs. For instance, in a situation in which the user requires that the input to the computing environment be private, the computer-assisted task is complex, and the user has access to a head-mounted display (HMD) and a keyboard, the UI needs are different than a situation in which the user does not require any privacy, has access to a desktop computer with a monitor, and the computer-assisted task is simple.

Unfortunately, current computing systems and software applications (including WIMP interfaces) do not explicitly model sufficient UI needs (e.g., privacy, safety, available I/O devices, learning style, etc.) to allow an optimal or near-optimal UI to be dynamically determined and used during execution. In fact, most computing systems and software applications do not explicitly model any UI needs, and make no attempt to dynamically modify their UI during execution to reflect current conditions.

Some current systems do attempt to provide modifiability of UI designs in various limited ways that do not involve modeling such UI needs, but each fail for one reason or another. Some such current techniques include:

changing UI design based on device type;

specifying explicit user preferences; and

changing UI output by selecting a platform at compile-time.

Unfortunately, none of these techniques address the entire problem, as discussed below.

Changing the UI based on the type of device (e.g., providing a personal digital assistant (PDA) with a different UI than a desktop computer or a computer in an automobile) typically involves designing completely separate UIs that are not inter-compatible and that do not react to the user's context. Thus, the user gets a different UI on each computing device that they use, and gets the same UI on a particular device regardless of their situation (e.g., whether they are driving a car, working on an airplane engine, or sitting at a desk).

Specifying of user preferences (e.g., as allowed by the Microsoft Windows operating system and some application programs) typically allows a UI to be modified, but in ways that are limited to appearance and superficial functionality (e.g., accessibility, pointers, color schemes, etc.), and requires an explicit user intervention (which is typically difficult and time-consuming to specify) every time that the UI is to change.

Changing the type of UI output that will be presented (e.g., pop-up menus versus scrolling lists) based on the underlying software platform (e.g., operating system) that will be used to support the presentation is typically a choice that must be made at compile time, and often involves requiring the UI to be limited to a subset of functionality that is available on every platform to be supported. For example, Geoworks' U.S. Pat. No. 5,327,529 describes a system that supports the creation of software applications that can change their appearance in limited manners based on different platforms.

Thus, while current systems provide limited modifiability of UI designs, such current systems do not dynamically modify a UI during execution so as to appropriately reflect current conditions. The ability to provide such dynamic modification of a UI would provide significant benefits in a wide variety of situations.

### BRIEF DESCRIPTION OF THE DRAWINGS

FIG. 1 is a data flow diagram illustrating one embodiment of dynamically determining an appropriate or optimal UI.

FIG. 2 is a block diagram illustrating an embodiment of a computing device with a system for dynamically determining an appropriate UI.

FIG. 3 illustrates an example relationship between various techniques related to dynamic optimization of computer user interfaces.

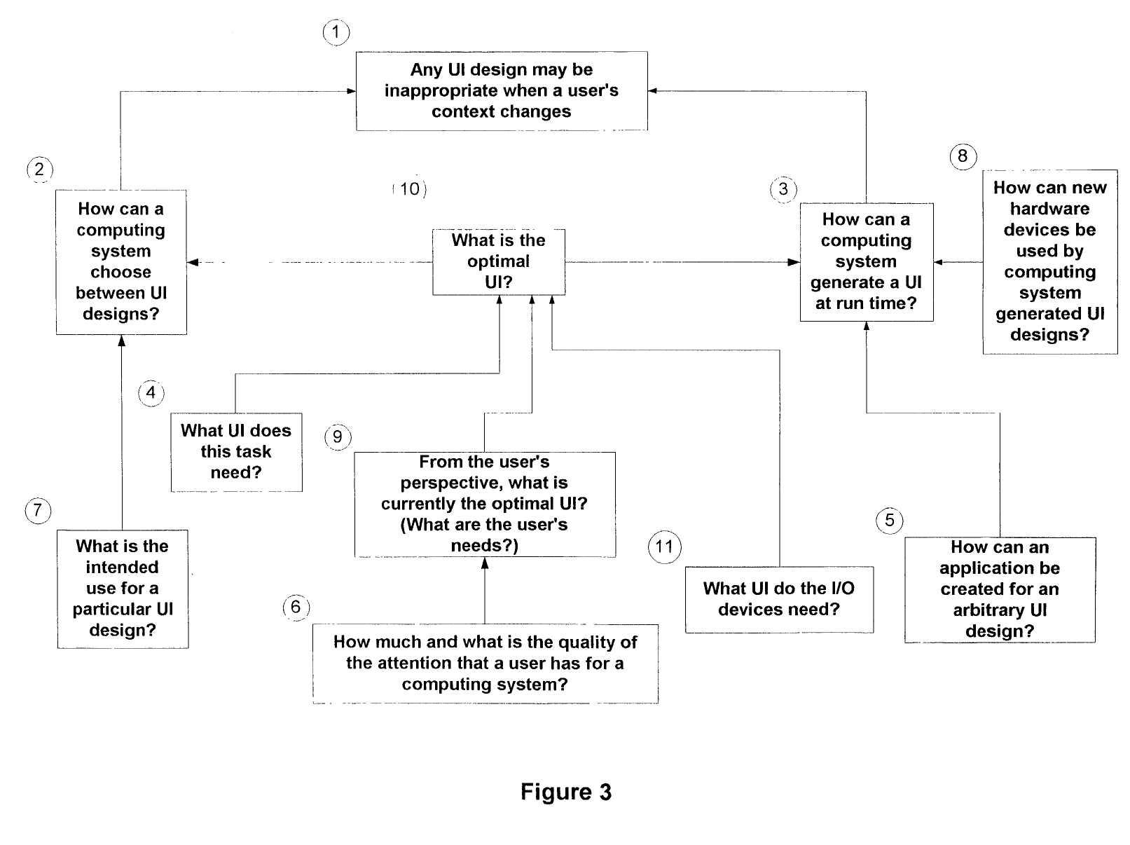

FIG. 4 illustrates an example of an overall mechanism for characterizing a user's context.

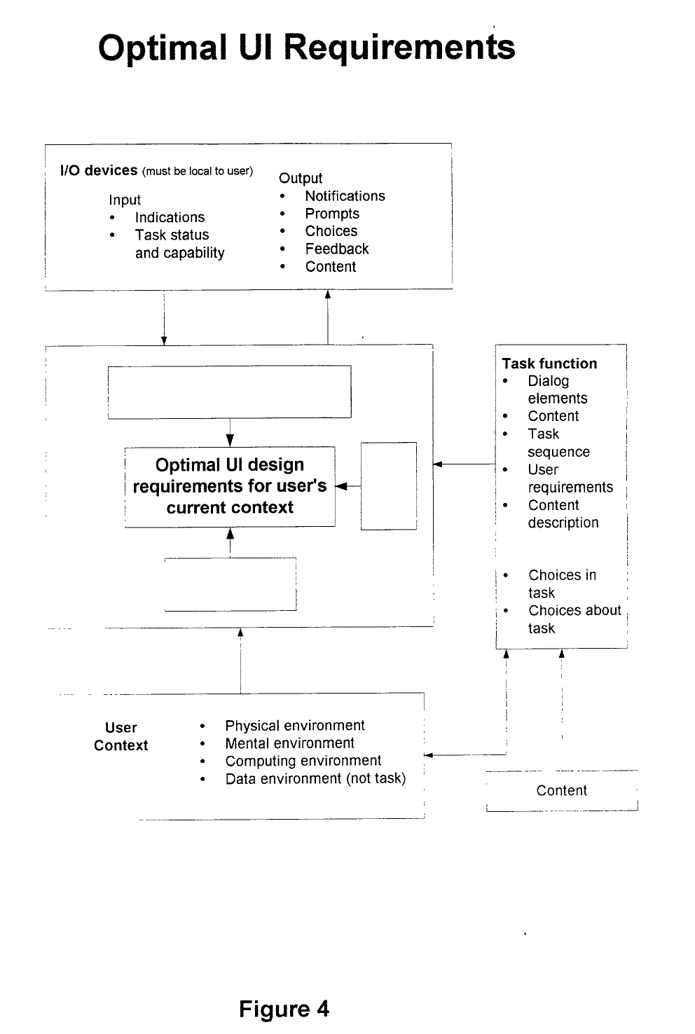

FIG. 5 illustrates an example of automatically generating a task characterization at run time.

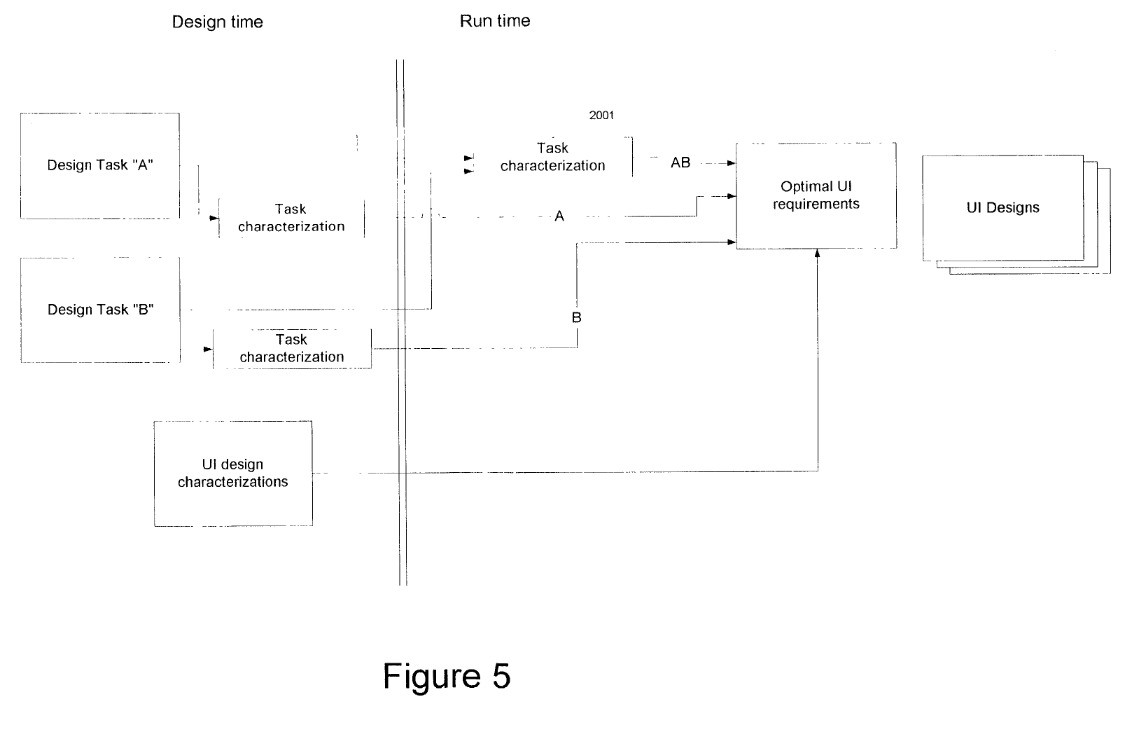

FIG. 6 is a representation of an example of choosing one of multiple arbitrary predetermined UI designs at run time.

FIG. 7 is a representation of example logic that can be used to choose a UI design at run time.

FIG. 8 is an example of how to match a UI design characterization with UI requirements via a weighted matching index.

FIG. 9 is an example of how UI requirements can be weighted so that one characteristic overrides all other characteristics when using a weighted matching index.

FIG. 10 is an example of how to match a UI design characterization with UI requirements via a weighted matching index.

FIG. 11 is a block diagram illustrating an embodiment of a computing device capable of executing a system for dynamically determining an appropriate

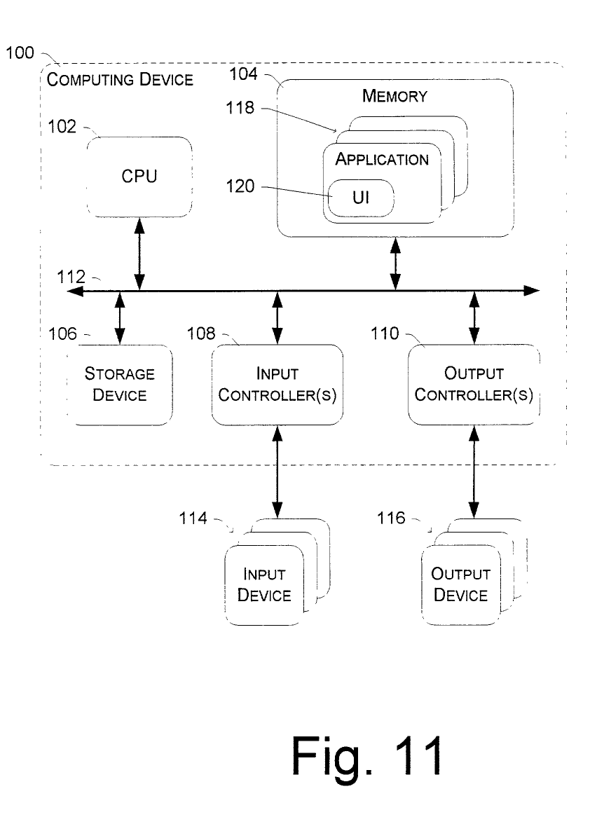

FIG. 12 is a diagram illustrating an example of characterizing multiple UI designs.

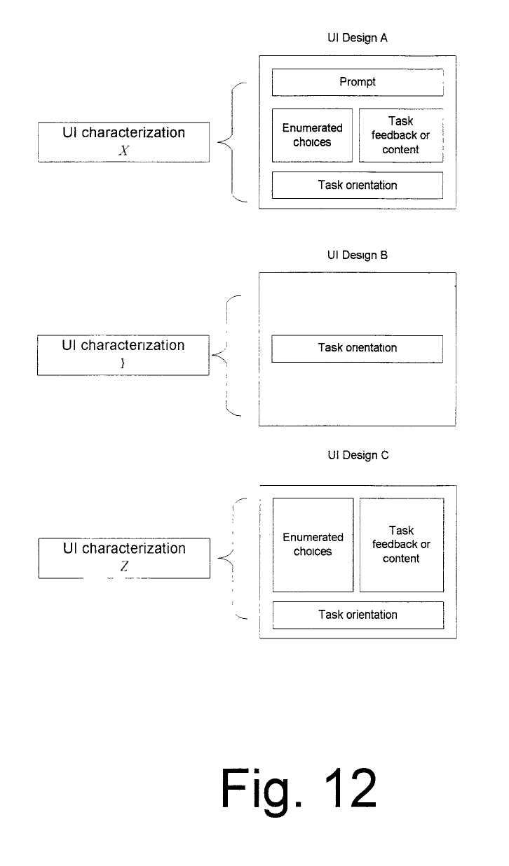

FIG. 13 is a diagram illustrating another example of characterizing multiple UI designs.

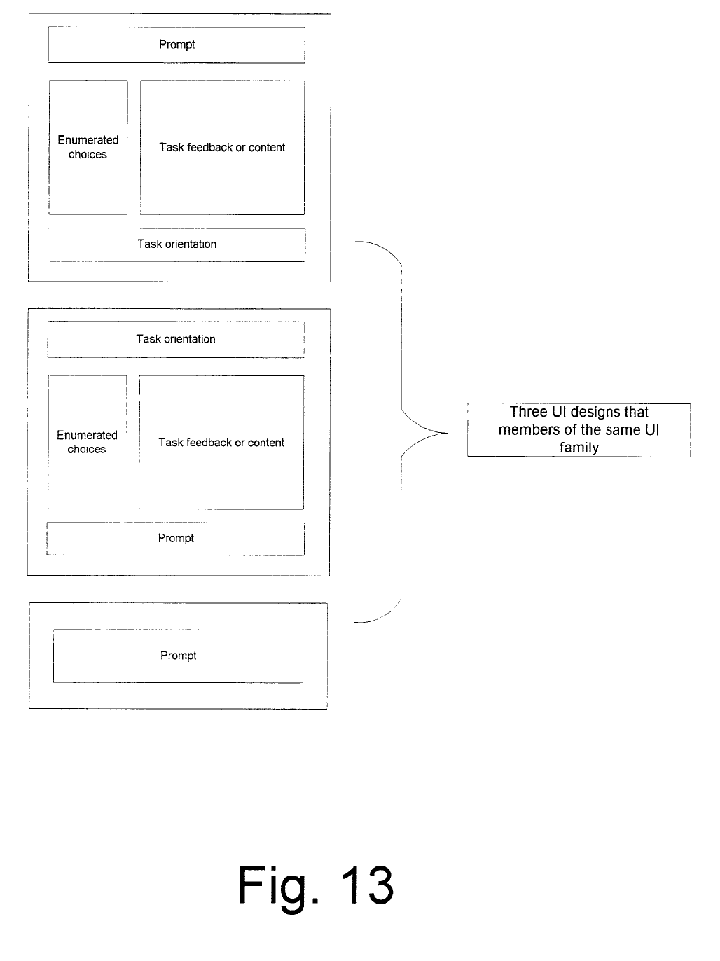

FIG. 14 illustrates an example UI.

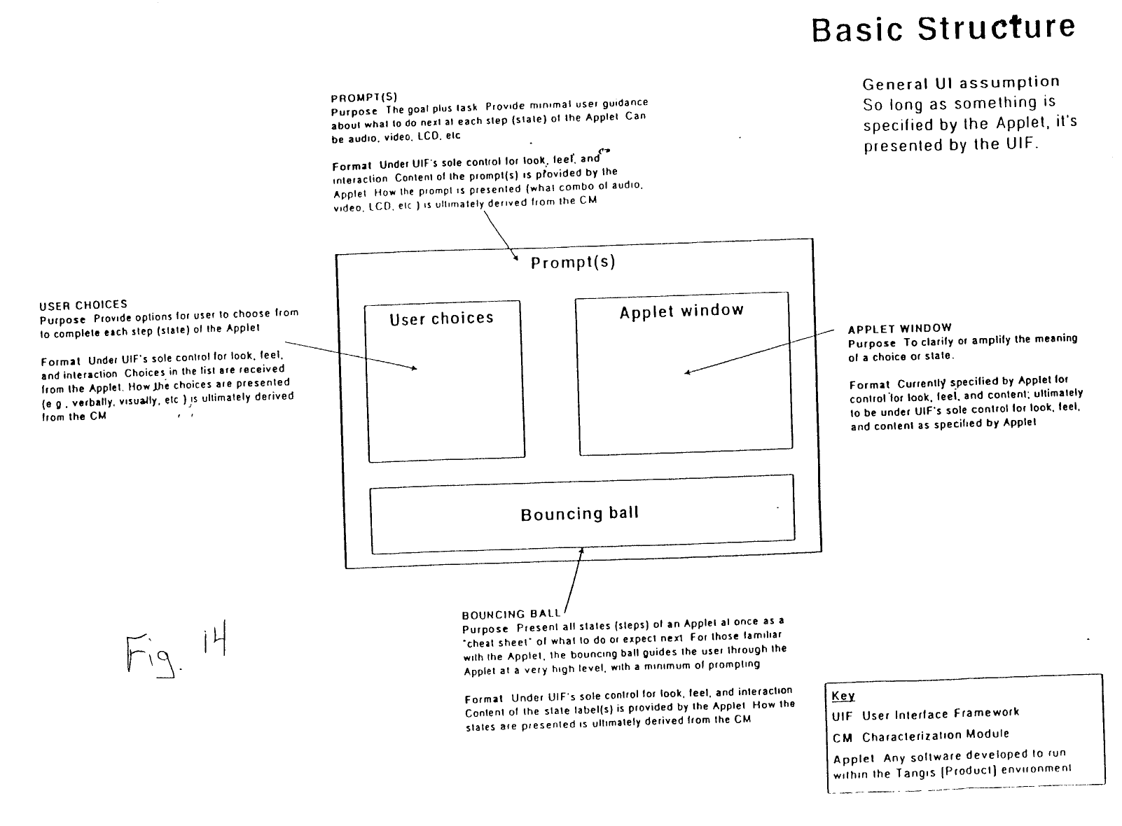

### DETAILED DESCRIPTION

A software facility is described below that provides various techniques for dynamically determining an appropriate UI to be provided to a user. In some embodiments, the software facility executes on behalf of a wearable computing device in order to dynamically modify a UI being provided to a user of the wearable computing device (also referred to as a wearable personal computer or “WPC”) so that the current UI is appropriate for a current context of the user. In order to dynamically determine an appropriate UI, various embodiments characterize various types of UI needs (e.g., based on a current user's situation, a current task being performed, current I/O devices that are available, etc.) in order to determine characteristics of a UI that is currently optimal or appropriate, characterize various existing UI designs or templates in order to identify situations for which they are optimal or appropriate, and then selects and uses one of the existing UIs that is most appropriate based on the current UI needs. In other embodiments, various types of UI needs are characterized and a UI is dynamically generated to reflect those UI needs, such as by combining in an appropriate or optimal manner various UI building block elements that are appropriate or optimal for the UI needs. A UI may in some embodiments be dynamically generated only if an existing available UI is not sufficiently appropriate, and in some embodiments a UI to be used is dynamically generated by modifying an existing available UI.

For illustrative purposes, some embodiments of the software facility are described below in which current UI needs are determined in particular ways, in which existing UIs are characterized in various ways, and in which appropriate or optimal UIs are selected or generated in various ways. In addition, some embodiments of the software facility are described below in which described techniques are used to provide an appropriate UI to a user of a wearable computing device based on a current context of the user. However, those skilled in the art will appreciate that the disclosed techniques can be used in a wide variety of other situations and that UI needs and UI characterizations can be determined in a variety of ways.

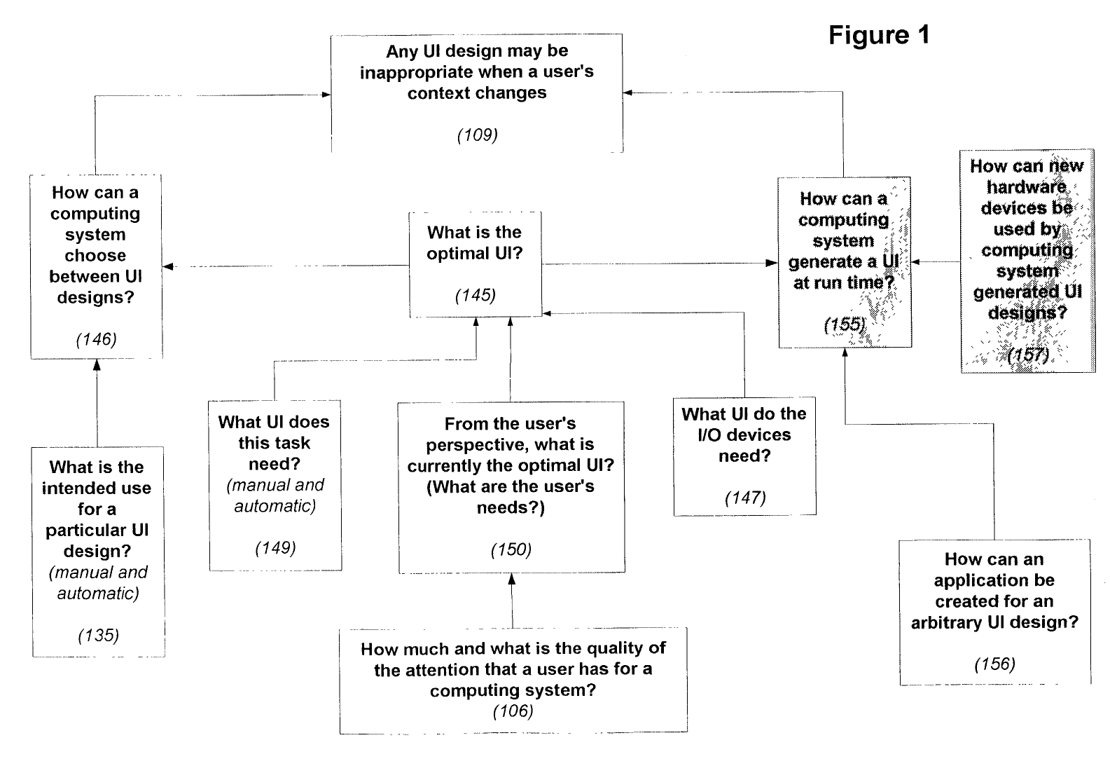

FIG. 1 illustrates an example of one embodiment of an architecture for dynamically determining an appropriate UI. In particular, box 109 represents using an appropriate UI for a current context. When changes in the current context render a previous UI inappropriate or non-optimal, a new UI appropriate or optimal UI can be selected or generated, as is shown in boxes 146 and 155 respectively. In order to enable selection of a new UI that is appropriate or optimal, the characteristics of a UI that is currently appropriate or optimal are determined in box 145 and the characteristics of various existing UIs are determined in box 135 (e.g., in a manual and/or automatic manner). In order to enable the determination of the characteristics of a UI that is currently appropriate or optimal, in the illustrated embodiment the UI requirements of the current task are determined in box 149 (e.g., in a manual and/or automatic manner), the UI requirements corresponding to the user are determined in box 150 (e.g., based on the user's current needs), and the UI requirements corresponding to the currently available I/O devices are determined in box 147. The UI requirements corresponding to the user can be determined in various ways, such as in the illustrated embodiment by determining in box 106 the quantity and quality of attention that the user can currently provide to their computing system and/or executing application. If a new appropriate or optimal UI is to generated in box 155, the generation is enabled in the illustrated embodiment by determining the characteristics of a UI that is currently appropriate or optimal in box 145, determining techniques for constructing a UI design to reflect UI requirements in box 156 (e.g., by combining various specified UI building block elements), and determining how newly available hardware devices can be used as part of the UI. The order and frequency of the illustrated types of processing can be varied in various embodiments, and in other embodiments some of the illustrated types of processing may not be performed and/or additional non-illustrated types of processing may be used.

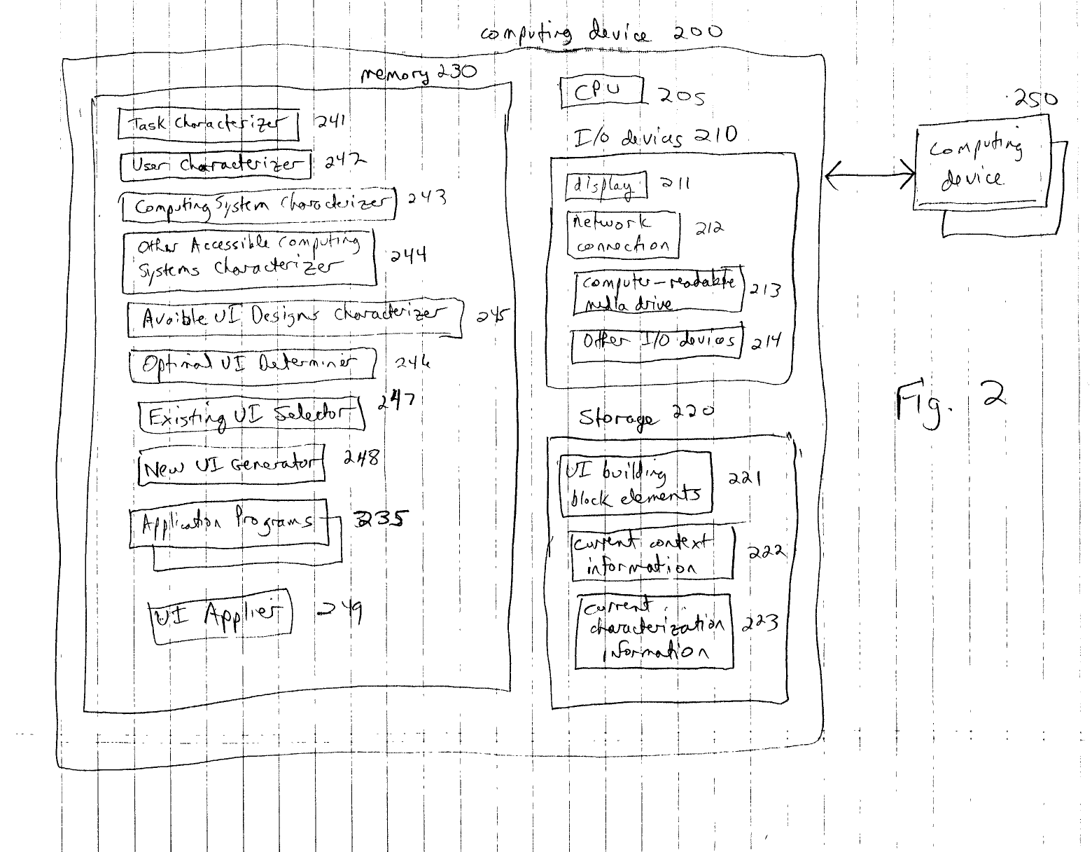

FIG. 2 illustrates an example computing device 200 suitable for executing an embodiment of the facility, as well as one or more additional computing device 250s with which the computing device 200 may interact. The computing device 200 includes a CPU 205, various I/O devices 210, storage 220, and memory 230. The I/O devices include a display 211, a network connection 212, a computer-readable media drive 213, and other I/O devices 214.

Various components 241-248 are executing in memory 230 to enable dynamic determination of appropriate or optimal UIs, as are a UI Applier component 249 to apply an appropriate or optimal UI that is dynamically determined. One or more other application programs 235 may also be executing in memory, and the UI Applier may supply, replace or modify the UIs of those application programs. The dynamic determination components include a Task Characterizer 241, a User Characterizer 242, a Computing System Characterizer 243, an Other Accessible Computing Systems Characterizer 244, an Available UI Designs Characterizer 245, an Optimal UI Determiner 246, an Existing UI Selector 247, and a New UI Generator 248. The various components may use and/or generate a variety of information when executing, such as UI building block elements 221, current context information 222, and current characterization information 223.

Those skilled in the art will appreciate that computing devices 200 and 250 are merely illustrative and are not intended to limit the scope of the present invention. Computing device 200 may be connected to other devices that are not illustrated, including through one or more networks such as the Internet or via the World Wide Web (WWW), and many in some embodiments be a wearable computer. In other embodiments, the computing devices may comprise other combinations of hardware and software, including computers, network devices, internet appliances, PDAs, wireless phones, pagers, electronic organizers, television-based systems and various other consumer products that include inter-communication capabilities. In addition, the functionality provided by the illustrated components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Some or all of the components and their data structures may also be stored (e.g., as instructions or structured data) on a computer-readable medium, such as a hard disk, a memory, a network, or a portable article to be read by an appropriate drive. The components and data structures can also be transmitted as generated data signals (e.g., as part of a carrier wave) on a variety of computer-readable transmission mediums, including wireless-based and wired/cable-based mediums Accordingly, the present invention may be practiced with other computer system configurations.

What follows are various examples of techniques for dynamically determining an appropriate UI, such as by characterizing various types of UI needs and/or by characterizing various existing UI designs or templates in order to identify situations for which they are optimal or appropriate.

Modeling a Computer User's Cognitive Availability

User's Meaning

(the significance and/or implication of things, in the user's mind)

Task, Purpose, Activity, Destination, Motivation, Desired Privacy

When we assign a type, a friendly name, or description to a thing like place, we support the inference of intention.

A grocery store is where activity associated with shopping can be accomplished—it is a characterization, an association of activities, in the mind of the user about a specific place.

User's Cognition

Cognitive/Attention Availability

“Change in Cognitive Availability [symbol] Change in Mode of interaction” (could differentiate between ‘user doesn't have the cycles’ and ‘user has them, but does not chose to give them to WPC’)

“State Info/Compartmentalization [symbol] Complexity of UI”

Characterize tasks as PC Aware, or not.

Divided User Attention

This section will deal primarily with Divided Attention.

When performing more than one task at a time, the user can engage in three types of tasks:

Focus Tasks: requires the users primary attention

An example of a Focus Task is looking at a map.

Routine Tasks: requires attention from the user, but allows multi-tasking in parallel

An example of a Routine Task is talking on a cell phone, through the headset.

Awareness Tasks: does not require any significant attention from the user

For an example of an “Awareness Task”, imagine that the rate of data connectivity were represented as the background sound of flowing water. The user would be aware of the rate at some level, without significantly impacting the available User Attention.

To perform tasks simultaneously, there are three kinds of divided attention-Task Switched, Parallel, and Awareness, as follows:

Task Switching (Focus Task+Focus Task)

When the user is engaged in more than one Focus Task, the attention is Task Switched. The user performs a compartmentalized subset of one task, interrupts that task, and performs a compartmentalized subset of the other task, as follows:

[image]

Re-Grounding Phase: As the user returns to a Focus Task, they first reacquire any state information associated with the task, and/or acquire the UI elements themselves. Either the user or the WPC can carry the state information.

Work Phase: Here the user actually performs the sub-task. The longer this phase, the more complex the subtask can be.

Interruption/Off Task: When the interruption occurs, the user switches from one Focus Task to another task.

When the duration of Work on Task increases (say, when the user's motion temporarily goes from 30 MPH to 0), then task presentation can more complex. This includes increased context of the steps involved (e.g., view more steps in the Bouncing Ball Wizard) or greater detail of each step (addition of other people's schedule when making appointments).

The longer the Off Task cycle, the more likely the user is to lose Task State Information that is carried in their head. Also, the more complex or voluminous the Task State Information, the more desirable it becomes to allow the WPC to present the state information. The side effect of using the WPC to present Task State Information is that the Re-Grounding Phase may be lengthened, reducing the Work Phase.

Parallel

(Focus Task+Routine) OR (Routine+Routine)

Background Awareness

The concept of Background Awareness is that a non-focus output stimulus allows the user to monitor information without devoting significant attention or cognition. The stimulus retreats to the subconscious, but the user is consciously aware of an abrupt change in the stimulus.

Cocktail Party Effect

In audio, a phenomenon known as the “Cocktail Party Effect” allows a user to listen to multiple background audio channels, as long as the sounds representing each process are distinguishable.

Experiments have shown that increasing the channels beyond three (3) causes degradation in comprehension. [Stiefelman94]

Spatial layout (3D Audio) can be used as an aid to audio memory. Focus can be given to a particular audio channel by increasing the gain on that channel.

Listening and Monitoring have different cognitive burdens.

The MIT Nomadic Radio Paper “Simultaneous and Spatial Listening” provides additional information on this phenomenon.

Characterizing a Computer User's UI Requirements

When monitoring and evaluating some or all available characteristics that could cause a UI to change (regardless of the source of the characteristic), it is possible to choose one or more of the most important characteristics upon which to build a UI, and then pass those characteristics to the computing system.

Considered singularly, many of the characteristics described in this disclosure can be beneficially used to inform a computing system when to change. However, with an extensible system, additional characteristics can be considered (or ignored) at anytime, providing precision to the optimization.

Attributes Analyzed

This section describes various modeled real-world and virtual contexts The described model for optimal UI design characterization includes at least the following categories of attributes when determining the optimal UI design:

All available attributes. The model is dynamic so it can accommodate for any and all attributes that could affect the optimal UI design for a user's context.

For example, this model could accommodate for temperature, weather conditions, time of day, available I/O devices, preferred volume level, desired level of privacy, and so on.

Significant attributes. Some attributes have a more significant influence on the optimal UI design than others. Significant attributes include, but are not limited to, the following:

The user can see video.

The user can hear audio.

The computing system can hear the user.

The interaction between the user and the computing system must be private.

The user's hands are occupied.

Attributes that correspond to a theme. Specific or programmatic. Individual or group.

Using even one of these attribute categories can produce a large number of potential UIs. As discussed below, a limited model of user context can generate a large number of distinct situations, each potentially requiring a unique UI design. Despite this large number, this is not a challenge for software implementation. Modern computers can easily handle software implementations of much larger lookup tables.

Although this document lists many attributes of a user's tasks and mental and physical environment, these attributes are meant to be illustrative because it is not possible to know all of the attributes that will affect a UI design until run time. The described model is dynamic so it can account for unknown attributes.

It is important to note that any of the attributes mentioned in this document are just examples. There are other attributes that can cause a UI to change that are not listed in this document. However, the dynamic model can account for additional attributes.

User Characterizations

This section describes the characteristics that are related to the user.

User Preferences

User preferences are a set of attributes that reflect the user's likes and dislikes, such as I/O devices preferences, volume of audio output, amount of haptic pressure, and font size and color for visual display surfaces. User preferences can be classified in the following categories:

Self characterization. Self-characterized user preferences are indications from the user to the computing system about themselves. The self-characterizations can be explicit or implicit. An explicit, self-characterized user preference results in a tangible change in the interaction and presentation of the UI. An example of an explicit, self characterized user preference is “Always use the font size 18” or “The volume is always off.” An implicit, self-characterized user preference results in a change in the interaction and presentation of the UI, but it might be not be immediately tangible to the user. A learning style is an implicit self-characterization. The user's learning style could affect the UI design, but the change is not as tangible as an explicit, self-characterized user preference.

If a user characterizes themselves to a computing system as a “visually impaired, expert computer user,” the UI might respond by always using 24-point font and monochrome with any visual display surface. Additionally, tasks would be chunked differently, shortcuts would be available immediately, and other accommodations would be made to tailor the UI to the expert user.

Theme selection. In some situations, it is appropriate for the computing system to change the UI based on a specific theme. For example, a high school student in public school 1420 who is attending a chemistry class could have a UI appropriate for performing chemistry experiments. Likewise, an airplane mechanic could also have a UI appropriate for repairing airplane engines. While both of these UIs would benefit from hands free, eyes out computing, the UI would be specifically and distinctively characterized for that particular system.

System characterization. When a computing system somehow infers a user's preferences and uses those preferences to design an optimal UI, the user preferences are considered to be system characterizations. These types of user preferences can be analyzed by the computing system over a specified period on time in which the computing system specifically detects patterns of use, learning style, level of expertise, and so on. Or, the user can play a game with the computing system that is specifically designed to detect these same characteristics.

Pre-configured. Some characterizations can be common and the UI can have a variety of pre-configured settings that the user can easily indicate to the UI. Pre-configured settings can include system settings and other popular user changes to default settings.

Remotely controlled. From time to time, it may be appropriate for someone or something other than the user to control the UI that is displayed.

Example User Preference Characterization Values

This UI characterization scale is enumerated. Some example values include:

Self characterization

Theme selection

System characterization

Pre-configured

Remotely controlled

Theme

A theme is a related set of measures of specific context elements, such as ambient temperature, current user task, and latitude, which reflect the context of the user. In other words, theme is a name collection of attributes, attribute values, and logic that relates these things. Typically, themes are associated with user goals, activities, or preferences. The context of the user includes:

The user's mental state, emotional state, and physical or health condition.

The user's setting, situation or physical environment. This includes factors external to the user that can be observed and/or manipulated by the user, such as the state of the user's computing system.

The user's logical and data telecommunications environment (or “cyber-environment,” including information such as email addresses, nearby telecommunications access such as cell sites, wireless computer ports, etc.).

Some examples of different themes include: home, work, school, and so on. Like user preferences, themes can be self characterized, system characterized, inferred, pre-configured, or remotely controlled.

Example Theme Characterization Values

This characteristic is enumerated. The following list contains example enumerated values for theme.

No theme

The user's theme is inferred.

The user's theme is pre-configured.

The user's theme is remotely controlled.

The user's theme is self characterized.

The user's theme is system characterized.

User Characteristics

User characteristics include:

Emotional state

Physical state

Cognitive state

Social state

Example User Characteristics Characterization Values

This UI characterization scale is enumerated. The following lists contain some of the enumerated values for each of the user characteristic qualities listed above.

* Emotional state.

* Happiness
* Sadness
* Anger
* Frustration
* Confusion

* Physical state

* Body
* Biometrics
* Posture
* Motion
* Physical Availability

* Senses

* Eyes
* Ears
* Tactile
* Hands
* Nose
* Tongue

* Workload demands/effects
* Interaction with computer devices
* Interaction with people
* Physical Health

* Environment

* Time/Space
* Objects
* Persons
* Audience/Privacy Availability

* Scope of Disclosure
* Hardware affinity for privacy
* Privacy indicator for user
* Privacy indicator for public
* Watching indicator
* Being observed indicator

* Ambient Interference

* Visual
* Audio
* Tactile

* Location.

* Place_name
* Latitude
* Longitude
* Altitude
* Room
* Floor
* Building
* Address
* Street
* City
* County
* State
* Country
* Postal_Code

* Physiology.

* Pulse
* Body_temperature
* Blood_pressure
* Respiration

* Activity

* Driving
* Eating
* Running
* Sleeping
* Talking
* Typing
* Walking

*Cognitive state

* Meaning

* Cognition

* Divided User Attention
* Task Switching
* Background Awareness

* Solitude
* Privacy

* Desired Privacy
* Perceived Privacy

* Social Context
* Affect

* Social state

* Whether the user is alone or if others are present
* Whether the user is being observed (e.g., by a camera)
* The user's perceptions of the people around them and the user's

perceptions of the intentions of the people that surround them.

* The user's social role (e.g. they are a prisoner, they are a guard, they are

a nurse, they are a teacher, they are a student, etc.)

Cognitive Availability

There are three kinds of user tasks: focus, routine, and awareness and three main categories of user attention: background awareness, task switched attention, and parallel. Each type of task is associated with a different category of attention. Focus tasks require the highest amount of user attention and are typically associated with task-switched attention. Routine tasks require a minimal amount of user attention or a user's divided attention and are typically associated with parallel attention. Awareness tasks appeals to a user's precognitive state or attention and are typically associated with background awareness. When there is an abrupt change in the sound, such as changing from a trickle to a waterfall, the user is notified of the change in activity.

Background Awareness

Background awareness is a non-focus output stimulus that allows the user to monitor information without devoting significant attention or cognition.

Example Background Awareness Characterization Values

This characterization is scalar, with the minimum range being binary. Example binary values or scale endpoints are: the user has no awareness of the computing system/the user has background awareness of the computing system.

Using these values as scale endpoints, the following list is an example background awareness scale.

No background awareness is available. A user's pre-cognitive state is unavailable.

A user has enough background awareness available to the computing system to receive one type of feedback or status.

A user has enough background awareness available to the computing system to receive more than one type of feedback, status and so on.

A user's background awareness is fully available to the computing system. A user has enough background awareness available for the computing system such that they can perceive more than two types of feedback or status from the computing system.

Exemplary UI Design Implementations for Background Awareness

The following list contains examples of UI design implementations for how a computing system might respond to a change in background awareness.

If a user does not have any attention for the computing system, that implies that no input or output are needed.

If a user has enough background awareness available to receive one type of feedback, the UI might:

Present a single light in the peripheral vision of a user. For example, this light can represent the amount of battery power available to the computing system. As the battery life weakens, the light gets dimmer. If the battery is recharging, the light gets stronger.

If a user has enough background awareness available to receive more than one type of feedback, the UI might:

Present a single light in the peripheral vision of the user that signifies available battery power and the sound of water to represent data connectivity.

If a user has full background awareness, then the UI might:

Present a single light in the peripheral vision of the user that signifies available battery power, the sound of water that represents data connectivity, and pressure on the skin to represent the amount of memory available to the computing system.

Task Switched Attention

When the user is engaged in more than one focus task, the user's attention can be considered to be task switched.

Example Task Switched Attention Characterization Values

This characteristic is scalar, with the minimum range being binary. Example binary values, or scale endpoints, are: the user does not have any attention for a focus task/the user has full attention for a focus task.

Using these characteristics as the scale endpoints, the following list is an example of a task switched attention scale.

A user does not have any attention for a focus task.

A user does not have enough attention to complete a simple focus task. The time between focus tasks is long.

A user has enough attention to complete a simple focus task. The time between focus tasks is long.

A user does not have enough attention to complete a simple focus task. The time between focus tasks is moderately long.

A user has enough attention to complete a simple focus task. The time between tasks is moderately long.

A user does not have enough attention to complete a simple focus task. The time between focus tasks is short.

A user has enough attention to complete a simple focus task. The time between focus tasks is short.

A user does not have enough attention to complete a moderately complex focus task. The time between focus tasks is long.

A user has enough attention to complete a moderately complex focus task. The time between focus tasks is long.

A user does not have enough attention to complete a moderately complex focus task. The time between focus tasks is moderately long.

A user has enough attention to complete a moderately complex focus task. The time between tasks is moderately long.

A user does not have enough attention to complete a moderately complex focus task. The time between focus tasks is short.

A user has enough attention to complete a moderately complex focus task. The time between focus tasks is short.

A user does not have enough attention to complete a moderately complex focus task. The time between focus tasks is long.

A user has enough attention to complete a complex focus task. The time between focus tasks is long.

A user does not have enough attention to complete a complex focus task. The time between focus tasks is moderately long.

A user has enough attention to complete a complex focus task. The time between tasks is moderately long.

A user does not have enough attention to complete a complex focus task. The time between focus tasks is short.

A user has enough attention to complete a complex focus task. The time between focus tasks is short.

A user has enough attention to complete a very complex, multi-stage focus task before moving to a different focus task.

Parallel

Parallel attention can consist of focus tasks interspersed with routine tasks (focus task+routine task) or a series of routine tasks (routing task+routine task).

Example Parallel Attention Characterization Values

This characteristic is scalar, with the minimum range being binary. Example binary values, or scale endpoints, are: the user does not have enough attention for a parallel task/the user has full attention for a parallel task.

Using these characteristics as scale endpoints, the following list is an example of a parallel attention scale.

A user has enough available attention for one routine task and that task is not with the computing system.

A user has enough available attention for one routine task and that task is with the computing system.

A user has enough attention to perform two routine tasks and at least of the routine tasks is with the computing system.

A user has enough attention to perform a focus task and a routine task. At least one of the tasks is with the computing system.

A user has enough attention to perform three or more parallel tasks and at least one of those tasks is in the computing system.

Physical Availability

Physical availability is the degree to which a person is able to perceive and manipulate a device. For example, an airplane mechanic who is repairing an engine does not have hands available to input indications to the computing systems by using a keyboard.

Learning Profile

A user's learning style is based on their preference for sensory intake of information. That is, most users have a preference for which sense they use to assimilate new information.

Example Learning Style Characterization Values

This characterization is enumerated. The following list is an example of learning style characterization values.

Auditory

Visual

Tactile

Exemplary UI Design Implementation for Learning Style

The following list contains examples of UI design implementations for how the computing system might respond to a learning style.

If a user is a auditory learner, the UI might:

Present content to the user by using audio more frequently.

Limit the amount of information presented to a user if these is a lot of ambient noise.

If a user is a visual learner, the UI might:

Present content to the user in a visual format whenever possible.

Use different colors to group different concepts or ideas together.

Use illustrations, graphs, charts, and diagrams to demonstrate content when appropriate.

If a user is a tactile learner, the UI might:

Present content to the user by using tactile output.

Increase the affordance of tactile methods of input (e.g. increase the affordance of keyboards).

Software Accessibility

If an application requires a media-specific plug-in, and the user does not have a network connection, then a user might not be able to accomplish a task.

Example Software Accessibility Characterization Values

This characterization is enumerated. The following list is an example of software accessibility values.

The computing system does not have access to software.

The computing system has access to some of the local software resources.

The computing system has access to all of the local software resources.

The computing system has access to all of the local software resources and some of the remote software resources by availing itself to opportunistic user of software resources.

The computing system has access to all of the local software resources and all remote software resources by availing itself to the opportunistic user of software resources.

The computing system has access to all software resources that are local and remote.

Perception of Solitude

Solitude is a user's desire for, and perception of, freedom from input. To meet a user's desire for solitude, the UI can do things like:

Cancel unwanted ambient noise

Block out human made symbols generated by other humans and machines

Example Solitude Characterization Values

This characterization is scalar, with the minimum range being binary. Example binary values, or scalar endpoints, are: no solitude/complete solitude.

Using these characteristics as scale endpoints, the following list is an example of a solitude scale.

No solitude

Some solitude

Complete solitude

Privacy

Privacy is the quality or state of being apart from company or observation. It includes a user's trust of audience. For example, if a user doesn't want anyone to know that they are interacting with a computing system (such as a wearable computer), the preferred output device might be a head mounted display (HMD) and the preferred input device might be an eye-tracking device.

Hardware Affinity for Privacy

Some hardware suits private interactions with a computing system more than others. For example, an HMD is a far more private output device than a desk monitor. Similarly, an earphone is more private than a speaker.

The UI should choose the correct input and output devices that are appropriate for the desired level of privacy for the user's current context and preferences.

Example Privacy Characterization Values

This characteristic is scalar, with the minimum range being binary. Example binary values, or scale endpoints, are: not private/private, public/not public, and public/private.

Using no privacy and fully private as the scale endpoints, the following list is an example privacy characterization scale.

No privacy is needed for input or output interaction

The input must be semi-private. The output does not need to be private.

The input must be fully private. The output does not need to be private.

The input must be fully private. The output must be semi-private.

The input does not need to be private. The output must be fully private.

The input does not need to be private. The output must be semi-private.

The input must be semi-private. The output must be semi-private.

The input and output interaction must be fully private.

Semi-private. The user and at least one other person can have access to or knowledge of the interaction between the user and the computing system.

Fully private. Only the user can have access to or knowledge of the interaction between the user and the computing system.

Exemplary UI Design Implementation for Privacy

The following list contains examples of UI design implementations for how the computing system might respond to a change in task complexity.

If no privacy is needed for input or output interaction:

The UI is not restricted to any particular I/O device for presentation and interaction. For example, the UI could present content to the user through speakers on a large monitor in a busy office.

If the input must be semi-private and if the output does not need to be private, the UI might:

Encourage the user to use coded speech commands or use a keyboard if one is available. There are no restrictions on output presentation.

If the input must be fully private and if the output does not need to be private, the UI might:

Not allow speech commands. There are no restrictions on output presentation.

If the input must be fully private and if the output needs to be semi-private, the UI might:

Not allow speech commands (allow only keyboard commands). Not allow an LCD panel and use earphones to provide audio response to the user.

If the output must be semi-private and if the input does not need to be private, the UI might:

Restrict users to an HMD device and/or an earphone for output. There are no restrictions on input interaction,

If the output must be semi-private and if the input does not need to be private, the UI might:

Restrict users to HMD devices, earphones, and/or LCD panels. There are no restrictions on input interaction.

If the input and output must be semi-private, the UI might:

Encourage the user to use coded speech commands and keyboard methods for input. Output may be restricted to HMD devices, earphones or LCD panels.

If the input and output interaction must be completely private, the UI might:

Not allow speech commands and encourage the user of keyboard methods of input. Output is restricted to HMD devices and/or earphones.

User Expertise

As the user becomes more familiar with the computing system or the UI, they may be able to navigate through the UI more quickly. Various levels of user expertise can be accommodated. For example, instead of configuring all the settings to make an appointment, users can recite all the appropriate commands in the correct order to make an appointment. Or users might be able to use shortcuts to advance or move back to specific screens in the UI. Additionally, expert users may not need as many prompts as novice users. The UI should adapt to the expertise level of the user.

Example User Expertise Characterization Values

This characteristic is scalar, with the minimum range being binary. Example binary values, or scale endpoints, are: new user/not new user, not an expert user/expert user, new user/expert user, and novice/expert.

Using novice and expert as scale endpoints, the following list is an example user expertise scale.

The user is new to the computing system and to computing in general.

The user is new to the computing system and is an intermediate computer user.

The user is new to the computing system, but is an expert computer user.

The user is an intermediate user in the computing system.

The user is an expert user in the computing system.

Exemplary UI Design Implementation for User Expertise

The following are characteristics of an exemplary audio UI design for novice and expert computer users.

The computing system speaks a prompt to the user and waits for a response.

If the user responds in x seconds or less, then the user is an expert. The computing system gives the user prompts only.

If the user responds in >x seconds, then the user is a novice and the computing system begins enumerating the choices available.

This type of UI design works well when more than 1 user accesses the same computing system and the computing system and the users do not know if they are a novice or an expert.

Language

User context may include language, as in the language they are currently speaking (e.g. English, German, Japanese, Spanish, etc.).

Example Language Characterization Values

This characteristic is enumerated. Example values include:

American English

British English

German

Spanish

Japanese

Chinese

Vietnamese

Russian

French

Computing System

This section describes attributes associated with the computing system that may cause a UI to change.

Computing Hardware Capability

For purposes of user interfaces designs, there are four categories of hardware:

Input/output devices

Storage (e.g. RAM)

Processing capabilities

Power supply

The hardware discussed in this topic can be the hardware that is always available to the computing system. This type of hardware is usually local to the user. Or the hardware could sometimes be available to the computing system. When a computing system uses resources that are sometimes available to it, this can be called an opportunistic use of resources.

Storage

Storage capacity refers to how much random access memory (RAM) is available to the computing system at any given moment. This number is not considered to be constant because the computing system might avail itself to the opportunistic use of memory.

Usually the user does not need to be aware of how much storage is available unless they are engaged in a task that might require more memory than to which they reliably have access. This might happen when the computing system engages in opportunistic use of memory. For example, if an in-motion user is engaged in a task that requires the opportunistic use of memory and that user decides to change location (e.g. they are moving from their vehicle to a utility pole where they must complete other tasks), the UI might warn the user that if they leave the current location, the computing system may not be able to complete the task or the task might not get completed as quickly.

Example Storage Characterization Values

This UI characterization is scalar, with the minimum range being binary. Example binary values or scale endpoints are: no RAM is available/all RAM is available.

Using no RAM is available and all RAM is available, the following table lists an example storage characterization scale.

| Scale attribute | Implication |
|---|---|
| No RAM is available to the | If no RAM is available, there is |
| computing system | no UI available.-Or-There is no |
| | change to the UI. |
| Of the RAM available to the | The UI is restricted to the |
| computing system, only the | opportunistic use of RAM. |
| opportunistic use of RAM is available. | |
| Of the RAM that is available to | The UI is restricted to using |
| the computing system, only the local | local RAM. |
| RAM is accessible | |
| Of the RAM that is available to | The UI might warn the user |
| the computing system, the local RAM is | that if they lose |
| available and the user is about to lose | opportunistic use of memory, |
| opportunistic use of RAM. | the computing system might |
| | not be able to complete the |
| | task, or the task might not |
| | be completed as quickly |
| Of the total possible RAM | If there is enough memory |
| available to the computing system, all | available to the computing |
| of it is available. | system to fully function |
| | at a high level, the UI |
| | may not need to inform the |
| | user. If the user indicates |
| | to the computing system that |
| | they want a task completed |
| | that requires more memory, |
| | the UI might suggest that |
| | the user change locations |
| | to take advantage of |
| | additional opportunistic |
| | use of memory. |

Processing Capabilities

Processing capabilities fall into two general categories:

Speed. The processing speed of a computing system is measured in megahertz (MHz). Processing speed can be reflected as the rate of logic calculation and the rate of content delivery. The more processing power a computing system has, the faster it can calculate logic and deliver content to the user.

CPU usage. The degree of CPU usage does not affect the UI explicitly.

With current UI design, if the CPU becomes too busy, the UI Typically “freezes” and the user is unable to interact with the computing system. If the CPU usage is too high, the UI will change to accommodate the CPU capabilities. For example, if the processor cannot handle the demands, the UI can simplify to reduce demand on the processor.

Example Processing Capability Characterization Values

This UI characterization is scalar, with the minimum range being binary. Example binary or scale endpoints are: no processing capability is available/all processing capability is available.

Using no processing capability is available and all processing capability as scale endpoints, the following table lists an example processing capability scale.

| | |
|---|---|
| Scale attribute | Implication |
| No processing power is | There is no change to the UI |
| available to the comput- | |
| ing system | |
| The computing system has | The UI might be audio or text |
| access to a slower speed CPU. | only. |
| The computing system has | The UI might choose to use |
| access to a high speed CPU | video in the presentation |
| | instead of a still picture. |
| The computing system has | There are no restrictions on the |
| access to and control of all | UI based on processing power. |
| processing power available | |
| to the computing system. | |

Power Supply

There are two types of power supplies available to computing systems: alternating current (AC) and direct current (DC). Specific scale attributes for AC power supplies are represented by the extremes of the exemplary scale. However, if a user is connected to an AC power supply, it may be useful for the UI to warn an in-motion user when they're leaving an AC power supply. The user might need to switch to a DC power supply if they wish to continue interacting with the computing system while in motion. However, the switch from AC to DC power should be an automatic function of the computing system and not a function of the UI.

On the other hand, many computing devices, such as wearable personal computers (WPCs), laptops, and PDAs, operate using a battery to enable the user to be mobile. As the battery power wanes, the UI might suggest the elimination of video presentations to extend battery life. Or the UI could display a VU meter that visually demonstrates the available battery power so the user can implement their preferences accordingly.

Example Power Supply Characterization Values

This task characterization is binary if the power supply is AC and scalar if the power supply is DC. Example binary values are: no power/full power. Example scale endpoints are: no power/all power.

Using no power and full power as scale endpoints, the following list is an example power supply scale.

There is no power to the computing system.

There is an imminent exhaustion of power to the computing system.

There is an inadequate supply of power to the computing system.

There is a limited, but potentially inadequate supply of power to the computing system.

There is a limited but adequate power supply to the computing system.

There is an unlimited supply of power to the computing system.

Exemplary UI Design Implementations for Power Supply

The following list contains examples of UI design implementations for how the computing system might respond to a change in the power supply capacity.

If there is minimal power remaining in a battery that is supporting a computing system, the UI might:

Power down any visual presentation surfaces, such as an LCD.

Use audio output only.

If there is minimal power remaining in a battery and the UI is already audio-only, the UI might:

Decrease the audio output volume.

Decrease the number of speakers that receive the audio output or use earplugs only.

Use mono versus stereo output.

Decrease the number of confirmations to the user.

If there is, for example, six hours of maximum-use battery life available and the computing system determines that the user not have access to a different power source for 8 hours, the UI might:

Decrease the luminosity of any visual display by displaying line drawings instead of 3-dimensional illustrations.

Change the chrominance from color to black and white.

Refresh the visual display less often.

Decrease the number of confirmations to the user.

Use audio output only.

Decrease the audio output volume.

Computing Hardware Characteristics

The following is a list of some of the other hardware characteristics that may be influence what is an optimal UI design.

Cost

Waterproof

Ruggedness

Mobility

Again, there are other characteristics that could be added to this list. However, it is not possible to list all computing hardware attributes that might influence what is considered to be an optimal UI design until run time.

Bandwidth

There are different types of bandwidth, for instance:

Network bandwidth

Inter-device bandwidth

Network Bandwidth

Network bandwidth is the computing system's ability to connect to other computing resources such as servers, computers, printers, and so on. A network can be a local area network (LAN), wide area network (WAN), peer-to-peer, and so on. For example, if the user's preferences are stored at a remote location and the computing system determines that the remote resources will not always be available, the system might cache the user's preferences locally to keep the UI consistent. As the cache may consume some of the available RAM resources, the UI might be restricted to simpler presentations, such as text or audio only.

If user preferences cannot be cached, then the UI might offer the user choices about what UI design families are available and the user can indicate their design family preference to the computing system.

Example Network Bandwidth Characterization Values

This UI characterization is scalar, with the minimum range being binary. Example binary values or scale endpoints are: no network access/full network access.

Using no network access and full network access as scale endpoints, the following table lists an example network bandwidth scale.

| Scale attribute | Implication |
|---|---|
| The computing system does not | The UI is restricted to using local |
| have a connection to network | computing resources only. If user |
| resources. | preferences are stored remotely, then |
| | the UI might not account for user |
| | preferences. |
| The computing system has an | The UI might warn the user that |
| unstable connection to | the connection to remote resources |
| network resources | might be interrupted. The UI might |
| | ask the user if they want to cache |
| | appropriate information to |
| | accommodate for the unstable |
| | connection to network resources. |
| The computing system has a | The UI might simplify, such as |
| slow connection to network | offer audio or text only, to |
| resources | accommodate for the slow connection. |
| | Or the computing system might cache |
| | appropriate data for the UI so the UI |
| | can always be optimized without |
| | restriction of the slow connection. |
| The computing system has a | In the present moment, the UI |
| high speed, yet limited (by | does not have any restrictions based |
| time) access to network | on access to network resources. If the |
| resources | computing system determines that |
| | it will lose a network connection, |
| | then the UI can warn the user and |
| | offer choices, such as does the |
| | user want to cache appropriate |
| | information, about what to do. |
| The computing system has a | There are no restrictions to the |
| very high-speed connection | UI based on access to network |
| to network resources. | resources. The UI can offer text, |
| | audio, video, haptic output, and so |
| | on. |

Inter-Device Bandwidth

Inter-device bandwidth is the ability of the devices that are local to the user to communicate with each other. Inter-device bandwidth can affect the UI in that if there is low inter-device bandwidth, then the computing system cannot compute logic and deliver content as quickly. Therefore, the UI design might be restricted to a simpler interaction and presentation, such as audio or text only. If bandwidth is optimal, then there are no restrictions on the UI based on bandwidth. For example, the UI might offer text, audio, and 3-D moving graphics if appropriate for the user's context.

Example Inter-Device Bandwidth Characterization Values

This UI characterization is scalar, with the minimum range being binary. Example binary values or scale endpoints are: no inter-device bandwidth/full inter-device bandwidth.

Using no inter-device bandwidth and full inter-device bandwidth as scale endpoints, the following table lists an example inter-device bandwidth scale.

| Scale attribute | Implication |
|---|---|
| The computing system does not | Input and output is restricted to |
| have inter-device connectivity. | each of the disconnected devices. The |
| | UI is restricted to the capability of each |
| | device as a stand-alone device. |
| Some devices have connectivity | It depends |
| and others do not. | |
| The computing system has | The task that the user wants to |
| slow inter-device bandwidth. | complete might require more bandwidth |
| | that is available among devices. In this |
| | case, the UI can offer the user a choice. |
| | Does the user want to continue and |
| | encounter slow performance? Or, does |
| | the user want to acquire more |
| | bandwidth by moving to a different |
| | location and taking advantage of |
| | opportunistic use of bandwidth? |
| The computing system has fast | There are few, if any, restrictions |
| inter-device bandwidth. | on the interaction and presentation |
| | between the user and the computing |
| | system. The UI sends a warning |
| | message only if there is not enough |
| | bandwidth between devices. |
| The computing system has very | There are no restrictions on the |
| high-speed inter-device | UI based on inter-device connectivity. |
| connectivity. | |

Context Availability

Context availability is related to whether the information about the model of the user context is accessible. If the information about the model of the context is intermittent, deemed inaccurate, and so on, then the computing system might not have access to the user's context.

Example Context Availability Characterization Values

This task characterization is scalar, with the minimum range being binary. Example binary values or scale endpoints are: context not available/context available.

Using context not available and context available as scale endpoints, the following list is an example context availability scale.

No context is available to the computing system

Some of the user's context is available to the computing system.

A moderate amount of the user's context is available to the computing system.

Most of the user's context is available to the computing system.

All of the user's context is available to the computing system

Exemplary UI Design for Context Availability

The following list contains examples of UI design implementations for how the computing system might respond to a change in context availability.

If the information about the model of context is intermittent, deemed inaccurate, or otherwise unavailable, the UI might:

Stay the same.

Ask the user if the UI needs to change.

Infer a UI from a previous pattern if the user's context history is available.

Change the UI based on all other attributes except for user context (e.g. I/O device availability, privacy, task characteristics, etc.)

Use a default UI.

Opportunistic Use of Resources

Some UI components, or other enabling UI content, may allow acquisition from outside sources. For example, if a person is using a wearable computer and they sit at a desk that has a monitor on it, the wearable computer might be able to use the desktop monitor as an output device.

Example Opportunistic Use of Resources Characterization Scale

This characteristic is scalar, with the minimum range being binary. Example binary values, or scale endpoints, are: no opportunistic use of resources/use of all opportunistic resources.

Using these characteristics, the following list is an example of an opportunistic use of resources scale.

The circumstances do not allow for the opportunistic use of resources in the computing system.

Of the resources available to the computing system, there is a possibility to make opportunistic use of resources.

Of the resources available to the computing system, the computing system can make opportunistic use of most of the resources.

Of the resources available to the computing system, all are accessible and available.

Content

Content is defined as information or data that is part of or provided by a task. Content, in contrast to UI elements, does not serve a specific role in the user/computer dialog. It provides informative or entertaining information to the user. It is not a control. For example a radio has controls (knobs, buttons) used to choose and format (tune a station, adjust the volume & tone) of broadcasted audio content.

Sometimes content has associated metadata, but it is not necessary.

Example content characterization values

Quality

Static/streamlined

Passive/interactive

Type

Output device required

Output device affinity

Output device preference

Rendering software

Implicit. The computing system can use characteristics that can be inferred from the information itself, such as message characteristics for received messages.

Source. A type or instance of carrier, media, channel or network path

Destination. Address used to reach the user (e.g., a user typically has multiple address, phone numbers, etc.)

Message content. (parseable or described in metadata)

Data format type.

Arrival time.

Size.

Previous messages. Inference based on examination of log of actions on similar messages.

Explicit. Many message formats explicitly include message-characterizing information, which can provide additional filtering criteria.

Title.

Originator identification. (e.g., email author)

Origination date & time

Routing. (e.g., email often shows path through network routers)

Priority

Sensitivity. Security levels and permissions

Encryption type

File format. Might be indicated by file name extension

Language. May include preferred or required font or font type

Other recipients (e.g., email cc field)

Required software

Certification. A trusted indication that the offer characteristics are dependable and accurate.

Recommendations. Outside agencies can offer opinions on what information may be appropriate to a particular type of user or situation.

Security

Controlling security is controlling a user's access to resources and data available in a computing system. For example when a user logs on a network, they must supply a valid user name and password to gain access to resource on the network such as, applications, data, and so on.

In this sense, security is associated with the capability of a user or outside agencies in relation to a user's data or access to data, and does not specify what mechanisms are employed to assure the security.

Security mechanisms can also be separately and specifically enumerated with characterizing attributes.

Permission is related to security. Permission is the security authorization presented to outside people or agencies. This characterization could inform UI creation/selection by giving a distinct indication when the user is presented information that they have given permission to others to access.

Example Security Characterization Values

This characteristic is scalar, with the minimum range being binary. Example binary values, or scale endpoints are: no authorized user access/all user access, no authorized user access/public access, and no public access/public access.

Using no authorized user access and public access as scale endpoints, the following list is an example security scale.

No authorized access.

Single authorized user access.

Authorized access to more than one person

Authorized access for more than one group of people

Public access

Single authorized user only access. The only person who has authorized access to the computing system is a specific user with valid user credentials.

Public access. There are no restrictions on who has access to the computing system. Anyone and everyone can access the computing system.

Exposing Characterization of User's UI Needs

There are many ways to expose user UI need characterizations to the computing system. This section describes some of the ways in which this can be accomplished.

Numeric Key

A context characterization can be exposed to the system with a numeric value corresponding to values of a predefined data structure.

For instance, a binary number can have each of the bit positions associated with a specific characteristic. The least significant bit may represent the need for a visual display device capable of displaying at least 24 characters of text in an unbroken series. Therefore a UI characterization of decimal 5 would require such a display to optimally display its content.

XML Tags

A UI's characterization can be exposed to the system with a string of characters conforming to the XML structure.

For instance, a context characterization might be represented by the following:

<Context Characterization>

<Theme>Work </Theme>

<Bandwidth>High Speed LAN Network Connection</Bandwidth>

<Field of View>28°</Field of View>

<Privacy>None </Privacy>

</Context Characterization>

One significant advantage of the mechanism is that it is easily extensible.

Programming Interface

A context characterization can be exposed to the computing system by associating the design with a specific program call.

For instance:

GetSecureContext can return a handle to the computing system that describes a UI a high security user context.

Name/Value Pairs

A user's UI needs can be modeled or represented with multiple attributes that each correspond to a specific element of the context (e.g., safety, privacy, or security), and the value of an attribute represents a specific measure of that element. For example, for an attribute that represents the a user's privacy needs, a value of “5” represents a specific measurement of privacy. Each attribute preferably has the following properties: a name, a value, an uncertainty level, and a timestamp. For example, the name of the privacy attribute may be “User Privacy” and its value at a particular time may be 5. Associated with the current value may be a timestamp of 08/01/2001 13:07 PST that indicates when the value was generated, and an uncertainty level of +/−1 degrees.

How to Expose Manual Characterization

The UI Designer or other person manually and explicitly determines the task characteristic values. For example, XML metadata could be attached to a UI design that explicitly characterizes it as “private” and “very secure.”

Manual and Automatic Characterization

A UI Designer or other person could manually and explicitly determine a task characteristic and the computing system could automatically derive additional values from the manual characterization. For example, if a UI Designer characterized cognitive load as “high,” then the computing system might infer that the values of task complexity and task length are “high” and “long,” respectively.

Automatic Characterization

The following list contains some ways in which the previously described methods of task characterization could be automatically exposed to the computing system.

The computing system examines the structure of the task and automatically evaluates calculates the task characterization method. For example, an application could evaluate how many steps there are in a wizard to task assistant to determine task complexity. The more steps, the higher the task complexity.

The computing system could apply patterns of use to establish implicit characterizations. For example, characteristics can be based on historic use. A task could have associated with is a list of selected UI designs. A task could therefore have an arbitrary characteristic, such as “activity” with associated values, such as “driving.” A pattern recognition engine determines a predictive correlation using a mechanism such as neural networks.

Characterizing a Task's UI Requirements

For a system to accurately determine an optimal UI design for a user's current computing context, it should be able to determine the task function including the dialog elements, content, task sequence, user requirements, choices in task and the choices about the task. This disclosure describes an explicit extensible method to characterize tasks executed with the assistance of a computing system. Computer UIs are designed to allow the interaction between users and computers for a wide range of system configurations and user situations. In general, any task characterizations can be considered if they are exposed in a way that the system can interpret. Therefore there are three aspects

What task characteristics are exposed?

What are the methods to characterize the tasks?

How are task characteristics exposed to the computing system?

Task Characterizations

A task is a user-perceived objective comprising steps. The topics in this section enumerate some of the important characteristics that can be used to describe tasks. In general, characterizations are needed only if they require a change in the UI design.

The topics in this section include examples of task characterizations, example characterization values, and in some cases, example UI designs or design characteristics.

Task Length

Whether a task is short or long depends upon how long it takes a target user to complete the task. That is, a short task takes a lesser amount of time to complete than a long task. For example, a short task might be creating an appointment. A long task might be playing a game of chess.

Example Task Length Characterization Values

This task characterization is scalar, with the minimum range being binary. Example binary values or scale endpoints are: short/not short, long/not long, or short/long.

Using short/long as scale endpoints, the list is an example task length scale.

The task is very short and can be completed in 30 seconds or less

The task is moderately short and can be completed in 31-60 seconds.

The task is short and can be completed in 61-90 seconds.

The task is slightly long and can be completed in 91-300 seconds.

The task is moderately long and can be completed in 301-1,200 seconds.

The task is long and can be completed in 1,201-3,600 seconds.

The task is very long and can be completed in 3,601 seconds or more.

Task Complexity

Task complexity is measured using the following criteria:

Number of elements in the task. The greater the number of elements, the more likely the task is complex.

Element interrelation. If the elements have a high degree of interrelation, then the more likely the task is complex.

User knowledge of structure. If the structure, or relationships, between the elements in the task is unclear, then the more likely the task is considered to be complex.

If a task has a large number of highly interrelated elements and the relationship between the elements is not known to the user, then the task is considered to be complex. On the other hand, if there are a few elements in the task and their relationship is easily understood by the user, then the task is considered to be well-structured. Sometimes a well-structured task can also be considered simple.

Example Task Complexity Characterization Values

This task characterization is scalar, with the minimum range being binary. Example binary values or scale endpoints are: simple/not simple, complex/not complex, simple/complex, well-structured/not well-structured, or well-structured/complex.

Using simple/complex as scale endpoints, the list is an example task complexity scale.

There is one, very simple task composed of 1-5 interrelated elements whose relationship is well understood.

There is one simple task composed of 6-10 interrelated elements whose relationship is understood.

There is more than one very simple task and each task is composed of 1-5 elements whose relationship is well understood.

There is one moderately simple task composed of 11-15 interrelated elements whose relationship is 80-90% understood by the user.

There is more than one simple task and each task is composed of 6-10 interrelated whose relationship is understood by the user.

There is one somewhat simple task composed of 16-20 interrelated elements whose relationship is understood by the user.

There is more than one moderately simple task and each task is composed of 11-15 interrelated elements whose relationship is 80-90% understood by the user.

There is one complex task complex task composed of 21-35 interrelated elements whose relationship is 60-79% understood by the user.

There is more than one somewhat complex task and each task is composed of 16-20 interrelated elements whose relationship is understood by the user.

There is one moderately complex task composed of 36-50 elements whose relationship is 80-90% understood by the user.

There is more than one complex task and each task is composed of 21-35 elements whose relationship is 60-79% understood by the user.

There is one very complex task composed of 51 or more elements whose relationship is 40-60% understood by the user.

There is more than one complex task and each task is composed of 36-50 elements whose relationship is 40-60% understood by the user.

There is more than one very complex task and each part is composed of 51 or more elements whose relationship is 20-40% understood by the user.

Exemplary UI Design Implementation for Task Complexity

The following list contains examples of UI design implementations for how the computing system might respond to a change in task complexity.

For a task that is long and simple (well-structured), the UI might:

Give prominence to information that could be used to complete the task.

Vary the text-to-speech output to keep the user's interest or attention.

For a task that is short and simple, the U might:

Optimize to receive input from the best device. That is, allow only input that is most convenient for the user to use at that particular moment.

If a visual presentation is used, such as an LCD panel or monitor, prominence may be implemented using visual presentation only.

For a task that is long and complex, the UI might:

Increase the orientation to information and devices

Increase affordance to pause in the middle of a task. That is, make it easy for a user to stop in the middle of the task and then return to the task.

For a task that is short and complex, the UI might:

Default to expert mode.

Suppress elements not involved in choices directly related to the current task.

Change modality

Task Familiarity

Task familiarity is related to how well acquainted a user is with a particular task. If a user has never completed a specific task, they might benefit from more instruction from the computing environment than a user who completes the same task daily. For example, the first time a car rental associate rents a car to a consumer, the task is very unfamiliar. However, after about a month, the car rental associate is very familiar with renting cars to consumers.

Example Task Familiarity Characterization Values

This task characterization is scalar, with the minimum range being binary. Example binary values or scale endpoints are: familiar/not familiar, not unfamiliar/unfamiliar, and unfamiliar/familiar.

Using unfamiliar and familiar as scale endpoints, the list is an example task familiarity scale.

On a scale of 1 to 5, where one is very unfamiliar and 5 is very familiar, the task familiarity rating is 1.

On a scale of 1 to 5, where one is very unfamiliar and 5 is very familiar, the task familiarity rating is 2.

On a scale of 1 to 5, where one is very unfamiliar and 5 is very familiar, the task familiarity rating is 3.

On a scale of 1 to 5, where one is very unfamiliar and 5 is very familiar, the task familiarity rating is 4.

On a scale of 1 to 5, where one is very unfamiliar and 5 is very familiar, the task familiarity rating is 5.

Exemplary UI Design Implementation for Task Familiarity

The following list contains examples of UI design implementations for how the computing system might respond to a change in task familiarity.

For a task that is unfamiliar, the UI might:

Increase task orientation to provide a high level schema for the task.

Offer detailed help.

Present the task in a greater number of steps.

Offer more detailed prompts.

Provide information in as many modalities as possible.

For a task that is familiar, the UI might:

Decrease the affordances for help

Offer summary help

Offer terse prompts

Decrease the amount of detail given to the user

Use auto-prompt and auto-complete (that is, make suggestions based on past choices made by the user).

The ability to barge ahead is available.

Use user-preferred modalities.

Task Sequence

A task can have steps that must be performed in a specific order. For example, if a user wants to place a phone call, the user must dial or send a phone number before they are connected to and can talk with another person. On the other hand, a task, such as searching the Internet for a specific topic, can have steps that do not have to be performed in a specific order.

Example Task Sequence Characterization Values

This task characterization is scalar, with the minimum range being binary. Example binary values or scale endpoints are: scripted/not scripted, nondeterministic/not nondeterministic, or scripted/nondeterministic.

Using scripted/nondeterministic as scale endpoints, the following list is an example task sequence scale.

The each step in the task is completely scripted.

The general order of the task is scripted. Some of the intermediary steps can be performed out of order.

The first and last steps of the task are scripted. The remaining steps can be performed in any order.

The steps in the task do not have to be performed in any order.

Exemplary UI Design Implementation for Task Sequence

The following list contains examples of UI design implementations for how the computing system might respond to a change in task sequence.

For a task that is scripted, the UI might:

Present only valid choices.

Present more information about a choice so a user can understand the choice thoroughly.

Decrease the prominence or affordance of navigational controls.

For a task that is nondeterministic, the UI might:

Present a wider range of choices to the user.

Present information about the choices only upon request by the user.

Increase the prominence or affordance of navigational controls

Task Independence

The UI can coach a user though a task or the user can complete the task without any assistance from the UI. For example, if a user is performing a safety check of an aircraft, the UI can coach the user about what questions to ask, what items to inspect, and so on. On the other hand, if the user is creating an appointment or driving home, they might not need input from the computing system about how to successfully achieve their objective.

Example Task Independence Characterization Values

This task characterization is scalar, with the minimum range being binary. Example binary values or scale endpoints are: coached/not coached, not independently executed/independently executed, or coached/independently executed.

Using coached/independently executed as scale endpoints, the following list is an example task guidance scale.

The each step in the task is completely scripted.

The general order of the task is scripted. Some of the intermediary steps can be performed out of order. For example, the first and last steps of the task are scripted and the remaining steps can be performed in any order.

The steps in the task do not have to be performed in any order.

Task Creativity

A formulaic task is a task in which the computing system can precisely instruct the user about how to perform the task. A creative task is a task in which the computing system can provide general instructions to the user, but the user uses their knowledge, experience, and/or creativity to complete the task. For example, the computing system can instruct the user about how to write a sonnet. However, the user must ultimately decide if the combination of words is meaningful or poetic.

Example Task Creativity Characterization Values

This task characterization is scalar, with the minimum range being binary. Example binary values or scale endpoints could be defined as formulaic/not formulaic, creative/not creative, or formulaic/creative.

Using formulaic and creative as scale endpoints, the following list is an example task creativity scale.

On a scale of 1 to five, where 1 is formulaic and 5 is creative, the task creativity rating is 1.

On a scale of 1 to five, where 1 is formulaic and 5 is creative, the task creativity rating is 2.

On a scale of 1 to five, where 1 is formulaic and 5 is creative, the task creativity rating is 3.

On a scale of 1 to five, where 1 is formulaic and 5 is creative, the task creativity rating is 4.

On a scale of 1 to five, where 1 is formulaic and 5 is creative, the task creativity rating is 5.

Software Requirements

Tasks can be intimately related to software requirements. For example, a user cannot create a complicated database without software.

Example Software Requirements Characterization Values

This task characterization is enumerated. Example values include:

JPEG viewer

PDF reader

Microsoft Word

Microsoft Access

Microsoft Office

Lotus Notes

Windows NT 4.0

Mac OS 10

Task Privacy

Task privacy is related to the quality or state of being apart from company or observation. Some tasks have a higher level of desired privacy than others. For example, calling a physician to receive medical test results has a higher level of privacy than making an appointment for a meeting with a co-worker.

Example Task Privacy Characterization Values

This task characterization is scalar, with the minimum range being binary. Example binary values or scale endpoints are: private/not private, public/not public, or private/public.

Using private/public as scale endpoints, the following table is an example task privacy scale.

The task is not public. Anyone can have knowledge of the task.

The task is semi-private. The user and at least one other person have knowledge of the task.

The task is fully private. Only the user can have knowledge of the task.

Hardware Requirements

A task can have different hardware requirements. For example, talking on the phone requires audio input and output while entering information into a database has an affinity for a visual display surface and a keyboard.

Example Hardware Requirements Characterization Values

10 MB available of storage

1 hour of power supply

A free USB connection

Task Collaboration

A task can be associated with a single user or more than one user. Most current computer-assisted tasks are designed as single-user tasks. Examples of collaborative computer-assisted tasks include participating in a multi-player video game or making a phone call.

Example Task Collaboration Characterization Values

This task characterization is binary. Example binary values are single user/co laboration.

Task Relation

A task can be associated with other tasks, people, applications, and so on. Or a task can stand alone on it's own.

Example Task Relation Characterization Values

This task characterization is binary. Example binary values are unrelated task/related task.

Task Completion

There are some tasks that must be completed once they are started and others that do not have to be completed. For example, if a user is scuba diving and is using a computing system while completing the task of decompressing, it is essential that the task complete once it is started. To ensure the physical safety of the user, the software must maintain continuous monitoring of the user's elapsed time, water pressure, and air supply pressure/quantity. The computing system instructs the user about when and how to safely decompress. If this task is stopped for any reason, the physical safety of the user could be compromised.

Example Task Completion Characterization Values

Example values are:

Must be completed

Does not have to be completed

Can be paused

Not known

Task Priority

Task priority is concerned with order. The order may refer to the order in which the steps in the task must be completed or order may refer to the order in which a series of tasks must be performed. This task characteristic is scalar. Tasks can be characterized with a priority scheme, such as (beginning at low priority) entertainment, convenience, economic/personal commitment, personal safety, personal safety and the safety of others. Task priority can be defined as giving one task preferential treatment over another. Task priority is relative to the user. For example, “all calls from mom” may be a high priority for one user, but not another user.

Example Task Privacy Characterization Values

This task characterization is scalar, with the minimum range being binary. Example binary values or scale endpoints are no priority/high priority.

Using no priority and high priority as scale endpoints, the following list is an example task priority scale.

The current task is not a priority. This task can be completed at any time.

The current task is a low priority. This task can wait to be completed until the highest priority, high priority, and moderately high priority tasks are completed.

The current task is moderately high priority. This task can wait to be completed until the highest priority and high priority tasks are addressed.

The current task is high priority. This task must be completed immediately after the highest priority task is addressed.

The current task is of the highest priority to the user. This task must be completed first.

Task Importance

Task importance is the relative worth of a task to the user, other tasks, applications, and so on. Task importance is intrinsically associated with consequences. For example, a task has higher importance if very good or very bad consequences arise if the task is not addressed. If few consequences are associated with the task, then the task is of lower importance.

Example Task Importance Characterization Values

This task characterization is scalar, with the minimum range being binary. Example binary values or scale endpoints are not important/very important.

Using not important and very important as scale endpoints, the following list is an example task importance scale.

The task in not important to the user. This task has an importance rating of “1.”

The task is of slight importance to the user. This task has an importance rating of “2.”

The task is of moderate importance to the user. This task has an importance rating of “3.”

The task is of high importance to the user. This task has an importance rating of “4.”

The task is of the highest importance to the user. This task has an importance rating of “5.”

Task Urgency

Task urgency is related to how immediately a task should be addressed or completed. In other words, the task is time dependent. The sooner the task should be completed, the more urgent it is.

Example Task Urgency Characterization Values

This task characterization is scalar, with the minimum range being binary. Example binary values or scale endpoints are not urgent/very urgency.

Using not urgent and very urgent as scale endpoints, the following list is an example task urgency scale.

A task is not urgent. The urgency rating for this task is “1.”

A task is slightly urgent. The urgency rating for this task is “2.”

A task is moderately urgent. The urgency rating for this task is “3.”

A task is urgent. The urgency rating for this task is “4.”

A task is of the highest urgency and requires the user's immediate attention. The urgency rating for this task is “5.”

Exemplary UI Design Implementation for Task Urgency

The following list contains examples of UI design implementations for how the computing system might respond to a change in task urgency.

If the task is not very urgent (e.g. a task urgency rating of 1, using the scale from the previous list), the UI might not indicate task urgency.

If the task is slightly urgent (e.g. a task urgency rating of 2, using the scale from the previous list), and if the user is using a head mounted display (HMD), the UI might blink a small light in the peripheral vision of the user.

If the task is moderately urgent (e.g. a task urgency rating of 3, using the scale from the previous list), and if the user is using an HMD, the UI might make the light that is blinking in the peripheral vision of the user blink at a faster rate.

If the task is urgent, (e.g. a task urgency rating of 4, using the scale from the previous list), and if the user is wearing an HMD, two small lights might blink at a very fast rate in the peripheral vision of the user.

If the task is very urgent, (e.g. a task urgency rating of 5, using the scale from the previous list), and if the user is wearing an HMD, three small lights might blink at a very fast rate in the peripheral vision of the user. In addition, a notification is sent to the user's direct line of sight that warns the user about the urgency of the task. An audio notification is also presented to the user.

Task Concurrency

Mutually exclusive tasks are tasks that cannot be completed at the same time while concurrent tasks can be completed at the same time. For example, a user cannot interactively create a spreadsheet and a word processing document at the same time. These two tasks are mutually exclusive. However, a user can talk on the phone and create a spreadsheet at the same time.

Example Task Concurrency Characterization Values

This task characterization is binary. Example binary values are mutually exclusive and concurrent.

Task Continuity

Some tasks can have their continuity or uniformity broken without comprising the integrity of the task, while other cannot be interrupted without compromising the outcome of the task. The degree to which a task is associated with saving or preserving human life is often associated with the degree to which it can be interrupted. For example, if a physician is performing heart surgery, their task of performing heart surgery is less interruptible than the task of making an appointment.

Example Task Continuity Characterization Values

This task characterization is scalar, with the minimum range being binary. Example binary values or scale endpoints are interruptible/not interruptible or abort/pause.

Using interruptible/not interruptible as scale endpoints, the following list is an example task continuity scale.

The task cannot be interrupted.

The task can be interrupted for 5 seconds at a time or less.

The task can be interrupted for 6-15 seconds at a time.

The task can be interrupted for 16-30 seconds at a time.

The task can be interrupted for 31-60 seconds at a time.

The task can be interrupted for 61-90 seconds at a time.

The task can be interrupted for 91-300 seconds at a time.

The task can be interrupted for 301-1,200 seconds at a time.

The task can be interrupted 1,201-3,600 seconds at a time.

The task can be interrupted for 3,601 seconds or more at a time.

The task can be interrupted for any length of time and for any frequency.

Cognitive Load

Cognitive load is the degree to which working memory is engaged in processing information. The more working memory is used, the higher the cognitive load. Cognitive load encompasses the following two facets: cognitive demand and cognitive availability.

Cognitive demand is the number of elements that a user processes simultaneously. To measure the user's cognitive load, the system can combine the following three metrics: number of elements, element interaction, and structure. Cognitive demand is increased by the number of elements intrinsic to the task. The higher the number of elements, the more likely the task is cognitively demanding. Second, cognitive demand is measured by the level of interrelation between the elements in the task. The higher the interrelation between the elements, the more likely the task is cognitively demanding. Finally, cognitive load is measured by how well revealed the relationship between the elements is. If the structure of the elements is known to the user or if it's easily understood, then the cognitive demand of the task is reduced.

Cognitive availability is how much attention the user uses during the computer-assisted task. Cognitive availability is composed of the following:

Expertise. This includes schema and whether or not it is in long term memory

The ability to extend short term memory.

Distraction. A non-task cognitive demand.

How Cognitive Load Relates to Other Attributes

Cognitive load relates to at least the following attributes:

Learner expertise (novice/expert). Compared to novices, experts have an extensive schemata of a particular set of elements and have automaticity, the ability to automatically understand a class of elements while devoting little to no cognition to the classification. For example, a novice reader must examine every letter of the word that they're trying to read. On the other hand, an expert reader has built a schema so that elements can be “chunked” into groups and accessed as a group rather than a single element. That is, an expert reader can consume paragraphs of text at a time instead of examining each letter.

Task familiarity (unfamiliar/familiar). When a novice and an expert come across an unfamiliar task, each will handle it differently. An expert is likely to complete the task either more quickly or successfully because they access schemas that they already have and use those to solve the problem/understand the information. A novice may spend a lot of time developing a new schema to understand the information/solve the problem.

Task complexity (simple/complex or well-structured/complex). A complex task is a task whose structure is not well-known. There are many elements in the task and the elements are highly interrelated. The opposite of a complex task is well-structured. An expert is well-equipped to deal with complex problems because they have developed habits and structures that can help them decompose and solve the problem.

Task length (short/long). This relates to how much a user has to retain in working memory.

Task creativity. (formulaic/creative) How well known is the structure of the interrelation between the elements?

Example Cognitive Demand Characterization Values

This task characterization is scalar, with the minimum range being binary. Example binary values or scale endpoints are cognitively undemanding/cognitively demanding.

Exemplary UI Design Implementation for Cognitive Load

A UI design for cognitive load is influenced by a tasks intrinsic and extrinsic cognitive load. Intrinsic cognitive load is the innate complexity of the task and extrinsic cognitive load is how the information is presented. If the information is presented well (e.g. the schema of the interrelation between the elements is revealed), it reduces the overall cognitive load.

The following list contains examples of UI design implementations for how the computing system might respond to a change cognitive load.

Present information to the user by using more than one channel. For example, present choices visually to the user, but use audio for prompts.

Use a visual presentation to reveal the relationships between the elements. For example if a family tree is revealed, use colors and shapes to represent male and female members of the tree or shapes and colors can be used to represent different family units.

Reduce the redundancy. For example, if the structure of the elements is revealed visually, do not use audio to explain the same structure to the user.

Keep complementary or associated information together. For example, if creating a dialog box so a user can print, create a button that has the word “Print” on it instead of a dialog box that has a question “Do you want to print?” with a button with the work “OK” on it.

Task Alterability

Some task can be altered after they are completed while others cannot be changed. For example, if a user moves a file to the Recycle Bin, they can later retrieve the file. Thus, the task of moving the file to the Recycle Bin is alterable. However, if the user deletes the file from the Recycle Bin, they cannot retrieve it at a later time. In this situation, the task is irrevocable.

Example Task Alterability Characterization Values

This task characterization is binary, with the minimum range being binary. Example binary values or scale endpoints are alterable/not alterable, irrevocable/revocable, or alterable/irrevocable.

Task Content Type

This task characteristic describes the type of content to be used with the task. For example, text, audio, video, still pictures, and so on.

Example Content Type Characteristics Values

This task characterization is an enumeration. Some example values are:

asp

.jpeg

.avi

.jpg

.bmp

.jsp

.gif

.php

.htm

.txt

.html

.wav

.doc

.xls

.mdb

.vbs

.mpg

Again, this list is meant to be illustrative, not exhaustive.

Task Type

A task can be performed in many types of situations. For example, a task that is performed in an augmented reality setting might be presented differently to the user than the same task that is executed in a supplemental setting.

Example Task Type Characteristics Values

This task characterization is an enumeration. Example values can include:

Supplemental

Augmentative

Mediated

Methods of Task Characterization

There are many ways to expose task characterizations to the system. This section describes some of the ways in which this can be accomplished.

Numeric Key

Task characterization can be exposed to the system with a numeric value corresponding to values of a predefined data structure.

For instance, a binary number can have each of the bit positions associated with a specific characteristic. The least significant bit may represent task hardware requirements. Therefore a task characterization of decimal 5 would indicate that minimal processing power is required to complete the task.

XML Tags

Task characterization can be exposed to the system with a string of characters conforming to the XML structure.

For instance, a simple and important task could be represented as:

<Task Characterization><Task Complexity=“0” Task Length=“9”></Task Characterization>

One significant advantage of this mechanism is that it is easily extensible.

Programming Interface

A task characterization can be exposed to the system by associating a task characteristic with a specific program call.

For instance:

GetUrgentTask can return a handle to that communicates that task urgency to the UI.

Name/Value Pairs

A task is modeled or represented with multiple attributes that each correspond to a specific element of the task (e.g., complexity, cognitive load or task length), and the value of an attribute represents a specific measure of that element. For example, for an attribute that represents the task complexity, a value of “5” represents a specific measurement of complexity. Each attribute preferably has the following properties: a name, a value, an uncertainty level, and a timestamp. For example, the name of the complexity attribute may be “task complexity” and its value at a particular time may be 5. Associated with the current value may be a timestamp of 08/01/2001 13:07 PST that indicates when the value was generated, and an uncertainty level of +/−1 degrees.

How to Expose to the Computing System Manual Characterization

The UI Designer or other person manually and explicitly determines the task characteristic values. For example, XML metadata could be attached to a UI design that explicitly characterizes it as “private” and “very secure.”

Manual and Automatic Characterization

A UI Designer or other person could manually and explicitly determine a task characteristic and the computing system could automatically derive additional values from the manual characterization. For example, if a UI Designer characterized cognitive load as “high,” then the computing system might infer that the values of task complexity and task length are “high” and “long,” respectively.

Another manual and automatic characterization is to group together tasks can as a series of interconnected subtasks, creating both a micro-level view of intermediary steps as well as a macro-level view of the method for accomplishing an overall user task. This applies to tasks that range from simple single steps to complicated parallel and serial tasks that can also include calculations, logic, and nondeterministic subtask paths through the overall task completion process.

Macro-level task characterizations can then be assessed at design time, such as task length, number of steps, depth of task flow hierarchy, number of potential options, complexity of logic, amount of user inputs required, and serial vs. parallel vs. nondeterministic subtask paths.

Micro-level task characterizations can also be determined to include subtask content and expected task performance based on prior historical databases of task performance relative to user, task type, user and computing system context, and relevant task completion requirements.

Examples of methods include:

Add together and utilize a weighting algorithm across the number of exit options from the current state of the procedure.

Calculate depth and size of associated text (more text implying longer time needs and more complexity, and vice versa), graphics, and content types (audio, visual, and other input/output modalities).

Determine number/type of steps and number/type of follow-on calculations affected.

Use associated metadata based on historical databases of relevant actual time, complexity, and user context metrics.

Bound the overall task sequence and associate them as a subroutine, and then all intermediary steps can be individually assessed and added together for cumulative and synergistic characterization of the task. Cumulative characterization will add together specific metrics over all subtasks within the overall task, and synergistic characterization will include user response variables to certain subtask sequences (example: multiple long text descriptions may generally be skimmed by the user to decrease overall time commitment to the task, thereby providing a sliding scale weight relating text length to actual time to read and understand).

Determine level of input(s) needed by whether the subtask options are predetermined or require independent thought, creation, and input into the system for nondeterministic potential task flow inputs and outcomes.

Pre-set task feasibility factors at design time to include the needs and relative weighting factors for related software, hardware, I/O device availability, task length, task privacy, and other characteristics for task completion and/or for expediting completion of task. Compare these values to real time/run time values to determine expected effects for different value ranges for task characterizations.

Automatic Characterization

The following list contains some ways in which the previously described methods of task characterization could be automatically exposed to the computing system.

The computing system examines the structure of the task and automatically evaluates calculates the task characterization method. For example, an application could evaluate how many steps there are in a wizard to task assistant to determine task complexity. The more steps, the higher the task complexity.

The computing system could apply patterns of use to establish implicit characterizations. For example, characteristics can be based on historic use. A task could have associated with is a list of selected UI designs. A task could therefore have an arbitrary characteristics, such as “activity” with associated values, such as “driving.” A pattern recognition engine determines a predictive correlation using a mechanism such as neural networks.

Characterizing I/O Devices' UI Requirements Characterized I/O Device Attributes

The described model for optimal UI design characterization includes at least the following categories of attributes when determining the optimal UI design:

All available attributes. The model is dynamic so it can accommodate for any and all attributes that could affect the optimal UI design for a user's context. For example, this model could accommodate for temperature, weather conditions, time of day, available I/O devices, preferred volume level, desired level of privacy, and so on.

Significant attributes. Some attributes have a more significant influence on the optimal UI design than others. Significant attributes include, but are not limited to, the following:

The user can see video.

The user can hear audio.

The computing system can hear the user.

The interaction between the user and the computing system must be private.

The user's hands are occupied.

Attributes that correspond to a theme. Specific or programmatic. Individual or group.

The attributes described in this section are example important attributes for determining an optimal UI. Any of the listed attributes can have additional supplemental characterizations. For clarity, each attribute described in this topic is presented with a scale and some include design examples. It is important to note that any of the attributes mentioned in this document are just examples. There are other attributes that can cause a UI to change that are not listed in this document. However, the dynamic model can account for additional attribute triggers.

Physical Availability

Physical availability is the degree to which a person is able to perceive and manipulate a device. For example, an airplane mechanic who is repairing an engine does not have hands available to input indications to the computing systems by using a keyboard.

I/O Device Selection

Users may have access to multiple input and output (I/O) devices. Which input or output devices they use depends on their context. The UI should pick the ideal input and output devices so the user can interact effectively and efficiently with the computer or computing device.

Redundant Controls

Privacy

Privacy is the quality or state of being apart from company or observation. It includes a user's trust of audience. For example, if a user doesn't want anyone to know that they are interacting with a computing system (such as a wearable computer), the preferred output device might be an HMD and the preferred input device might be an eye-tracking device.

Hardware Affinity for Privacy

Some hardware suits private interactions with a computing system more than others. For example, an HMD is a far more private output device than a desk monitor. Similarly, an earphone is more private than a speaker.

The UI should choose the correct input and output devices that are appropriate for the desired level of privacy for the user's current context and preferences.

Example Privacy Characterization Values

This characteristic is scalar, with the minimum range being binary. Example binary values, or scale endpoints, are: not private/private, public/not public, and public/private.

Using no privacy and fully private as the scale endpoints, the following table lists an example privacy characterization scale.

No privacy is needed for input or output interaction The UI is not restricted to any particular I/O device for presentation and interaction. For example, the UI could present content to the user through speakers on a large monitor in a busy office.

The input must be semi-private. The output does not need to be private.

Coded speech commands, and keyboard methods are appropriate. No restrictions on output presentation.

The input must be fully private. The output does not need to be private.

No speech commands. No restriction on output presentation.

The input must be fully private. The output must be semi-private. No speech commands. No LCD panel.

The input does not need to be private. The output must be fully private.

No restrictions on input interaction. The output is restricted to an HMD device and/or an earphone.

The input does not need to be private. The output must be semi-private.

No restrictions on input interaction. The output is restricted to HMD device, earphone, and/or an LCD panel.

The input must be semi-private. The output must be semi-private. Coded speech commands and keyboard methods are appropriate. Output is restricted to an HMD device, earphone or an LCD panel.

The input and output interaction must be fully private. No speech commands. Keyboard devices might be acceptable. Output is restricted to and HMD device and/or an earphone.

Semi-private. The user and at least one other person can have access to or knowledge of the interaction between the user and the computing system.

Fully private. Only the user can have access to or knowledge of the interaction between the user and the computing system.

Computing Hardware Capability

For purposes of user interfaces designs, there are four categories of hardware:

Input/output devices

Storage (e.g. RAM)

Processing capabilities

Power supply

The hardware discussed in this topic can be the hardware that is always available to the computing system. This type of hardware is usually local to the user. Or the hardware could sometimes be available to the computing system. When a computing system uses resources that are sometimes available to it, this can be called an opportunistic use of resources.

I/O Devices

Scales for input and output devices are described later in this document.

Storage

Storage capacity refers to how much random access memory (RAM) and/or other storage is available to the computing system at any given moment. This number is not considered to be constant because the computing system might avail itself to the opportunistic use of memory.

Usually the user does not need to be aware of how much storage is available unless they are engaged in a task that might require more memory than to which they reliably have access. This might happen when the computing system engages in opportunistic use of memory. For example, if an in-motion user is engaged in a task that requires the opportunistic use of memory and that user decides to change location (e.g. they are moving from their vehicle to a utility pole where they must complete other tasks), the UI might warn the user that if they leave the current location, the computing system may not be able to complete the task or the task might not get completed as quickly.

Example Storage Characterization Values

This UI characterization is scalar, with the minimum range being binary. Example binary values or scale endpoints are: no RAM is available/all RAM is available.

Using no RAM is available and all RAM is available, the following table lists an example storage characterization scale.

No RAM is available to the computing system If no RAM is available, there is no UI available.—Or—There is no change to the UI.

Of the RAM available to the computing system, only the opportunistic use of RAM is available. The UI is restricted to the opportunistic use of RAM.

Of the RAM that is available to the computing system, only the local RAM is accessible The UI is restricted to using local RAM.

Of the RAM that is available to the computing system, the RAM local to the computing system and a portion of the opportunistic use of RAM is available.

Of the RAM that is available to the computing system, the local RAM is available and the user is about to lose opportunistic use of RAM. The UI might warn the user that if they lose opportunistic use of memory, the computing system might not be able to complete the task, or the task might not be completed as quickly.

Of the total possible RAM available to the computing system, all of it is available. If there is enough memory available to the computing system to fully function at a high level, the UI may not need to inform the user. If the user indicates to the computing system that they want a task completed that requires more memory, the UI might suggest that the user change locations to take advantage of additional opportunistic use of memory.

Processing Capabilities

Processing capabilities fall into two general categories:

Speed. The processing speed of a computing system is measured in megahertz (MHz). Processing speed can be reflected as the rate of logic calculation and the rate of content delivery. The more processing power a computing system has, the faster it can calculate logic and deliver content to the user.

CPU usage. The degree of CPU usage does not affect the UI explicitly. With current UI design, if the CPU becomes too busy, the UI Typically “freezes” and the user is unable to interact with the computing system. If the CPU usage is too high, the UI will change to accommodate the CPU capabilities. For example, if the processor cannot handle the demands, the UI can simplify to reduce demand on the processor.

Example Processing Capability Characterization Values

This UI characterization is scalar, with the minimum range being binary. Example binary or scale endpoints are: no processing capability is available/all processing capability is available.

Using no processing capability is available and all processing capability as scale endpoints, the following table lists an example processing capability scale.

No processing power is available to the computing system There is no change to the UI.

The computing system has access to a slower speed CPU. The UI might be audio or text only.

The computing system has access to a high speed CPU The UI might choose to use video in the presentation instead of a still picture.

The computing system has access to and control of all processing power available to the computing system. There are no restrictions on the UI based on processing power.

Power Supply

There are two types of power supplies available to computing systems alternating current (AC) and direct current (DC). Specific scale attributes for AC power supplies are represented by the extremes of the exemplary scale. However, if a user is connected to an AC power supply, it may be useful for the UI to warn an in-motion user when they're leaving an AC power supply. The user might need to switch to a DC power supply if they wish to continue interacting with the computing system while in motion. However, the switch from AC to DC power should be an automatic function of the computing system and not a function of the

On the other hand, many computing devices, such as WPCs, laptops, and PDAs, operate using a battery to enable the user to be mobile. As the battery power wanes, the UI might suggest the elimination of video presentations to extend battery life. Or the UI could display a VU meter that visually demonstrates the available battery power so the user can implement their preferences accordingly.

Example Power Supply Characterization Values

This task characterization is binary if the power supply is AC and scalar if the power supply is DC. Example binary values are: no power/full power. Example scale endpoints are: no power/all power.

Using no power and full power as scale endpoints, the following tables lists an example power supply scale.

There is no power to the computing system. No changes to the UI are possible

There is an imminent exhaustion of power to the computing system.

The UI might suggest that the user power down the computing system before critical data is lost, or system could write most significant/useful data to display that does not require power

There is an inadequate supply of power to the computing system. If a user is listening to music, the UI might suggest that the user stop entertainment uses of the system to preserve the power supply of the computing system for critical tasks.

There is a limited, but potentially inadequate supply of power to the computing system. If the battery life is 6 hours and the computing system logic determines that the user will be away from a power source for more than 6 hours, the UI might suggest that the user conserve battery power. Or the UI might automatically operate in a “conserve power mode,” by showing still pictures instead of video or using audio instead of a visual display when appropriate.

There is a limited but adequate power supply to the computing system.

The UI might alert the user about how many hours are available in the power supply.

There is an unlimited supply of power to the computing system. The UI can use any device for presentation and interaction without restriction.

Exemplary UI Design Implementations

The following list contains examples of UI design implementations for how the computing system might respond to a change in the power supply capacity.

If there is minimal power remaining in a battery that is supporting a computing system, the UI might:

Power down any visual presentation surfaces, such as an LCD.

Use audio output only.

If there is minimal power remaining in a battery and the UI is already audio-only, the UI might:

Decrease the audio output volume.

Decrease the number of speakers that receive the audio output or use earplugs only.

Use mono versus stereo output.

Decrease the number of confirmations to the user.

If there is, for example, six hours of maximum-use battery life available and the computing system determines that the user not have access to a different power source for 8 hours, the UI might:

Decrease the luminosity of any visual display by displaying line drawings instead of 3-dimensional illustrations.

Change the chrominance from color to black and white.

Refresh the visual display less often.

Decrease the number of confirmations to the user.

Use audio output only.

Decrease the audio output volume.

Computing Hardware Characteristics

The following is a list of some of the other hardware characteristics that may be influence what is an optimal UI design.

Cost

Waterproof

Ruggedness

Mobility

Again, there are other characteristics that could be added to this list. However, it is not possible to list all computing hardware attributes that might influence what is considered to be an optimal UI design until run time.

Input/Output Devices

Different presentation and manipulation technologies typically have different maximum usable information densities.

Visual

Visual output refers to the available visual density of the display surface is characterized by the amount of content a presentation surface can present to a user. For example, an LED output device, desktop monitor, dashboard display, hand-held device, and head mounted display all have different amounts of visual density. UI designs that are appropriate for a desktop monitor are very different than those that are appropriate for head-mounted displays. In short, what is considered to be the optimal UI will change based on what visual output device(s) is available.

In addition to density, visual display surfaces have the following characteristics:

Color. This characterizes whether or not the presentation surface displays color. Color can be directly related to the ability of the presentation surface, of it could be assigned as a user preference.

Chrominance. The color information in a video signal. See luminance for an explanation of chrominance and luminance.

Motion. This characterizes whether or not a presentation surface presents motion to the user.

Field of view. A presentation surface can display content in the focus of a user's vision, in the user's periphery, or both.

Depth. A presentation surface can display content in 2 dimensions (e.g. a desktop monitor) or 3 dimensions (a holographic projection).

Luminance. The amount of brightness, measured in lumens, which is given off by a pixel or area on a screen. It is the black/gray/white information in a video signal. Color information is transmitted as luminance (brightness) and chrominance (color). For example, dark red and bright red would have the same chrominance, but a different luminance. Bright red and bright green could have the same luminance, but would always have a different chrominance.

Reflectivity. The fraction of the total radiant flux incident upon a surface that is reflected and that varies according to the wavelength distribution of the incident radiation.

Size. Refers to the actual size of the visual presentation surface.

Position/location of visual display surface in relation to the user and the task that they're performing.

Number of focal points. A UI can have more than one focal point and each focal point can display different information.

Distance of focal points from the user. A focal point can be near the user or it can be far away. The amount distance can help dictate what kind and how much information is presented to the user.

Location of focal points in relation to the user. A focal point can be to the left of the user's vision, to the right, up, or down.

With which eye(s) the output is associated. Output can be associated with a specific eye or both eyes.

Ambient light.

Others

Example Visual Density Characterization Values

This UI characterization is scalar, with the minimum range being binary Example binary values or scale endpoints are: no visual density/full visual density.

Using no visual density and full visual density as scale endpoints, the following table lists an example visual density scale.

There is no visual density The UI is restricted to non-visual output such as audio, haptic, and chemical.

Visual density is very low The UI is restricted to a very simple output, such as single binary output devices (a single LED) or other simple configurations and arrays of light. No text is possible.

Visual density is low The UI can handle text, but is restricted to simple prompts or the bouncing ball.

Visual density is medium The UI can display text, simple prompts or the bouncing ball, and very simple graphics.

Visual density is high The visual display has fewer restrictions. Visually dense items such as windows, icons, menus, and prompts are available as well as streaming video, detailed graphics and so on.

Visual density is very high

Visual density is the highest available The UI is not restricted by visual density. A visual display that mirrors reality (e.g. 3-dimensional) is possible and appropriate.

Example Color Characterization Values

This UI characterization is scalar, with the minimum range being binary. Example binary values or scale endpoints are: no color/full color.

Using no color and full color as scale endpoints, the following table lists an example color scale.

| | |
|---|---|
| No color is available. | The UI visual presentation is monochrome. |
| One color is available. | The UI visual presentation is monochrome plus |
| one color. | |
| Two colors are available | The UI visual presentation is monochrome plus |
| | two colors or any combination |
| | of the two colors. |
| Full color is available. | The UI is not restricted by color. |

Example Motion Characterization Values

This UI characterization is scalar, with the minimum range being binary. Example binary values, or scale endpoints, are: no motion is available/full motion is available.

Using no motion is available and full motion is available as scale endpoints, the following table lists an example motion scale.

No motion is available The UI is restricted by motion. There are no

videos, streaming videos moving text, and so on.

Limited motion is available
Moderate motion is available
Full range of motion is available The UI is not restricted by motion.

Example Field of View Characterization Values

This UI characterization is scalar, with the minimum range being binary. Example binary values, or scale endpoints, are: peripheral vision only/field of focus and peripheral vision is available.

Using peripheral vision only and field of focus and peripheral vision is available as scale endpoints, the following tables lists an example field of view scale.

All visual display is in the peripheral vision of the user The UI is restricted to using the peripheral vision of the user. Lights, colors and other simple visual display are appropriate. Text is not appropriate.

Only the user's field of focus is available. The UI is restricted to using

the users field of vision only. Text and other complex visual displays are
appropriate.

Both field of focus and the peripheral vision of the user are used.

The UI is not restricted by the user's field of view.

Exemplary UI Design Implementation for Changes in Field of View

The following list contains examples of UI design implementations for how the computing system might respond to a change in field of view.

If the field of view for the visual presentation is more than 28°, then the UI might:

Display the most important information at the center of the visual presentation surface.

Devote more of the UI to text

Use periphicons outside of the field of view.

If the field of view for the visual presentation is less than 28°, then the UI might:

Restrict the size of the font allowed in the visual presentation. For example, instead of listing “Monday, Tuesday, and Wednesday,” and so on as choices, the UI might list “M, Tu, W” instead.

The body or environment stabilized image can scroll.

Example Depth Characterization Values

This characterization is binary and the values are: 2 dimensions, 3 dimensions.

Exemplary UI design implementation for changes in reflectivity

The following list contains examples of UI design implementations for how the computing system might respond to a change in reflectivity.

If the output device has high reflectivity—a lot of glare—then the visual presentation will change to a light colored UI.

Audio

Audio input and output refers to the UI's ability to present and receive audio signals. While the UI might be able to present or receive any audio signal strength, if the audio signal is outside the human hearing range (approximately 20 Hz to 20,000 Hz) it is converted so that it is within the human hearing range, or it is transformed into a different presentation, such as haptic output, to provide feedback, status, and so on to the user.

Factors that influence audio input and output include (but this is not an inclusive list):

Level of ambient noise (this is an environmental characterization)

Directionality of the audio signal

Head stabilized output (e.g. earphones)

Environment stabilized output (e.g. speakers)

Spatial layout (3-D audio)

Proximity of the audio signal to the user

Frequency range of the speaker

Fidelity of the speaker, e.g. total harmonic distortion

Left, right, or both ears

What kind of noise is it?

Others

Example Audio Output Characterization Values

This characterization is scalar, with the minimum range being binary. Example binary values or scale endpoints are: the user cannot hear the computing system/the user can hear the computing system.

Using the user cannot hear the computing system and the user can hear the computing system as scale endpoints, the following table lists an example audio output characterization scale.

The user cannot hear the computing system. The UI cannot use audio to give the user choices, feedback, and so on.

The user can hear audible whispers (approximately 10-30 dBA). The UI might offer the user choices, feedback, and so on by using the earphone only.

The user can hear normal conversation (approximately 50-60 dBA).

The UI might offer the user choices, feedback, and so on by using a speaker(s) connected to the computing system.

The user can hear communications from the computing system without restrictions. The UI is not restricted by audio signal strength needs or concerns.

Possible ear damage (approximately 85+ dBA) The UI will not output audio for extended periods of time that will damage the user's hearing.

Example Audio Input Characterization Values

This characterization is scalar, with the minimum range being binary. Example binary values or scale endpoints are: the computing system cannot hear the user/the computing system can hear the user.

Using the computing system cannot hear the user and the computing system can hear the user as scale endpoints, the following table lists an example audio input scale.

The computing system cannot receive audio input from the user. When the computing system cannot receive audio input from the user, the UI will notify the user that audio input is not available.

The computing system is able to receive audible whispers from the user (approximate 10-30 dBA).

The computing system is able to receive normal conversational tones from the user (approximate 50-60 dBA).

The computing system can receive audio input from the user without restrictions. The UI is not restricted by audio signal strength needs or concerns.

The computing system can receive only high volume audio input from the user. The computing system will not require the user to give indications using a high volume. If a high volume is required, then the UI will notify the user that the computing system cannot receive audio input from the user.

Haptics

Haptics refers to interacting with the computing system using a tactile method. Haptic input includes the computing system's ability to sense the user's body movement, such as finger or head movement. Haptic output can include applying pressure to the user's skin. For haptic output, the more transducers, the more skin covered, the more resolution for presentation of information. That is if the user is covered with transducers, the computing system receives a lot more input from the user. Additionally, the ability for haptically-oriented output presentations is far more flexible.

Example Haptic Input Characterization Values

This characteristic is enumerated. Possible values include accuracy, precision, and range of:

Pressure

Velocity

Temperature

Acceleration

Torque

Tension

Distance

Electrical resistance

Texture

Elasticity

Wetness

Additionally, the characteristics listed previously are enhanced by:

Number of dimensions

Density and quantity of sensors (e.g. a 2 dimensional array of sensors. The sensors could measure the characteristics previously listed).

Chemical Output

Chemical output refers to using chemicals to present feedback, status, and so on to the user. Chemical output can include:

Things a user can taste

Things a user can smell

Characteristics of taste include:

Bitter

Sweet

Salty

Sour

Characteristics of smell include:

Strong/weak

Pungent/bland

Pleasant/unpleasant

Intrinsic, or signaling

Electrical Input

Electrical input refers to a user's ability to actively control electrical impulses to send indications to the computing system.

Brain activity

Muscle activity

Characteristics of electrical input can include:

Strength of impulse

Bandwidth

There are different types of bandwidth, for instance:

Network bandwidth

Inter-device bandwidth

Network Bandwidth

Network bandwidth is the computing system's ability to connect to other computing resources such as servers, computers, printers, and so on. A network can be a local area network (LAN), wide area network (WAN), peer-to-peer, and so on. For example, if the user's preferences are stored at a remote location and the computing system determines that the remote resources will not always be available, the system might cache the user's preferences locally to keep the UI consistent. As the cache may consume some of the available RAM resources, the UI might be restricted to simpler presentations, such as text or audio only.

If user preferences cannot be cached, then the UI might offer the user choices about what UI design families are available and the user can indicate their design family preference to the computing system.

Example Network Bandwidth Characterization Values

This UI characterization is scalar, with the minimum range being binary. Example binary values or scale endpoints are: no network access/full network access.

Using no network access and full network access as scale endpoints, the following table lists an example network bandwidth scale.

The computing system does not have a connection to network resources.

The UI is restricted to using local computing resources only. If user preferences are stored remotely, then the UI might not account for user preferences.

The computing system has an unstable connection to network resources.

The UI might warn the user that the connection to remote resources might be interrupted. The UI might ask the user if they want to cache appropriate information to accommodate for the unstable connection to network resources.

The computing system has a slow connection to network resources.

The UI might simplify, such as offer audio or text only, to accommodate for the slow connection. Or the computing system might cache appropriate data for the UI so the UI can always be optimized without restriction of the slow connection.

The computing system has a high speed, yet limited (by time) access to network resources. In the present moment, the UI does not have any restrictions based on access to network resources. If the computing system determines that it will lose a network connection, then the UI can warn the user and offer choices, such as, does the user want to cache appropriate information, about what to do.

The computing system has a very high-speed connection to network resources. There are no restrictions to the UI based on access to network resources. The UI can offer text, audio, video, haptic output, and so on.

Inter-Device Bandwidth

Inter-device bandwidth is the ability of the devices that are local to the user to communicate with each other. Inter-device bandwidth can affect the UI in that if there is low inter-device bandwidth, then the computing system cannot compute logic and deliver content as quickly. Therefore, the UI design might be restricted to a simpler interaction and presentation, such as audio or text only. If bandwidth is optimal, then there are no restrictions on the UI based on bandwidth. For example, the UI might offer text, audio, and 3-D moving graphics if appropriate for the user's context.

Example Inter-Device Bandwidth Characterization Values

This UI characterization is scalar, with the minimum range being binary. Example binary values or scale endpoints are: no inter-device bandwidth/full inter-device bandwidth.

Using no inter-device bandwidth and full inter-device bandwidth as scale endpoints, the following table lists an example inter-device bandwidth scale.

The computing system does not have inter-device connectivity. Input and output is restricted to each of the disconnected devices. The UI is restricted to the capability of each device as a stand-alone device.

Some devices have connectivity and others do not. It depends

The computing system has slow inter-device bandwidth. The task that the user wants to complete might require more bandwidth that is available among devices. In this case, the UI can offer the user a choice. Does the user want to continue and encounter slow performance? Or, does the user want to acquire more bandwidth by moving to a different location and taking advantage of opportunistic use of bandwidth?

The computing system has fast inter-device bandwidth. There are few, if any, restrictions on the interaction and presentation between the user and the computing system. The UI sends a warning message only if there is not enough bandwidth between devices.

The computing system has very high-speed inter-device connectivity.

There are no restrictions on the UI based on inter-device connectivity.

Exposing Device Characterization to the Computing System

There are many ways to expose the context characterization to the computing system, as shown by the following three examples.

Numeric Key

A context characterization can be exposed to the system with a numeric value corresponding to values of a predefined data structure.

For instance, a binary number can have each of the bit positions associated with a specific characteristic. The least significant bit may represent the need for a visual display device capable of displaying at least 24 characters of text in an unbroken series. Therefore a UI characterization of decimal 5 would require such a display to optimally display its content.

XML Tags

A UI's characterization can be exposed to the system with a string of characters conforming to the XML structure.

For instance, a context characterization might be represented by the following:

<Context Characterization>

<Theme>Work </Theme>

<Bandwidth>High Speed LAN Network Connection</Bandwidth>

<Field of View>28°</Field of View>

<Privacy>None </Privacy>

</Context Characterization>

One significant advantage of the mechanism is that it is easily extensible.

Programming Interface

A context characterization can be exposed to the computing system by associating the design with a specific program call.

For instance:

GetSecureContext can return a handle to the computing system that describes a UI a high security user context.

Name/Value Pairs

A context is modeled or represented with multiple attributes that each correspond to a specific element of the context (e.g., ambient temperature, location or a current user activity), and the value of an attribute represents a specific measure of that element. Thus, for example, for an attribute that represents the temperature of the surrounding air, an 80° Fahrenheit value represents a specific measurement of that temperature. Each attribute preferably has the following properties: a name, a value, an uncertainty level, units, and a timestamp. Thus, for example, the name of the air temperature attribute may be “ambient-temperature,” its units may be degrees Fahrenheit, and its value at a particular time may by 80. Associated with the current value may be a timestamp of 02/27/99 13:07 PST that indicates when the value was generated, and an uncertainty level of +/−1 degrees.

Determining UI Requirements for an Optimal or Appropriate UI

Considered singularly, many of the characteristics described below can be beneficially used to inform a computing system when to change. However, with an extensible system, additional characteristics can be considered (or ignored) at anytime, providing precision to the optimization.

Attributes Analyzed

At least the following categories of attributes can be used when determining the optimal UI design:

All available attributes. The model is dynamic so it can accommodate for any and all attributes that could affect the optimal UI design for a user's context. For example, this model could accommodate for temperature, weather conditions, time of day, available I/O devices, preferred volume level, desired level of privacy, and so on.

Significant attributes. Some attributes have a more significant influence on the optimal UI design than others. Significant attributes include, but are not limited to, the following:

The user can see video.

The user can hear audio.

The computing system can hear the user.

The interaction between the user and the computing system must be private.

The user's hands are occupied.

Attributes that correspond to a theme. Specific or programmatic. Individual or group.

The attributes discussed below are meant to be illustrative because it is often not possible to know all of the attributes that will affect a UI design until run time. Thus, the described techniques are dynamic to allowing accounting for unknown attributes. For clarity, attributes described below are presented with a scale and some include design examples. It is important to note that any of the attributes mentioned in this document are just examples. There are other attributes that can cause a UI to change that are not listed in this document. However, the dynamic model can account for additional attributes.

I/O Devices

Output—Devices that are directly perceivable by the user. For example, a visual output device creates photons that enter the user's eye. Output devices are always local to the user.

Input—A device that can be directly manipulated by the user. For example, a microphone translates energy created by the user's voice into electrical signals that can control a computer. Input devices are always local to the user.

The input devices to which the user has access to interact with the computer in ways that convey choices include, but are not limited to:

Keyboards

Touch pads

Mice

Trackballs

Microphones

Rolling/pointing/pressing/bending/turning/twisting/switching/rubbing/zipping cursor controllers—anything that the user's manipulation of can be sensed by the computer, this includes body movement that forms recognizable gestures.

Buttons, etc.

Output devices allow the presentation of computer-controlled information and content to the user, and include:

Speakers

Monitors

Pressure actuators, etc.

Input Device Types

Some characterizations of input devices are a direct result of the device itself.

Touch Screen

A display screen that is sensitive to the touch of a finger or stylus. Touch screens are very resistant to harsh environments where keyboards might eventually fail. They are often used with custom-designed applications so that the on-screen buttons are large enough to be pressed with the finger. Applications are typically very specialized and greatly simplified so they can be used by anyone. However, touch screens are also very popular on PDAs and full-size computers with standard applications, where a stylus is required for precise interaction with screen objects.

Example Touch Screen Attribute Characteristic Values

This characteristic is enumerated. Some example values are:

Screen objects must be at least 1 centimeter square

The user can see the touch screen directly

The user can see the touch screen indirectly (e.g. by using a monitor)

Audio feedback is available

Spatial input is difficult

Feedback to the user is presented to the user through a visual presentation surface.

Pointing Device

An input device used to move the pointer (cursor) on screen.

Example Pointing Device Characteristic Values

This characteristic is enumerated. Some example values are:

1-dimension (D) pointing device

2-D pointing device

3-D pointing device

Position control device

Range control device

Feedback to the user is presented through a visual presentation surface.

Speech

The conversion of spoken words into computer text. Speech is first digitized and then matched against a dictionary of coded waveforms. The matches are converted into text as if the words were typed on the keyboard.

Example Speech Characteristic Values

This characteristic is enumerated. Example values are:

Command and control

Dictation

Constrained grammar

Unconstrained grammar

Keyboard

A set of input keys. On terminals and personal computers, it includes the standard typewriter keys, several specialized keys and the features outlined below.

Example Keyboard Characteristic Values

This characteristic is enumerated. Example values are:

Numeric

Alphanumeric

Optimized for discreet input

Pen Tablet

A digitizer tablet that is specialized for handwriting and hand marking. LCD-based tablets emulate the flow of ink as the tip touches the surface and pressure is applied. Non-display tablets display the handwriting on a separate computer screen.

Example Pen Tablet Characteristic Values

This characteristic is enumerated. Example values include:

Direct manipulation device

Feedback is presented to the user through a visual presentation surface

Supplemental feedback can be presented to the user using audio output.

Optimized for special input

Optimized for data entry

Eye Tracking

An eye-tracking device is a device that uses eye movement to send user indications about choices to the computing system. Eye tracking devices are well suited for situations where there is little to no motion from the user (e.g. the user is sitting at a desk) and has much potential for non-command user interfaces.

Example Eye Tracking Characteristic Values

This characteristic is enumerated. Example values include:

2-D pointing device

User motion=still

Privacy=high

Output Device Types

Some characterizations of input devices are a direct result of the device itself.

HMD

Head Mounted Display) A display system built and worn like goggles that gives the illusion of a floating monitor in front of the user's face. The HMD is an important component of a body-worn computer (wearable computer). Single-eye units are used to display hands-free instructional material, and dual-eye, or stereoscopic, units are used for virtual reality applications.

Example HMD Characteristic Values

This characteristic is enumerated. Example values include:

Field of view>28°

User's hands=not available

User's eyes=forward and out

User's reality=augmented, mediated, or virtual

Monitors

A display screen used to present output from a computer, camera, VCR or other video generator. A monitor's clarity is based on video bandwidth, dot pitch, refresh rate, and convergence.

Example Monitor Characteristic Values

This characteristic is enumerated. Some example values include:

Required graphical resolution=high

User location=stationary

User attention=high

Visual density=high

Animation=yes

Simultaneous presentation of information=yes (e.g. text and image)

Spatial content=yes

I/O Device Use

This attribute characterizes how or for what an input or output device can be optimized for use. For example, a keyboard is optimized for entering alphanumeric text characters and monitor, head mounted display (HMD), or LCD panel is optimized for displaying those characters and other visual information.

Example Device Use Characterization Values

This characterization is enumerated. Example values include:

Speech recognition

Alphanumeric character input

Handwriting recognition

Visual presentation

Audio presentation

Haptic presentation

Chemical presentation

Redundant Controls

The user may have more than one way to perceive or manipulate the computing environment. For instance, they may be able to indicate choices by manipulating a mouse, or speaking.

By providing UI designs that have more than one I/O modality (also known as “multi-modal”), greater flexibility can be provided to the user. However, there are times when this is not appropriate. For instance, the devices may not be constantly available (user's hands are occupied, the ambient noise increases defeating voice recognition).

Example Redundant Controls Characterization Values

As a minimum, a numeric value could be associated with a configuration of devices.

1—keyboard and touch screen

2—HMD and 2-D pointing device

Alternately, a standardized list of available, preferred, or historically used devices could be used.

QWERTY keyboard

Twiddler

HMD

VGA monitor

SVGA monitor

LCD display

LCD panel

Privacy

Privacy is the quality or state of being apart from company or observation. It includes a user's trust of audience. For example, if a user doesn't want anyone to know that they are interacting with a computing system (such as a wearable computer), the preferred output device might be an HMD and the preferred input device might be an eye-tracking device.

Hardware Affinity for Privacy

Some hardware suits private interactions with a computing system more than others. For example, an HMD is a far more private output device than a desk monitor. Similarly, an earphone is more private than a speaker.

The UI should choose the correct input and output devices that are appropriate for the desired level of privacy for the user's current context and preferences.

Example Privacy Characterization Values

This characteristic is scalar, with the minimum range being binary. Example binary values, or scale endpoints, are: not private/private, public/not public, and public/private.

Using no privacy and fully private as the scale endpoints, the following table lists an example privacy characterization scale.

| Scale attribute | Implication/Example |
|---|---|
| No privacy is needed for input or | The UI is not restricted to any |
| output interaction | particular I/O device for presentation |
| | and interaction. For example, the UI |
| | could present content to the user |
| | through speakers on a large |
| | monitor in a busy office. |
| The input must be semi-private. | Coded speech commands, and |
| The output does not need to be | keyboard methods are appropriate. |
| private. | No restrictions on output |
| | presentation. |
| The input must be fully private. | No speech commands. No |
| The output does not need to be | restriction on output presentation. |
| private. | |
| The input must be fully private. | No speech commands. No LCD |
| The output must be semi-private, | panel. |
| The input does not need to be | No restrictions on input |
| private. The output must be fully | interaction. The output is restricted to |
| private. | an HMD device and/or an earphone. |
| The input does not need to be | No restrictions on input |
| private. The output must be semi- | interaction. The output is restricted to |
| private. | HMD device, earphone, and/or |
| | an LCD panel. |
| The input must be semi-private. | Coded speech commands and |
| The output must be semi-private. | keyboard methods are appropriate. |
| | Output is restricted to an HMD |
| | device, earphone or an LCD panel. |
| The input and output interaction | No speech commands. Keyboard |
| must be fully private. | devices might be acceptable. |
| | Output is restricted to and |
| | HMD device and/or an earphone. |

* Semi-private. The user and at least one other person can have access to or knowledge of the interaction between the user and the computing system.
* Fully private. Only the user can have access to or knowledge of the interaction between the user and the computing system.

Semi-private. The user and at least one other person can have access to or knowledge of the interaction between the user and the computing system.

Fully private. Only the user can have access to or knowledge of the interaction between the user and the computing system.

Visual

Visual output refers to the available visual density of the display surface is characterized by the amount of content a presentation surface can present to a user. For example, an LED output device, desktop monitor, dashboard display, hand-held device, and head mounted display all have different amounts of visual density. UI designs that are appropriate for a desktop monitor are very different than those that are appropriate for head-mounted displays. In short, what is considered to be the optimal UI will change based on what visual output device(s) is available.

In addition to density, visual display surfaces have the following characteristics:

Color

Motion

Field of view

Depth

Reflectivity

Size. Refers to the actual size of the visual presentation surface.

Position/location of visual display surface in relation to the user and the task that they're performing.

Number of focal points. A UI can have more than one focal point and each focal point can display different information.

Distance of focal points from the user. A focal point can be near the user or it can be far away. The amount distance can help dictate what kind and how much information is presented to the user.

Location of focal points in relation to the user. A focal point can be to the left of the user's vision, to the right, up, or down.

With which eye(s) the output is associated. Output can be associated with a specific eye or both eyes.

Ambient light.

Others (e.g., cost, flexibility, breakability, mobility, exit pupil, . . . )

The topics in this section describe in further detail the characteristics of some of these previously listed attributes.

Example Visual Density Characterization Values

This UI characterization is scalar, with the minimum range being binary. Example binary values or scale endpoints are: no visual density/full visual density.

Using no visual density and full visual density as scale endpoints, the following table lists an example visual density scale. Note that in some situations density might not be uniform across the presentation surface. For example, it may mimic the eye and have high resolution toward the center where text could be supported, but low resolution at the periphery where graphics are appropriate.

| Scale attribute | Implication/Design example |
|---|---|
| There is no visual density | The UI is restricted to non-visual |
| | output such as audio, haptic, and |
| | chemical. |
| Visual density is very low | The UI is restricted to a very |
| | simple output, such as single binary |
| | output devices (a single LED) or other |
| | simple configurations and arrays of light. |
| | No text is possible. |
| Visual density is low | The UI can handle text, but is |
| | restricted to simple prompts or the |
| | bouncing ball. |
| Visual density is medium | The UI can display text, simple |
| | prompts or the bouncing ball, and very |
| | simple graphics. |
| Visual density is high | The visual display has fewer |
| | restrictions. Visually dense items such |
| | as windows, icons, menus, and prompts |
| | are available as well as streaming video, |
| | detailed graphics and so on. |
| Visual density is the highest | The UI is not restricted by visual |
| available | density. A visual display that mirrors |
| | reality (e.g. 3-dimensional) is possible |
| | and appropriate. |

Color

This characterizes whether or not the presentation surface displays color. Color can be directly related to the ability of the presentation surface, or it could be assigned as a user preference.

Chrominance. The color information in a video signal.

Luminance. The amount of brightness, measured in lumens, which is given off by a pixel or area on a screen. It is the black/gray/white information in a video signal. Color information is transmitted as luminance (brightness) and chrominance (color). For example, dark red and bright red would have the same chrominance, but a different luminance. Bright red and bright green could have the same luminance, but would always have a different chrominance.

Example Color Characterization Values

This UI characterization is scalar, with the minimum range being binary. Example binary values or scale endpoints are: no color/full color.

Using no color and full color as scale endpoints, the following table lists an example color scale.

| Scale attribute | Implication/Design example |
|---|---|
| No color is available. | The UI visual presentation is |
| | monochrome. |
| One color is available. | The UI visual presentation is |
| | monochrome plus one color. |
| Two colors are available | The UI visual presentation is |
| | monochrome plus two colors or |
| | any combined of the two colors. |
| Full color is available. | The UI is not restricted by |
| | color. |

Motion

This characterizes whether or not a presentation surface has the ability to present motion to the user. Motion can be considered as a stand-alone attribute or as a composite attribute.

Example Motion Characterization Values

As a stand-alone attribute, this characterization is binary. Example binary values are: no animation available/animation available.

As a composite attribute, this characterization is scalar. Example scale endpoints include no motion/motion available, no animation available/animation available, or no video/video. The values between the endpoints depend on the other characterizations that are included in the composite. For example, the attributes color, visual density, and frames per second, etc. change the values between no motion and motion available.

Field of View

A presentation surface can display content in the focus of a user's vision, in the user's periphery, or both.

Example Field of View Characterization Values

This UI characterization is scalar, with the minimum range being binary. Example binary values, or scale endpoints, are: peripheral vision only/field of focus and peripheral vision is available.

Using peripheral vision only and field of focus and peripheral vision is available as scale endpoints, the following tables lists an example field of view scale.

| Scale attribute | Implication |
|---|---|
| All visual display is in the | The UI is restricted to using the |
| peripheral vision of the user | peripheral vision of the user. Lights, |
| | colors and other simple visual display |
| | are appropriate. Text is not appropriate. |
| Only the user's field of focus is | The UI is restricted to using the |
| available. | users field of vision only. |
| Text and other complex visual | |
| | displays are appropriate. |
| Both field of focus and the | The UI is not restricted by the |
| peripheral vision of the user | user's field of view. |
| are used. | |

Exemplary UI Design Implementation for Changes in Field of View

The following list contains examples of UI design implementations for how the computing system might respond to a change in field of view.

If the field of view for the visual presentation is more than 28°, then the UI might:

Display the most important information at the center of the visual presentation surface.

Devote more of the UI to text

Use periphicons outside of the field of view.

If the field of view for the visual presentation is less than 28°, then the UI might:

Restrict the size of the font allowed in the visual presentation. For example, instead of listing “Monday, Tuesday, and Wednesday,” and so on as choices, the UI might list “M, Tu, W” instead.

The body or environment stabilized image can scroll.

Depth

A presentation surface can display content in 2 dimensions (e.g., a desktop monitor) or 3 dimensions (a holographic projection).

Example Depth Characterization Values

This characterization is binary and the values are: 2 dimensions, 3 dimensions.

Reflectivity

The fraction of the total radiant flux incident upon a surface that is reflected and that varies according to the wavelength distribution of the incident radiation.

Example Reflectivity Characterization Values

This characterization is scalar, with the minimum range being binary. Example binary values, or scale endpoints, are: not reflective/highly reflective or no glare/high glare.

Using not reflective and highly reflective as scale endpoints, the following list is an example of a reflectivity scale.

Not reflective (no surface reflectivity).

10% surface reflectivity

20% surface reflectivity

30% surface reflectivity

40% surface reflectivity

50% surface reflectivity

60% surface reflectivity

70% surface reflectivity

80% surface reflectivity

90% surface reflectivity

Highly reflective (100% surface reflectivity)

Exemplary UI Design Implementation for Changes in Reflectivity

The following list contains examples of UI design implementations for how the computing system might respond to a change in reflectivity.

If the output device has high reflectivity—a lot of glare—then the visual presentation will change to a light colored UI.

Audio

Audio input and output refers to the UI's ability to present and receive audio signals. While the UI might be able to present or receive any audio signal strength, if the audio signal is outside the human hearing range (approximately 20 Hz to 20,000 Hz) it is converted so that it is within the human hearing range, or it is transformed into a different presentation, such as haptic output, to provide feedback, status, and so on to the user

Factors that influence audio input and output include (but this is not an inclusive list):

Level of ambient noise (this is an environmental characterization)

Directionality of the audio signal

Head-stabilized output (e.g. earphones)

Environment-stabilized output (e.g. speakers)

Spatial layout (3-D audio)

Proximity of the audio signal to the user

Frequency range of the speaker

Fidelity of the speaker, e.g. total harmonic distortion

Left, right, or both ears

What kind of noise is it?

Others (e.g., cost, proximity to other people, . . . )

Example Audio Output Characterization Values

This characterization is scalar, with the minimum range being binary. Example binary values or scale endpoints are: the user cannot hear the computing system/the user can hear the computing system.

Using the user cannot hear the computing system and the user can hear the computing system as scale endpoints, the following table lists an example audio output characterization scale.

| Scale attribute | Implication |
|---|---|
| The user cannot hear the | The UI cannot use audio to give |
| computing system. | the user choices, feedback, and so on. |
| The user can hear audible | The UI might offer the user |
| whispers (approximately 10-30 | choices, feedback, and so on by using |
| dBA). | the earphone only. |
| The user can hear normal | The UI might offer the user |
| conversation (approximately | choices, feedback, and so on by using |
| 50-60 dBA). | a speaker(s) connected to the |
| | computing system. |
| The user can hear | The UI is not restricted by audio |
| communications from the | signal strength needs or concerns. |
| computing system without | |
| restrictions. | |
| Possible ear damage | The UI will not output audio for |
| (approximately 85+ dBA) | extended periods of time that will |
| | damage the user's hearing. |

Example Audio Input Characterization Values

This characterization is scalar, with the minimum range being binary. Example binary values or scale endpoints are: the computing system cannot hear the user/the computing system can hear the user.

Using the computing system cannot hear the user and the computing system can hear the user as scale endpoints, the following table lists an example audio input scale.

| Scale attribute | Implication |
|---|---|
| The computing system cannot | When the computing system |
| receive audio input from | cannot receive audio input from the |
| the user. | user, the UI will notify the user that |
| | audio input is not available. |
| The computing system is able to | |
| receive audible whispers from | |
| the user (approximate 10-30 | |
| dBA). | |
| The computing system is able to | |
| receive normal conversational | |
| tones from the user (approximate | |
| 50-60 dBA). | |
| The computing system can | The UI is not restricted by audio |
| receive audio input from the | signal strength needs or concerns. |
| user without restrictions. | |
| The computing system can | The computing system will not |
| receive only high volume | require the user to give indications |
| audio input from the user. | using a high volume. If a high volume |
| | is required, then the UI will notify |
| | the user that the computing system |
| | cannot receive audio input from the |
| | user. |

Haptics

Haptics refers to interacting with the computing system using a tactile method. Haptic input includes the computing system's ability to sense the user's body movement, such as finger or head movement. Haptic output can include applying pressure to the user's skin. For haptic output, the more transducers, the more skin covered, the more resolution for presentation of information. That is if the user is covered with transducers, the computing system receives a lot more input from the user. Additionally, the ability for haptically-oriented output presentations is far more flexible.

Example Haptic Input Characterization Values

This characteristic is enumerated. Possible values include accuracy, precision, and range of:

Pressure

Velocity

Temperature

Acceleration

Torque

Tension

Distance

Electrical resistance

Texture

Elasticity

Wetness

Additionally, the characteristics listed previously are enhanced by:

Number of dimensions

Density and quantity of sensors (e.g., a 2 dimensional array of sensors. The sensors could measure the characteristics previously listed).

Chemical Output

Chemical output refers to using chemicals to present feedback, status, and so on to the user. Chemical output can include:

Things a user can taste

Things a user can smell

Example Taste Characteristic Values

This characteristic is enumerated. Example characteristic values of taste include:

Bitter

Sweet

Salty

Sour

Example Smell Characteristic Values

This characteristic is enumerated. Example characteristic values of smell include:

Strong/weak

Pungent/bland

Pleasant/unpleasant

Intrinsic, or signaling

Electrical Input

Electrical input refers to a user's ability to actively control electrical impulses to send indications to the computing system.

Brain activity

Muscle activity

Example Electrical Input Characterization Values

This characteristic is enumerated. Example values of electrical input can include:

Strength of impulse

Frequency

User Characterizations

This section describes the characteristics that are related to the user.

User Preferences

User preferences are a set of attributes that reflect the user's likes and dislikes, such as I/O devices preferences, volume of audio output, amount of haptic pressure, and font size and color for visual display surfaces. User preferences can be classified in the following categories:

Self characterization. Self-characterized user preferences are indications from the user to the computing system about themselves. The self-characterizations can be explicit or implicit. An explicit, self-characterized user preference results in a tangible change in the interaction and presentation of the UI. An example of an explicit, self characterized user preference is “Always use the font size 18” or “The volume is always off.” An implicit, self-characterized user preference results in a change in the interaction and presentation of the UI, but it might be not be immediately tangible to the user. A learning style is an implicit self-characterization. The user's learning style could affect the UI design, but the change is not as tangible as an explicit, self-characterized user preference.

If a user characterizes themselves to a computing system as a “visually impaired, expert computer user,” the UI might respond by always using 24-point font and monochrome with any visual display surface. Additionally, tasks would be chunked differently, shortcuts would be available immediately, and other accommodations would be made to tailor the UI to the expert user.

Theme selection. In some situations, it is appropriate for the computing system to change the UI based on a specific theme. For example, a high school student in public school 1420 who is attending a chemistry class could have a UI appropriate for performing chemistry experiments. Likewise, an airplane mechanic could also have a UI appropriate for repairing airplane engines. While both of these UIs would benefit from hands free, eyes out computing, the UI would be specifically and distinctively characterized for that particular system.

System characterization. When a computing system somehow infers a user's preferences and uses those preferences to design an optimal UI, the user preferences are considered to be system characterizations. These types of user preferences can be analyzed by the computing system over a specified period on time in which the computing system specifically detects patterns of use, learning style, level of expertise, and so on. Or, the user can play a game with the computing system that is specifically designed to detect these same characteristics.

Pre-configured. Some characterizations can be common and the UI can have a variety of pre-configured settings that the user can easily indicate to the UI. Pre-configured settings can include system settings and other popular user changes to default settings.

Remotely controlled. From time to time, it may be appropriate for someone or something other than the user to control the UI that is displayed.

Example User Preference Characterization Values

This UI characterization scale is enumerated. Some example values include:

Self characterization

Theme selection

System characterization

Pre-configured

Remotely controlled

Theme

A theme is a related set of measures of specific context elements, such as ambient temperature, current user task, and latitude, which reflect the context of the user. In other words, theme is a name collection of attributes, attribute values, and logic that relates these things. Typically, themes are associated with user goals, activities, or preferences. The context of the user includes:

The user's mental state, emotional state, and physical or health condition.

The user's setting, situation or physical environment. This includes factors external to the user that can be observed and/or manipulated by the user, such as the state of the user's computing system.

The user's logical and data telecommunications environment (or “cyber-environment,” including information such as email addresses, nearby telecommunications access such as cell sites, wireless computer ports, etc.).

Some examples of different themes include: home, work, school, and so on. Like user preferences, themes can be self characterized, system characterized, inferred, pre-configured, or remotely controlled.

Example Theme Characterization Values

This characteristic is enumerated. The following list contains example enumerated values for theme.

No theme

The user's theme is inferred.

The user's theme is pre-configured.

The user's theme is remotely controlled.

The user's theme is self characterized.

The user's theme is system characterized.

User Characteristics

User characteristics include:

Emotional state

Physical state

Cognitive state

Social state

Example User Characteristics Characterization Values

This UI characterization scale is enumerated. The following lists contain some of the enumerated values for each of the user characteristic qualities listed above.

* Emotional state.

* Happiness
* Sadness
* Anger
* Frustration
* Confusion

* Physical state

* Body
* Biometrics
* Posture
* Motion
* Physical Availability

* Senses
* Eyes
* Ears
* Tactile
* Hands
* Nose
* Tongue

* Workload demands/effects
* Interaction with computer devices
* Interaction with people
* Physical Health

* Environment

* Time/Space
* Objects
* Persons

* Audience/Privacy Availability

* Scope of Disclosure
* Hardware affinity for privacy
* Privacy indicator for user
* Privacy indicator for public
* Watching indicator
* Being observed indicator

* Ambient Interference

* Visual
* Audio
* Tactile

* Location.

* Place_name

* Latitude
* Longitude
* Altitude
* Room
* Floor
* Building
* Address
* Street
* City
* County
* State
* Country
* Postal_Code

* Physiology.

* Pulse
* Body_temperature
* Blood_pressure
* Respiration

* Activity

* Driving
* Eating
* Running
* Sleeping
* Talking
* Typing
* Walking

*Cognitive state

* Meaning
* Cognition

* Divided User Attention
* Task Switching
* Background Awareness

* Solitude
* Privacy

* Desired Privacy
* Perceived Privacy

* Social Context
* Affect

* Social state

* Whether the user is alone or if others are present
* Whether the user is being observed (e.g., by a camera)
* The user's perceptions of the people around them and the user's

perceptions of the intentions of the people that surround them.

* The user's social role (e.g. they are a prisoner, they are a guard,

they are a nurse, they are a teacher, they are a student, etc.)

Cognitive Availability

There are three kinds of user tasks: focus, routine, and awareness and three main categories of user attention: background awareness, task switched attention, and parallel. Each type of task is associated with a different category of attention. Focus tasks require the highest amount of user attention and are typically associated with task-switched attention. Routine tasks require a minimal amount of user attention or a user's divided attention and are typically associated with parallel attention. Awareness tasks appeals to a user's precognitive state or attention and are typically associated with background awareness. When there is an abrupt change in the sound, such as changing from a trickle to a waterfall, the user is notified of the change in activity.

Background Awareness

Background awareness is a non-focus output stimulus that allows the user to monitor information without devoting significant attention or cognition.

Example Background Awareness Characterization Values

This characterization is scalar, with the minimum range being binary. Example binary values or scale endpoints are: the user has no awareness of the computing system/the user has background awareness of the computing system.

Using these values as scale endpoints, the following list is an example background awareness scale.

No background awareness is available. A user's pre-cognitive state is unavailable.

A user has enough background awareness available to the computing system to receive one type of feedback or status.

A user has enough background awareness available to the computing system to receive more than one type of feedback, status and so on.

A user's background awareness is fully available to the computing system. A user has enough background awareness available for the computing system such that they can perceive more than two types of feedback or status from the computing system.

Exemplary UI Design Implementation for Background Awareness

The following list contains examples of UI design implementations for how a computing system might respond to a change in background awareness.

If a user does not have any attention for the computing system, that implies that no input or output are needed.

If a user has enough background awareness available to receive one type of feedback, the UI might:

Present a single light in the peripheral vision of a user. For example, this light can represent the amount of battery power available to the computing system. As the battery life weakens, the light gets dimmer. If the battery is recharging, the light gets stronger.

If a user has enough background awareness available to receive more than one type of feedback, the UI might:

Present a single light in the peripheral vision of the user that signifies available battery power and the sound of water to represent data connectivity.

If a user has full background awareness, then the UI might:

Present a single light in the peripheral vision of the user that signifies available battery power, the sound of water that represents data connectivity, and pressure on the skin to represent the amount of memory available to the computing system.

Task Switched Attention

When the user is engaged in more than one focus task, the user's attention can be considered to be task switched.

Example Task Switched Attention Characterization Values

This characteristic is scalar, with the minimum range being binary. Example binary values, or scale endpoints, are: the user does not have any attention for a focus task/the user has full attention for a focus task.

Using these characteristics as the scale endpoints, the following list is an example of a task switched attention scale.

A user does not have any attention for a focus task.

A user does not have enough attention to complete a simple focus task. The time between focus tasks is long.

A user has enough attention to complete a simple focus task. The time between focus tasks is long.

A user does not have enough attention to complete a simple focus task. The time between focus tasks is moderately long.

A user has enough attention to complete a simple focus task. The time between tasks is moderately long.

A user does not have enough attention to complete a simple focus task. The time between focus tasks is short.

A user has enough attention to complete a simple focus task. The time between focus tasks is short.

A user does not have enough attention to complete a moderately complex focus task. The time between focus tasks is long.

A user has enough attention to complete a moderately complex focus task. The time between focus tasks is long.

A user does not have enough attention to complete a moderately complex focus task. The time between focus tasks is moderately long.

A user has enough attention to complete a moderately complex focus task. The time between tasks is moderately long.

A user does not have enough attention to complete a moderately complex focus task. The time between focus tasks is short.

A user has enough attention to complete a moderately complex focus task. The time between focus tasks is short.

A user does not have enough attention to complete a moderately complex focus task. The time between focus tasks is long.

A user has enough attention to complete a complex focus task. The time between focus tasks is long.

A user does not have enough attention to complete a complex focus task. The time between focus tasks is moderately long.

A user has enough attention to complete a complex focus task. The time between tasks is moderately long.

A user does not have enough attention to complete a complex focus task. The time between focus tasks is short.

A user has enough attention to complete a complex focus task. The time between focus tasks is short.

A user has enough attention to complete a very complex, multi-stage focus task before moving to a different focus task.

Parallel

Parallel attention can consist of focus tasks interspersed with routine tasks (focus task+routine task) or a series of routine tasks (routine task+routine task).

Example Parallel Attention Characterization Values

This characteristic is scalar, with the minimum range being binary. Example binary values, or scale endpoints, are: the user does not have enough attention for a parallel task/the user has full attention for a parallel task.

Using these characteristics as scale endpoints, the following list is an example of a parallel attention scale.

A user has enough available attention for one routine task and that task is not with the computing system.

A user has enough available attention for one routine task and that task is with the computing system.

A user has enough attention to perform two routine tasks and at least of the routine tasks is with the computing system.

A user has enough attention to perform a focus task and a routine task. At least one of the tasks is with the computing system.

A user has enough attention to perform three or more parallel tasks and at least one of those tasks is in the computing system.

Physical Availability

Physical availability is the degree to which a person is able to perceive and manipulate a device. For example, an airplane mechanic who is repairing an engine does not have hands available to input indications to the computing systems by using a keyboard.

Learning Profile

A user's learning style is based on their preference for sensory intake of information. That is, most users have a preference for which sense they use to assimilate new information.

Example Learning Style Characterization Values

This characterization is enumerated. The following list is an example of learning style characterization values.

Auditory

Visual

Tactile

Exemplary UI Design Implementation for Learning Style

The following list contains examples of UI design implementations for how the computing system might respond to a learning style.

If a user is a auditory learner, the UI might:

Present content to the user by using audio more frequently.

Limit the amount of information presented to a user if these is a lot of ambient noise.

If a user is a visual learner, the UI might:

Present content to the user in a visual format whenever possible.

Use different colors to group different concepts or ideas together.

Use illustrations, graphs, charts, and diagrams to demonstrate content when appropriate.

If a user is a tactile learner, the UI might:

Present content to the user by using tactile output.

Increase the affordance of tactile methods of input (e.g. increase the affordance of keyboards).

Software Accessibility

If an application requires a media-specific plug-in, and the user does not have a network connection, then a user might not be able to accomplish a task.

Example Software Accessibility Characterization Values

This characterization is enumerated. The following list is an example of software accessibility values.

The computing system does not have access to software.

The computing system has access to some of the local software resources.

The computing system has access to all of the local software resources.

The computing system has access to all of the local software resources and some of the remote software resources by availing itself to opportunistic user of software resources.

The computing system has access to all of the local software resources and all remote software resources by availing itself to the opportunistic user of software resources.

The computing system has access to all software resources that are local and remote.

Perception of Solitude

Solitude is a user's desire for, and perception of, freedom from input. To meet a user's desire for solitude, the UI can do things like:

Cancel unwanted ambient noise

Block out human made symbols generated by other humans and machines

Example Solitude Characterization Values

This characterization is scalar, with the minimum range being binary. Example binary values, or scalar endpoints, are: no solitude/complete solitude.

Using these characteristics as scale endpoints, the following list is an example of a solitude scale.

No solitude

Some solitude

Complete solitude

Privacy

Privacy is the quality or state of being apart from company or observation. It includes a user's trust of audience. For example, if a user doesn't want anyone to know that they are interacting with a computing system (such as a wearable computer), the preferred output device might be a head mounted display (HMD) and the preferred input device might be an eye-tracking device.

Hardware Affinity for Privacy

Some hardware suits private interactions with a computing system more than others. For example, an HMD is a far more private output device than a desk monitor. Similarly, an earphone is more private than a speaker.

The UI should choose the correct input and output devices that are appropriate for the desired level of privacy for the user's current context and preferences.

Example Privacy Characterization Values

This characteristic is scalar, with the minimum range being binary. Example binary values, or scale endpoints, are: not private/private, public/not public, and public/private.

Using no privacy and fully private as the scale endpoints, the following list is an example privacy characterization scale.

No privacy is needed for input or output interaction

The input must be semi-private. The output does not need to be private.

The input must be fully private. The output does not need to be private.

The input must be fully private. The output must be semi-private.

The input does not need to be private. The output must be fully private.

The input does not need to be private. The output must be semi-private.

The input must be semi-private. The output must be semi-private.

The input and output interaction must be fully private.

Semi-private. The user and at least one other person can have access to or knowledge of the interaction between the user and the computing system.

Fully private. Only the user can have access to or knowledge of the interaction between the user and the computing system.

Exemplary UI Design Implementation for Privacy

The following list contains examples of UI design implementations for how the computing system might respond to a change in task complexity.

If no privacy is needed for input or output interaction:

The UI is not restricted to any particular I/O device for presentation and interaction. For example, the UI could present content to the user through speakers on a large monitor in a busy office.

If the input must be semi-private and if the output does not need to be private, the UI might:

Encourage the user to use coded speech commands or use a keyboard if one is available. There are no restrictions on output presentation.

If the input must be fully private and if the output does not need to be private, the UI might:

Not allow speech commands. There are no restrictions on output presentation.

If the input must be fully private and if the output needs to be semi-private, the UI might:

Not allow speech commands (allow only keyboard commands). Not allow an LCD panel and use earphones to provide audio response to the user.

If the output must be semi-private and if the input does not need to be private, the UI might:

Restrict users to an HMD device and/or an earphone for output. There are no restrictions on input interaction.

If the output must be semi-private and if the input does not need to be private, the UI might:

Restrict users to HMD devices, earphones, and/or LCD panels. There are no restrictions on input interaction.

If the input and output must be semi-private, the UI might:

Encourage the user to use coded speech commands and keyboard methods for input. Output may be restricted to HMD devices, earphones or LCD panels.

If the input and output interaction must be completely private, the UI might:

Not allow speech commands and encourage the user of keyboard methods of input. Output is restricted to HMD devices and/or earphones.

User Expertise

As the user becomes more familiar with the computing system or the UI, they may be able to navigate through the UI more quickly. Various levels of user expertise can be accommodated. For example, instead of configuring all the settings to make an appointment, users can recite all the appropriate commands in the correct order to make an appointment. Or users might be able to use shortcuts to advance or move back to specific screens in the UI. Additionally, expert users may not need as many prompts as novice users. The UI should adapt to the expertise level of the user.

Example User Expertise Characterization Values

This characteristic is scalar, with the minimum range being binary. Example binary values, or scale endpoints, are: new user/not new user, not an expert user/expert user, new user/expert user, and novice/expert.

Using novice and expert as scale endpoints, the following list is an example user expertise scale.

The user is new to the computing system and to computing in general.

The user is new to the computing system and is an intermediate computer user.

The user is new to the computing system, but is an expert computer user.

The user is an intermediate user in the computing system.

The user is an expert user in the computing system.

Exemplary UI Design Implementation for User Expertise

The following are characteristics of an exemplary audio UI design for novice and expert computer users.

The computing system speaks a prompt to the user and waits for a response.

If the user responds in x seconds or less, then the user is an expert. The computing system gives the user prompts only.

If the user responds in >x seconds, then the user is a novice and the computing system begins enumerating the choices available.

This type of UI design works well when more than 1 user accesses the same computing system and the computing system and the users do not know if they are a novice or an expert.

Language

User context may include language, as in the language they are currently speaking (e.g. English, German, Japanese, Spanish, etc.).

Example Language Characterization Values

This characteristic is enumerated. Example values include:

American English

British English

German

Spanish

Japanese

Chinese

Vietnamese

Russian

French

Computing System

This section describes attributes associated with the computing system that may cause a UI to change.

Computing hardware capability.

For purposes of user interfaces designs, there are four categories of hardware:

Input/output devices

Storage (e.g. RAM)

Processing capabilities

Power supply

The hardware discussed in this topic can be the hardware that is always available to the computing system. This type of hardware is usually local to the user. Or the hardware could sometimes be available to the computing system. When a computing system uses resources that are sometimes available to it, this can be called an opportunistic use of resources.

Storage

Storage capacity refers to how much random access memory (RAM) is available to the computing system at any given moment. This number is not considered to be constant because the computing system might avail itself to the opportunistic use of memory.

Usually the user does not need to be aware of how much storage is available unless they are engaged in a task that might require more memory than to which they reliably have access. This might happen when the computing system engages in opportunistic use of memory. For example, if an in-motion user is engaged in a task that requires the opportunistic use of memory and that user decides to change location (e.g. they are moving from their vehicle to a utility pole where they must complete other tasks), the UI might warn the user that if they leave the current location, the computing system may not be able to complete the task or the task might not get completed as quickly.

Example Storage Characterization Values

This UI characterization is scalar, with the minimum range being binary. Example binary values or scale endpoints are: no RAM is available/all RAM is available.

Using no RAM is available and all RAM is available, the following table lists an example storage characterization scale.

| Scale attribute | Implication |
|---|---|
| No RAM is available to the | If no RAM is available, there is |
| computing system | no UI available.-Or-There is no |
| | change to the UI. |
| Of the RAM available to the | The UI is restricted to the |
| computing system, only the | opportunistic use of RAM. |
| opportunistic use of RAM | |
| is available. | |
| Of the RAM that is available | The UI is restricted to using |
| to the computing system, only | RAM. |
| the local RAM is accessible | |
| Of the RAM that is available | The UI might warn the user that |
| to the computing system, the | if they lose oppportunistic use |
| local RAM is available and | of memory, the computing system |
| the user is about to lose | might not be able to complete |
| opportunistic use of RAM. | the task, or the task might |
| | not be completed as quickly. |
| Of the total possible RAM | If there is enough memory |
| available to the computing | available to the computing |
| system, all of it is | system to fully function at a |
| available. | high level, the UI may not need |
| | to inform the user. If the user |
| | indicates to the computing system |
| | that they want a task completed that |
| | requires more memory, the UI might |
| | suggest that the user change |
| | locations to take advantage of |
| | additional opportunistic use of |
| | memory |

Processing Capabilities

Processing capabilities fall into two general categories:

Speed. The processing speed of a computing system is measured in megahertz (MHz). Processing speed can be reflected as the rate of logic calculation and the rate of content delivery. The more processing power a computing system has, the faster it can calculate logic and deliver content to the user.

CPU usage. The degree of CPU usage does not affect the UI explicitly. With current UI design, if the CPU becomes too busy, the UI Typically “freezes” and the user is unable to interact with the computing system. If the CPU usage is too high, the UI will change to accommodate the CPU capabilities. For example, if the processor cannot handle the demands, the UI can simplify to reduce demand on the processor.

Example Processing Capability Characterization Values

This UI characterization is scalar, with the minimum range being binary. Example binary or scale endpoints are: no processing capability is available/all processing capability is available.

Using no processing capability is available and all processing capability as scale endpoints, the following table lists an example processing capability scale.

| Scale attribute | Implication |
|---|---|
| No processing power is | There is no change to the UI. |
| available to the computing system | |
| The computing system has | The UI might be audio or text |
| access to a slower speed CPU. | only. |
| The computing system has | The UI might choose to use |
| access to a high speed CPU | video in the presentation instead of a |
| | still picture. |
| The computing system has | There are no restrictions on the |
| access to and control of all | UI based on processing power. |
| processing power available to | |
| the computing system. | |

Power Supply

There are two types of power supplies available to computing systems: alternating current (AC) and direct current (DC). Specific scale attributes for AC power supplies are represented by the extremes of the exemplary scale. However, if a user is connected to an AC power supply, it may be useful for the UI to warn an in-motion user when they're leaving an AC power supply. The user might need to switch to a DC power supply if they wish to continue interacting with the computing system while in motion. However, the switch from AC to DC power should be an automatic function of the computing system and not a function of the UI.

On the other hand, many computing devices, such as wearable personal computers (WPCs), laptops, and PDAs, operate using a battery to enable the user to be mobile. As the battery power wanes, the UI might suggest the elimination of video presentations to extend battery life. Or the UI could display a VU meter that visually demonstrates the available battery power so the user can implement their preferences accordingly.

Example Power Supply Characterization Values

This task characterization is binary if the power supply is AC and scalar if the power supply is DC. Example binary values are: no power/full power. Example scale endpoints are: no power/all power.

Using no power and full power as scale endpoints, the following list is an example power supply scale.

There is no power to the computing system.

There is an imminent exhaustion of power to the computing system.

There is an inadequate supply of power to the computing system.

There is a limited, but potentially inadequate supply of power to the computing system.

There is a limited but adequate power supply to the computing system.

There is an unlimited supply of power to the computing system.

Exemplary UI Design Implementation for Power Supply

The following list contains examples of UI design implementations for how the computing system might respond to a change in the power supply capacity.

If there is minimal power remaining in a battery that is supporting a computing system, the UI might:

Power down any visual presentation surfaces, such as an LCD.

Use audio output only.

If there is minimal power remaining in a battery and the UI is already audio-only, the UI might:

Decrease the audio output volume.

Decrease the number of speakers that receive the audio output or use earplugs only.

Use mono versus stereo output.

Decrease the number of confirmations to the user.

If there is, for example, six hours of maximum-use battery life available and the computing system determines that the user not have access to a different power source for 8 hours, the UI might:

Decrease the luminosity of any visual display by displaying line drawings instead of 3-dimensional illustrations.

Change the chrominance from color to black and white.

Refresh the visual display less often.

Decrease the number of confirmations to the user.

Use audio output only.

Decrease the audio output volume.

Computing Hardware Characteristics

The following is a list of some of the other hardware characteristics that may be influence what is an optimal UI design.

Cost

Waterproof

Ruggedness

Mobility

Again, there are other characteristics that could be added to this list. However, it is not possible to list all computing hardware attributes that might influence what is considered to be an optimal UI design until run time.

Bandwidth

There are different types of bandwidth, for instance:

Network bandwidth

Inter-device bandwidth

Network Bandwidth

Network bandwidth is the computing system's ability to connect to other computing resources such as servers, computers, printers, and so on. A network can be a local area network (LAN), wide area network (WAN), peer-to-peer, and so on. For example, if the user's preferences are stored at a remote location and the computing system determines that the remote resources will not always be available, the system might cache the user's preferences locally to keep the UI consistent. As the cache may consume some of the available RAM resources, the UI might be restricted to simpler presentations, such as text or audio only.

If user preferences cannot be cached, then the UI might offer the user choices about what UI design families are available and the user can indicate their design family preference to the computing system.

Example Network Bandwidth Characterization Values

This UI characterization is scalar, with the minimum range being binary. Example binary values or scale endpoints are: no network access/full network access.

Using no network access and full network access as scale endpoints, the following table lists an example network bandwidth scale.

| Scale attribute | Implication |
|---|---|
| The computing system does not | The UI is restricted to using local |
| have a connection to network | computing resources only. If user |
| resources. | preferences are stored remotely, then |
| | the UI might not account for user |
| | preferences. |
| The computing system has an | The UI might warn the user that |
| unstable connection to network | the connection to remote resources |
| resources. | might be interrupted. The UI might ask |
| | the user if they want to cache |
| | appropriate information to |
| | accommodate for the unstable |
| | connection to network resources. |
| The computing system has a | The UI might simplify, such as |
| slow connection to network | offer audio or text only, to |
| resources. | accommodate for the slow connection. |
| | Or the computing system might cache |
| | appropriate data for the UI so the UI |
| | can always be optimized without |
| | restriction of the slow connection. |
| The computing system has a | In the present moment, the UI |
| high speed, yet limited (by | does not have any restrictions based on |
| time) access to network | access to network resources. If the |
| resources. | computing system determines that it |
| | will lose a network connection, then the |
| | UI can warn the user and offer choices, |
| | such as does the user want to cache |
| | appropriate information, about what to |
| | do. |
| The computing system has a | There are no restrictions to the |
| very high-speed connection to | UI based on access to network |
| network resources. | resources. The UI can offer text, audio, |
| | video, haptic output, and so on. |

Inter-device Bandwidth

Inter-device bandwidth is the ability of the devices that are local to the user to communicate with each other. Inter-device bandwidth can affect the UI in that if there is low inter-device bandwidth, then the computing system cannot compute logic and deliver content as quickly. Therefore, the UI design might be restricted to a simpler interaction and presentation, such as audio or text only. If bandwidth is optimal, then there are no restrictions on the UI based on bandwidth. For example, the UI might offer text, audio, and 3-D moving graphics if appropriate for the user's context.

Example Inter-device Bandwidth Characterization Values

This UI characterization is scalar, with the minimum range being binary. Example binary values or scale endpoints are: no inter-device bandwidth/full inter-device bandwidth.

Using no inter-device bandwidth and full inter-device bandwidth as scale endpoints, the following table lists an example inter-device bandwidth scale.

| Scale attribute | Implication |
|---|---|
| The computing system | Input and output is restricted to |
| does not have inter-device | each of the disconnected devices. The |
| connectivity. | UI is restricted to the capability |
| | of each device as a stand-alone |
| | device. |
| Some devices have connectivity | It depends |
| and others do not. | |
| The computing system has slow | The task that the user wants to |
| inter-device bandwidth. | complete might require more |
| | bandwidth that is available among |
| | devices. In this case, the UI can |
| | offer the user a choice. Does the |
| | user want to continue and encounter |
| | slow performance? Or, does |
| | the user want to acquire more |
| | bandwidth by moving to a different |
| | location and taking advantage of |
| | opportunistic use of bandwidth? |
| The computing system has | There are few, if any, restrictions |
| fast inter-device | on the interaction and presentation |
| bandwidth. | between the user and the computing |
| | system. The UI sends a warning |
| | message only if there is not enough |
| | bandwidth between devices. |
| The computing system has | There are no restrictions on the |
| very high-speed | UI based on inter-device |
| inter-device connectivity. | connectivity. |

Context Availability

Context availability is related to whether the information about the model of the user context is accessible. If the information about the model of the context is intermittent, deemed inaccurate, and so on, then the computing system might not have access to the user's context.

Example Context Availability Characterization Values

This task characterization is scalar, with the minimum range being binary. Example binary values or scale endpoints are: context not available/context available.

Using context not available and context available as scale endpoints, the following list is an example context availability scale.

No context is available to the computing system.

Some of the user's context is available to the computing system.

A moderate amount of the user's context is available to the computing system.

Most of the user's context is available to the computing system.

All of the user's context is available to the computing system.

Exemplary UI Design for Context Availability

The following list contains examples of UI design implementations for how the computing system might respond to a change in context availability.

If the information about the model of context is intermittent, deemed inaccurate, or otherwise unavailable, the UI might:

Stay the same.

Ask the user if the UI needs to change.

Infer a UI from a previous pattern if the user's context history is available.

Change the UI based on all other attributes except for user context (e.g. I/O device availability, privacy, task characteristics, etc.)

Use a default UI.

Opportunistic Use of Resources

Some UI components, or other enabling UI content, may allow acquisition from outside sources. For example, if a person is using a wearable computer and they sit at a desk that has a monitor on it, the wearable computer might be able to use the desktop monitor as an output device.

Example Opportunistic Use of Resources Characterization Scale

This characteristic is scalar, with the minimum range being binary. Example binary values, or scale endpoints, are: no opportunistic use of resources/use of all opportunistic resources.

Using these characteristics, the following list is an example of an opportunistic use of resources scale.

The circumstances do not allow for the opportunistic use of resources in the computing system.

Of the resources available to the computing system, there is a possibility to make opportunistic use of resources.

Of the resources available to the computing system, the computing system can make opportunistic use of most of the resources.

Of the resources available to the computing system, all are accessible and available.

Additional information corresponding to this list can be found below in sections related to exemplary scale for storage, exemplary scale for processing capability, and exemplary scale for power supply

Content

Content is defined as information or data that is part of or provided by a task. Content, in contrast to UI elements, does not serve a specific role in the user/computer dialog. It provides informative or entertaining information to the user. It is not a control. For example a radio has controls (knobs, buttons) used to choose and format (tune a station, adjust the volume & tone) of broadcasted audio content.

Sometimes content has associated metadata, but it is not necessary.

Example content characterization values.

This characterization is enumerated. Example values include:

Quality

Static/streamlined

Passive/interactive

Type

Output device required

Output device affinity

Output device preference

Rendering software

Implicit. The computing system can use characteristics that can be inferred from the information itself, such as message characteristics for received messages.

Source. A type or instance of carrier, media, channel or network path.

Destination. Address used to reach the user (e.g., a user typically has multiple address, phone numbers, etc.).

Message content. (parseable or described in metadata)

Data format type.

Arrival time.

Size.

Previous messages. Inference based on examination of log of actions on similar messages.

Explicit. Many message formats explicitly include message-characterizing information, which can provide additional filtering criteria.

Title.

Originator identification. (e.g., email author)

Origination date & time.

Routing. (e.g., email often shows path through network routers)

Priority.

Sensitivity. Security levels and permissions

Encryption type.

File format. Might be indicated by file name extension.

Language. May include preferred or required font or font type.

Other recipients (e.g., email cc field).

Required software.

Certification. A trusted indication that the offer characteristics are dependable and accurate.

Recommendations. Outside agencies can offer opinions on what information may be appropriate to a particular type of user or situation.

Security

Controlling security is controlling a user's access to resources and data available in a computing system. For example when a user logs on a network, they must supply a valid user name and password to gain access to resource on the network such as, applications, data, and so on.

In this sense, security is associated with the capability of a user or outside agencies in relation to a user's data or access to data, and does not specify what mechanisms are employed to assure the security.

Security mechanisms can also be separately and specifically enumerated with characterizing attributes.

Permission is related to security. Permission is the security authorization presented to outside people or agencies. This characterization could inform UI creation/selection by giving a distinct indication when the user is presented information that they have given permission to others to access.

Example Security Characterization Values

This characteristic is scalar, with the minimum range being binary. Example binary values, or scale endpoints are: no authorized user access/all user access, no authorized user access/public access, and no public access/public access.

Using no authorized user access and public access as scale endpoints, the following list is an example security scale.

No authorized access.

Single authorized user access.

Authorized access to more than one person.

Authorized access for more than one group of people.

Public access.

Single authorized user only access. The only person who has authorized access to the computing system is a specific user with valid user credentials.

Public access. There are no restrictions on who has access to the computing system. Anyone and everyone can access the computing system.

Task Characterizations

A task is a user-perceived objective comprising steps. The topics in this section enumerate some of the important characteristics that can be used to describe tasks. In general, characterizations are needed only if they require a change in the UI design.

The topics in this section include examples of task characterizations, example characterization values, and in some cases, example UI designs or design characteristics.

Task Length

Whether a task is short or long depends upon how long it takes a target user to complete the task. That is, a short task takes a lesser amount of time to complete than a long task. For example, a short task might be creating an appointment. A long task might be playing a game of chess.

Example Task Length Characterization Values

This task characterization is scalar, with the minimum range being binary. Example binary values or scale endpoints are: short/not short, long/not long, or short/long.

Using short/long as scale endpoints, the list is an example task length scale.

The task is very short and can be completed in 30 seconds or less

The task is moderately short and can be completed in 31-60 seconds.

The task is short and can be completed in 61-90 seconds.

The task is slightly long and can be completed in 91-300 seconds.

The task is moderately long and can be completed in 301-1,200 seconds.

The task is long and can be completed in 1,201-3,600 seconds.

The task is very long and can be completed in 3,601 seconds or more.

Task Complexity

Task complexity is measured using the following criteria:

Number of elements in the task. The greater the number of elements, the more likely the task is complex.

Element interrelation. If the elements have a high degree of interrelation, then the more likely the task is complex.

User knowledge of structure. If the structure, or relationships, between the elements in the task is unclear, then the more likely the task is considered to be complex.

If a task has a large number of highly interrelated elements and the relationship between the elements is not known to the user, then the task is considered to be complex. On the other hand, if there are a few elements in the task and their relationship is easily understood by the user, then the task is considered to be well-structured. Sometimes a well-structured task can also be considered simple.

Example Task Complexity Characterization Values

This task characterization is scalar, with the minimum range being binary. Example binary values or scale endpoints are: simple/not simple, complex/not complex, simple/complex, well-structured/not well-structured, or well-structured/complex.

Using simple/complex as scale endpoints, the list is an example task complexity scale.

There is one, very simple task composed of 1-5 interrelated elements whose relationship is well understood.

There is one simple task composed of 6-10 interrelated elements whose relationship is understood.

There is more than one very simple task and each task is composed of 1-5 elements whose relationship is well understood.

There is one moderately simple task composed of 11-15 interrelated elements whose relationship is 80-90% understood by the user.

There is more than one simple task and each task is composed of 6-10 interrelated whose relationship is understood by the user.

There is one somewhat simple task composed of 16-20 interrelated elements whose relationship is understood by the user.

There is more than one moderately simple task and each task is composed of 11-15 interrelated elements whose relationship is 80-90% understood by the user.

There is one complex task complex task composed of 21-35 interrelated elements whose relationship is 60-79% understood by the user.

There is more than one somewhat complex task and each task is composed of 16-20 interrelated elements whose relationship is understood by the user.

There is one moderately complex task composed of 36-50 elements whose relationship is 80-90% understood by the user.

There is more than one complex task and each task is composed of 21-35 elements whose relationship is 60-79% understood by the user.

There is one very complex task composed of 51 or more elements whose relationship is 40-60% understood by the user.

There is more than one complex task and each task is composed of 36-50 elements whose relationship is 40-60% understood by the user.

There is more than one very complex task and each part is composed of 51 or more elements whose relationship is 20-40% understood by the user.

Exemplary UI Design Implementation for Task Complexity

The following list contains examples of UI design implementations for how the computing system might respond to a change in task complexity.

For a task that is long and simple (well-structured), the UI might:

Give prominence to information that could be used to complete the task.

Vary the text-to-speech output to keep the user's interest or attention.

For a task that is short and simple, the UI might:

Optimize to receive input from the best device. That is, allow only input that is most convenient for the user to use at that particular moment.

If a visual presentation is used, such as an LCD panel or monitor, prominence may be implemented using visual presentation only.

For a task that is long and complex, the UI might:

Increase the orientation to information and devices.

Increase affordance to pause in the middle of a task. That is, make it easy for a user to stop in the middle of the task and then return to the task.

For a task that is short and complex, the UI might:

Default to expert mode.

Suppress elements not involved in choices directly related to the current task.

Change modality.

Task Familiarity

Task familiarity is related to how well acquainted a user is with a particular task. If a user has never completed a specific task, they might benefit from more instruction from the computing environment than a user who completes the same task daily. For example, the first time a car rental associate rents a car to a consumer, the task is very unfamiliar. However, after about a month, the car rental associate is very familiar with renting cars to consumers.

Example Task Familiarity Characterization Values

This task characterization is scalar, with the minimum range being binary. Example binary values or scale endpoints are: familiar/not familiar, not unfamiliar/unfamiliar, and unfamiliar/familiar.

Using unfamiliar and familiar as scale endpoints, the list is an example task familiarity scale.

On a scale of 1 to 5, where one is very unfamiliar and 5 is very familiar, the task familiarity rating is 1.

On a scale of 1 to 5, where one is very unfamiliar and 5 is very familiar, the task familiarity rating is 2.

On a scale of 1 to 5, where one is very unfamiliar and 5 is very familiar, the task familiarity rating is 3.

On a scale of 1 to 5, where one is very unfamiliar and 5 is very familiar, the task familiarity rating is 4.

On a scale of 1 to 5, where one is very unfamiliar and 5 is very familiar, the task familiarity rating is 5.

Exemplary UI Design Implementation for Task Familiarity

The following list contains examples of UI design implementations for how the computing system might respond to a change in task familiarity.

For a task that is unfamiliar, the UI might:

Increase task orientation to provide a high level schema for the task.

Offer detailed help.

Present the task in a greater number of steps.

Offer more detailed prompts.

Provide information in as many modalities as possible.

For a task that is familiar, the UI might:

Decrease the affordances for help.

Offer summary help.

Offer terse prompts.

Decrease the amount of detail given to the user.

Use auto-prompt and auto-complete (that is, make suggestions based on past choices made by the user).

The ability to barge ahead is available.

Use user-preferred modalities.

Task Sequence

A task can have steps that must be performed in a specific order. For example, if a user wants to place a phone call, the user must dial or send a phone number before they are connected to and can talk with another person. On the other hand, a task, such as searching the Internet for a specific topic, can have steps that do not have to be performed in a specific order.

Example Task Sequence Characterization Values

This task characterization is scalar, with the minimum range being binary. Example binary values or scale endpoints are: scripted/not scripted, nondeterministic/not nondeterministic, or scripted/nondeterministic.

Using scripted/nondeterministic as scale endpoints, the following list is an example task sequence scale.

The each step in the task is completely scripted.

The general order of the task is scripted. Some of the intermediary steps can be performed out of order.

The first and last steps of the task are scripted. The remaining steps can be performed in any order.

The steps in the task do not have to be performed in any order.

Exemplary UI Design Implementation for Task Sequence

The following list contains examples of UI design implementations for how the computing system might respond to a change in task sequence.

For a task that is scripted, the UI might:

Present only valid choices.

Present more information about a choice so a user can understand the choice thoroughly.

Decrease the prominence or affordance of navigational controls.

For a task that is nondeterministic, the UI might:

Present a wider range of choices to the user.

Present information about the choices only upon request by the user.

Increase the prominence or affordance of navigational controls.

Task Independence

The UI can coach a user though a task or the user can complete the task without any assistance from the UI. For example, if a user is performing a safety check of an aircraft, the UI can coach the user about what questions to ask, what items to inspect, and so on. On the other hand, if the user is creating an appointment or driving home, they might not need input from the computing system about how to successfully achieve their objective.

Example Task Independence Characterization Values

This task characterization is scalar, with the minimum range being binary. Example binary values or scale endpoints are: coached/not coached, not independently executed/independently executed, or coached/independently executed.

Using coached/independently executed as scale endpoints, the following list is an example task guidance scale.

Each step in the task is completely scripted.

The general order of the task is scripted. Some of the intermediary steps can be performed out of order.

The first and last steps of the task are scripted. The remaining steps can be performed in any order.

The steps in the task do not have to be performed in any order.

Task Creativity

A formulaic task is a task in which the computing system can precisely instruct the user about how to perform the task. A creative task is a task in which the computing system can provide general instructions to the user, but the user uses their knowledge, experience, and/or creativity to complete the task. For example, the computing system can instruct the user about how to write a sonnet. However, the user must ultimately decide if the combination of words is meaningful or poetic.

Example Task Creativity Characterization Values

This task characterization is scalar, with the minimum range being binary. Example binary values or scale endpoints could be defined as formulaic/not formulaic, creative/not creative, or formulaic/creative.

Using formulaic and creative as scale endpoints, the following list is an example task creativity scale.

On a scale of 1 to five, where 1 is formulaic and 5 is creative, the task creativity rating is 1.

On a scale of 1 to five, where 1 is formulaic and 5 is creative, the task creativity rating is 2.

On a scale of 1 to five, where 1 is formulaic and 5 is creative, the task creativity rating is 3.

On a scale of 1 to five, where 1 is formulaic and 5 is creative, the task creativity rating is 4.

On a scale of 1 to five, where 1 is formulaic and 5 is creative, the task creativity rating is 5.

Software Requirements

Tasks can be intimately related to software requirements. For example, a user cannot create a complicated database without software.

Example Software Requirements Characterization Values

This task characterization is enumerated. Example values include.

JPEG viewer

PDF reader

Microsoft Word

Microsoft Access

Microsoft Office

Lotus Notes

Windows NT 4.0

Mac OS 10

Task Privacy

Task privacy is related to the quality or state of being apart from company or observation. Some tasks have a higher level of desired privacy than others. For example, calling a physician to receive medical test results has a higher level of privacy than making an appointment for a meeting with a co-worker.

Example Task Privacy Characterization Values

This task characterization is scalar, with the minimum range being binary. Example binary values or scale endpoints are: private/not private, public/not public, or private/public.

Using private/public as scale endpoints, the following table is an example task privacy scale.

The task is not public. Anyone can have knowledge of the task.

The task is semi-private. The user and at least one other person have knowledge of the task.

The task is fully private. Only the user can have knowledge of the task.

Hardware Requirements

A task can have different hardware requirements. For example, talking on the phone requires audio input and output while entering information into a database has an affinity for a visual display surface and a keyboard.

Example Hardware Requirements Characterization Values

This task characterization is enumerated. Example values include:

10 MB available of storage

1 hour of power supply

A free USB connection

Task Collaboration

A task can be associated with a single user or more than one user. Most current computer-assisted tasks are designed as single-user tasks. Examples of collaborative computer-assisted tasks include participating in a multi-player video game or making a phone call.

Example Task Collaboration Characterization Values

This task characterization is binary. Example binary values are single user/collaboration.

Task Relation

A task can be associated with other tasks people, applications, and so on. Or a task can stand alone on it's own.

Example Task Relation Characterization Values

This task characterization is binary. Example binary values are unrelated task/related task.

Task Completion

There are some tasks that must be completed once they are started and others that do not have to be completed. For example, if a user is scuba diving and is using a computing system while completing the task of decompressing, it is essential that the task complete once it is started. To ensure the physical safety of the user, the software must maintain continuous monitoring of the user's elapsed time, water pressure, and air supply pressure/quantity. The computing system instructs the user about when and how to safely decompress. If this task is stopped for any reason, the physical safety of the user could be compromised.

Example Task Completion Characterization Values

This task characterization is enumerated. Example values are:

Must be completed

Does not have to be completed

Can be paused

Not known

Task Priority

Task priority is concerned with order. The order may refer to the order in which the steps in the task must be completed or order may refer to the order in which a series of tasks must be performed. This task characteristic is scalar. Tasks can be characterized with a priority scheme, such as (beginning at low priority) entertainment, convenience, economic/personal commitment, personal safety, personal safety and the safety of others. Task priority can be defined as giving one task preferential treatment over another. Task priority is relative to the user. For example, “all calls from mom” may be a high priority for one user, but not another user.

Example Task Privacy Characterization Values

This task characterization is scalar, with the minimum range being binary. Example binary values or scale endpoints are no priority/high priority.

Using no priority and high priority as scale endpoints, the following list is an example task priority scale.

The current task is not a priority. This task can be completed at any time.

The current task is a low priority. This task can wait to be completed until the highest priority, high priority, and moderately high priority tasks are completed.

The current task is moderately high priority. This task can wait to be completed until the highest priority and high priority tasks are addressed.

The current task is high priority. This task must be completed immediately after the highest priority task is addressed.

The current task is of the highest priority to the user. This task must be completed first.

Task Importance

Task importance is the relative worth of a task to the user, other tasks, applications, and so on. Task importance is intrinsically associated with consequences. For example, a task has higher importance if very good or very bad consequences arise if the task is not addressed. If few consequences are associated with the task, then the task is of lower importance.

Example Task Importance Characterization Values

This task characterization is scalar, with the minimum range being binary. Example binary values or scale endpoints are not important/very important.

Using not important and very important as scale endpoints, the following list is an example task importance scale.

The task in not important to the user. This task has an importance rating of “1.”

The task is of slight importance to the user. This task has an importance rating of “2.”

The task is of moderate importance to the user. This task has an importance rating of “3.”

The task is of high importance to the user. This task has an importance rating of “4.”

The task is of the highest importance to the user. This task has an importance rating of “5.”

Task Urgency

Task urgency is related to how immediately a task should be addressed or completed. In other words, the task is time dependent. The sooner the task should be completed, the more urgent it is.

Example Task Urgency Characterization Values

This task characterization is scalar, with the minimum range being binary. Example binary values or scale endpoints are not urgent/very urgency.

Using not urgent and very urgent as scale endpoints, the following list is an example task urgency scale.

A task is not urgent. The urgency rating for this task is “1.”

A task is slightly urgent. The urgency rating for this task is “2.”

A task is moderately urgent. The urgency rating for this task is “3.”

A task is urgent. The urgency rating for this task is “4.”

A task is of the highest urgency and requires the user's immediate attention. The urgency rating for this task is “5.”

Exemplary UI Design Implementation for Task Urgency

The following list contains examples of UI design implementations for how the computing system might respond to a change in task urgency.

If the task is not very urgent (e.g. a task urgency rating of 1, using the scale from the previous list), the UI might not indicate task urgency.

If the task is slightly urgent (e.g. a task urgency rating of 2, using the scale from the previous list), and if the user is using a head mounted display (HMD), the UI might blink a small light in the peripheral vision of the user.

If the task is moderately urgent (e.g. a task urgency rating of 3, using the scale from the previous list), and if the user is using an HMD, the UI might make the light that is blinking in the peripheral vision of the user blink at a faster rate.

If the task is urgent, (e.g. a task urgency rating of 4, using the scale from the previous list), and if the user is wearing an HMD, two small lights might blink at a very fast rate in the peripheral vision of the user.

If the task is very urgent, (e.g. a task urgency rating of 5, using the scale from the previous list), and if the user is wearing an HMD, three small lights might blink at a very fast rate in the peripheral vision of the user. In addition, a notification is sent to the user's direct line of sight that warns the user about the urgency of the task. An audio notification is also presented to the user.

Task Concurrency

Mutually exclusive tasks are tasks that cannot be completed at the same time while concurrent tasks can be completed at the same time. For example, a user cannot interactively create a spreadsheet and a word processing document at the same time. These two tasks are mutually exclusive. However, a user can talk on the phone and create a spreadsheet at the same time.

Example Task Concurrency Characterization Values

This task characterization is binary. Example binary values are mutually exclusive and concurrent.

Task Continuity

Some tasks can have their continuity or uniformity broken without comprising the integrity of the task, while other cannot be interrupted without compromising the outcome of the task. The degree to which a task is associated with saving or preserving human life is often associated with the degree to which it can be interrupted. For example, if a physician is performing heart surgery, their task of performing heart surgery is less interruptible than the task of making an appointment.

Example Task Continuity Characterization Values

This task characterization is scalar, with the minimum range being binary. Example binary values or scale endpoints are interruptible/not interruptible or abort/pause.

Using interruptible/not interruptible as scale endpoints, the following list is an example task continuity scale.

The task cannot be interrupted.

The task can be interrupted for 5 seconds at a time or less.

The task can be interrupted for 6-15 seconds at a time.

The task can be interrupted for 16-30 seconds at a time.

The task can be interrupted for 31-60 seconds at a time.

The task can be interrupted for 61-90 seconds at a time.

The task can be interrupted for 91-300 seconds at a time.

The task can be interrupted for 301-1,200 seconds at a time.

The task can be interrupted 1,201-3,600 seconds at a time.

The task can be interrupted for 3,601 seconds or more at a time.

The task can be interrupted for any length of time and for any frequency.

Cognitive Load

Cognitive load is the degree to which working memory is engaged in processing information. The more working memory is used, the higher the cognitive load. Cognitive load encompasses the following two facets: cognitive demand and cognitive availability.

Cognitive demand is the number of elements that a user processes simultaneously. To measure the user's cognitive load, the system can combine the following three metrics: number of elements, element interaction, and structure. Cognitive demand is increased by the number of elements intrinsic to the task. The higher the number of elements, the more likely the task is cognitively demanding. Second, cognitive demand is measured by the level of interrelation between the elements in the task. The higher the inter-relation between the elements, the more likely the task is cognitively demanding. Finally, cognitive load is measured by how well revealed the relationship between the elements is. If the structure of the elements is known to the user or if it's easily understood, then the cognitive demand of the task is reduced.

Cognitive availability is how much attention the user engages in during the computer-assisted task. Cognitive availability is composed of the following:

Expertise. This includes schema and whether or not it is in long term memory.

The ability to extend short term memory.

Distraction. A non-task cognitive demand.

How Cognitive Load Relates to Other Attributes

Cognitive load relates to at least the following attributes:

Learner expertise (novice/expert). Compared to novices, experts have an extensive schemata of a particular set of elements and have automaticity, the ability to automatically understand a class of elements while devoting little to no cognition to the classification. For example, a novice reader must examine every letter of the word that they're trying to read. On the other hand, an expert reader has built a schema so that elements can be “chunked” into groups and accessed as a group rather than a single element. That is, an expert reader can consume paragraphs of text at a time instead of examining each letter.

Task familiarity (unfamiliar/familiar). When a novice and an expert come across an unfamiliar task, each will handle it differently. An expert is likely to complete the task either more quickly or successfully because they access schemas that they already have and use those to solve the problem/understand the information. A novice may spend a lot of time developing a new schema to understand the information/solve the problem.

Task complexity (simple/complex or well-structured/complex). A complex task is a task whose structure is not well-known. There are many elements in the task and the elements are highly interrelated. The opposite of a complex task is well-structured. An expert is well-equipped to deal with complex problems because they have developed habits and structures that can help them decompose and solve the problem.

Task length (short/long). This relates to much a user has to retain in working memory.

Task creativity. (formulaic/creative) How well known is the structure of the interrelation between the elements?

Example Cognitive Demand Characterization Values

This task characterization is scalar, with the minimum range being binary. Example binary values or scale endpoints are cognitively undemanding/cognitively demanding.

Exemplary UI Design Implementation for Cognitive Load

A UI design for cognitive load is influenced by a tasks intrinsic and extrinsic cognitive load. Intrinsic cognitive load is the innate complexity of the task and extrinsic cognitive load is how the information is presented. If the information is presented well (e.g. the schema of the interrelation between the elements is revealed), it reduces the overall cognitive load.

The following list contains examples of UI design implementations for how the computing system might respond to a change cognitive load.

Present information to the user by using more than one channel. For example, present choices visually to the user, but use audio for prompts.

Use a visual presentation to reveal the relationships between the elements. For example if a family tree is revealed, use colors and shapes to represent male and female members of the tree or shapes and colors can be used to represent different family units.

Reduce the redundancy. For example, if the structure of the elements is revealed visually, do not use audio to explain the same structure to the user.

Keep complementary or associated information together. For example, if creating a dialog box so a user can print, create a button that has the word “Print” on it instead of a dialog box that has a question “Do you want to print?” with a button with the work “OK” on it.

Task Alterability

Some task can be altered after they are completed while others cannot be changed. For example, if a user moves a file to the Recycle Bin, they can later retrieve the file. Thus, the task of moving the file to the Recycle Bin is alterable. However, if the user deletes the file from the Recycle Bin, they cannot retrieve it at a later time. In this situation, the task is irrevocable.

Example Task Alterability Characterization Values

This task characterization is binary, with the minimum range being binary. Example binary values or scale endpoints are alterable/not alterable, irrevocable/revocable, or alterable/irrevocable.

Task Content Type

This task characteristic describes the type of content to be used with the task. For example, text, audio, video, still pictures, and so on.

Example Content Type Characteristics Values

This task characterization is an enumeration. Some example values are:

asp

.jpeg

.avi

.jpg

.bmp

.jsp

.gif

.php

.htm

.txt

.html

.wav

.doc

.xls

.mdb

.vbs

.mpg

Again, this list is meant to be illustrative, not exhaustive.

Task Type

A task can be performed in many types of situations. For example, a task that is performed in an augmented reality setting might be presented differently to the user than the same task that is executed in a supplemental setting.

Example Task Type Characteristics Values

This task characterization is an enumeration. Example values can include:

Supplemental

Augmentative

Mediated

Methods of Evaluating Attributes

This section describes some of the ways in which the UI needs can be passed to the computing system.

Predetermined Logic

A human, such as a UI Designer, Software Developer, or outside agency (military, school system, employer, etc.,) can create logic at design time that determines which attributes are passed to the computing system and how they are passed to the computing system. For example, a human could prioritize all of the known attributes. If any of those attributes were present, they would take priority in a very specific order, such as safety, privacy, user preferences and I/O device type.

Predetermined logic can include, but is not limited to, one or more of the following methods:

Numeric key

XML tags

Programmatic interface

Name/value pairs

Numeric Key

UI needs characterizations can be exposed to the system with a numeric value corresponding to values of a predefined data structure.

For instance, a binary number can have each of the bit positions associated with a specific characteristic. The least significant bit may represent task hardware requirements. Therefore a task characterization of decimal 5 would indicate that minimal processing power is required to complete the task.

XML Tags

UI needs can be exposed to the system with a string of characters conforming to the XML structure.

For instance, a simple and important task could be represented as:

<Task Characterization> <Task Complexity=“0” Task Length=“9”> </Task Characterization>

And a context characterization might be represented by the following:

<Context Characterization>

<Theme>Work </Theme>

<Bandwidth>High Speed LAN Network Connection</Bandwidth>

<Field of View>28°</Field of View>

<Privacy>None </Privacy>

</Context Characterization>

And an I/O device characterization might be represented by the following:

<IO Device Characterization>

<Input>Keyboard</Input>

<Input>Mouse</Input>

<Output>Monitor</Output>

<Audio>None</Audio>

</IO Device Characterization>

Note: One significant advantage of this mechanism is that it is easily extensible.

Programming Interface

A task characterization can be exposed to the system by associating a task characteristic with a specific program call.

For instance:

GetUrgentTask can return a handle to that communicates that task urgency to the UI.

Or it could be:

GetHMDDevice can return a handle to the computing system that describes a UI for an HMD.

Or it could be:

GetSecureContext can return a handle to the computing system that describes a UI a high security user context.

Name/Value Pairs

UI needs can be modeled or represented with multiple attributes that each correspond to specific elements of the task (e.g., complexity, cognitive load or task length), user needs (e.g. privacy, safety, preferences, characteristics) and I/O devices (e.g. device type, redundant controls, audio availability, etc.) and the value of an attribute represents a specific measure of that element. For example, for an attribute that represents the task complexity, a value of “5” represents a specific measurement of complexity. Or an attribute that represents an output device type, a value of “HMD” represents a specific device. Or an attribute that represents the a user's privacy needs, a value of “5” represents a specific measurement of privacy.

Each attribute preferably has the following properties: a name, a value, a timestamp and in some cases (user and task attributes) an uncertainty level. For example, the name of the complexity attribute may be “task complexity” and its value at a particular time may be 5. Associated with the current value may be a timestamp of Aug. 1, 2001 13:07 PST that indicates when the value was generated, and an uncertainty level of +/−1 degrees. Or the name of the output device type attribute may be “output device,” and its value at a particular time may be “HMD” Associated with the current value may be a timestamp of Aug. 7, 2001 13:07 PST that indicates when the value was generated. Or the name of the privacy attribute may be “User Privacy” and its value at a particular time may be 5. Associated with the current value may be a timestamp of Aug. 1, 2001 13:07 PST that indicates when the value was generated, and an uncertainty level of +/−1 degrees.

User Feedback

Another embodiment is for the computing system to implement user feedback. In this embodiment, the computing system is designed to provide choices to the user and seek feedback about what attribute is most important. This can be implemented when a new attribute becomes available at run time. If the computing system does not recognize the attribute, the user can be queried about how to characterize the attribute. For example, if task privacy had not been previously characterized, the computing system could query the user about how to handle the task (e.g. which I/O devices should be used, hardware affinity, software requirements, and so on).

Pattern Recognition

By using pattern recognition algorithms (e.g. neural networks), implicit correlators over time between particular UI designs used and any context attribute (including task, user, and device) can be discovered and used predictively.

Characterizing Computer UI Designs with Respect to UI Requirements

For a system to accurately choose a UI design that is appropriate or optimal for the user's current computing context, it is useful to determine the design's intended use, required computer configuration, user task, user preferences and other attributes. This section describes an explicit extensible method to characterize UIs.

In general, any design considerations can be considered when choosing between different UI designs, if they are exposed in a way that the system can interpret.

This disclosure focuses on the first of the following three types of UI designs:

Supplemental—a software application that runs without integration with the current real world context, such as when the real world context is not even considered.

Augmentative—a software application that presents information in meaningful relationship to the user's perception of the real-world. An example of a UI design characteristic unique to this type of UI design is an indication of whether the design elements are curvaceous or rectilinear. The former is useful when seeking to differentiate the UI elements from man-made environments, the latter from natural environments.

Mediated—a software application that allows the user to perceive and manipulate the real-world from a remote location. An example of a UI design characteristic unique to this type of UI design is whether the design assumes a low time latency between the remote environment and the user (i.e., fast refresh of sounds and images) or one that is optimized for a significant delay.

There are two important aspects to characterizing UI designs: what UI design attributes are exposed and how are they exposed.

Characterized Attributes

In some embodiments, a human prepares an explicit characterization of a design before, during, and/or immediately after that UI is designed.

The characterization can be very simple, such as an indication whether the UI makes use of audio or not. Or the characterization can be arbitrarily complex For example, one or more of the following attributes could be used to characterize a UI.

Identification (ID). The identifier for a UI design. Any design can have more than one ID. For example, it can have an associated text string designed to be easy to recall by a user, and simultaneously a secure code component that is programmatically recognized.

Source. An identification of the originator or distributor of the design. Like the ID, this can include a user readable description and/or a machine-readable description.

Date. The date for the UI design. Any design can have more than one date. Some relevant dates include when the design was created, updated, or provided.

Version. The version indicates when modifications to existing designs are provided or anticipated.

Input/output device. Many of the methods of presenting or interacting with UI's are dependent on what devices the user can directly manipulate or perceive. Therefore a description of the hardware requirements or affinity is useful.

Cost. Since UI designs can be provided by commercial software vendors, who may or may not require payment, the cost to the consumer may be significant in deciding on whether to use a particular design.

Design elements. A UI can be characterized as being composed of particular graphically-described design elements.

Functional elements. A UI can be constructed of abstracted UI elements defined by their function, rather than their presentation. A design characterization can include a list of the required elements, allowing the system to choose.

Use. A description of intended or appropriate use of a design can be implicit in the characterization of dependencies such as hardware, software, or user profile and preference, or it can be explicitly described. For instance, a design can be characterized as a “deep sea diving” UI.

Content. The supported, required, or affinities for specific types of content can be characterized. For instance, a design intended to be used as a virtual radio appliance could enumerate two channels of 44.2 kHz audio as part of its provided content. Or a design could note that though it can display and control motion video, it has been optimized for the slow transition of a series of still images.

The useful consideration as to whether an attribute should be added to a UI design characterization is whether a change in the attribute would result in the choice of a different design. For example, characterizing the design's intent of working with a head-mounted video display can be important, while noting that the design was created on a Tuesday is not.

How the Characterization is Exposed to the System

There are many ways to expose the UI's characterization to the system, as shown by the following three examples.

Numeric Key

A UI's characterization can be exposed to the system with a numeric value corresponding to values of a predefined data structure.

For instance, a binary number can have each of the bit positions associated with a specific characteristic. The least significant bit may represent the need for a visual display device capable of displaying at least 24 characters of text in an unbroken series. Therefore a UI characterization of decimal 5 would require such a display to optimally display its content.

XML Tags

A UI's characterization can be exposed to the system with a string of characters conforming to the XML structure.

For instance, a UI design optimized for an audio presentation can include:

<UI Characterization> <Video Display Required=“0” Audio Output=“1”></UI Characterization>

One significant advantage of the mechanism is that it is easily extensible.

Programming Interface

A UI's characterization can be exposed to the system by associating the design with a specific program call.

For instance:

GetAudioOnlyUI can return a handle to a UI optimized for audio.

Illustrative UI Design Attributes

The attributes listed in this spreadsheet are intended to be illustrative. There could be many more attributes that characterize a UI design.

| Attribute | Description |
|---|---|
| Content | Characterizes how a UI design presents content |
| | to the user. For example, if the UI design is for a LCD, |
| | this attribute characterization might communicate to |
| | the computing environment that all task content and |
| | feedback is on the right side of the display and all user |
| | choices are offered in a menu on the left side of the |
| | screen. |
| Cost | Characterizes the purchase price of the UI |
| | design. |
| Date | The date for the UI design. Any design can have |
| | more than one date. Some relevant dates include |
| | when the design was created, updated, or provided. |
| Design elements | Characterizes how the graphically described |
| | design elements are assembled in a UI design. |
| Functional | Characterizes how and which abstracted UI |
| elements | elements defined by their function are assembled in a |
| | UI design. A design characterization can include a list |
| | of the required elements, allowing the system to |
| | choose. |
| Hardware affinity | Characterizes with which hardware the UI |
| | design has affinity. This characteristic does not include |
| | output devices. |
| Identification (ID) | The identifier for a UI design. Any design can |
| | have more than one ID. |
| Importance | Characterizes the UI design for task importance. |
| Input and output | Characterizes for which input and output |
| devices | devices have affinity for this particular UI design. |
| Language | Characterizes for which language(is) the UI |
| | design is optimized. |
| Learning profile | Characterizes the learning style built into the UI. |
| Length | Characterizes how the UI design accommodates |
| | the task length. |
| Name | The name of the UI design. |
| Physical | Characterizes how the UI design accommodates |
| availability | different levels of physical availability (the |
| | degree to which user'is body or part of their |
| | body is in use). For |
| | example, a UI designed to work with speech |
| | commands accommodates users who hands are |
| | physically unavailable because the user is repairing an |
| | airplane engine. |
| Power supply | Characterizes how much power the UI design |
| | uses. Typically, this is determined by the type of |
| | hardware the design requires. |
| Priority | Characterizes how the UI design presents task |
| | priority. |
| Privacy | Characterizes the level of privacy built in to the |
| | UI design. For example, a UI that is designed to use |
| | coded speech commands and a head mounted display |
| | is more private than a UI designed to use non-coded |
| | speech commands and a desktop monitor. |
| Processing | Characterizes the speed and CPU usage |
| | capabilities required for a UI design. |
| Safety | Characterizes the safety precautions built into |
| | the UI design. For instance, designs that require |
| | greater user attention may be characterized as less |
| | safe. |
| Security | Characterizes a the level of security built into a |
| | UI design. |
| Software | Characterizes the ability of the software |
| capability | available to the computing environment. |
| Source | Indicates the person, organization, business, or |
| | otherwise who created the UI design. This attribute can |
| | include a user readable description and/or a machine- |
| | readable description. |
| Storage | Characterizes the amount of storage (e.g. RAM) |
| | needed by the UI design. |
| System audio | Characterizes whether the UI is capable to |
| | receive audio signals from the user on behalf of the |
| | computing environment. |
| Task complexity | Characterizes the UI design for task complexity. |
| | For example, if the UI is output to a visual |
| | presentation surface and the task is simple, the |
| | entire task might be encapsulated in one screen. |
| | If the task is complex, the task might be |
| | separated into multiple steps. |
| Theme | Characterizes a related set of measures of |
| | specific context elements, such as ambient |
| | temperature and current task, built into the UI design. |
| Urgency | Characterizes how the UI design presents task |
| | urgency to the user. |
| Use | The explicit characterization of the intended |
| | purpose or use of a UI design. For instance, a design |
| | can be characterized as a “deep sea diving” UI. |
| User attention | Characterizes the UI design for user attention. |
| | For example, if the user has full attention for the |
| | computing environment, the UI may be more |
| | complicated than a UI design for a user who has only |
| | background attention for the computing environment. |
| User audio | Characterizes the UI'is ability to present audio |
| | signals to the user. |
| User | Characterizes how the UI design accommodates |
| characteristics | for user characteristics such as emotional and physical |
| | states. |
| User expertise | Characterizes how the UI design accommodates |
| | user expertise. |
| User preferences | Characterizes how a UI design accommodates |
| | for a set of attributes that reflect user likes and |
| | dislikes, such as I/O devices preferences, volume of |
| | audio output, amount of haptic pressure, and font size |
| | and color for visual display surfaces. |
| Version | The version indicates when modifications to |
| | existing designs are provided or anticipated. |
| Video | Characterizes whether the UI design presents |
| | visual output to the user through a visual presentation |
| | surface such as a head mounted display, monitor, or |
| | LCD. |

Automated Selection of Appropriate or Optimal Computer UI

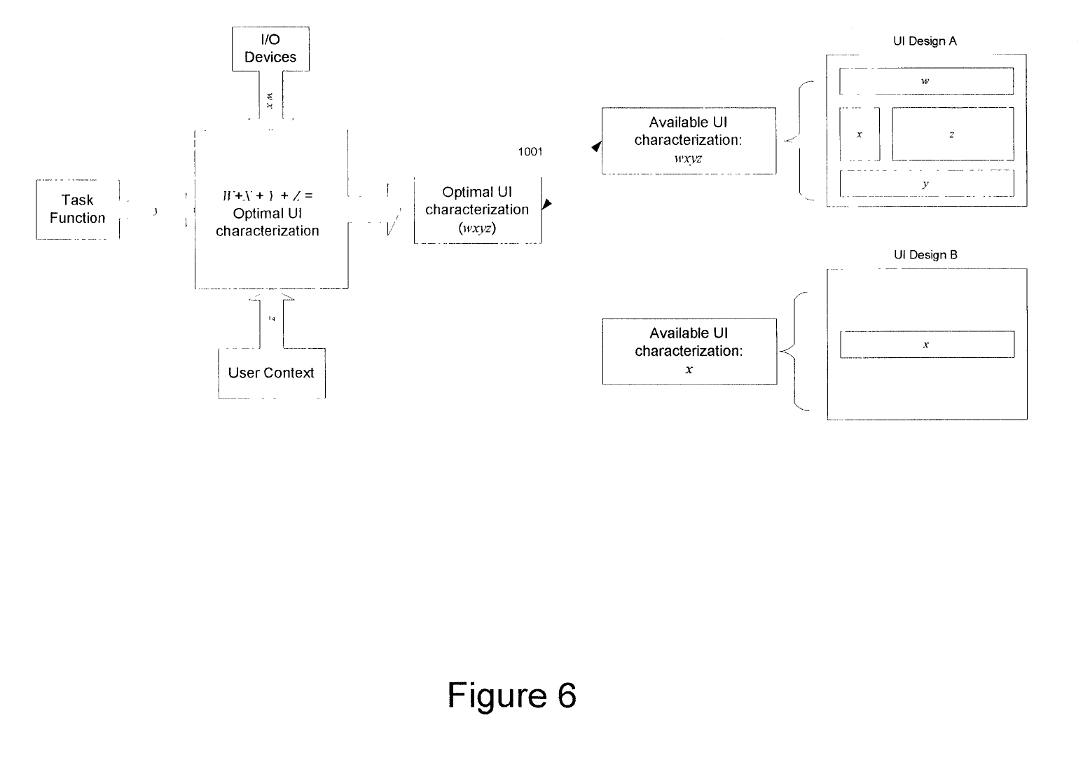

This section describes techniques to enable a computing system to change the user interface by choosing from a group of preexisting UI designs at run time. FIG. 6 provides an overview of how this is accomplished.

The left side of FIG. 6 shows how the characterizations of the user's task functionality, I/O devices local to the user, and context are combined to create a description of the optimal UI for the current situation. The right side of FIG. 6 shows UI designs that have been explicitly characterized. These optimal UI characterizations are compared to the available UI characterizations and when a match is found, that UI is used.

To accurately choose which UI design is optimal for the user's current computing context, a system compares a design's intended use to the current requirements for a UI. This disclosure describes an explicit extensible method to dynamically compare the characterizations of UI designs to the characterization of the current UI needs and then choose a UI design based on how the characterizations match run time. FIG. 6 shows the overall logic.

3001: Characterized UI Designs

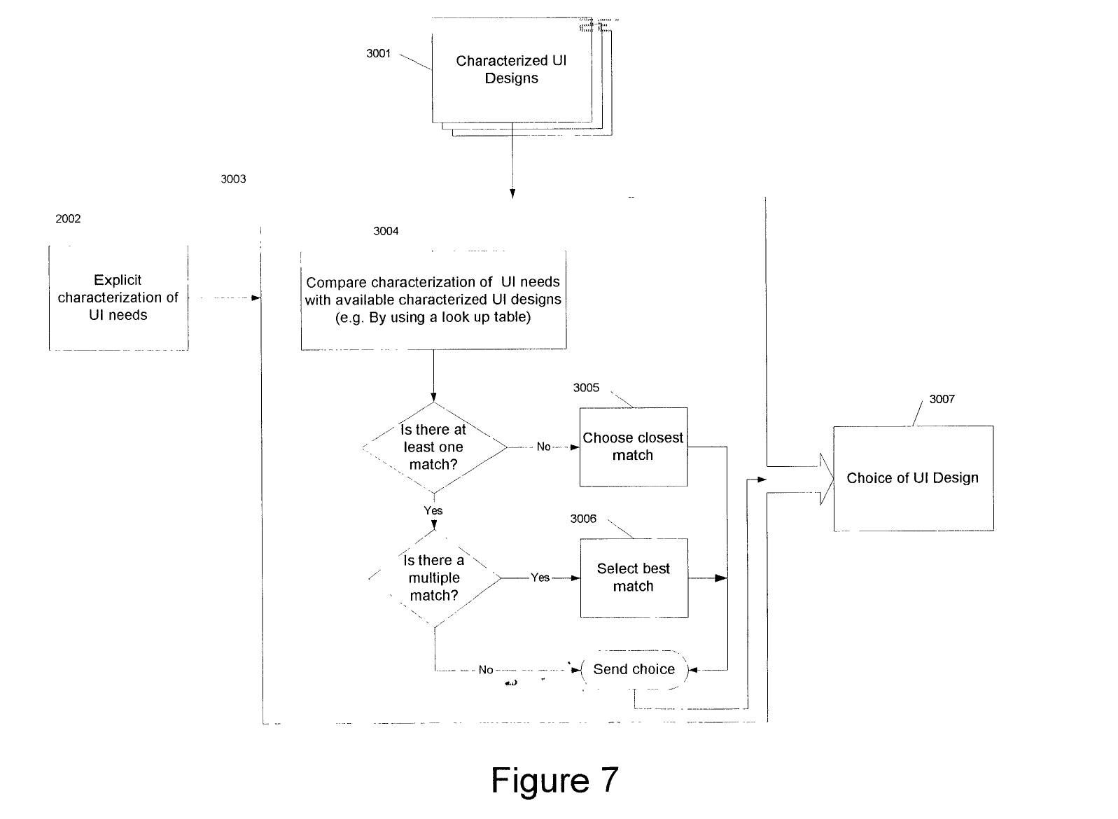

FIG. 7 illustrates a variety of characterized UI designs 3001. These UI designs can be characterized in various ways, such as by a human preparing an explicit characterization of that design before, during or immediately after a UI is designed. The characterization can be very simple, such as an indication whether the UI makes use of audio or not. Or the characterization can be arbitrarily complex. For example, one or more of the following attributes could be used to characterize a UI.

Identification (ID). The identifier for a UI design. Any design can have more than one ID. For example, it can have an associated text string designed to be easy to recall by a user, and simultaneously a secure code component that is programmatically recognized.

Source. An identification of the originator or distributor of the design. Like the ID, this can include a user readable description and/or a machine-readable description.

Date. The date for the UI design. Any design can have more than one date. Some relevant dates include when the design was created, updated, or provided.

Version. The version indicates when modifications to existing designs are provided or anticipated.

Input/output device. Many of the methods of presenting or interacting with UI's are dependent on what devices the user can directly manipulate or perceive. Therefore a description of the hardware requirements or affinity is useful.

Cost. Since UI designs can be provided by commercial software vendors, who may or may not require payment, the cost to the consumer may be significant in deciding on whether to use a particular design.

Design elements. A UI can be characterized as being composed of particular graphically-described design elements.

Functional elements. A UI can be constructed of abstracted UI elements defined by their function, rather than their presentation. A design characterization can include a list of the required elements, allowing the system to choose.

Use. A description of intended or appropriate use of a design can be implicit in the characterization of dependencies such as hardware, software, or user profile and preference, or it can be explicitly described. For instance, a design can be characterized as a “deep sea diving” UI.

Content. The supported, required, or affinities for specific types of content can be characterized. For instance, a design intended to be used as a virtual radio appliance could enumerate two channels of 44.2 kHz audio as part of its provided content. Or a design could note that though it can display and control motion video, it has been optimized for the slow transition of a series of still images.

The useful consideration as to whether an attribute should be added to a UI design characterization is whether a change in the attribute would result in the choice of a different design. For example, characterizing the design's intent of working with a head-mounted video display can be important, while noting that the design was created on a Tuesday is not.

How the Characterization is Exposed to the System

There are many ways to expose the UI's characterization to the system, as shown by the following three examples.

Numeric Key

A UI's characterization can be exposed to the system with a numeric value corresponding to values of a predefined data structure.

For instance, a binary number can have each of the bit positions associated with a specific characteristic. The least significant bit may represent the need for a visual display device capable of displaying at least 24 characters of text in an unbroken series. Therefore a UI characterization of decimal 5 would require such a display to optimally display its content.

XML Tags

A UI's characterization can be exposed to the system with a string of characters conforming to the XML structure.

For instance, a UI design optimized for an audio presentation can include:

<UI Characterization><Video Display Required=“0” Audio Output=“1”></UI Characterization>

One significant advantage of the mechanism is that it is easily extensible.

Programming Interface

A UI's characterization can be exposed to the system by associating the design with a specific program call.

For instance:

GetAudioOnlyUI can return a handle to a UI optimized for audio.

3002: Optimal UI Characterizations

This section describes modeled real-world and virtual contexts to which the described techniques can respond. The described model for optimal UI design characterization includes at least the following categories of attributes when determining the optimal UI design:

All available attributes. The model is dynamic so it can accommodate for any and all attributes that could affect the optimal UI design for a user's context. For example, this model could accommodate for temperature, weather conditions, time of day, available I/O devices, preferred volume level, desired level of privacy, and so on.

Significant attributes. Some attributes have a more significant influence on the optimal UI design than others. Significant attributes include, but are not limited to, the following:

The user can see video.

The user can hear audio.

The computing system can hear the user.

The interaction between the user and the computing system must be private.

The user's hands are occupied.

Attributes that correspond to a theme. Specific or programmatic. Individual or group.

For clarity, many of the example attributes described in this topic is presented with a scale and some include design examples. It is important to note that any of the attributes mentioned in this document are just examples, however. There are other attributes that can cause a UI to change that are not listed in this document. The described dynamic model can account for additional attributes.

I/O Devices

Output—Devices that are directly perceivable by the user. For example, a visual output device creates photons that enter the user's eye. Output devices are always local to the user.

Input—A device that can be directly manipulated by the user. For example, a microphone translates energy created by the user's voice into electrical signals that can control a computer. Input devices are always local to the user.

The input devices to which the user has access to interact with the computer in ways that convey choices include, but is not limited to:

Keyboards

Touch pads

Mice

Trackballs

Microphones

Rolling/pointing/pressing/bending/turning/twisting/switching/rubbing/zipping cursor controllers—anything that the user's manipulation of can be sensed by the computer, this includes body movement that forms recognizable gestures.

Buttons, etc.

Output devices allow the presentation of computer-controlled information and content to the user, and includes:

Speakers

Monitors

Pressure actuators, etc.

Input Device Types

Some characterizations of input devices are a direct result of the device itself.

Touch Screen

A display screen that is sensitive to the touch of a finger or stylus. Touch screens are very resistant to harsh environments where keyboards might eventually fail. They are often used with custom-designed applications so that the on-screen buttons are large enough to be pressed with the finger. Applications are typically very specialized and greatly simplified so they can be used by anyone. However, touch screens are also very popular on PDAs and full-size computers with standard applications, where a stylus is required for precise interaction with screen objects.

Example Touch Screen Attribute Characteristic Values

This characteristic is enumerated. Some example values are:

Screen objects must be at least 1 centimeter square

The user can see the touch screen directly

The user can see the touch screen indirectly (e.g. by using a monitor)

Audio feedback is available

Spatial input is difficult

Feedback to the user is presented to the user through a visual presentation surface.

Pointing Device

An input device used to move the pointer (cursor) on screen.

Example Pointing Device Characteristic Values

This characteristic is enumerated. Some example values are:

1-dimension (D) pointing device

2-D pointing device

3-D pointing device

Position control device

Range control device

Feedback to the user is presented through a visual presentation surface.

Speech

The conversion of spoken words into computer text. Speech is first digitized and then matched against a dictionary of coded waveforms. The matches are converted into text as if the words were typed on the keyboard.

Example Speech Characteristic Values

This characteristic is enumerated. Example values are:

Command and control

Dictation

Constrained grammar

Unconstrained grammar

Keyboard

A set of input keys. On terminals and personal computers, it includes the standard typewriter keys, several specialized keys and the features outlined below.

Example Keyboard Characteristic Values

This characteristic is enumerated. Example values are:

Numeric

Alphanumeric

Optimized for discreet input

Pen Tablet

A digitizer tablet that is specialized for handwriting and hand marking. LCD-based tablets emulate the flow of ink as the tip touches the surface and pressure is applied. Non-display tablets display the handwriting on a separate computer screen.

Example Pen Tablet Characteristic Values

This characteristic is enumerated. Example values include:

Direct manipulation device

Feedback is presented to the user through a visual presentation surface

Supplemental feedback can be presented to the user using audio output.

Optimized for special input

Optimized for data entry

Eye Tracking

An eye-tracking device is a device that uses eye movement to send user indications about choices to the computing system. Eye tracking devices are well suited for situations where there is little to no motion from the user (e.g. the user is sitting at a desk) and has much potential for non-command user interfaces.

Example Eye Tracking Characteristic Values

This characteristic is enumerated. Example values include:

2-D pointing device

User motion=still

Privacy=high

Output Device Types

Some characterizations of input devices are a direct result of the device itself.

HMD

Head Mounted Display) A display system built and worn like goggles that gives the illusion of a floating monitor in front of the user's face. The HMD is an important component of a body-worn computer (wearable computer). Single-eye units are used to display hands-free instructional material, and dual-eye, or stereoscopic, units are used for virtual reality applications.

Example HMD Characteristic Values

This characteristic is enumerated. Example values include:

Field of view >28°

User's hands=not available

User's eyes=forward and out

User's reality=augmented, mediated, or virtual

Monitors

A display screen used to present output from a computer, camera, VCR or other video generator. A monitor's clarity is based on video bandwidth, dot pitch, refresh rate, and convergence.

Example Monitor Characteristic Values

This characteristic is enumerated. Some example values include:

Required graphical resolution=high

User location=stationary

User attention=high

Visual density=high

Animation=yes

Simultaneous presentation of information=yes (e.g. text and image)

Spatial content=yes

I/O Device Use

This attribute characterizes how or for what an input or output device can be optimized for use. For example, a keyboard is optimized for entering alphanumeric text characters and monitor, head mounted display (HMD), or LCD panel is optimized for displaying those characters and other visual information.

Example Device Use Characterization Values

This characterization is enumerated. Example values include:

Speech recognition

Alphanumeric character input

Handwriting recognition

Visual presentation

Audio presentation

Haptic presentation

Chemical presentation

Redundant Controls

The user may have more than one way to perceive or manipulate the computing environment. For instance, they may be able to indicate choices by manipulating a mouse, or speaking.

By providing UI designs that have more than one I/O modality (also known as “multi-modal”), greater flexibility can be provided to the user. However, there are times when this is not appropriate. For instance, the devices may not be constantly available (user's hands are occupied, the ambient noise increases defeating voice recognition).

Example Redundant Controls Characterization Values

As a minimum, a numeric value could be associated with a configuration of devices.

1—keyboard and touch screen

2—HMD and 2-D pointing device

Alternately, a standardized list of available, preferred, or historically used devices could be used.

QWERTY keyboard

Twiddler

HMD

VGA monitor

SVGA monitor

LCD display

LCD panel

Privacy

Privacy is the quality or state of being apart from company or observation. It includes a user's trust of audience. For example, if a user doesn't want anyone to know that they are interacting with a computing system (such as a wearable computer), the preferred output device might be an HMD and the preferred input device might be an eye-tracking device.

Hardware Affinity for Privacy

Some hardware suits private interactions with a computing system more than others. For example, an HMD is a far more private output device than a desk monitor. Similarly, an earphone is more private than a speaker.

The UI should choose the correct input and output devices that are appropriate for the desired level of privacy for the user's current context and preferences.

Example Privacy Characterization Values

This characteristic is scalar, with the minimum range being binary. Example binary values, or scale endpoints, are: not private/private, public/not public, and public/private.

Using no privacy and fully private as the scale endpoints, the following table lists an example privacy characterization scale.

| Scale attribute | Implication/Example |
|---|---|
| No privacy is needed for | The UI is not restricted to any |
| input or output interaction | particular I/O device for presentation |
| | and interaction. For example, the UI |
| | could present content to the user |
| | through speakers on a large monitor in |
| | a busy office. |
| The input must be semi-private. | Coded speech commands, and |
| The output does not need to be | keyboard methods are appropriate. No |
| private. | restrictions on output presentation. |
| The input must be fully private. | No speech commands. No |
| The output does not need to be | restriction on output presentation. |
| private. | |
| The input must be fully private. | No speech commands. No LCD |
| The output must be semi-private. | panel. |
| The input does not need to be | No restrictions on input |
| private. The output must be | interaction. The output is restricted to |
| fully private. | an HMD device and/or an earphone. |
| The input does not need to be | No restrictions on input |
| private. The output must be | interaction. The output is restricted to |
| semi-private. | HMD device, earphone, and/or an LCD |
| | panel. |
| The input must be semi-private. | Coded speech commands and |
| The output must be semi-private. | keyboard methods are appropriate. |
| | Output is restricted to an HMD device, |
| | earphone or an LCD panel. |
| The input and output interaction | No speech commands. Keyboard |
| must be fully private. | devices might be acceptable. Output is |
| | restricted to and HMD device and/or an |
| | earphone. |

* Semi-private. The user and at least one other person can have access to or knowledge of the interaction between the user and the computing system.
* Fully private. Only the user can have access to or knowledge of the interaction between the user and the computing system.

Semi-private. The user and at least one other person can have access to or knowledge of the interaction between the user and the computing system.

Fully private. Only the user can have access to or knowledge of the interaction between the user and the computing system.

Visual

Visual output refers to the available visual density of the display surface is characterized by the amount of content a presentation surface can present to a user. For example, an LED output device, desktop monitor, dashboard display, hand-held device, and head mounted display all have different amounts of visual density. UI designs that are appropriate for a desktop monitor are very different than those that are appropriate for head-mounted displays. In short, what is considered to be the optimal UI will change based on what visual output device(s) is available.

In addition to density, visual display surfaces have the following characteristics:

Color

Motion

Field of view

Depth

Reflectivity

Size. Refers to the actual size of the visual presentation surface.

Position/location of visual display surface in relation to the user and the task that they're performing.

Number of focal points. A UI can have more than one focal point and each focal point can display different information.

Distance of focal points from the user. A focal point can be near the user or it can be far away. The amount distance can help dictate what kind and how much information is presented to the user.

Location of focal points in relation to the user. A focal point can be to the left of the user's vision, to the right, up, or down.

With which eye(s) the output is associated. Output can be associated with a specific eye or both eyes.

Ambient light.

Others

The topics in this section describe in further detail the characteristics of some of these previously listed attributes.

Example Visual Density Characterization Values

This UI characterization is scalar, with the minimum range being binary. Example binary values or scale endpoints are: no visual density/full visual density.

Using no visual density and full visual density as scale endpoints, the following table lists an example visual density scale.

| Scale attribute | Implication/Design example |
|---|---|
| There is no visual density | The UI is restricted to non-visual |
| | output such as audio, haptic, and |
| | chemical. |
| Visual density is very low | The UI is restricted to a very |
| | simple output, such as single binary |
| | output devices (a single LED) or other |
| | simple configurations and arrays of |
| | light. No text is possible. |
| Visual density is low | The UI can handle text, but is |
| | restricted to simple prompts or the |
| | bouncing ball. |
| Visual density is medium | The UI can display text, simple |
| | prompts or the bouncing ball, and very |
| | simple graphics. |
| Visual density is high | The visual display has fewer |
| | restrictions. Visually dense items such |
| | as windows, icons, menus, and prompts |
| | are available as well as streaming |
| | video, detailed graphics and so on. |
| Visual density is the highest | The UI is not restricted by visual |
| available | density. A visual display that mirrors |
| | reality (e.g. 3-dimensional) is possible |
| | and appropriate. |

Color

This characterizes whether or not the presentation surface displays color. Color can be directly related to the ability of the presentation surface, or it could be assigned as a user preference.

Chrominance. The color information in a video signal.

Luminance. The amount of brightness, measured in lumens, which is given off by a pixel or area on a screen. It is the black/gray/white information in a video signal. Color information is transmitted as luminance (brightness) and chrominance (color). For example, dark red and bright red would have the same chrominance, but a different luminance. Bright red and bright green could have the same luminance, but would always have a different chrominance.

Example Color Characterization Values

This UI characterization is scalar, with the minimum range being binary. Example binary values or scale endpoints are: no color/full color.

Using no color and full color as scale endpoints, the following table lists an example color scale.

| Scale attribute | Implication/Design example |
|---|---|
| No color is available. | The UI visual presentation is |
| | monochrome. |
| One color is available. | The UI visual presentation is |
| | monochrome plus one color. |
| Two colors are available | The UI visual presentation is |
| | monochrome plus two colors or any |
| | combination of the two colors. |
| Full color is available. | The UI is not restricted by color. |

Motion

This characterizes whether or not a presentation surface has the ability to present motion to the user. Motion can be considered as a stand-alone attribute or as a composite attribute.

Example Motion Characterization Values

As a stand-alone attribute, this characterization is binary. Example binary values are: no animation available/animation available.

As a composite attribute, this characterization is scalar. Example scale endpoints include no motion/motion available, no animation available/animation available, or no video/video. The values between the endpoints depend on the other characterizations that are included in the composite. For example, the attributes color, visual density, and frames per second, etc. change the values between no motion and motion available.

Field of View

A presentation surface can display content in the focus of a user's vision, in the user's periphery, or both.

Example Field of View Characterization Values

This UI characterization is scalar, with the minimum range being binary. Example binary values, or scale endpoints, are: peripheral vision only/field of focus and peripheral vision is available.

Using peripheral vision only and field of focus and peripheral vision is available as scale endpoints, the following tables lists an example field of view scale.

| Scale attribute | Implication |
|---|---|
| All visual display is in the | The UI is restricted to using the |
| peripheral vision of the user | peripheral vision of the user. Lights, |
| | colors and other simple visual display |
| | are appropriate. Text is not appropriate. |
| Only the user's field of | The UI is restricted to using the |
| focus is available. | users field of vision only. Text and |
| | other complex visual displays are |
| | appropriate. |
| Both field of focus and the | The UI is not restricted by the |
| peripheral vision of the user | user's field of view. |
| are used. | |

Exemplary UI Design Implementation for Changes in Field of View

The following list contains examples of UI design implementations for how the computing system might respond to a change in field of view.

If the field of view for the visual presentation is more than 28°, then the UI might:

Display the most important information at the center of the visual presentation surface.

Devote more of the UI to text

Use periphicons outside of the field of view.

If the field of view for the visual presentation is less than 28°, then the UI might:

Restrict the size of the font allowed in the visual presentation. For example, instead of listing “Monday, Tuesday, and Wednesday,” and so on as choices, the UI might list “M, Tu, W” instead.

The body or environment stabilized image can scroll.

Depth

A presentation surface can display content in 2 dimensions (e.g. a desktop monitor) or 3 dimensions (a holographic projection).

Example Depth Characterization Values

This characterization is binary and the values are: 2 dimensions 3 dimensions.

Reflectivity

The fraction of the total radiant flux incident upon a surface that is reflected and that varies according to the wavelength distribution of the incident radiation.

Example Reflectivity Characterization Values

This characterization is scalar, with the minimum range being binary. Example binary values, or scale endpoints, are: not reflective/highly reflective or no glare/high glare.

Using not reflective and highly reflective as scale endpoints, the following list is an example of a reflectivity scale.

Not reflective (no surface reflectivity).

10% surface reflectivity

20% surface reflectivity

30% surface reflectivity

40% surface reflectivity

50% surface reflectivity

60% surface reflectivity

70% surface reflectivity

80% surface reflectivity

90% surface reflectivity

Highly reflective (100% surface reflectivity)

Exemplary UI Design Implementation for Changes in Reflectivity

The following list contains examples of UI design implementations for how the computing system might respond to a change in reflectivity.

If the output device has high reflectivity—a lot of glare—then the visual presentation will change to a light colored UI.

Audio

Audio input and output refers to the UI's ability to present and receive audio signals. While the UI might be able to present or receive any audio signal strength, if the audio signal is outside the human hearing range (approximately 20 Hz to 20,000 Hz) it is converted so that it is within the human hearing range, or it is transformed into a different presentation, such as haptic output, to provide feedback, status, and so on to the user

Factors that influence audio input and output include (but this is not an inclusive list):

Level of ambient noise (this is an environmental characterization)

Directionality of the audio signal

Head-stabilized output (e.g. earphones)

Environment-stabilized output (e.g. speakers)

Spatial layout (3-D audio)

Proximity of the audio signal to the user

Frequency range of the speaker

Fidelity of the speaker, e.g. total harmonic distortion

Left, right, or both ears

What kind of noise is it?

Others

Example Audio Output Characterization Values

This characterization is scalar, with the minimum range being binary. Example binary values or scale endpoints are: the user cannot hear the computing system/the user can hear the computing system.

Using the user cannot hear the computing system and the user can hear the computing system as scale endpoints, the following table lists an example audio output characterization scale.

| Scale attribute | Implication |
|---|---|
| The user cannot hear the | The UI cannot use audio to |
| computing system. | give the user choices, feedback, |
| | and so on. |
| The user can hear audible | The UI might offer the user |
| whispers (approximately | choices, feedback, and so on by |
| 10-30 dBA). | using the earphone only. |
| The user can hear normal | The UI might offer the user |
| conversation (approximately | choices, feedback, and so on |
| 50-60 dBA). | by using a speaker(s) connected |
| | to the computing system. |
| The user can hear | The UI is not restricted by |
| communications from the computing | audio signal strength needs or |
| system without restrictions. | concerns. |
| Possible ear damage | The UI will not output audio for |
| (approximately 85+ dBA) | extended periods of time that will |
| | damage the user's hearing. |

Example Audio Input Characterization Values

This characterization is scalar, with the minimum range being binary. Example binary values or scale endpoints are: the computing system cannot hear the user/the computing system can hear the user.

Using the computing system cannot hear the user and the computing system can hear the user as scale endpoints, the following table lists an example audio input scale.

| Scale attribute | Implication |
|---|---|
| The computing system cannot | When the computing system |
| receive audio input from | cannot receive audio input from the |
| the user. | user, the UI will notify the user |
| | that audio input is not available. |
| The computing system is able | |
| to receive audible whispers | |
| from the user (approximate | |
| 10-30 dBA). | |
| The computing system is able to | |
| receive normal conversational | |
| tones from the user (approximate | |
| 50-60 dBA). | |
| The computing system can | The UI is not restricted by audio |
| receive audio input from the | signal strength needs or concerns. |
| user without restrictions. | |
| The computing system can | The computing system will not |
| receive only high volume audio | require the user to give indications |
| input from the user. | using a high volume. If a high volume |
| | is required, then the UI will notify |
| | the user that the computing system |
| | cannot receive audio input from the |
| | user. |

Haptics

Haptics refers to interacting with the computing system using a tactile method. Haptic input includes the computing system's ability to sense the user's body movement, such as finger or head movement. Haptic output can include applying pressure to the user's skin. For haptic output, the more transducers, the more skin covered, the more resolution for presentation of information. That is if the user is covered with transducers, the computing system receives a lot more input from the user. Additionally, the ability for haptically-oriented output presentations is far more flexible.

Example Haptic Input Characterization Values

This characteristic is enumerated. Possible values include accuracy, precision, and range of:

Pressure

Velocity

Temperature

Acceleration

Torque

Tension

Distance

Electrical resistance

Texture

Elasticity

Wetness

Additionally, the characteristics listed previously are enhanced by:

Number of dimensions

Density and quantity of sensors (e.g. a 2 dimensional array of sensors. The sensors could measure the characteristics previously listed).

Chemical Output

Chemical output refers to using chemicals to present feedback, status, and so on to the user. Chemical output can include:

Things a user can taste

Things a user can smell

Example Taste Characteristic Values

This characteristic is enumerated. Example characteristic values of taste include:

Bitter

Sweet

Salty

Sour

Example Smell Characteristic Values

This characteristic is enumerated. Example characteristic values of smell include:

Strong/weak

Pungent/bland

Pleasant/unpleasant

Intrinsic, or signaling

Electrical Input

Electrical input refers to a user's ability to actively control electrical impulses to send indications to the computing system.

Brain activity

Muscle activity

Example Electrical Input Characterization Values

This characteristic is enumerated. Example values of electrical input can include:

Strength of impulse

Frequency

User Characterizations

This section describes the characteristics that are related to the user.

User Preferences

User preferences are a set of attributes that reflect the user's likes and dislikes, such as I/O devices preferences, volume of audio output, amount of haptic pressure, and font size and color for visual display surfaces. User preferences can be classified in the following categories:

Self characterization. Self-characterized user preferences are indications from the user to the computing system about themselves. The self-characterizations can be explicit or implicit. An explicit, self-characterized user preference results in a tangible change in the interaction and presentation of the UI. An example of an explicit, self characterized user preference is “Always use the font size 18” or “The volume is always off.” An implicit, self-characterized user preference results in a change in the interaction and presentation of the UI, but it might be not be immediately tangible to the user. A learning style is an implicit self-characterization. The user's learning style could affect the UI design, but the change is not as tangible as an explicit, self-characterized user preference. If a user characterizes themselves to a computing system as a “visually impaired, expert computer user,” the UI might respond by always using 24-point font and monochrome with any visual display surface. Additionally, tasks would be chunked differently, shortcuts would be available immediately, and other accommodations would be made to tailor the UI to the expert user.

Theme selection. In some situations, it is appropriate for the computing system to change the UI based on a specific theme. For example, a high school student in public school 1420 who is attending a chemistry class could have a UI appropriate for performing chemistry experiments. Likewise, an airplane mechanic could also have a UI appropriate for repairing airplane engines. While both of these UIs would benefit from hands free, eyes out computing, the UI would be specifically and distinctively characterized for that particular system.

System characterization. When a computing system somehow infers a user's preferences and uses those preferences to design an optimal UI, the user preferences are considered to be system characterizations. These types of user preferences can be analyzed by the computing system over a specified period on time in which the computing system specifically detects patterns of use, learning style, level of expertise, and so on. Or, the user can play a game with the computing system that is specifically designed to detect these same characteristics.

Pre-configured. Some characterizations can be common and the UI can have a variety of pre-configured settings that the user can easily indicate to the UI. Pre-configured settings can include system settings and other popular user changes to default settings.

Remotely controlled. From time to time, it may be appropriate for someone or something other than the user to control the UI that is displayed.

Example User Preference Characterization Values

This UI characterization scale is enumerated. Some example values include:

Self characterization

Theme selection

System characterization

Pre-configured

Remotely controlled

Theme

A theme is a related set of measures of specific context elements, such as ambient temperature, current user task, and latitude, which reflect the context of the user. In other words, theme is a name collection of attributes, attribute values, and logic that relates these things. Typically, themes are associated with user goals, activities, or preferences. The context of the user includes:

The user's mental state, emotional state, and physical or health condition.

The user's setting, situation or physical environment. This includes factors external to the user that can be observed and/or manipulated by the user, such as the state of the user's computing system.

The user's logical and data telecommunications environment (or “cyber-environment,” including information such as email addresses, nearby telecommunications access such as cell sites, wireless computer ports, etc.).

Some examples of different themes include: home, work, school, and so on. Like user preferences, themes can be self characterized, system characterized, inferred, pre-configured, or remotely controlled.

Example Theme Characterization Values

This characteristic is enumerated. The following list contains example enumerated values for theme.

No theme

The user's theme is inferred.

The user's theme is pre-configured.

The user's theme is remotely controlled.

The user's theme is self characterized.

The user's theme is system characterized.

User Characteristics

User characteristics include:

Emotional state

Physical state

Cognitive state

Social state

Example User Characteristics Characterization Values

This UI characterization scale is enumerated. The following lists contain some of the enumerated values for each of the user characteristic qualities listed above.

* Emotional state.

* Happiness
* Sadness
* Anger
* Frustration
* Confusion

* Physical state

* Body
* Biometrics
* Posture
* Motion
* Physical Availability

* Senses
* Eyes
* Ears
* Tactile
* Hands
* Nose
* Tongue

* Workload demands/effects
* Interaction with computer devices
* Interaction with people
* Physical Health

* Environment

* Time/Space
* Objects
* Persons

* Audience/Privacy Availability

* Scope of Disclosure
* Hardware affinity for privacy
* Privacy indicator for user
* Privacy indicator for public
* Watching indicator
* Being observed indicator

* Ambient Interference

* Visual
* Audio
* Tactile

* Location.

* Place_name
* Latitude
* Longitude
* Altitude
* Room
* Floor
* Building
* Address
* Street
* City
* County
* State
* Country
* Postal_Code

* Physiology.

* Pulse
* Body_temperature
* Blood_pressure
* Respiration

* Activity

* Driving
* Eating
* Running
* Sleeping
* Talking
* Typing
* Walking

*Cognitive state

* Meaning
* Cognition

* Divided User Attention
* Task Switching
* Background Awareness

* Solitude
* Privacy

* Desired Privacy
* Perceived Privacy

* Social Context
* Affect

* Social state

* Whether the user is alone or if others are present
* Whether the user is being observed (e.g., by a camera)
* The user's perceptions of the people around them and the user's

perceptions of the intentions of the people that surround them.

* The user's social role (e.g they are a prisoner, they are a guard,

they are a nurse, they are a teacher, they are a student, etc.)

Cognitive Availability

There are three kinds of user tasks: focus, routine, and awareness and three main categories of user attention: background awareness, task switched attention, and parallel. Each type of task is associated with a different category of attention. Focus tasks require the highest amount of user attention and are typically associated with task-switched attention. Routine tasks require a minimal amount of user attention or a user's divided attention and are typically associated with parallel attention. Awareness tasks appeals to a user's precognitive state or attention and are typically associated with background awareness. When there is an abrupt change in the sound, such as changing from a trickle to a waterfall, the user is notified of the change in activity.

Background Awareness

Background awareness is a non-focus output stimulus that allows the user to monitor information without devoting significant attention or cognition.

Example Background Awareness Characterization Values

This characterization is scalar, with the minimum range being binary. Example binary values or scale endpoints are: the user has no awareness of the computing system/the user has background awareness of the computing system.

Using these values as scale endpoints, the following list is an example background awareness scale.

No background awareness is available. A user's pre-cognitive state is unavailable.

A user has enough background awareness available to the computing system to receive one type of feedback or status.

A user has enough background awareness available to the computing system to receive more than one type of feedback, status and so on.

A user's background awareness is fully available to the computing system. A user has enough background awareness available for the computing system such that they can perceive more than two types of feedback or status from the computing system.

Exemplary UI Design Implementations for Background Awareness

The following list contains examples of UI design implementations for how a computing system might respond to a change in background awareness.

If a user does not have any attention for the computing system, that implies that no input or output are needed.

If a user has enough background awareness available to receive one type of feedback, the UI might:

Present a single light in the peripheral vision of a user. For example, this light can represent the amount of battery power available to the computing system. As the battery life weakens, the light gets dimmer. If the battery is recharging, the light gets stronger.

If a user has enough background awareness available to receive more than one type of feedback, the UI might:

Present a single light in the peripheral vision of the user that signifies available battery power and the sound of water to represent data connectivity.

If a user has full background awareness, then the UI might:

Present a single light in the peripheral vision of the user that signifies available battery power, the sound of water that represents data connectivity, and pressure on the skin to represent the amount of memory available to the computing system.

Task Switched Attention

When the user is engaged in more than one focus task, the user's attention can be considered to be task switched.

Example Task Switched Attention Characterization Values

This characteristic is scalar, with the minimum range being binary. Example binary values, or scale endpoints, are: the user does not have any attention for a focus task/the user has full attention for a focus task.

Using these characteristics as the scale endpoints, the following list is an example of a task switched attention scale.

A user does not have any attention for a focus task.

A user does not have enough attention to complete a simple focus task. The time between focus tasks is long.

A user has enough attention to complete a simple focus task. The time between focus tasks is long.

A user does not have enough attention to complete a simple focus task. The time between focus tasks is moderately long.

A user has enough attention to complete a simple focus task. The time between tasks is moderately long.

A user does not have enough attention to complete a simple focus task. The time between focus tasks is short.

A user has enough attention to complete a simple focus task. The time between focus tasks is short.

A user does not have enough attention to complete a moderately complex focus task. The time between focus tasks is long.

A user has enough attention to complete a moderately complex focus task. The time between focus tasks is long.

A user does not have enough attention to complete a moderately complex focus task. The time between focus tasks is moderately long.

A user has enough attention to complete a moderately complex focus task. The time between tasks is moderately long.

A user does not have enough attention to complete a moderately complex focus task. The time between focus tasks is short.

A user has enough attention to complete a moderately complex focus task. The time between focus tasks is short.

A user does not have enough attention to complete a moderately complex focus task. The time between focus tasks is long.

A user has enough attention to complete a complex focus task. The time between focus tasks is long.

A user does not have enough attention to complete a complex focus task. The time between focus tasks is moderately long.

A user has enough attention to complete a complex focus task. The time between tasks is moderately long.

A user does not have enough attention to complete a complex focus task. The time between focus tasks is short.

A user has enough attention to complete a complex focus task. The time between focus tasks is short.

A user has enough attention to complete a very complex, multi-stage focus task before moving to a different focus task.

Parallel

Parallel attention can consist of focus tasks interspersed with routine tasks (focus task+routine task) or a series of routine tasks (routine task+routine task).

Example Parallel Attention Characterization Values

This characteristic is scalar, with the minimum range being binary. Example binary values, or scale endpoints, are: the user does not have enough attention for a parallel task/the user has full attention for a parallel task.

Using these characteristics as scale endpoints, the following list is an example of a parallel attention scale.

A user has enough available attention for one routine task and that task is not with the computing system.

A user has enough available attention for one routine task and that task is with the computing system.

A user has enough attention to perform two routine tasks and at least of the routine tasks is with the computing system.

A user has enough attention to perform a focus task and a routine task. At least one of the tasks is with the computing system.

A user has enough attention to perform three or more parallel tasks and at least one of those tasks is in the computing system.

Physical Availability

Physical availability is the degree to which a person is able to perceive and manipulate a device. For example, an airplane mechanic who is repairing an engine does not have hands available to input indications to the computing systems by using a keyboard.

Learning Profile

A user's learning style is based on their preference for sensory intake of information. That is, most users have a preference for which sense they use to assimilate new information.

Example Learning Style Characterization Values

This characterization is enumerated. The following list is an example of learning style characterization values.

Auditory

Visual

Tactile

Exemplary UI Design Implementation for Learning Style

The following list contains examples of UI design implementations for how the computing system might respond to a learning style.

If a user is a auditory learner, the UI might:

Present content to the user by using audio more frequently.

Limit the amount of information presented to a user if these is a lot of ambient noise.

If a user is a visual learner, the UI might:

Present content to the user in a visual format whenever possible.

Use different colors to group different concepts or ideas together.

Use illustrations, graphs, charts, and diagrams to demonstrate content when appropriate.

If a user is a tactile learner, the UI might:

Present content to the user by using tactile output.

Increase the affordance of tactile methods of input (e.g. increase the affordance of keyboards).

Software Accessibility

If an application requires a media-specific plug-in, and the user does not have a network connection, then a user might not be able to accomplish a task.

Example Software Accessibility Characterization Values

This characterization is enumerated. The following list is an example of software accessibility values.

The computing system does not have access to software.

The computing system has access to some of the local software resources.

The computing system has access to all of the local software resources.

The computing system has access to all of the local software resources and some of the remote software resources by availing itself to opportunistic user of software resources.

The computing system has access to all of the local software resources and all remote software resources by availing itself to the opportunistic user of software resources.

The computing system has access to all software resources that are local and remote.

Perception of Solitude

Solitude is a user's desire for, and perception of, freedom from input. To meet a user's desire for solitude, the UI can do things like:

Cancel unwanted ambient noise

Block out human made symbols generated by other humans and machines

Example Solitude Characterization Values

This characterization is scalar, with the minimum range being binary. Example binary values, or scalar endpoints, are: no solitude/complete solitude.

Using these characteristics as scale endpoints, the following list is an example of a solitude scale.

No solitude

Some solitude

Complete solitude

Privacy

Privacy is the quality or state of being apart from company or observation. It includes a user's trust of audience. For example, if a user doesn't want anyone to know that they are interacting with a computing system (such as a wearable computer), the preferred output device might be a head mounted display (HMD) and the preferred input device might be an eye-tracking device.

Hardware Affinity for Privacy

Some hardware suits private interactions with a computing system more than others. For example, an HMD is a far more private output device than a desk monitor. Similarly, an earphone is more private than a speaker.

The UI should choose the correct input and output devices that are appropriate for the desired level of privacy for the user's current context and preferences.

Example Privacy Characterization Values

This characteristic is scalar, with the minimum range being binary. Example binary values, or scale endpoints, are: not private/private, public/not public, and public/private.

Using no privacy and fully private as the scale endpoints, the following list is an example privacy characterization scale.

No privacy is needed for input or output interaction.

The input must be semi-private. The output does not need to be private.

The input must be fully private. The output does not need to be private.

The input must be fully private. The output must be semi-private.

The input does not need to be private. The output must be fully private.

The input does not need to be private. The output must be semi-private.

The input must be semi-private. The output must be semi-private.

The input and output interaction must be fully private.

Semi-private. The user and at least one other person can have access to or knowledge of the interaction between the user and the computing system.

Fully private. Only the user can have access to or knowledge of the interaction between the user and the computing system.

Exemplary UI Design Implementation for Privacy

The following list contains examples of UI design implementations for how the computing system might respond to a change in task complexity.

If no privacy is needed for input or output interaction:

The UI is not restricted to any particular I/O device for presentation and interaction. For example, the UI could present content to the user through speakers on a large monitor in a busy office.

If the input must be semi-private and if the output does not need to be private, the UI might:

Encourage the user to use coded speech commands or use a keyboard if one is available. There are no restrictions on output presentation.

If the input must be fully private and if the output does not need to be private, the UI might:

Not allow speech commands. There are no restrictions on output presentation.

If the input must be fully private and if the output needs to be semi-private, the UI might:

Not allow speech commands (allow only keyboard commands). Not allow an LCD panel and use earphones to provide audio response to the user.

If the output must be semi-private and if the input does not need to be private, the UI might:

Restrict users to an HMD device and/or an earphone for output. There are no restrictions on input interaction.

If the output must be semi-private and if the input does not need to be private, the UI might:

Restrict users to HMD devices, earphones, and/or LCD panels. There are no restrictions on input interaction.

If the input and output must be semi-private, the UI might:

Encourage the user to use coded speech commands and keyboard methods for input. Output may be restricted to HMD devices, earphones or LCD panels.

If the input and output interaction must be completely private, the UI might:

Not allow speech commands and encourage the user of keyboard methods of input. Output is restricted to HMD devices and/or earphones.

User Expertise

As the user becomes more familiar with the computing system or the UI, they may be able to navigate through the UI more quickly. Various levels of user expertise can be accommodated. For example, instead of configuring all the settings to make an appointment, users can recite all the appropriate commands in the correct order to make an appointment. Or users might be able to use shortcuts to advance or move back to specific screens in the UI. Additionally, expert users may not need as many prompts as novice users. The UI should adapt to the expertise level of the user.

Example User Expertise Characterization Values

This characteristic is scalar, with the minimum range being binary. Example binary values, or scale endpoints, are: new user/not new user, not an expert user/expert user, new user/expert user, and novice/expert.

Using novice and expert as scale endpoints, the following list is an example user expertise scale.

The user is new to the computing system and to computing in general.

The user is new to the computing system and is an intermediate computer user.

The user is new to the computing system, but is an expert computer user.

The user is an intermediate user in the computing system.

The user is an expert user in the computing system.

Exemplary UI Design Implementation for User Expertise

The following are characteristics of an exemplary audio UI design for novice and expert computer users.

The computing system speaks a prompt to the user and waits for a response.

If the user responds in x seconds or less, then the user is an expert. The computing system gives the user prompts only.

If the user responds in>x seconds, then the user is a novice and the computing system begins enumerating the choices available.

This type of UI design works well when more than 1 user accesses the same computing system and the computing system and the users do not know if they are a novice or an expert.

Language

User context may include language, as in the language they are currently speaking (e.g. English, German, Japanese, Spanish, etc.).

Example Language Characterization Values

This characteristic is enumerated. Example values include:

American English

British English

German

Spanish

Japanese

Chinese

Vietnamese

Russian

French

Computing System

This section describes attributes associated with the computing system that may cause a UI to change.

Computing hardware capability

For purposes of user interfaces designs, there are four categories of hardware:

Input/output devices

Storage (e.g. RAM)

Processing capabilities

Power supply

The hardware discussed in this topic can be the hardware that is always available to the computing system. This type of hardware is usually local to the user. Or the hardware could sometimes be available to the computing system. When a computing system uses resources that are sometimes available to it, this can be called an opportunistic use of resources.

Storage

Storage capacity refers to how much random access memory (RAM) is available to the computing system at any given moment. This number is not considered to be constant because the computing system might avail itself to the opportunistic use of memory.

Usually the user does not need to be aware of how much storage is available unless they are engaged in a task that might require more memory than to which they reliably have access. This might happen when the computing system engages in opportunistic use of memory. For example, if an in-motion user is engaged in a task that requires the opportunistic use of memory and that user decides to change location (e.g. they are moving from their vehicle to a utility pole where they must complete other tasks), the UI might warn the user that if they leave the current location, the computing system may not be able to complete the task or the task might not get completed as quickly.

Example Storage Characterization Values

This UI characterization is scalar, with the minimum range being binary. Example binary values or scale endpoints are: no RAM is available/all RAM is available.

Using no RAM is available and all RAM is available, the following table lists an example storage characterization scale.

| Scale attribute | Implication |
|---|---|
| No RAM is available to the | If no RAM is available, there is |
| computing system. | no UI available.-Or-There is no |
| | change to the UI. |
| Of the RAM available to the | The UI is restricted to the |
| computing system, only the | opportunistic use of RAM. |
| opportunistic use of RAM | |
| is available. | |
| Of the RAM that is available | The UI is restricted to using |
| to the computing system, | local RAM. |
| only the local RAM | |
| is accessible | |
| Of the RAM that is available | The UI might warn the user that if |
| to the computing system, | they lose opportunistic use of memory, |
| the local RAM is available | the computing system might not be able |
| and the user is about to | to complete the task, or the task might |
| lose opportunistic use of RAM. | not be completed as quickly. |
| Of the total possible RAM | If there is enough memory |
| available to the computing | available to the computing system to |
| system, all of it is | fully function at a high level, |
| available. | the UI may not need to inform the user. |
| | If the user indicates to the |
| | computing system that they want a |
| | task completed that requires more |
| | memory, the UI might |
| | suggest that the user change locations |
| | to take advantage of additional |
| | opportunistic use of memory. |

Processing Capabilities

Processing capabilities fall into two general categories:

Speed. The processing speed of a computing system is measured in megahertz (MHz). Processing speed can be reflected as the rate of logic calculation and the rate of content delivery. The more processing power a computing system has, the faster it can calculate logic and deliver content to the user.

CPU usage. The degree of CPU usage does not affect the UI explicitly. With current UI design, if the CPU becomes too busy, the UI Typically “freezes” and the user is unable to interact with the computing system. If the CPU usage is too high, the UI will change to accommodate the CPU capabilities. For example, if the processor cannot handle the demands, the UI can simplify to reduce demand on the processor.

Example Processing Capability Characterization Values

This UI characterization is scalar, with the minimum range being binary Example binary or scale endpoints are: no processing capability is available/all processing capability is available.

Using no processing capability is available and all processing capability as scale endpoints, the following table lists an example processing capability scale.

| Scale attribute | Implication |
|---|---|
| No processing power is | There is no change to the UI. |
| available to the computing system | |
| The computing system has | The UI might be audio or text |
| access to a slower speed CPU. | only. |
| The computing system has | The UI might choose to use |
| access to a high speed CPU | video in the presentation instead of |
| | a still picture. |
| The computing system has | There are no restrictions on the |
| access to and control of all processing | UI based on processing power. |
| power available to the computing | |
| system. | |

Power Supply

There are two types of power supplies available to computing systems: alternating current (AC) and direct current (DC). Specific scale attributes for AC power supplies are represented by the extremes of the exemplary scale. However, if a user is connected to an AC power supply, it may be useful for the UI to warn an in-motion user when they're leaving an AC power supply. The user might need to switch to a DC power supply if they wish to continue interacting with the computing system while in motion. However, the switch from AC to DC power should be an automatic function of the computing system and not a function of the UI.

On the other hand, many computing devices, such as wearable personal computers (WPCs), laptops, and PDAs, operate using a battery to enable the user to be mobile. As the battery power wanes, the UI might suggest the elimination of video presentations to extend battery life. Or the UI could display a VU meter that visually demonstrates the available battery power so the user can implement their preferences accordingly.

Example Power Supply Characterization Values

This task characterization is binary if the power supply is AC and scalar if the power supply is DC. Example binary values are: no power/full power. Example scale endpoints are: no power/all power.

Using no power and full power as scale endpoints, the following list is an example power supply scale.

There is no power to the computing system.

There is an imminent exhaustion of power to the computing system.

There is an inadequate supply of power to the computing system.

There is a limited, but potentially inadequate supply of power to the computing system.

There is a limited but adequate power supply to the computing system.

There is an unlimited supply of power to the computing system.

Exemplary UI Design Implementations for Power Supply

The following list contains examples of UI design implementations for how the computing system might respond to a change in the power supply capacity.

If there is minimal power remaining in a battery that is supporting a computing system, the UI might:

Power down any visual presentation surfaces, such as an LCD.

Use audio output only.

If there is minimal power remaining in a battery and the UI is already audio-only, the UI might:

Decrease the audio output volume.

Decrease the number of speakers that receive the audio output or use earplugs only.

Use mono versus stereo output.

Decrease the number of confirmations to the user.

If there is, for example, six hours of maximum-use battery life available and the computing system determines that the user not have access to a different power source for 8 hours, the UI might:

Decrease the luminosity of any visual display by displaying line drawings instead of 3-dimensional illustrations.

Change the chrominance from color to black and white.

Refresh the visual display less often.

Decrease the number of confirmations to the user.

Use audio output only.

Decrease the audio output volume.

Computing Hardware Characteristics

The following is a list of some of the other hardware characteristics that may be influence what is an optimal UI design.

Cost

Waterproof

Ruggedness

Mobility

Again, there are other characteristics that could be added to this list. However, it is not possible to list all computing hardware attributes that might influence what is considered to be an optimal UI design until run time.

Bandwidth

There are different types of bandwidth, for instance:

Network bandwidth

Inter-device bandwidth

Network Bandwidth

Network bandwidth is the computing system's ability to connect to other computing resources such as servers, computers, printers, and so on. A network can be a local area network (LAN), wide area network (WAN), peer-to-peer, and so on. For example, if the user's preferences are stored at a remote location and the computing system determines that the remote resources will not always be available, the system might cache the user's preferences locally to keep the UI consistent. As the cache may consume some of the available RAM resources, the UI might be restricted to simpler presentations, such as text or audio only.

If user preferences cannot be cached, then the UI might offer the user choices about what UI design families are available and the user can indicate their design family preference to the computing system.

Example Network Bandwidth Characterization Values

This UI characterization is scalar, with the minimum range being binary. Example binary values or scale endpoints are: no network access/full network access.

Using no network access and full network access as scale endpoints, the following table lists an example network bandwidth scale.

| Scale attribute | Implication |
|---|---|
| The computing system does | The UI is restricted to using local |
| not have a connection to | computing resources only. If user |
| network resources. | preferences are stored remotely, then |
| | the UI might not account for user |
| | preferences. |
| The computing system has an | The UI might warn the user that |
| unstable connection to | the connection to remote resources |
| network resources. | might be interrupted. The UI might ask |
| | the user if they want to cache |
| | appropriate information to |
| | accommodate for the unstable |
| | connection to network resources. |
| The computing system has a | The UI might simplify, such as |
| slow connection to network | offer audio or text only, to |
| resources. | accommodate for the slow connection. |
| | Or the computing system might cache |
| | appropriate data for the UI so the |
| | UI can always be optimized without |
| | restriction of the slow connection. |
| The computing system has a | In the present moment, the UI |
| high speed, yet limited (by time) | does not have any restrictions based on |
| access to network resources. | access to network resources. If the |
| | computing system determines that |
| | it will lose a network connection, |
| | then the UI can warn the user |
| | and offer choices, such as does |
| | the user want to cache |
| | appropriate information, about what to |
| | do. |
| The computing system has a | There are no restrictions to the UI |
| very high-speed connection to | based on access to network resources. |
| network resources. | The UI can offer text, audio, video, |
| | haptic output, and so on. |

Inter-device Bandwidth

Inter-device bandwidth is the ability of the devices that are local to the user to communicate with each other. Inter-device bandwidth can affect the UI in that if there is low inter-device bandwidth, then the computing system cannot compute logic and deliver content as quickly. Therefore, the UI design might be restricted to a simpler interaction and presentation, such as audio or text only. If bandwidth is optimal, then there are no restrictions on the UI based on bandwidth. For example, the UI might offer text, audio, and 3-D moving graphics if appropriate for the user's context.

Example Inter-Device Bandwidth Characterization Values

This UI characterization is scalar, with the minimum range being binary. Example binary values or scale endpoints are: no inter-device bandwidth/full inter-device bandwidth.

Using no inter-device bandwidth and full inter-device bandwidth as scale endpoints, the following table lists an example inter-device bandwidth scale.

| Scale attribute | Implication |
|---|---|
| The computing system does not | Input and output is restricted to |
| have inter-device connectivity. | each of the disconnected devices. The |
| | UI is restricted to the capability of each |
| | device as a stand-alone device. |
| Some devices have connectivity | It depends |
| and others do not. | |
| The computing system has slow | The task that the user wants to |
| inter-device bandwidth. | complete might require more |
| | bandwidth that is available among |
| | devices. In this case, the UI can offer |
| | the user a choice. Does the user want |
| | to continue and encounter slow |
| | performance? Or, does the user want |
| | to acquire more bandwidth by moving |
| | to a different location and taking |
| | advantage of opportunistic use of |
| | bandwidth? |
| The computing system has fast | There are few, if any, |
| inter-device bandwidth. | restrictions on the interaction and |
| | presentation between the user and the |
| | computing system. The UI sends a |
| | warning message only if there is not |
| | enough bandwidth between devices. |
| The computing system has very | There are no restrictions on the |
| high-speed inter-device | UI based on inter-device connectivity. |
| connectivity. | |

Context Availability

Context availability is related to whether the information about the model of the user context is accessible. If the information about the model of the context is intermittent, deemed inaccurate, and so on, then the computing system might not have access to the user's context.

Example Context Availability Characterization Values

This task characterization is scalar, with the minimum range being binary. Example binary values or scale endpoints are: context not available/context available.

Using context not available and context available as scale endpoints, the following list is an example context availability scale.

No context is available to the computing system

Some of the user's context is available to the computing system.

A moderate amount of the user's context is available to the computing system.

Most of the user's context is available to the computing system.

All of the user's context is available to the computing system

Exemplary UI Design for Context Availability

The following list contains examples of UI design implementations for how the computing system might respond to a change in context availability.

If the information about the model of context is intermittent, deemed inaccurate, or otherwise unavailable, the UI might:

Stay the same.

Ask the user if the UI needs to change.

Infer a UI from a previous pattern if the user's context history is available.

Change the UI based on all other attributes except for user context (e.g. I/O device availability, privacy, task characteristics, etc.)

Use a default UI.

Opportunistic Use of Resources

Some UI components, or other enabling UI content, may allow acquisition from outside sources. For example, if a person is using a wearable computer and they sit at a desk that has a monitor on it, the wearable computer might be able to use the desktop monitor as an output device.

Example Opportunistic Use of Resources Characterization Scale

This characteristic is scalar, with the minimum range being binary. Example binary values, or scale endpoints, are: no opportunistic use of resources/use of all opportunistic resources.

Using these characteristics, the following list is an example of an opportunistic use of resources scale.

The circumstances do not allow for the opportunistic use of resources in the computing system.

Of the resources available to the computing system, there is a possibility to make opportunistic use of resources.

Of the resources available to the computing system, the computing system can make opportunistic use of most of the resources.

Of the resources available to the computing system, all are accessible and available.

Content

Content is defined as information or data that is part of or provided by a task. Content, in contrast to UI elements, does not serve a specific role in the user/computer dialog. It provides informative or entertaining information to the user. It is not a control. For example a radio has controls (knobs, buttons) used to choose and format (tune a station, adjust the volume & tone) of broadcasted audio content.

Sometimes content has associated metadata, but it is not necessary.

Example content characterization values

This characterization is enumerated. Example values include:

Quality

Static/streamlined

Passive/interactive

Type

Output device required

Output device affinity

Output device preference

Rendering software

Implicit. The computing system can use characteristics that can be inferred from the information itself, such as message characteristics for received messages.

Source. A type or instance of carrier, media, channel or network path

Destination. Address used to reach the user (e.g., a user typically has multiple address, phone numbers, etc.)

Message content. (parseable or described in metadata)

Data format type.

Arrival time.

Size.

Previous messages. Inference based on examination of log of actions on similar messages.

Explicit. Many message formats explicitly include message-characterizing information, which can provide additional filtering criteria.

Title.

Originator identification. (e.g., email author)

Origination date & time

Routing. (e.g., email often shows path through network routers)

Priority

Sensitivity. Security levels and permissions

Encryption type

File format. Might be indicated by file name extension

Language. May include preferred or required font or font type

Other recipients (e.g., email cc field)

Required software

Certification. A trusted indication that the offer characteristics are dependable and accurate.

Recommendations. Outside agencies can offer opinions on what information may be appropriate to a particular type of user or situation.

Security

Controlling security is controlling a user's access to resources and data available in a computing system. For example when a user logs on a network, they must supply a valid user name and password to gain access to resource on the network such as, applications, data, and so on.

In this sense, security is associated with the capability of a user or outside agencies in relation to a user's data or access to data, and does not specify what mechanisms are employed to assure the security.

Security mechanisms can also be separately and specifically enumerated with characterizing attributes.

Permission is related to security. Permission is the security authorization presented to outside people or agencies. This characterization could inform UI creation/selection by giving a distinct indication when the user is presented information that they have given permission to others to access.

Example Security Characterization Values

This characteristic is scalar, with the minimum range being binary. Example binary values, or scale endpoints are: no authorized user access/all user access, no authorized user access/public access, and no public access/public access.

Using no authorized user access and public access as scale endpoints, the following list is an example security scale.

No authorized access.

Single authorized user access.

Authorized access to more than one person

Authorized access for more than one group of people

Public access

Single authorized user only access. The only person who has authorized access to the computing system is a specific user with valid user credentials.

Public access. There are no restrictions on who has access to the computing system. Anyone and everyone can access the computing system.

Task Characterizations

A task is a user-perceived objective comprising steps. The topics in this section enumerate some of the important characteristics that can be used to describe tasks. In general, characterizations are needed only if they require a change in the UI design.

The topics in this section include examples of task characterizations, example characterization values, and in some cases, example UI designs or design characteristics.

Task Length

Whether a task is short or long depends upon how long it takes a target user to complete the task. That is, a short task takes a lesser amount of time to complete than a long task. For example, a short task might be creating an appointment. A long task might be playing a game of chess.

Example Task Length Characterization Values

This task characterization is scalar, with the minimum range being binary. Example binary values or scale endpoints are: short/not short, long/not long, or short/long.

Using short/long as scale endpoints, the list is an example task length scale.

The task is very short and can be completed in 30 seconds or less

The task is moderately short and can be completed in 31-60 seconds.

The task is short and can be completed in 61-90 seconds.

The task is slightly long and can be completed in 91-300 seconds.

The task is moderately long and can be completed in 301-1,200 seconds.

The task is long and can be completed in 1,201-3,600 seconds.

The task is very long and can be completed in 3,601 seconds or more.

Task Complexity

Task complexity is measured using the following criteria:

Number of elements in the task. The greater the number of elements, the more likely the task is complex.

Element interrelation. If the elements have a high degree of interrelation, then the more likely the task is complex.

User knowledge of structure. If the structure, or relationships, between the elements in the task is unclear, then the more likely the task is considered to be complex.

If a task has a large number of highly interrelated elements and the relationship between the elements is not known to the user, then the task is considered to be complex. On the other hand, if there are a few elements in the task and their relationship is easily understood by the user, then the task is considered to be well-structured. Sometimes a well-structured task can also be considered simple.

Example Task Complexity Characterization Values

This task characterization is scalar, with the minimum range being binary. Example binary values or scale endpoints are: simple/not simple, complex/not complex, simple/complex, well-structured/not well-structured, or well-structured/complex.

Using simple/complex as scale endpoints, the list is an example task complexity scale.

There is one, very simple task composed of 1-5 interrelated elements whose relationship is well understood.

There is one simple task composed of 6-10 interrelated elements whose relationship is understood.

There is more than one very simple task and each task is composed of 1-5 elements whose relationship is well understood.

There is one moderately simple task composed of 11-15 interrelated elements whose relationship is 80-90% understood by the user.

There is more than one simple task and each task is composed of 6-10 interrelated whose relationship is understood by the user.

There is one somewhat simple task composed of 16-20 interrelated elements whose relationship is understood by the user.

There is more than one moderately simple task and each task is composed of 11-15 interrelated elements whose relationship is 80-90% understood by the user.

There is one complex task complex task composed of 21-35 interrelated elements whose relationship is 60-79% understood by the user.

There is more than one somewhat complex task and each task is composed of 16-20 interrelated elements whose relationship is understood by the user.

There is one moderately complex task composed of 36-50 elements whose relationship is 80-90% understood by the user.

There is more than one complex task and each task is composed of 21-35 elements whose relationship is 60-79% understood by the user.

There is one very complex task composed of 51 or more elements whose relationship is 40-60% understood by the user.

There is more than one complex task and each task is composed of 36-50 elements whose relationship is 40-60% understood by the user.

There is more than one very complex task and each part is composed of 51 or more elements whose relationship is 20-40% understood by the user.

Exemplary UI Design Implementation for Task Complexity

The following list contains examples of UI design implementations for how the computing system might respond to a change in task complexity.

For a task that is long and simple (well-structured), the UI might:

Give prominence to information that could be used to complete the task.

Vary the text-to-speech output to keep the user's interest or attention.

For a task that is short and simple, the UI might:

Optimize to receive input from the best device. That is, allow only input that is most convenient for the user to use at that particular moment.

If a visual presentation is used, such as an LCD panel or monitor, prominence may be implemented using visual presentation only.

For a task that is long and complex, the UI might:

Increase the orientation to information and devices

Increase affordance to pause in the middle of a task. That is, make it easy for a user to stop in the middle of the task and then return to the task.

For a task that is short and complex, the UI might:

Default to expert mode.

Suppress elements not involved in choices directly related to the current task.

Change modality

Task Familiarity

Task familiarity is related to how well acquainted a user is with a particular task. If a user has never completed a specific task, they might benefit from more instruction from the computing environment than a user who completes the same task daily. For example, the first time a car rental associate rents a car to a consumer, the task is very unfamiliar. However, after about a month, the car rental associate is very familiar with renting cars to consumers.

Example Task Familiarity Characterization Values

This task characterization is scalar, with the minimum range being binary. Example binary values or scale endpoints are: familiar/not familiar, not unfamiliar/unfamiliar, and unfamiliar/familiar.

Using unfamiliar and familiar as scale endpoints, the list is an example task familiarity scale.

On a scale of 1 to 5, where one is very unfamiliar and 5 is very familiar, the task familiarity rating is 1.

On a scale of 1 to 5, where one is very unfamiliar and 5 is very familiar, the task familiarity rating is 2.

On a scale of 1 to 5, where one is very unfamiliar and 5 is very familiar, the task familiarity rating is 3.

On a scale of I to 5, where one is very unfamiliar and 5 is very familiar, the task familiarity rating is 4.

On a scale of 1 to 5, where one is very unfamiliar and 5 is very familiar, the task familiarity rating is 5.

Exemplary UI Design Implementation for Task Familiarity

The following list contains examples of UI design implementations for how the computing system might respond to a change in task familiarity.

For a task that is unfamiliar, the UI might:

Increase task orientation to provide a high level schema for the task.

Offer detailed help.

Present the task in a greater number of steps.

Offer more detailed prompts.

Provide information in as many modalities as possible.

For a task that is familiar, the UI might:

Decrease the affordances for help

Offer summary help

Offer terse prompts

Decrease the amount of detail given to the user

Use auto-prompt and auto-complete (that is, make suggestions based on past choices made by the user).

The ability to barge ahead is available.

Use user-preferred modalities.

Task Sequence

A task can have steps that must be performed in a specific order. For example, if a user wants to place a phone call, the user must dial or send a phone number before they are connected to and can talk with another person. On the other hand, a task, such as searching the Internet for a specific topic, can have steps that do not have to be performed in a specific order.

Example Task Sequence Characterization Values

This task characterization is scalar, with the minimum range being binary. Example binary values or scale endpoints are: scripted/not scripted, nondeterministic/not nondeterministic, or scripted/nondeterministic.

Using scripted/nondeterministic as scale endpoints, the following list is an example task sequence scale.

The each step in the task is completely scripted.

The general order of the task is scripted. Some of the intermediary steps can be performed out of order.

The first and last steps of the task are scripted. The remaining steps can be performed in any order.

The steps in the task do not have to be performed in any order.

Exemplary UI Design Implementation for Task Sequence

The following list contains examples of UI design implementations for how the computing system might respond to a change in task sequence.

For a task that is scripted, the UI might:

Present only valid choices.

Present more information about a choice so a user can understand the choice thoroughly.

Decrease the prominence or affordance of navigational controls.

For a task that is nondeterministic, the UI might:

Present a wider range of choices to the user.

Present information about the choices only upon request by the user.

Increase the prominence or affordance of navigational controls

Task Independence

The UI can coach a user though a task or the user can complete the task without any assistance from the UI. For example, if a user is performing a safety check of an aircraft, the UI can coach the user about what questions to ask, what items to inspect, and so on. On the other hand, if the user is creating an appointment or driving home, they might not need input from the computing system about how to successfully achieve their objective.

Example Task Independence Characterization Values

This task characterization is scalar, with the minimum range being binary. Example binary values or scale endpoints are: coached/not coached, not independently executed/independently executed, or coached/independently executed.

Using coached/independently executed as scale endpoints, the following list is an example task guidance scale.

Each step in the task is completely scripted.

The general order of the task is scripted. Some of the intermediary steps can be performed out of order.

The first and last steps of the task are scripted. The remaining steps can be performed in any order.

The steps in the task do not have to be performed in any order.

Task Creativity

A formulaic task is a task in which the computing system can precisely instruct the user about how to perform the task. A creative task is a task in which the computing system can provide general instructions to the user, but the user uses their knowledge, experience, and/or creativity to complete the task. For example, the computing system can instruct the user about how to write a sonnet. However, the user must ultimately decide if the combination of words is meaningful or poetic.

Example Task Creativity Characterization Values

This task characterization is scalar, with the minimum range being binary. Example binary values or scale endpoints could be defined as formulaic/not formulaic, creative/not creative, or formulaic/creative.

Using formulaic and creative as scale endpoints, the following list is an example task creativity scale.

On a scale of 1 to five, where 1 is formulaic and 5 is creative, the task creativity rating is 1.

On a scale of 1 to five, where 1 is formulaic and 5 is creative, the task creativity rating is 2.

On a scale of 1 to five, where 1 is formulaic and 5 is creative, the task creativity rating is 3.

On a scale of 1 to five, where I is formulaic and 5 is creative, the task creativity rating is 4.

On a scale of 1 to five, where 1 is formulaic and 5 is creative, the task creativity rating is 5.

Software Requirements

Tasks can be intimately related to software requirements. For example, a user cannot create a complicated database without software.

Example Software Requirements Characterization Values

This task characterization is enumerated. Example values include:

JPEG viewer

PDF reader

Microsoft Word

Microsoft Access

Microsoft Office

Lotus Notes

Windows NT 4.0

Mac OS 10

Task Privacy

Task privacy is related to the quality or state of being apart from company or observation. Some tasks have a higher level of desired privacy than others. For example, calling a physician to receive medical test results has a higher level of privacy than making an appointment for a meeting with a co-worker.

Example Task Privacy Characterization Values

This task characterization is scalar, with the minimum range being binary. Example binary values or scale endpoints are: private/not private, public/not public, or private/public.

Using private/public as scale endpoints, the following table is an example task privacy scale.

The task is not public. Anyone can have knowledge of the task.

The task is semi-private. The user and at least one other person have knowledge of the task.

The task is fully private. Only the user can have knowledge of the task.

Hardware Requirements

A task can have different hardware requirements. For example, talking on the phone requires audio input and output while entering information into a database has an affinity for a visual display surface and a keyboard.

Example Hardware Requirements Characterization Values

This task characterization is enumerated. Example values include:

10 MB available of storage

1 hour of power supply

A free USB connection

Task Collaboration

A task can be associated with a single user or more than one user. Most current computer-assisted tasks are designed as single-user tasks. Examples of collaborative computer-assisted tasks include participating in a multi-player video game or making a phone call.

Example Task Collaboration Characterization Values

This task characterization is binary. Example binary values are single user/collaboration.

Task Relation

A task can be associated with other tasks, people, applications, and so on. Or a task can stand alone on it's own.

Example Task Relation Characterization Values

This task characterization is binary. Example binary values are unrelated task/related task.

Task Completion

There are some tasks that must be completed once they are started and others that do not have to be completed. For example, if a user is scuba diving and is using a computing system while completing the task of decompressing, it is essential that the task complete once it is started. To ensure the physical safety of the user, the software must maintain continuous monitoring of the user's elapsed time, water pressure, and air supply pressure/quantity. The computing system instructs the user about when and how to safely decompress. If this task is stopped for any reason, the physical safety of the user could be compromised.

Example Task Completion Characterization Values

This task characterization is enumerated. Example values are:

Must be completed

Does not have to be completed

Can be paused

Not known

Task Priority

Task priority is concerned with order. The order may refer to the order in which the steps in the task should be completed or order may refer to the order in which a series of tasks should be performed. This task characteristic is scalar. Tasks can be characterized with a priority scheme, such as (beginning at low priority) entertainment, convenience, economic/personal commitment, personal safety, personal safety and the safety of others. Task priority can be defined as giving one task preferential treatment over another. Task priority is relative to the user. For example, “all calls from mom” may be a high priority for one user, but not another user.

Example Task Privacy Characterization Values

This task characterization is scalar, with the minimum range being binary. Example binary values or scale endpoints are no priority/high priority.

Using no priority and high priority as scale endpoints, the following list is an example task priority scale.

The current task is not a priority. This task can be completed at any time.

The current task is a low priority. This task can wait to be completed until the highest priority, high priority, and moderately high priority tasks are completed.

The current task is moderately high priority. This task can wait to be completed until the highest priority and high priority tasks are addressed.

The current task is high priority. This task must be completed immediately after the highest priority task is addressed.

The current task is of the highest priority to the user. This task must be completed first.

Task Importance

Task importance is the relative worth of a task to the user, other tasks, applications, and so on. Task importance is intrinsically associated with consequences. For example, a task has higher importance if very good or very bad consequences arise if the task is not addressed. If few consequences are associated with the task, then the task is of lower importance.

Example Task Importance Characterization Values

This task characterization is scalar, with the minimum range being binary. Example binary values or scale endpoints are not important/very important.

Using not important and very important as scale endpoints, the following list is an example task importance scale.

The task in not important to the user. This task has an importance rating of “1.”

The task is of slight importance to the user. This task has an importance rating of “2.”

The task is of moderate importance to the user. This task has an importance rating of “3.”

The task is of high importance to the user. This task has an importance rating of “4.”

The task is of the highest importance to the user. This task has an importance rating of “5.”

Task Urgency

Task urgency is related to how immediately a task should be addressed or completed. In other words, the task is time dependent. The sooner the task should be completed, the more urgent it is.

Example Task Urgency Characterization Values

This task characterization is scalar, with the minimum range being binary. Example binary values or scale endpoints are not urgent/very urgency.

Using not urgent and very urgent as scale endpoints, the following list is an example task urgency scale.

A task is not urgent. The urgency rating for this task is “1.”

A task is slightly urgent. The urgency rating for this task is “2.”

A task is moderately urgent. The urgency rating for this task is “3.”

A task is urgent. The urgency rating for this task is “4.”

A task is of the highest urgency and requires the user's immediate attention. The urgency rating for this task is “5.”

Exemplary UI Design Implementation for Task Urgency

The following list contains examples of UI design implementations for how the computing system might respond to a change in task urgency.

If the task is not very urgent (e.g. a task urgency rating of 1, using the scale from the previous list), the UI might not indicate task urgency.

If the task is slightly urgent (e.g. a task urgency rating of 2, using the scale from the previous list), and if the user is using a head mounted display (HMD), the UI might blink a small light in the peripheral vision of the user.

If the task is moderately urgent (e.g. a task urgency rating of 3, using the scale from the previous list), and if the user is using an HMD, the UI might make the light that is blinking in the peripheral vision of the user blink at a faster rate.

If the task is urgent, (e.g. a task urgency rating of 4, using the scale from the previous list), and if the user is wearing an HMD, two small lights might blink at a very fast rate in the peripheral vision of the user.

If the task is very urgent, (e.g. a task urgency rating of 5, using the scale from the previous list), and if the user is wearing an HMD, three small lights might blink at a very fast rate in the peripheral vision of the user. In addition, a notification is sent to the user's direct line of sight that warns the user about the urgency of the task. An audio notification is also presented to the user.

Task Concurrency

Mutually exclusive tasks are tasks that cannot be completed at the same time while concurrent tasks can be completed at the same time. For example, a user cannot interactively create a spreadsheet and a word processing document at the same time. These two tasks are mutually exclusive. However, a user can talk on the phone and create a spreadsheet at the same time.

Example Task Concurrency Characterization Values

This task characterization is binary. Example binary values are mutually exclusive and concurrent.

Task Continuity

Some tasks can have their continuity or uniformity broken without comprising the integrity of the task, while other cannot be interrupted without compromising the outcome of the task. The degree to which a task is associated with saving or preserving human life is often associated with the degree to which it can be interrupted. For example, if a physician is performing heart surgery, their task of performing heart surgery is less interruptible than the task of making an appointment.

Example Task Continuity Characterization Values

This task characterization is scalar, with the minimum range being binary. Example binary values or scale endpoints are interruptible/not interruptible or abort/pause.

Using interruptible/not interruptible as scale endpoints, the following list is an example task continuity scale.

The task cannot be interrupted.

The task can be interrupted for 5 seconds at a time or less.

The task can be interrupted for 6-15 seconds at a time .

The task can be interrupted for 16-30 seconds at a time.

The task can be interrupted for 31-60 seconds at a time.

The task can be interrupted for 61-90 seconds at a time.

The task can be interrupted for 91-300 seconds at a time.

The task can be interrupted for 301-1,200 seconds at a time.

The task can be interrupted 1,201-3,600 seconds at a time.

The task can be interrupted for 3,601 seconds or more at a time.

The task can be interrupted for any length of time and for any frequency.

Cognitive Load

Cognitive load is the degree to which working memory is engaged in processing information. The more working memory is used, the higher the cognitive load. Cognitive load encompasses the following two facets: cognitive demand and cognitive availability.

Cognitive demand is the number of elements that a user processes simultaneously. To measure the user's cognitive load, the system can combine the following three metrics: number of elements, element interaction, and structure. Cognitive demand is increased by the number of elements intrinsic to the task. The higher the number of elements, the more likely the task is cognitively demanding. Second, cognitive demand is measured by the level of interrelation between the elements in the task. The higher the inter-relation between the elements, the more likely the task is cognitively demanding. Finally, cognitive load is measured by how well revealed the relationship between the elements is. If the structure of the elements is known to the user or if it's easily understood, then the cognitive demand of the task is reduced.

Cognitive availability is how much attention the user engages in during the computer-assisted task. Cognitive availability is composed of the following:

Expertise. This includes schema and whether or not it is in long term memory

The ability to extend short term memory.

Distraction. A non-task cognitive demand.

How Cognitive Load Relates to Other Attributes

Cognitive load relates to at least the following attributes:

Learner expertise (novice/expert). Compared to novices, experts have an extensive schemata of a particular set of elements and have automaticity, the ability to automatically understand a class of elements while devoting little to no cognition to the classification. For example, a novice reader must examine every letter of the word that they're trying to read. On the other hand, an expert reader has built a schema so that elements can be “chunked” into groups and accessed as a group rather than a single element. That is, an expert reader can consume paragraphs of text at a time instead of examining each letter.

Task familiarity (unfamiliar/familiar). When a novice and an expert come across an unfamiliar task, each will handle it differently. An expert is likely to complete the task either more quickly or successfully because they access schemas that they already have and use those to solve the problem/understand the information. A novice may spend a lot of time developing a new schema to understand the information/solve the problem.

Task complexity (simple/complex or well-structured/complex). A complex task is a task whose structure is not well-known. There are many elements in the task and the elements are highly interrelated. The opposite of a complex task is well-structured. An expert is well-equipped to deal with complex problems because they have developed habits and structures that can help them decompose and solve the problem.

Task length (short/long). This relates to how much a user has to retain in working memory.

Task creativity. (formulaic/creative) How well known is the structure of the interrelation between the elements?

Example Cognitive Demand Characterization Values

This task characterization is scalar, with the minimum range being binary. Example binary values or scale endpoints are cognitively undemanding/cognitively demanding.

Exemplary UI Design Implementation for Cognitive Load

A UI design for cognitive load is influenced by a tasks intrinsic and extrinsic cognitive load. Intrinsic cognitive load is the innate complexity of the task and extrinsic cognitive load is how the information is presented. If the information is presented well (e.g. the schema of the interrelation between the elements is revealed), it reduces the overall cognitive load.

The following list contains examples of UI design implementations for how the computing system might respond to a change cognitive load.

Present information to the user by using more than one channel. For example, present choices visually to the user, but use audio for prompts.

Use a visual presentation to reveal the relationships between the elements. For example if a family tree is revealed, use colors and shapes to represent male and female members of the tree or shapes and colors can be used to represent different family units.

Reduce the redundancy. For example, if the structure of the elements is revealed visually, do not use audio to explain the same structure to the user.

Keep complementary or associated information together. For example, if creating a dialog box so a user can print, create a button that has the word “Print” on it instead of a dialog box that has a question “Do you want to print?” with a button with the work “OK” on it.

Task Alterability

Some task can be altered after they are completed while others cannot be changed. For example, if a user moves a file to the Recycle Bin, they can later retrieve the file. Thus, the task of moving the file to the Recycle Bin is alterable. However, if the user deletes the file from the Recycle Bin, they cannot retrieve it at a later time. In this situation, the task is irrevocable.

Example Task Alterability Characterization Values

This task characterization is binary, with the minimum range being binary. Example binary values or scale endpoints are alterable/not alterable, irrevocable/revocable, or alterable/irrevocable.

Task Content Type

This task characteristic describes the type of content to be used with the task. For example, text, audio, video, still pictures, and so on.

Example Content Type Characteristics Values

This task characterization is an enumeration. Some example values are:

asp

.jpeg

.avi

.jpg

.bmp

.jsp

.gif

.php

.htm

.txt

.html

.wav

.doc

.xls

.mdb

.vbs

.mpg

Again, this list is meant to be illustrative, not exhaustive.

Task Type

A task can be performed in many types of situations. For example, a task that is performed in an augmented reality setting might be presented differently to the user than the same task that is executed in a supplemental setting.

Example Task Type Characteristics Values

This task characterization is an enumeration. Example values can include:

Supplemental

Augmentative

Mediated

3003: Compare UI Designs with UI Needs

3003 in FIG. 7 describes how to match an optimal UI characterization with a UI design characterization, as shown by the double-headed arrow in FIG. 1. First, the UI design characterizations are compared to the optimal UI characterizations (3004). This can be done, for example, by assembling the sets of characterizations into rows and columns of a look-up table. The following is a simple example of such a lookup table. The rows correspond to the UI design characterizations and the columns correspond to the UI needs characterizations.

| | | Output | Cognitive | | |
|---|---|---|---|---|---|
| Design | Input device | device | load | Privacy | Safety |
| A | 1 | 2 | 3 | 4 | |
| B | 1 | 3 | 2 | 2 | |
| C | 2 | 1 | 1 | 1 | |

In FIG. 7, if there is not at least one match in the look-up table, then the closest match is chosen (3005). If there is more than one match, then the best match is selected (3006). Once the match is made, it is sent to the computing system (3007).

3004: Assembling UI Designs and UI Needs

As mentioned previously, this step of the process compares available UI design characterizations to UI needs characterizations. This can be done by matching XML metadata, numeric key metadata (such as values of a binary bit field), or assembling said metadata into rows and columns in a look-up table to determine if there is a match.

If there is a match, the request for that particular UI design is sent to the computing system and the UI changes.

3005: Closest Match

If there is no match for the current UI design, then the closest match is chosen. This section describes two ways to make the closest match:

Using a weighted matching index.

Creating explicit rules or logic

Weighted Matching Index

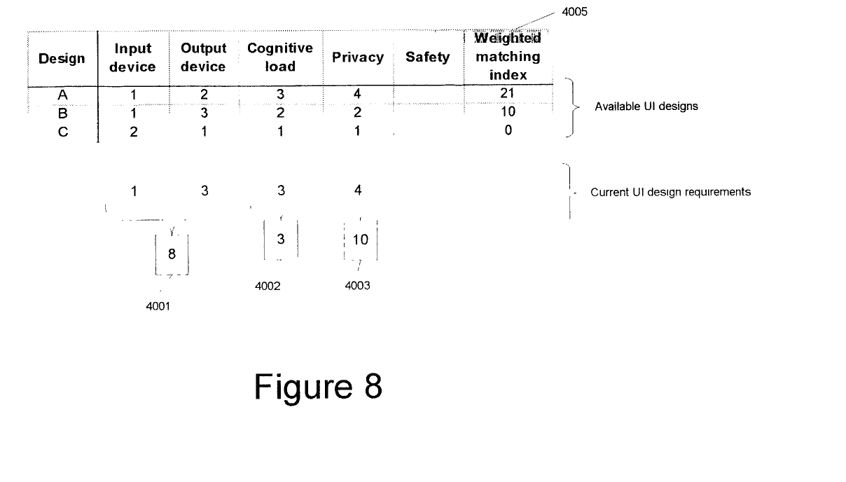

In this embodiment, the optimal UI needs and UI design characterizations are assembled into a look-up table in 3004. If there is no match in the lookup table, then the characterizations of the current UI needs are weighted against the available UI designs and then the closest match is chosen. FIG. 8 shows how this is done.

In FIG. 8, a weight is assigned to a particular characteristic or characteristics (4001, 4002, 4003, 4004). If the characterization in a design matches a UI design requirement, then the weighted number is added to the total. If a UI design characterization does not match a UI design requirement, then no value is added. For example, in the FIG. 8, the weighted matching index value for design A is “21.” The logic used to determine this value is as follows:

If A(Input device) matches the first UI design requirement characterization value, then add 8. If it does not match, then do not add any value.

If A(Cognitive load) matches the cognitive load UI design requirement characterization value, then add 3. If there is no match, then do not add any value.

If A(Privacy) matches the Privacy UI design requirement characterization value, then add 10. If there is no match, then do not add any value.

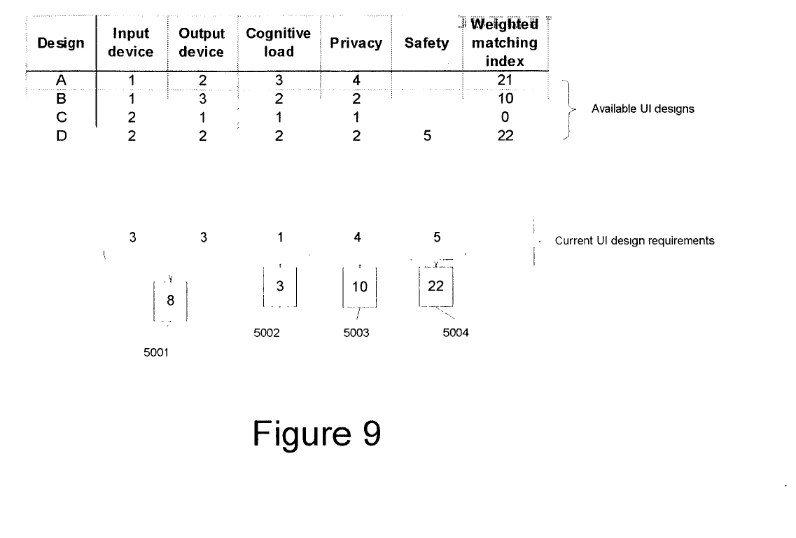

However, there are times when some characteristics override all others. FIG. 9 shows an example of such a situation.

In FIG. 9, even though attributes 5001, 5002, and 5003 do not match any available designs, 4004 matches the Safety characterization for design D. In this case, the logic used is as follows.

If A(Input device) matches the first UI design requirement characterization value, then add 8. If it does not match, then do not add any value.

If A(Cognitive load) matches the cognitive load UI design requirement characterization value, then add 3. If there is no match, then do not add any value.

If A(Privacy) matches the Privacy UI design requirement characterization value, then add 10. If there is no match, then do not add any value.

If A(Safety) matches the Safety UI design requirement characterization value, then choose design D.

The values for Input device, Cognitive load, Privacy, and Safety are determined by whether or not the characteristics are desirable, supplemental, or necessary. If a characteristic is necessary, then is gets a high weighted value. If a characteristic is desirable, then it gets next highest weighted value. If a characteristic is supplemental, then it gets the least amount of weight. In FIG. 8, 4004 is a necessary characteristic, 4001 and 4003 are desired characteristics, and 4002 is a supplemental characteristic.

Explicit Rules

Explicit rules can be implements before (pre-matching logic), during (rules), or after (post-matching logic) the UI design choice is made.

Pre-Matching Logic

The following is an example of pre-matching logic that can be applied to a look-up table to decrease the number of possible rows and/or columns in the table.

If personal risk is>moderate, then

If activity driving, then choose design D, else

If activity=sitting, then choose design B, else

Rules

The following is an example of an explicit rule that can be applied to a look-up table.

If Need=(Audio (Y)+Safety (high)), then choose only design B12.

Note: In this example, design B12 is the “Audio safety UI.”

Post-Matching Logic

At this step in the process, the computing system can verify with a user whether the choice is appropriate. This is optional. Example logic includes:

If the design has not been previously used, then verify with user.

3006: Selecting the Best Match

There are two types of multiple matches. There are conditions in which more than one design is potentially suitable for a context characterization. Similarly, there are conditions in which a single UI design is suitable for more than one context characterization.

UI Family Match

If a context characterization has more than one UI design match (e.g. there are multiple UI characterizations that match a context characterization), then the UI that is in the same UI family is chosen. UI family membership is part of the metadata that characterizes a UI design.

Non UI Family Match

If none of the matches are in the same UI family, then the same mechanisms as described above can be used (weighted matching index, explicit logic, pre-matching logic, and post-matching logic.

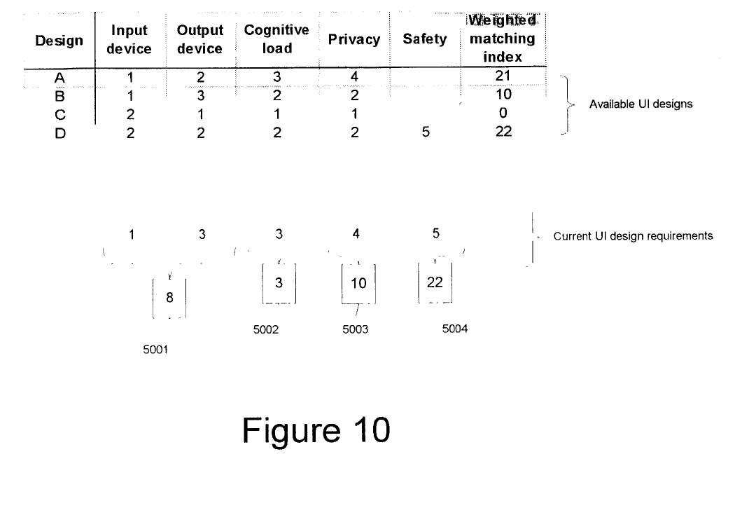

In FIG. 10, design D is the design of choice due to the following logic:

If A(Input device) matches the first UI design requirement characterization value, then add 8. If it does not match, then do not add any value.

If A(Cognitive load) matches the cognitive load UI design requirement characterization value, then add 3. If there is no match, then do not add any value.

If A(Privacy) matches the Privacy UI design requirement characterization value, then add 10. If there is no match, then do not add any value.

If A(Safety) matches the Safety UI design requirement characterization value, then choose design D, regardless of other characterization value matches.

Dynamically Optimizing Computer UIS

By characterizing the function of user interface independently from its presentation and interaction with a broad set of attributes related to the changing needs of the user, in particularly to their changing contexts, a computer can make use of the various methods for optimizing a UI. These methods include the modification of:

Prominence—conspicuousness of a UI element.

Association—he indication of relationship between UI elements through similarity or grouping.

Metaphor

Sensory Analogy

Background Awareness

Invitation—Creating a sense of enticement or allurement to engage in interaction with a UI element(s).

Safety—A computer can enhance the safety of the user by either providing or emphasizing information that identifies real or potential danger or suggests a course of action that would allow the user to avoid danger, or a computer can suppress the presentation of information that may distract the user from safe actions, or it can offer modes of interaction that avoid either distraction or actual physical danger.

Example Characteristics of an Example WPC

“Wearable” is a bit of a misnomer in that the defining characteristic of a WPC isn't that it is worn or integrated into clothing, but that it travels with you at all times, is not removed or set down, and is considered by you and those around you as integral to your person, much as eyeglasses or a wristwatch or memories are. With such integration, wearable computers can truly become a component of you.

A wearable computer can also be distinguished by its ultimate promise: to serve as a capable, general-purpose computational platform which can, because it is always present, wholly integrate with your daily life.

The fuzzy description of a wearable computer is that it's a computer that is always with you, is comfortable and easy to keep and use, and is as unobtrusive as clothing. However, this “smart clothing” description is unsatisfactory when pushed in the details. A more specific description is that wearable computers have many of the following characteristics.

Present and Operational in all Circumstances

The most distinguishing feature of a wearable is that it can be used while walking or otherwise moving around. You do not need to arrange yourself to suit the computer. Rather, the computer provides the means by which you can operate it regardless of circumstances. A wearable is designed to operate on you day and night, and no “place” is needed to set it up-neither a hand nor a flat surface. This distinguishes wearable computers from both desktop and laptop computers.

Unrestrictive

A wearable is self-supporting on the body using some convenient means and works with you in all situations-walking, sitting, lying down. It doesn't necessarily impinge on your life or what you're doing. You can do other things while using it; for instance, you can walk to lunch while typing.

Integral

A wearable is a part of “you,” like a wristwatch or eyeglasses or ears or thoughts. And like a wallet or watch, it is not separable or easily lost because it resides on you and effortlessly travels with you without your keeping track of it (as opposed to a briefcase). It is also integrated into your daily processes and can supplement thought as it takes place.

Always On, Alert, and Available

By design, a wearable computer can be useful in whatever place you are in—it is always ready and responsive, reactive, proactive, and monitoring. It requires no setup time or manipulation to get started, unlike most pen-based personal digital assistants (PDAs) and laptops. (PDAs normally sit in a pocket and are only awakened when a task needs to be done; a laptop computer must be opened up, switched on, and booted up before use.) A wearable is in continuous interaction with you, even though it may not be your primary focus at all times.

Able to Attract Your Attention

A wearable can either make information available peripherally, or it can overtly interrupt you to gain your attention even when it's not actively being used. For example, if you want the computer to alert you when new e-mail arrives and to indicate its sender, the WPC can have a range of audible and visual means to communicate this depending on the urgency or importance of the e-mail, and on your willingness to deal with the notification at the time.

How a Wearable Changes the Way Computers Function

The promise of a wearable's unique characteristics make new uses of a computer inevitable.

The Computer Can Sense Context

Both interaction and information can be extremely contextual with a WPC. Given the right kind of sensors, the wearable can attend to (be aware of and draw input from) you and your environment. It could witness events around you, detect your circumstances or physical state (e.g., the level of ambient noise or privacy, whether you're sitting or standing), provide feedback about the environment (e.g., temperature, altitude), and adjust how it presents and receives information in keeping with your situation.

Always on and always sensing means a wearable might change which applications or UI elements it makes readily available as you move from work to home. Or it might tailor the UI and interaction to suit what's going on right now.

If it detects that you're flying, for instance, the wearable might automatically report your destination's local time and weather, track the status of your connecting flights, and help get you booked on another flight if your plane is going to be late. Similarly, if a wearable's sensors show that you're talking on the cell phone, the WPC might automatically turn off audio interruptions and use only a head-mount display to alert you to incoming e-mails, calls, or information you have requested.

None of these uses are possible with a PDA or other computer system.

The Computer Can Suggest and/or Direct

The better a WPC can sense context, the more appropriate and proactive its interaction can become for you. For instance, as you drive near your grocery store on the way home from work, your wearable might remind you that you should pick up cat food. This “eventing on context” gives the computer a whole new role in which it can suggest options and remind you of things like to putting out the trash on Tuesday or telling something to John as he walks into the room. You wouldn't be able to do this with a desktop or laptop system.

A computer that is with you while you're out in the world can also step you through processes and help troubleshoot problems within the very context in which they arise. This is different from a desktop system, which forces you to stay in its world, at its monitor, with your hands on its keyboard and mouse, printing out whatever instructions you may need offsite. The hands-free, always-with-you wearable can deliver procedures and instructions from any hard drive or web site at the very place where you're faced with the problem. It can even direct you verbally or visually as you perform each step.

The Computer can Augment Information, Memory, and Senses

Because a wearable computer can actively monitor, log, and preserve knowledge, it can have its own memories that you can rely on to augment your memory, intellect, or senses. For instance, its memory banks can help you recall where you parked the car at Disneyland, or replay the directions you asked for from the gas attendant. It might help you “sniff” carbon monoxide levels, see in infrared or at night, and hear ultrahigh frequencies. When you're traveling in France, it might overlay English translations onto road signs.

How a Wearable Changes the Way Computers and People Interact

Because a wearable computer is always around, always on, and always aware of you and your changing contexts, the WPC has the potential to become a working partner in almost any daily task. WPCs can prompt drastic shifts in how people interact with tools that were once viewed only as stationary, static devices.

People can be in Touch with the World in Ways Never Before Experienced

A computer that can sense can be a digital mediator to the world around you. You can hear the pronunciation of unfamiliar words, call up a thesaurus or dictionary or translator or instructions, or pull up any Internet-based fact you need when you need it. Because a wearable can talk to any device within its range, it could annotate the world around you with relevant information. For example, it might overlay people's names as you meet them, provide menus of restaurants as you pass by, and list street names or historical buildings as you visit a new city. A wearable will be able to “sense across time” to provide an instant replay of recent events or audio, in case you missed what was said or done. And unlike smart phones which have to be turned on, a WPC can provide all of this information with a whisper or a keystroke anytime it's needed.

The Computer can be Used Peripherally Throughout the Day

A wearable PC turns computing into a secondary, not primary, activity. Unlike a desktop system that becomes your sole focus because it's time to sit down in front of it, a WPC takes on an ancillary, peripheral role by being always “awake” and available when it's needed, yet staying alert in the background when you're busy with something else. Your interaction with a WPC is fluid and interruptible, allowing the computer to function as a supporting player throughout your day. This will make computer usage more incidental, with a get-in, get-out, and do-what-you-want focus.

People Can Alter Their Computer Interaction Based on Context

WPCs imply that your use of, and interaction with, the computer can dramatically change from moment to moment based on your:

Physical ability to direct the system—You and the WPC will communicate differently based on what combination of your hands, ears, eyes, and voice is busy at the moment.

Physical (whole-body) activity—Your ability or willingness to direct the WPC may be altered by what action your whole body is doing, such as driving, walking, running, sitting, etc.

Mental attention or willingness to interact with the system (your cognitive availability)—How and whether you choose to communicate with the WPC may vary if you're concentrating on a difficult task, negotiating a contract, or shooting the breeze.

Context, task, need, or purpose—What you need the WPC for will vary by your current task or topic, such as if you're going to a meeting, in a meeting, driving around doing errands, or traveling on vacation.

Location—Both the content and nature of your WPC interaction can change as you move from an airplane in the morning, to an office during the day, to a restaurant for lunch, and then to a soccer game with the kids in the evening. They can also change even as you move through three-dimensional space.

Desire for privacy, perceived situational constraints—How you interact with the WPC is likely to change many times a day to accommodate the amount of privacy you have or want, and whether you think using a WPC in a particular situation is socially acceptable.

People can Invest the Computer with More About Their Daily Lives

Things originally considered trivial will now be input into and shared with the use of a computer. The issue of privacy both in interaction and content will become more important with a WPC, as well.

Example Characteristics of a Desireable WPC UI Overview

1. Communicate the WPC's awareness of something to the user. p1 2. Receive acknowledgement or instructions from the user.

Just as the graphical user interface and mice made it easier to do certain things in a 2-D world of bitmap screens, so would a new UI make it easier to operate in the new settings demanded by wearable computing. Interfaces such as MS-Windows fail in a WPC setting. Based on the WPC's unique qualities and uses as defined in Section 2, the following are suggested capabilities of a successful wearable computer UI.

A WPC UI Should Let the User Direct the System Under any Circumstances.

Rationale Because the user's context, need for privacy, and physical and mental availability change all the time while using a WPC, the user should be able to communicate with the WPC using the most suitable input method of the moment. For instance, if he is driving or has his hands full or covered with grease, voice input would be preferable. However, if he's in a movie theater, on a subway, or in another public space where voice input may be inappropriate, he may prefer eye tracking or manual input.

In general, a UI's input system should accommodate minute-to-minute shifts in the user's:

Physical availability to direct the actions of the WPC, either with his hands (e.g., whether he has fine/gross motor control, or left/right/both/no hands free), voice, or other methods.

Mental availability to notice the WPC output and attend to or defer responding to it.

Desired privacy of the WPC interaction or content.

Context, task, or topic—that is, what his mind is working on at the moment.

Examples One way to direct a WPC under any circumstances is to allow the user to input in multiple ways, or modes (multi-modal input). The UI might offer all modes at once, or it might offer only the most appropriate modes for the context. In the former, the user would always be allowed to select the input mode that's appropriate to the context. In the latter, the UI would provide its best guess of input options and suppress the rest (e.g., if the room were dark, the UI might ignore taps on an unlighted keyboard but accept voice input).

Typical WPC multi-modal input methods could include touch pads, 1D and 2D pointing devices, voice, keyboard, virtual keyboard, handwriting recognition, gestures, eye tracking, and other tools.

A WPC UI Should be Able to Sense the User's Context

Rationale Ideally, a computer that is always on, always available, and not always the user's primary focus should be able to transcend all activities without the user always telling it what to do next. By “understanding” a context outside of itself, the WPC can change roles with the user and become an active support system. Doing so uses a level of awareness of the computer's outside surroundings that can drive and refine the appropriateness of WPC interactions, content, and WPC-initiated activities.

Current models of the UI between man and computer promote a master/slave relationship. A PC does the user's bidding and only “senses” the outside world through direct or indirect commands (via buttons, robotics, voice) from the user. Any input sensors that exist (e.g., cameras, microphones) merely reinforce this master/slave dynamic because they are controlled at the user's discretion. The computer is in essence deaf, dumb, blind, and non-sensing.

In the WPC world, the system has the potential to use computer-controlled (passive) sensors to hear, speak, see, and sense its own environment and the user's physical, mental, and contextual (content) states. By being aware of its own surroundings, the WPC can gather whatever information it wants (or thinks it needs) in order to appropriately respond to and serve its user.

The WPC UI should promote an exchange between man and machine that is a mix of active and passive interactions. As input is gathered, the UI should opportunistically generate a conceptual model of the world. It could use this model to make decisions in the moment (such as which output method is most appropriate or whether to send the person north or south when he's lost). It can also use the model to interpret and present information and choices to the user.

Sensory information that is gathered but not relevant in the moment might also be accumulated for future action and knowledge.

Examples To become aware of its user and context, a WPC could accept input from automatic internal sensors or external devices, from the user with manual overrides (e.g., by speaking, “I'm now in the car”), or through other means.

An example of a WPC UI that mixes active and passive interaction would be when a person passes active information (choices) to the WPC while the WPC picks up on passive info (context, mood, temperature, etc). The WPC blends the active command with the passive information to build a conceptual model of what's going on and what to do next. The computer then passes active information (such as a prompt or feedback) to the person and updates its conceptual-model based on changes to its passive sensors.

A WPC UI Should Provide Output that is Appropriate to the User's Context

Rationale A WPC provides output to a user for three reasons. When it is being proactive, it initiates interaction by getting the user's attention (notification or system initiated activity). When it is being reactive, it provides a response to the user's input (feedback). When it is being passive or inactive, it could present the results of what it is sensing, such as temperature, date, or time (status).

For an output to be appropriate to the context, the UI should:

Decide how and when it is best to communicate with the user. This should be based on his available attention and his ability/willingness to sense, direct, and process what the WPC is saying. For instance, the WPC might know to not provide audio messages while the user's on the phone.

Use a suitable output mechanism to minimize the disruption to the user and those around him. For instance, if the UI alerts a person about incoming mail, it might do so with only video in a noisy room, with only audio in a car, or with a blend of video and audio while the user is walking downtown.

Wait as necessary before interrupting the user to help the user appropriately shift focus. For instance, the WPC might wait until a phone call is completed before alerting him that e-mail has arrived.

This is called having a scalable output.

Examples One way to achieve scalable output is to use multiple output modes (multi-modal output). Typical WPC output modes could include video (monitors, lights, LEDs, flashes) through head-mounted and palm-top displays; audio (speech, beeps, buzzes, and similar sounds) through speakers or earphones; and haptics (vibration or other physical stimulus) through pressure pads.

Typical ways to address the appropriateness of the interaction include using and adjusting a suitable output mode for the user's location (such as automatically upping the volume on the earphone if in an airport), and waiting as necessary before interrupting the user (such as if he's in a meeting).

A WPC UI Should Account for the User's Cognitive Availability

Rationale A human being's capacity to process information changes throughout the day. Sometimes the WPC will be a person's primary focus; at others the system will be completely peripheral to his activities. Most often, the WPC will be used in divided-attention situations, with the user alternating between interacting with the WPC and interacting with the world around him. A WPC UI should help manage this varying cognitive availability in multiple ways.

The UI Should Accommodate the User's Available Attention to Acknowledge and Interpret the WPC

Rationale An on-the-go WPC user prefers to spend the least amount of attention and mental effort trying to acknowledge and interpret what the WPC has told him. For instance, as the focus of a user's attention ebbs and flows, he might prefer to become aware of a notification, pause to instruct the WPC how to defer it, or turn his attention fully to accomplishing the related task.

Examples Ways to accommodate the user's available attention include:

Allow the user to set preferences of the intensity of an alert for a particular context.

Provide multiple and perhaps increasingly demanding output modes.

Make using the WPC a supportive, peripheral activity.

Build in shortcuts.

Use design elements such as consistency, color, prominence, positioning, size, movement, icons, and so on to make it clear what the WPC needs or expects.

The UI Should Help the User Manage and Reduce the Mental Burden of using the WPC

Rationale Because the user is likely to be multi-tasking with the WPC and the real world at the same time, the UI should seek to streamline processes so that the user can spend the least amount of time getting the system to do what he wants.

Examples Ways to reduce the burden of using WPC include:

Help chop work into manageable pieces.

Compartmentalize tasks.

Provide wizards to automate interactions.

Be proactive in providing alerts and information, so that the user can be reactive in dealing with them. (Reacting to something takes less mental energy than initiating it.)

The UI Should Help the User Rapidly Ground and Reground with Each use of the WPC

Rationale The UI should make it easy for a user to figure out what the WPC expects anytime he switches among contexts and tasks (grounding). It should also help him reestablish his mental connections, or return to a dropped task, after an interruption-such as when switching among applications, switching between use and non-use of the WPC, or switching among uses of the WPC in various contexts (regrounding).

Examples Ways to rapidly ground and reground include:

Use design devices such as prominence, consistency, and very little clutter.

Remember and redisplay the user's last WPC screen.

Keep a user log that he can be searched or backtracked.

Allow for thematic regrounding, so that the user will find the system and information as he last left them in a certain context. For instance, there could be themed settings for times when he is at home, at work, driving, doing a hobby, making home repairs, doing car maintenance, etc.

The UI Should Promote the Quick Capture and Deferral of Ideas and Actions for Later Processing

Rationale A user prefers a low-effort, low-cognitive-load way to grab a fleeting thought as it comes, save it in whatever “raw” or natural format he wants, and then deal with it later when he is in a higher productivity mode.

Examples Ways to promote quick capture of information include:

Record audio clips or .wav files and present them later as reminders.

Take photos.

Let the user capture back-of-the-napkin sketches.

A WPC UI Should Present its Underlying Conceptual Model in a Meaningful Way (Offer Consistent Affordance)

Rationale Affordance is the ability for something to inherently communicate how it is to be used. For instance, a door with a handle encourages a person to pull; one with only a metal plate encourages him to push. These are examples of affordance—the design of the tool itself, as much as possible, “affords” the information required to use the tool.

Far more so than for stationary computers, the interaction and functionality of a WPC should always be readily and naturally “grasped” if the UI is to support constant on-again, off-again use across many applications. This not only means that the UI elements should be self-evident in their purpose and functionality. It also means that the system should never leave the user guessing about what to do or say next—that is, the UI should expose, rather than conceal, as much as possible of how it “thinks.”

This underlying “conceptual model” (metaphor, structure, inherent “how-it-works”-ness) controls how every computer relates to the world. A UI that exposes its conceptual model speeds the learning curve, reinforces habit to reduce the cognitive load of using the WPC, and helps the user shortcut his way through the system without losing track of where his mind is in the real world around him. Input and output mechanisms that are this self-evident in how they are to be used are said to offer affordance. The goal of affordance is to have the user be able to say, “Oh, I know how to operate this thing,” when he is faced with something new.

Examples UI elements that replicate, as closely as possible, real-world experiences are most likely to be understood with very little training. For example, a two-state button (on/off) shouldn't be used to make a person cycle through a three-state setting (low/medium/high). Instead, a dial, a series of radio buttons, an incremented slider bar, or some other mechanism should be used to imply more than an on/off choice.

Examples of how a UI can expose its underlying model include avoiding the use of hierarchical menus, using clear layman's terms, building in idiomatic (metaphorical and consistent) operation, presenting all the major steps of a process at once to guide the user through, and making it clear which terms and commands the WPC expects to hear spoken, clicked, or input at any time.

A WPC UI Should Help the User Manage His Privacy

Rationale Desktop monitors are usually configured to be private, and are treated as such by most people. However, because a WPC is around all the time, can log and output activity regardless of context, and becomes integrated with daily life, the issue of privacy becomes much more critical. At different times, a user might prefer either his content, his interaction with the WPC, or his information to stay private. Finding an unobserved spot to use a WPC is not always feasible—and having to do so is contrary to what a WPC is all about. A UI therefore should help the user continually manage the degree to which he wants privacy as situations change around him. In this context, there are four types of privacy the UI should account for.

Privacy of the Interaction with WPC

Rationale Because social mores or circumstances may dictate that interacting overtly with the WPC is unacceptable, a user might want to command the system without others knowing he's doing so. At the user's discretion, he should be able to make his interaction private or public, whether he's in a conference room, on a subway, or at a street corner.

Examples Ways to achieve privacy of interaction include:

Use HMD and earpieces for output to the user.

Provide for non-voice input, such as eye-tracking or an unobtrusive keyboard or pointer.

Privacy of the Nature of the WPC Interaction

Rationale Even if a person doesn't mind that others know he's using the WPC, he may not want others to eavesdrop on what he's trying to know, capture, call up, or retrieve, such as information, photos, e-mail, banking information, etc. The UI should support the desire to keep any combination of what the person is doing (e.g., making an appointment), saying (e.g., recording personal information), or choosing (e.g., visiting a specific web site) secret from those around him.

Examples Ways to achieve privacy of content of the interaction include:

Use keyboard input with a head-mounted display (HMD).

Allow a user to speak his choices with codes instead of actual content (e.g., saying “3” then “5” instead of “Appointment” and “Fred Murtz” when scheduling a meeting).

Privacy of the WPC Content

Rationale Once a person has retrieved the information he wants (regardless of whether he cares if someone else knows what he's calling up) he may not want others to actually hear or view the content. The UI should let him move into “secret mode” at any time.

Examples Ways to achieve privacy of the content include:

Provide a quick way for the user to switch from speakers or LCD panel output to a private-only mode, such as an HMD or earpiece.

Let the user set preferences that instruct the UI to switch automatically to private output based on content or context.

Privacy of Personal Identity and Information (Security)

Rationale A WPC is a logical place for a user to accumulate information about his identity, family, business, finances, and other information. The UI should provide an extremely secure, unforgettable identity that allows for anonymity when it's desired, secure transactions, and protected, private information.

Examples Ways to achieve security of identity include:

Block another's access to information that is within, or broadcast by, the WPC.

Selectively send WPC data only to specific people (such as the user's current location always to the spouse and family but not to anyone else).

A WPC UI Should Scale from Private to Collaborative use

Rationale Just as there are times when two or three people should huddle around a desktop system to share ideas, so a WPC user may want to shift from private only viewing and interaction to collaborate with others. The UI should support ways to publicly share WPC content so that others can see what he sees, and perhaps also manipulate it.

Examples Collaboration can be done by using a handheld monitor that both people can use at once or, if both people have WPCs, perhaps by wirelessly sharing the same monitor image on both HMDs. For collaborating with larger groups, the UI could support a way to transfer WPC information to a desktop or projection system, yet still let the user control what is viewed using standard WPC input methods.

A WPC UI Should Accept Spoken Input

Rationale A person should be able to command a WPC in any situation in which his hands are not free to manipulate a mouse, keyboard, or similar input device, such as when driving, carrying goods, or repairing an airplane engine. Using voice to control the WPC is a natural choice for almost all hands-busy situations. The WPC UI should therefore support and utilize a speech recognition system that understands what a user will say to it.

Examples Computer-based speech recognition capability can range from recognizing everything that a person can say (understanding natural language), to recognizing words and phrases from a large predefined vocabularies (such as thousands of words), to recognizing only a few dozen select words at a time (very limited vocabulary). Another level of speech recognition involves being able to also understand the way (tone) in which something is said.

A WPC UI Should Support Text Input Methods

Rationale A user is likely to want to capture brief text strings that the WPC has never seen before, such as people's names and URLs. For this reason, a UI should allow the user to accurately save, input, and/or select custom textual information. This capability should span multiple input modes, in keeping with the WPC's value as a hands-free, use-anywhere device.

Examples Accurate text input can be provided through a keyboard, virtual keyboard, handwriting recognition, voice spelling, and similar mechanisms.

A WPC UI Should Support Multiple Kinds of Voice Input

Rationale An ordinary computer microphone cannot discern between when someone is talking to the system or to someone else in the room. A microphone-equipped WPC is supposed to be able to understand and recognize this subtlety and process a user's voice input in several listening modes, including:

Voice commands—the computer instantly responds to instructions given without a pointer or keyboard.

Phone conversation—the system recognizes when its user's voice is directed to a phone instead of to it.

Recorded voice—the computer creates a .wav file or similar image of the sound on demand; this could be used with phone input and output.

Dictation to transcript—the system converts speech into ASCII on the fly.

Dictation to text box—in this special case of transcription, the computer accepts words from a constrained vocabulary and converts them to ASCII to insert into a given field, such as saying “December 16” and having it show up on a Date field on a form.

Dictation training—the system learns an individual's idiosyncratic pronunciation of words.

Silence—the system leaves its microphone on and awaits instructions; it may passively indicate volume.

Mode switch—the system understands that the user wants to switch between listening modes, such as with, “Computer <state|context|function|user-defined>” or “Computer, end transcription.”

Speaker differentiation—the computer recognizes its own user's voice, so that when someone else gives a command either deliberately or in the background, the system ignores it.

The UI should manage each type of voice transition fluidly and (preferably) in a hands-free manner.

Examples Using a push-to-talk button can alert the system when it is being addressed, and user settings or preferences can make it clear when to record or not record, when to listen or not listen, and how to respond in each case.

A WPC UI Should Work with Multiple WPC Applications

Rationale The value of a WPC is its ability to be used in multiple ways and for multiple purposes throughout the day. Related tasks will generally be grouped into one or more WPC applications that can help organize and simplify tasks, as well as help reduce the cognitive load of using the WPC.

Examples Single and group applications for WPCs are virtually limitless. Examples include forms creation, web linking, online readers, e-mail, phone, location (GPS), a datebook, a contacts book, camera, scanning tools, video and voiceover input, and tools to capture scrawled pictures.

A WPC UI Should Allow and Assist with Multitasking and Switching among WPC Applications

Rationale Many times a day, a WPC user will require more than one WPC application running at the same time to complete a task. For instance, when making an appointment with someone, a user might use an address book application to retrieve his photo and contact information; use a phone application to call him up; use a journal application to look up the information they were last talking about; use a voice recorder application to capture the audio of a phone call; use a note-taking application to scribble down notes and share with someone else who's standing by; use an e-mail application to attach the scribble to an e-mail; and use a to-do application to check off the phone call as a completed task and flag another task for follow-up. In all cases of cross-application work, the UI should help the user keep track of where he is, where he's been, and how to get where he wants to go.

Examples Ways that a UI could help the user keep track of these applications include:

Use icons that indicate which application(s) are on and which one is active.

Include logging methods to help the user back-track to the place where he left off from application to application.

Provide tools to jump ad hoc between applications at any time.

A WPC UI Should be Extensible to Future Technologies

Rationale As the wearable gains popularity, WPC uses that are unheard of today will become standard tomorrow. For this reason, the UI should be designed so that it is open enough to fold in new functionality in a consistent manner. Such new functionality might include enriched methods for gaining the user's attention, improvements to the WPC's context-awareness sensors, and new applications.

Examples Ways to make sure a UI is extensible include utilizing and building from currently accepted standards, or coding with an open or module-based architecture.

Details of an Example UI Overview of Example WPC Software and Tools

Five example types of products for WPCs:

User Interface (UI)—what the user interacts with. The UI enables the user and the WPC to hold a dialog—that is, to exchange input and output. It amends and facilitates this conversation. The UI solves the need for a WPC that a user can command and interact with.

Applets (many may be developed by third parties)—the WPC applications that run within the interface. Applets allow the user to accomplish specific tasks with a WPC, such as make a phone call or look up an online manual. They provide a means to input information that's relevant to the task at hand, and facilitate the tasks' completion. Applets solve the need for a WPC that can be useful in real-world situations.

Characterization Module (CM)—an architectural framework that allows awareness to be added to a WPC as WPC use evolves. In particular, the CM tells the WPC about the user's context, such as his physical, environmental, social, mental, or emotional state. It senses the external world, provides status or reporting to the UI, and facilitates UI conceptual models. The CM solves the need for a WPC that can sense the world around it.

Developer tools—software kits designed to help others develop compatible software. These comprise SDKs, sample software, and other instructional materials for use by developers and OEMs. Developer tools solve the need for how others can design applications and sensors that a WPC can use.

Portal—a future web site where people can find WPC Applets, upgrades, and new WPC services from developers. The Portal solves the need for keeping developers, users, and OEMs up to date on WPC-related information and software.

The Example UI will Manage Input and Output Independently of Applet Functionality

Supported UI Requirement: A WPC UI should let the user direct the system under any circumstance.

Supported UI Requirement: A WPC UI should provide output that is appropriate to the user's context.

Supported UI Requirement: A WPC UI should allow and assist with multitasking and switching among WPC applications.

Supported UI Requirement: A WPC UI should be extensible to future technologies.

Rationale For a WPC to achieve its ultimate value throughout the day, the UI should always reveal the workings of the system, what it's looking for from the user, and what the person can do with it—all suitable to the context. Moreover, how the system handles these three facets should be consistent, so that someone doesn't have to learn a whole new WPC mechanism with every Applet or input method.

To achieve these goals, the Example UI splits the WPC experience into three interrelated facets:

Presentation—what the user sees, hears, and senses from the WPC (WPC output). Presentation determines what the UI and the Applets look like and how intuitively and quickly they can be understood. Presentation can be achieved through audio, video, physical (haptics), or some combination.

Interaction—the conversation from a person to a WPC (user input). Interaction can be achieved through speech, keyboard, pointing devices, or some combination.

Functionality—what a person is trying to get the system to do through his interaction. Functionality can be achieved through WPC Applets talking through the UI's underlying engine (the UI Framework).

This independence of functionality, presentation, and interaction has many benefits:

We can support the conceptual model that if an input option is available in the UI (presentation), a person say or choose it; if it's not available, he can't.

We can use part of the UI to orient people to where they are in the WPC and what their choices are.

The separation of an Applet from the tasks needed to run it eliminates the need for the user to be interrogated by the Applet, yet still lets the UI cue the person on what's coming up next. The user can “rattle off” all relevant information as long as it's in the right order, to become a natural response to getting something done.

Applet programmers gain a systematic way to present the Applet's information. WPC users can be encouraged to form their own idiomatic routines to reduce cognitive load.

Take advantage of current formal grammar technology by building on a simple vocabulary.

Ideas and implications This division of labor could lead to a three-part UI design that simultaneously prompts the user for input, presents him with his choices, and gives him the perception that he is commanding the Applet without actually doing so. (In technical functionality, he will “command” only the UIF, which translates to and from the Applet.)

The Example UI will Present All Available Input Options at Once

Supported UI Requirement: The UI should let the user direct the system under any circumstances.

Rationale Current sensor technology will make it very difficult for the WPC to determine the user's context enough to present and accept only the kind of input that is appropriate to the situation. Rather than have the UI make an error of omission of input methods, it will present all available input options at once and expect the user to choose which one he wants to use.

Ideas and implications One way around the all-or-nothing input options is to have the user be able to set thematic preferences, such as “When I'm in the car, don't bother to activate the keyboard.”

The Example UI will Always Make All Input Options Obvious

Rationale An overriding goal for the Example UI is to make it fast and easy for the user to get in and out of a WPC interaction. As the UI prompts him for decisions and input, the user should be able to tell the following from the UI:

When voice, keyboard, stylus, or whatever other input option can be applied.

Which words the WPC will respond to verbally.

What keyboard and mouse/stylus actions are equivalent to voice.

Ideas and implications Visual can be the default (provides parallel input for faster interaction), but the user should be able to switch to audio (provides serial input for slower interaction) if appropriate. The UI should provide multiple and consistent mechanism(s) to enter new terms, names, an URLs. For this purpose, the UI should make it clear that the WPC supports: keyboard input, virtual keyboard input, voice spelling, and handwriting recognition (rudimentary). The methods for entering new names, etc. should be consistently available and consistently operated.

The Example UI will be as Proactive as Possible with Notification Cues

Supported UI Requirement: The UI should support the user's cognitive availability.

Rationale A WPC that can detect a user's context can play a significant role if it can proactively notify the user when things happen and prompt him for decisions and input. Presenting information and staging interactions so that the user can be reactive in handling them lowers the cognitive load required and makes the WPC less of a burden to use. The level of this proactivity may be limited by current sensor technology. To be proactive, the UI's notifications and prompts should:

Be a supportive, peripheral activity that is appropriate to the context—e.g., no audio messages while the user's on the phone, or perhaps it should even wait until the phone call is completed before alerting him.

Use a suitable output mechanism—e.g., into ear or eye, preferably depending on where user is at the moment (in car, at home, at office, in airplane).

Wait as necessary before interrupting the user—e.g., if he's on the phone. The user's ability to devote divided or undivided attention to the WPC interaction determines whether he is interruptible.

the Example UI will Allow 1-D and 2-D Input, but not Depend too Heavily on it

Supported UI Requirement: The UI should let the user direct the system under any circumstances.

Supported UI Requirement: The UI should provide output that is appropriate to the user's context.

Supported UI Requirement: The UI should accept spoken input.

Supported UI Requirement: The UI should account for the available attention to acknowledge the WPC.

Rationale When the user needs hands-on input such as typing or mousing, the WPC should support standard pointing and keyboard modes. However, the WPC should also be able to be used in hands-busy and eyes-busy circumstances, which demands the use of speech input and output. However, a two-dimensional, pointer-driven UI (such as most current WIMP applications) doesn't always translate well to voice-only commands. For instance, a user should not be forced into a complicated description of where to place the pointer before selecting something, nor should he be expected to use vocal variances (e.g., trills to grunts) to tell the cursor to move up and down or left and right. The Example UI will depend more on direct voice input/output and less heavily on 2-D output and input that can't be readily translated to voice.

Ideas and implications Exposing items as a list lets users choose what they want either verbally or with a pointer.

The Example UI will Scale with the User's Expertise

Supported UI Requirement: The UI should let the user direct the system under any circumstances.

Supported UI Requirement: The UI should account for the available attention to acknowledge the WPC.

Rationale Scale on expertise—shortcuts/post processing assists with cognitive load.

The Example UI will Surface its Best Guess about the User's Context

Supported UI Requirement: The UI should provide output that is appropriate to the user's context.

Supported UI Requirement: The UI should help the user manage and reduce the mental burden of interacting with the WPC.

Supported UI Requirement: The UI should help the user rapidly ground and reground with each use of the WPC.

Rationale Building from Characterization Module sensors, the UI should surface its best guess of the user's ability to direct, sense, and think or process at any time. Methods to set attributes could be both fine grained (“My eyes are not available now,” which could set the system to use the earpiece) and thematic (“I am driving now,” which could set information context plus eyes and hands not available). Eyes and ears can be available in diminishing capacity. Generally a person can't have fine and gross motor control simultaneously.

Ideas and implications From a UI standpoint, awareness could be manifest by changing the display to reveal what the system thinks is the context, yet still allow the user to change that context back to where he last was, or to something else altogether.

The Example UI will Reveal All of an Applet's Available Options at All Times

Supported UI Requirement: The UI should help the user manage and reduce the mental burden of interacting with the WPC.

Supported UI Requirement: The UI should help the user rapidly ground and reground with each use of the WPC.

Supported UI Requirement: The UI should present its underlying conceptual model in a meaningful way (offer affordance).

Rationale Rather than bury commands in multiple menus that force the user to pay close attention to learning and interacting with the WPC, the Example UI should expose all available user options all the time for each active Applet. This way, the user can see all of his choices (e.g., available tasks, not all data items such as names or addresses) at once.

The Example UI will Never be a Blank Slate

Supported UI Requirement: The UI should help the user manage and reduce the mental burden of interacting with the WPC.

Supported UI Requirement: The UI should help the user rapidly ground and reground with each use of the WPC.

Rationale By definition, a WPC that is context-aware should always be able to show information that is trenchant to the current circumstances. Even in “idle” mode, there is no reason for the WPC to be a blank slate. A continuously context-sensitive UI can help the user quickly ground when using the system, reduce the mental attention needed to use it, and depend on the WPC to provide just the right kind of information at just the right time.

Ideas and implications If the system is idle, it might display something different by default if the person is at home vs. if he's at the office. Similarly, if the person actively has an Applet running (such as a To Do list), what the UI shows could vary by where the user is—on the way home past Safeway or in an office.

The Example UI will be Consistent

Supported UI Requirement: The UI should help the user manage and reduce the mental burden of interacting with the WPC.

Supported UI Requirement: The UI should help the user rapidly ground and reground with each use of the WPC.

Supported UI Requirement: A WPC UI should allow and assist with multitasking and switching among WPC applications.

Rationale Throughout the day, a user's interaction with the WPC will occur amidst many distractions, in differing contexts, and across multiple related WPC applications. For this reason, the UI should provide fundamentally the same kind of interaction for every similar kind of input. For instance, what works for a voice command in one situation should work for a voice command in a similar situation. This consistency enables the user to:

Quickly grasp how to first use the WPC and what it expects at any given time.

Minimize his interaction time with the WPC and gain faster, more accurate results.

Reliably extrapolate how to use new WPC functionality as it becomes available.

Ideas and implications A consistent user interface should:

Make all applications operate through the same modes in the same way (such as through consistent voice or keyboard commands).

Make text input consistently available and operated.

Make it clear at all times which part of the UI the user is supposed to interact with (vs., say, which parts he only has to read).

Use standard formats for time, dates, GPS/location, etc. so that many Applets can use them.

The Example UI will be Concise and Uncluttered

Supported UI Requirement: The UI should help the user manage and reduce the mental burden of interacting with the WPC.

Supported UI Requirement: The UI should help the user rapidly ground and reground with each use of the WPC.

Rationale A WPC will often be used when attention to visual detail in the UI is unrealistic, such as while driving or in a meeting. The UI should therefore be concise, offering just enough information at all times. What is “just enough” should also be tempered by how much can be absorbed at one time. To promote the get-in-and-get-out nature of a WPC, the Example UI should also be designed with as little visual clutter as possible.

Ideas and implications In particular, the UI should display ear or eye output without obstructing anything else.

The Example UI will Guide the User to what is Most Important

Supported UI Requirement: The UI should help the user manage and reduce the mental burden of interacting with the WPC.

Supported UI Requirement: The UI should help the user rapidly ground and reground with each use of the WPC.

Supported UI Requirement: A WPC UI should allow and assist with multitasking and switching among WPC applications.

Rationale A fully context-aware WPC would be able to detect and keep track of a user's priorities, and constantly present information that's relevant to his content, purpose, environment, or level of urgency. When deciding what to present and when to present it, the UI should be able to guide the customer to what is most important to deal with at any given moment.

Ideas and implications This can be done through UI design techniques such as prominence, color, and motion.

The Example UI will Guide the User About what to do Next

Supported UI Requirement: The UI should help the user manage and reduce the mental burden of interacting with the WPC.

Supported UI Requirement: The UI should help the user rapidly ground and reground with each use of the WPC.

Supported UI Requirement: The UI should present its underlying conceptual model in a meaningful way (offer affordance).

Supported UI Requirement: A WPC UI should allow and assist with multitasking and switching among WPC applications.

Rationale As much as possible, the Example UI should assist the user so as to minimize the time to understand what to do, how to do it, and how to process what doing it has accomplished. The UI should provide a way for the user to know that a command is available and that his input has been received correctly. It should also help him reload dropped information and reground to a dropped task after or during an interruption in the task.

Ideas and implications A popular approach is to make everything that the user can do be visible and to have UI constrain what the WPC will recognize. For instance, text that is in gold can be said aloud, but text in the bouncing ball list exposes what to expect next in an Applet's process in a linear, language-oriented way. Incremental typing letters filters a list down.

The Example UI will Always Reveal the User's Place in the System

Supported UI Requirement: The UI should allow and assist with multitasking and switching among WPC applications.

Supported UI Requirement: The UI should help the user manage and reduce the mental burden of interacting with the WPC.

Supported UI Requirement: The UI should help the user rapidly ground and reground with each use of the WPC.

Rationale Because the user's focus and attention will often shift back and forth between the WPC and his surroundings, the UI should clearly show him where he is within the UI at all times (e.g., “I'm currently operating the Calendar and am this far along in it”). This means letting him switch among Applets easily without losing track of where he's been, as well as determining and returning to his previous state if he is doing “nested” work among several Applets.

Ideas and implications Orienting can be done through UI design techniques such as color, icons, banners, title bars, etc.

The Example UI will Use a Finite Spoken Vocabulary

Supported UI Requirement: The UI should help the user manage and reduce the mental burden of interacting with the WPC.

Supported UI Requirement: The UI should accept spoken input.

Rationale The current state of the art for speech recognition does not allow for natural language or large vocabularies. The dialog between computers and people is not like person-to-person conversation. People don't speak the same way in all settings, and the user may not be able to train the WPC. Meaning, tone, and nuance are difficult to capture accurately in a person-to-computer interaction. Voice systems are by nature linear and tedious because all interactions should be serial. Ambient sounds and quality of voice pickup dramatically affect the robustness of speech recognition programs. To succeed, the Example UI should not require a large vocabulary to use. However, the speech should be as natural as possible when using the system, not stilted or ping-pong. (That is, the system should allow the user to “rattle off” a string of items he wants, without waiting for each individual prompt to come from the WPC.)

Additional benefits Constraining the vocabulary provides several other developmental and functional benefits:

We can use a less expensive, less sophisticated speech recognition system, which means we have more vendors to choose from.

The speech system will consume less RAM, leaving more memory free for other wearable components and systems.

A constrained vocabulary requires less processing power, so speed won't be compromised.

We can use speech recognition engines that are tuned to excel in high-ambient-noise environments.

Ideas and implications The UI benefits from a dynamic vocabulary but also benefits from escape mechanisms to deal with words the engine has trouble recognizing algorithmically, such as foreign words. Thus, it is preferable to constrain grammar and vocabulary or, if unavoidable, to filter it further (e.g., 500 entries in contacts). Should make it clear which part of the UI the user is supposed to interact with, vs. which parts he's only has to read. It should accommodate the linearity of speech.

Some important words to recognize: days of the week, months of the year, 1-31, p.m., a.m., currency, system terms such as Page Down, Read, Reply, Forward, Back, Next, Previous, and Page Up. The UI should listen for certain words for itself (system terms), plus ones for the Applet (Applet terms).

The Example UI will Offer Multiple Ways to Select Items by Voice

Supported UI Requirement: The UI should let the user direct the system under any circumstances.

Supported UI Requirement: The UI should help the user manage his privacy.

Rationale Because there will be no speech training in the UI—e.g., no way to correctly pronounce Jim Rzygecki and have the WPC find it in the list—the UI should have an alternative method for accepting items it doesn't recognize. In other circumstances, the system may be able to interpret the name or command word, but the user may want to keep the content of such an interaction private while still using his voice. (For instance, if he's on a subway and doesn't want others to know he's making a stock buy with his financial advisor.)

Ideas and implications The user might be able to choose the number or letter of an item in a list rather than state the name of the item itself. He might also be able to voice-spell the first few letters of the name.

The Example UI will Work with Many WPC Applets at Once

Supported UI Requirement: The UI should work with multiple WPC applications.

Supported UI Requirement: The UI should allow and assist with multitasking and switching among WPC applications.

Supported UI Requirement: The UI should promote the quick capture and deferral of ideas for later processing.

Rationale A WPC can readily support the multi-tasked, stream-of-consciousness thinking and working methods that most people perform dozens of times a day. By combining Applets and connecting related information across them, a user can streamline his efforts and the WPC can more easily store and call up context-specific data for him.

Ideas and implications At the very least, the Example UI should support:

E-mail (MAPI)

Phone (TAPI)

Location (GPS)

Calendar/Appointments/Datebook

XML Routines

Forms creation—collect and commit information to a database

Web linking

Reading of online manuals

Camera

Scanning

Video and voiceover input—to use a radio/video machine—to talk to others and see what I see.

Capture of natural data, scan UPS codes, talk to systems, scrawl down something as pictures, take photos just to capture information.

The Example UI will let the User Defer Work and Pick Up where He Left Off

Supported UI Requirement: The UI should allow and assist with multitasking and switching among WPC applications.

Supported UI Requirement: The UI should help the user manage and reduce the mental burden of interacting with the WPC.

Supported UI Requirement: The UI should help the user rapidly ground and reground with each use of the WPC.

Supported UI Requirement: The UI should promote the quick capture and deferral of ideas for later processing.

Rationale The interruptible nature of using a WPC means the user should be able to defer or resume an activity anytime during the day. Examples include the ability to:

Open a new contact and go to new Applet but come back to where he left off in the contact.

Put something on the back burner as-is so that he can return to in later in the same state in which he left it (rather than putting it all away and starting over).

Pull up several Applets at once if a related series of tasks has been interrupted. (I.e., sequencing as stream of consciousness from one Applet to the next pulls up all related info at once—putting all related, cross-Applet info aside temporarily, rather than closing all, filing away, and reopening everything again. A form of regrounding.)

The Example UI Should Adjust Output Modes to the Desired Level of Privacy

Supported UI Requirement: The UI should help the user manage his privacy.

Rationale As wearables become more popular, users will become more concerned about social appropriateness and accidental or deliberate eavesdropping as they use the system. The Example UI should therefore address situational constraints that include a user's desired privacy for:

His interaction with the WPC (concealing whether he's using it or not).

His context for using it (concealing whether he's setting a dinner date or selling stock).

His WPC content (concealing what he's hearing or seeing through the WPC).

His own identity information (concealing personal information or location from others who have WPCs or other systems).

Ideas and implications The UI should be able to detect the user's position anonymously rather than, say, have a building tell him (and everyone else) where he is. If the UI cannot adequately detect the user's need for privacy automatically, it should provide a means for the user to input this setting and then adjust its output modes accordingly.

The Example UI will use Lists as the Primary Unifying UI Element

Supported U Requirement: The UI should let the user direct the system under any circumstances.

Supported UI Requirement: The UI should help the user manage and reduce the mental burden of interacting with the WPC.

Supported UI Requirement: A WPC UI should-be extensible to future technologies.

Rationale If a WPC is to be used in all contexts with the least amount of mental effort, it should not have fundamentally different interaction depending on the input mode. What works for hands-on operation should also work for hands-free operation. Because speech is assumed but is inadequate for directing a mouse, the Example UI will therefore map all input devices and modes to operate from a list. This single unifying element will enable the user to perform any function by selecting individual items from groups of items.

Using lists provides the following benefits to users:

Users can select from lists using any input mode available—speech, pointer, keyboard.

Having one primary input method lets users extrapolate across the system—learn a stick shift, know all stick shifts.

Lists simplify operation and promote consistency, which reduce cognitive load and accelerate the user's expertise.

New input modes (e.g., private) and devices (e.g., eye-tracking) can be mapped in without appreciably affecting the interaction or coding.

We don't have to care what WPC Applet the list is being applied to—the user just always selects from a list.

Ideas and implications The lists are the data items that pop up to select from using the menus.

The Example UI will be Windows Compatible

Supported UI Requirement: The UI should accept spoken input.

Supported UI Requirement: The UI should work with multiple WPC applications.

Rationale This will enable us to leverage the advantages of immense PC market and produce a general-platform product that takes advantage of the uniqueness of a WPC. The Example UI will be a shell that runs inside Windows. The user launches Windows, launches the shell, and then navigates the WPC functionality he wants. The Windows task bar is still visible.

Ideas and implications To make the most of standards, the UI should rely on PC hardware standards, especially for peripherals and connectors. Any new standards we create ought to be designed to be consistent with the rest of PC market. We intend to follow the current power curve and never compromise in power or capability.

Other Considerations

Why Don't Current Platforms Work for WPC Use? They Can't be Available All the Time

Current platforms can only be interacted with sporadically. A desktop system is only available at the desk. A laptop must be removed from a briefcase, and a suitable surface located. WinCE devices and palmtops must be removed from the pocket. The result is that tasks are deferred until the user can dedicate time to interaction with the platform.

This prevents the use of information storage and retrieval to be used as pervasive memory and knowledge augmentation. It makes solutions undependable by introducing the opportunity for lost or erroneous information.

As a result of this lack of availability, the system cannot gain the user's attention or initiate tasks. This thwarts opportunities to facilitate daily life tasks.

Takeaways for the UI The wearable PC will allow you to be in constant interaction with your computer. Daily life tasks can be dealt with as they occur, eliminating the delay associated with traditional platforms. The system can act as an extension of your self, and an integral part of your daily life.

They Offer Limited Functionality

Palmtop devices accomplish greater availability by severely compromising system functionality. They are too under-powered to be good general-purpose platforms. Scaled down “partner products” are often used in lieu of the standard tools available on desktop systems, and many hardware peripherals are unavailable. In general, the ability to leverage the advantages of mainstream hardware and software is lost.

Takeaways for the UI The wearable PC will be, as far as possible, a fully powered personal computer. It will use high end processors, have large amounts of RAM, and run the Windows operating system. As such, it will leverage all of the advantages enjoyed by laptop and desktop computers.

They Can't be Used in Every Environment

Even if current computing platforms were continuously available, they would be unusable in their current form. Laptops are unusable while walking. Palmtops are unusable while driving. The sounds that a traditional computer emits are inappropriate to a variety of social settings.

Additionally, current platforms have no sense of context, and cannot modify their behavior appropriately.

Takeaways for the UI Both the wearable PC and software will be tailored to use in everyday situations. Eyeglass-mounted displays, one-handed keyboards, private listening, and voice interaction will facilitate use in a variety of real life situations.

The software will also have a sense of context, and modify its behavior appropriately to the situation. A scaling UI will adapt to accommodate the user's cognitive load, providing subtler, less intrusive feedback when the user is more highly engaged.

They are Passive Rather than Reactive

Current solutions tend to work as passive tools, reacting to the user's commands during a productivity session. This is a lost opportunity to gain the attention of the user at the appropriate time, and offer assistance that the user has not requested, and may not have been aware of.

Takeaways for the UI With a wearable PC, the system can gain your attention in order to suggest, remind, notify, and augment your world in appropriate ways. Our mantra is: “How can we make computing power a proactive participant in daily life?”

### UI EXAMPLES

Prototype A

Description Built solely on a Windows interface. All visual—no voice used.

What we learned This prototype has problems because Windows is all two-dimensional. It cannot provide voice-based UI and feedback well. All-visual is sub-optimal for a WPC used in a hands-free environment. The result was a poor cousin to Outlook.

Prototype B

Description Built on voice recognition to control Outlook and Microsoft Agents to be the focal point for interactions and to handle the voice recognition. The Agents use a hierarchical menu system (HMS). Could try an all-voice, natural language interaction for no-hands use. This prototype integrated with Outlook for contacts, appointments, and e-mail; allowed the user to capture reminders as .wav files (i.e., recorded a note and then played it back at a specific time); and included an applet that we created for taking notes.

What we learned This prototype had problems because:

The HMS buried commands instead of exposing all the commands at once. It was like using a phone system that forces you to listen through all the options before choosing which one is right, and meanwhile you may have forgotten the option you wanted.

The Agents locked us into a ping-pong question-answer mode that forced you to hear a question, give a response, wait for the next screen and question, and give another response. The computer couldn't advance without you, and you couldn't advance without waiting for the computer. It was unnatural, stilted, boring, and time-consuming.

All the windows consumed a lot of display space.

This solution provided only one method of input—voice—which is not always appropriate for WPC users.

By providing a single point of action—an Agent that talked to them like a person—people wanted it to work with even more natural language, but it wouldn't. The closer it was to freeform and natural language, the more people gave it ambiguous language and treated it like a real person.

Takeaways for the UI This prototype influenced several UI decisions:

The goal is to interact with and talk to the WPC just as you would talk to a person taking an appointment. However, the tool should not use 100% natural language—it is too complicated to train the system to each user's style and vocabulary. Voice can be used if the vocabulary is constrained and the user is aware at all times of which words he's allowed to say to get a job done. A semi-formal grammar can constrain the options to specific natural-language vocabulary but still cue the user about his options. It enables the WPC to meet the user halfway.

The tool should provide an environment that's not ping-pong—it should let thoughts flow naturally from one part of a task to the next. A better solution would be to let the customer rattle off all the attributes desired (such as make an appointment with Bob for Tues June 13 at 12:30 and O'Malley's). Preferably, the system would let you say those things in any order.

The tool should provide alternatives to voice input at the same time that it provides voice input—voice alone is sub-optimal because it typically involves memorization and privacy to interact. Also, all-voice doesn't expose all the commands and options very well.

Agent technology is a poor UI choice for a WPC UI. It is bolted on to a system, rather than integral to it, and inflexible in how it can be used. In addition, its anthropomorphic nature caused people to try to interact inappropriately with the WPC.

Prototype(s) C

Description The many flavors of this version seek to blend voice, audio, and hands-on use. It uses a constrained voice recognition vocabulary and presents choices along the bottom that are specific to each Applet. (This row of choices has been referred to as the “bouncing ball.” It represents the steps the user goes through to complete any task. For instance, in the Calendar Applet, the steps for making an appointment might be Who, When, Where, What.) The choices are “meta commands” that are always present and, when selected, lead to lists that show the choices available for each step of the bouncing ball. The vocabulary can cross over to other applets using the same verbs or tasks. The words you can say are all in gold. The UI offers both audio and visual prompts to guide the user from one step to the next.

[image]

What we learned There are several elements that work well about this UI:

The consistent order of the bouncing-ball choices defines a pattern that you can learn and follow to speed up interaction. It helps you learn “the idiom”—the correct order for rattling off information at natural speaking speed so the computer can follow it. It also allows a semi-formal grammar to be imposed while still supporting voice recognition.

The bouncing ball lets you see the options before you navigate with the voice—you know what the holes are that can be filled when using the Applet.

The bouncing ball choices can be either clicked like a button or spoken, supporting both hands-free and hands-on use.

The gold text visually alerts you to what can be said. If you can't see it, you can't say it.

The who/what/where/when construction is always available—you never get a blank slate.

What you do is simple:

See the choices.

Make a choice.

Get a new set of choices.

If you want to know what you can do, look at the list, the bottom bar, or the gold text.

You only learn one input method, and it always works the same, no matter what list you're using.

The goal is to get the user to adapt to the system and to have the system meet them halfway. An all-natural-language solution would have the system totally adapting to the person.

UI Methods Supplementing Other Ideas

Learning Model—attributes that characterize the preferred learning style of the user. The UI can be changed over time as the different attributes and used to model to optimal presentation and interaction modes for the UI, including user preference.

Familiarity—a simpler model that Learning, in part, it focuses on characterizing a user's learning stage. In the designs shown, there is duplication in UI information (e.g. the prompt is large at the top of the box, implicitly duplicated in the list of choices, and it also appears in the sequence of steps in the box at the bottom of the screen). As a user becomes more familiar with a procedure, the duplication can be eliminated.

User Expertise—different from Familiarity, Expertise models a user's competence with their computing environment. This includes the use of the physical components of the system, and their competence with the software environment.

Tasks—characteristics of tasks include: complexity, seriality/parallel (e.g. you may want the system to provide the current time at any random moment, but you would not being able to use the command “Repeat” without following a multi-step procedure.), association, thread, user familiarity, security, ownership, categorization, type and quantity of attention for various use modes, use, prioritization (e.g. urgent safety override), and other attributes allowing the modeling of arbitrarily complex models of a task.

Reasons to Scale:

Urgency—especially of data

Collaboration—with other's, especially if they are interacting via their computer

Security—not the same a privacy, this is weather the user and data match minimum security levels

Prominence

Prominence is the relative conspicuousness of a UI element(s). It is typically achieved through contrast with other UI elements and/or change in presentation.

Uses

Communicate Urgency

Communicate Importance

Reduce acquisition/grounding time

Reduce cognitive load

Create simplicity

Create effectiveness

Implementation

Audio

Volume, Directionality (towards front of user), Proximity, tone, ‘irritable’ sounds (i.e. fingernails across a chalkboard), and changes in these properties.

Video

Size, intensity of color, luminosity, motion, selected video device (some have greater affinity for prominence), transparency, and changes in these properties.

Haptic

Pressure, area, location on body, frequency, and changes in these properties.

Presentation Type

Haptic vs. Audio vs. Video

Multiple types (associating audio with video; or Haptic with audio, etc.)

Order of Presentation

For example, putting the most commonly needed information towards the beginning of a process.

Association

[image]

Some examples of relationships are common goal (all file operations appearing under a file menu), hierarchy, function, etc.

Uses

Convey Source or Ownership

Reduce acquisition/grounding time

Reduce cognitive load

Create simplicity

Create effectiveness

Implementation

Similar presentation (same methods as Prominence)

Proximity of layout

Contained within a commonly bounded region. E.g. group boxes and windows

Invitation

Creating a sense of enticement or allurement to engage in interaction with a UI element(s). Beginning of Exploration. “Impulse Interaction”

Uses

Create Learnability (through explorability)

Implementation

Explicit suggestion

Safety (non-destructive, reversible)

Safety (not get lost)

Familiarity

Novel/New/Different

Uniqueness (if all familiar & one new; choose new, if all strange & one familiar; choose old)

Quick/Cheap/Instant Gratification

Simplicity of Understanding

Ease of Acquisition and Invocation/Prominence

Rest/Relaxation

Wanted/Solicited/Applause

Curiosity/Glimpse/Preview

Entertainment

Esthetics/Shiny/Bright/Colorful

Promises: titillation, macabre, health, money, self-improvement, knowledge, status, control

Stimulating (multiple sense), increased rate of change

Fear avoidance

Safety

A computer can enhance the safety of the user by either providing or emphasizing information that identifies real or potential danger or suggests a course of action that would allow the user to avoid danger, or a computer can suppress the presentation of information that may distract the user from safe actions, or it can offer modes of interaction that avoid either distraction or actual physical danger. An example of the latter case is when the physical configuration of the computer itself constitutes a hazard, such as having the physical burden of peripheral devices like keyboards which occupy the hands and offer opportunity for the device to strike or become entangled with the user or environment.

Uses

Help create learnability

Help create effectiveness

Implementation

The implication that interaction will not result in unintended or negative consequences. This can be created by:

Reversibility

Clarity/Orientation cues

Familiarity (not unknown)

Metaphor (Which button is safer? Juggling chainsaws, Grandma w/tray of cookies)

Consistent Mental Model

Full disclosure

Guardian (stop me before I do something dangerous: intervention)

Advisor (if I get confused, easy to get unconfused: solicitation)

Expert Companion (helps me make good decision)

Trusted Companionship (could be golden lab)

Metaphor

A UI element(s), with a presentation that is evocative of a real world object, implying an obvious interaction and/or function (provides “meaning”).

Uses

Create Learnability

Create Simplicity

Create Effectiveness

Reduce cognitive load

Reduce acquisition/grounding time

Implementation

Examples: Recycle Bin

Sensory Analogy

Expressing (by design) a UI Building Block(s)' presentation and or interaction with a sensory experience, in order to bypass cognition (work within the pre-attentive state) and take advantage of innate sensory understanding.

Mouse/Cursor interaction.

Uses

Reduce cognitive load

Reduce acquisition/grounding time

Create simplicity

Create effectiveness

Help create learnability

Implementation

Example: Conveying the location of a nearby object by producing a buzz or tone in 3D audio corresponding to the location of the object.

Background Awareness

A Sensory Analogy with low Prominence.

A non-focus output stimulus that allows the user to monitor information without devoting significant attention or cognition. The stimulus retreats to the subconscious, but the user is consciously aware of an abrupt change in the stimulus.

Uses

Reduce cognitive load

Reduce acquisition/grounding time

Create simplicity

Create effectiveness

Help create learnability

Implementation

Example: Using the sound of running water to communicate network activity. (Dribble to roaring waterfall)

Reasons to Scale

Platform Scaling

Power Supply

We might suggest the elimination of video presentations to extend weak battery life.

Input/Output Scaling

Presentation Real Estate

Different presentation technologies typically have different maximum usable information densities.

Visual—from desktop monitor, to dashboard, to hand-held, to head mounted

Audio—perhaps headphones support maximum number of distinct audio channels (many positions, large dynamic range of volume and pitch)

Haptic—the more transducers, the more skin covered, the more resolution for presentation of information.

User Adaptive Scaling Attention/Cognitive Scaling

Use Sensory Analogy

Use Background Awareness

Allow user option to “escape” from WPC interaction

Communicate task time, urgency, priority

Privacy Scaling

Use of Safety

H/W ‘Affinity’ for Privacy

Physical Emburdenment Scaling

I/O Device selection (hands free vs. hands)

Redundant controls

Allow user option to “escape” from WPC interaction

Communicate task time, urgency, priority

Expertise Scaling

Scaling on user expertise (novice to expert). Use of shortcuts/post processing.

Implementations

These are examples of specific UI implementations.

Acknowledgement

Constrain to a single phoneme (for binary input)

L/R eye close, hand pinch interactions

Confirmation

Constrain to a single phoneme (for binary input)

L/R eye close, hand pinch interactions

Lists

For choices in a list:

Many elements: characterize with examples

Few elements: enumerate

Windows Logon on a Wearable PC Technical Details

Winlogon is a component of Windows that provides interactive logon support. Winlogon is designed around an interactive logon model that consists of three components: the Winlogon executable, a Graphical Identification and Authentication dynamic-link library (DLL)—referred to as the GINA—and any number of network providers.

The GINA is a replaceable DLL component that is loaded by the Winlogon executable. The GINA implements the authentication policy of the interactive logon model (including the user interface), and is expected to perform all identification and authentication user interactions. For example, replacement GINA DLLs can implement smart card, retinal-scan, or other authentication mechanisms in place of the standard Windows user name and password authentication.

The Problem to be Solved

The problem falls into three parts:

Provide a paradigm Windows logon (logon mechanism consistent with our UI paradigm)

Allow for private entry of logon information

Allow for security concerns (ctrl-alt-del)

Biometrics

By scanning your fingerprint, hand geometry, face, voice, retinal or iris, biometrics software can quickly identify and authenticate a user logging on to the network. This technology is available today, but requires extra hardware, and thus may not be appropriate for an immediate solution.

Biometrics is a natural fit for Wearable PCs, as they are private, secure, and provide fast, efficient logins with minimal impact on the user's physical encumbrance, or cognitive load.

[image]

Note: this is meant to be merely illustrative. The blue highlight is run around the keyboard w/the scroll wheel.

Security Concerns

Separate from ability to input passwords without speaking them “in the clear”, it would be beneficial to provide a way for users to know that they are not entering their password into a “password harvester”, a program that pretends to be the windows logon, for the purpose of stealing passwords.

The windows logon mechanism for this is to require the user to press CTRL-ALT-DEL to get to the logon program. If there is a physical keyboard attached to the WPC, this mechanism can still be used. A virtual keyboard (including the Windows On-screen keyboard) cannot be trusted for this purpose. If there is not a physical keyboard, the only other reliable mechanism is for the user to power down the WPC and power it back up (cold boot).

Interface Modes

Output Modes

The example system supports the following interface output modes:

HMD

Touch screen

Audio (partial support)

The interface's primary output mode is video, i.e., HMD or touch screen. Although the touch screen interface is fully supported, the interface design is optimized for an HMD. For this release, audio is a secondary output mode. It is not intended as a standalone output mode.

Input Modes

The example system supports the following interface input modes:

Voice

1D Pointing Device (scroll wheel and two buttons)

2D Pointing Device (trackball with scroll wheel and two buttons)

Touch Screen (with left and right button support)

Physical Keyboard (standard PC keyboard)

Virtual keyboard (provided as part of the example system)

Although all input modes are fully supported, the interface design is optimized for voice and for 1D pointing devices.

Hybrid 1D/2D Pointing

Moving the trackball moves the pointer. List items (and other active screen objects) provide mouse-over feedback (focus) in the form of highlighting.

Rotating the scroll wheel moves the highlighting bar up and down in the list. The list itself does not move unless the user scrolls past the last visible item, which causes the next item to scroll into view. Rotating the scroll wheel also hides and disables the pointer. The pointer becomes visible and is reactivated as soon as the trackball is moved.

Single-clicking the left button causes one of the following:

If the pointer is visible and over a valid target (a list item, the System Menu icon, the Back button, Page Up, or Page Down), then the target is selected.

If the pointer is not visible or not over a valid target, then the currently highlighted list item is selected.

Single-clicking the right button opens the system menu.

The user can abort selection by moving the pointer off any valid target before releasing the left mouse button.

The user can disable 2D pointing entirely as a system preference setting.

Interface Design

Visual Design

Layout

The example system's visual user interface consists of five basic components in a standard layout:

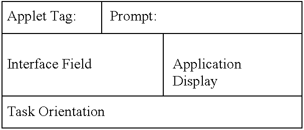

Font

By default, all text in the example system is displayed using 18-point Akzidenz Grotesk Be Bold.

Colors

Prompts are white. Speakable screen objects (can be activated using a voice command) are gold. Disabled speakable objects are dark gray/dark gold. All other text is light gray. (Commands that are permanently disabled should be removed from the list.)

Frame Components

Applet Tag

Identifies the current applet. The Applet Tag exists in the visual interface only—it has no audio equivalent.

Prompt

The prompt indicates to the user what s/he should do next. The system speaks the prompt as soon as the screen appears and displays the prompt in the designated area along the top edge of the screen. Users can issue voice commands even while the system is speaking a prompt. As soon as the system recognizes a valid voice command, it stops speaking the prompt and confirms the voice command (unless the user has disabled audio feedback for prompt confirmations, in which case it speaks the next prompt).

As a rule, audio and video prompts should use identical wording. Exceptions should be made only if alternative wording has been demonstrated to enhance usability.

Interface Fields

Interface fields serve two functions:

They reveal to users the range of appropriate responses to the current system prompt.

They allow users to communicate their responses to the system.

Four types of interaction field are supported by the example system: single selection lists, multiple selection lists, data entry fields, and trees. By default, interface fields are spoken by the system only when the user invokes the “list” command.

Lists

A list is a set of appropriate user responses to the current prompt. Each response is presented as a numbered item in the list.

In lists, the input focus—which indicates where the user's input is being directed—is shown by highlighting the currently targeted list item. Only one screen object can have the input focus at any time. By default, the first item in a list has the input focus. Selection—which indicates the current value of each list item—is shown by checking the item. Depending on the input device used, input focus and selection may or may not always move in tandem. Depending on whether the list is single or multiple selection, one or more list items may be checked at once. Unless an application specifies otherwise, focus defaults to the first list item.

Several types of visual feedback are associated with selection. On mouse-down, the selected menu item becomes checked. On mouse-up, the highlighting blinks.

Lists can contain more items than can be shown simultaneously. In this case, a scrollbar provides a visual indicator to the user that only a portion of a list is visible on the screen. When the user moves the mouse wheel beyond the last currently visible item, the next item in the list scrolls into view and becomes highlighted. List items move into view in single increments.

The size of the scroll box represents the proportion of the list content that is currently visible. The position of the scroll box within the scrollbar represents the position of the visible items within the list.

List Interaction

The Example UI supports list interaction though 1D (scroll wheel) and 2D (trackball, touch screen) pointing devices, voice commands, and keyboard.

1D Pointing Devices

When using a scroll wheel as a 1D pointing device, the user moves the input focus by rotated the scroll wheel and makes selections by clicking the left mouse button. With 1D pointing devices, focus and selection are independent: highlighting moves whenever the scroll wheel is rotated, but a checkmark doesn't appear until the left mouse button is clicked.

When the scroll wheel is rotated, the pointer is hidden and disabled; it remains so until the pointer is moved via the trackball or other 2D input device.

Trackball

When using a trackball as a 2D pointing device, the user moves the input focus by moving the pointer over the list items and makes selections by clicking the left mouse button. As with a scroll wheel, focus and selection are independent. The UI provides mouse-over highlighting for list items, but a checkmark doesn't appear until a selection is made. The user can abort a selection by moving the pointer off a valid target before mouse-up.

Touch Screen

When using a touch screen as a 2D pointing device, touching a list item moves both the input focus and the selection to the list item; the user cannot move highlighting independently from checking. The user can abort a selection by moving the pointer off a valid target before lifting her finger.

Voice Commands

When using voice commands, the user selects a list item by speaking it. (See also the section below on coded voice commands.) As with touch screen interaction, input focus and selection always move in tandem. Users can speak a list item that isn't currently visible. In this case, the selected list item is scrolled into view before checking it to give the user visual feedback for selection.

Keyboard

When using a keyboard to interact with lists, the user moves the input focus by pressing the up and down arrows and makes selections by pressing the enter key. In this case, focus and selection can be controlled independently.

Single Selection Lists

In single selection lists, selecting one item automatically unselects all other items. The user can invoke the “Next” system command to select the list item that currently has the focus.

Multiple Selection Lists

In multiple selection lists, selecting an item toggles it between the selected and unselected state. Selecting one item has no effect on the selection status of other list items. With certain input methods (e.g., scroll wheel, keyboard arrows), selection and focus may diverge as the user moves the focus without changing the selection. At the moment a selection is made, the focus shifts to the just-selected item. With other input methods (e.g., 2D pointer, voice), the focus and selection always move in tandem. The user should invoke the “Next” system command to indicate s/he is finished selecting items in a multiple selection list.

Data Entry Fields

A data entry field is a container for free-form alphanumeric data entry and editing. It can be defined to support a single line or multiple lines of text. Characters can be entered and edited in a data entry field using a physical or virtual keyboard, voice recognition, or handwriting recognition. Like the other interface fields, data entry fields appear in the central left portion of the frame, as shown below.

[image]

Focus

To enter or edit text, the keyboard should have the input focus, which is indicated by the presence of a blinking cursor (as shown above). When the keyboard does not currently have the input focus, the input area's outline box and text colors change from white to gray, and the cursor disappears.

Because interface fields are displayed one at a time, input focus shifts to the keyboard input area automatically (e.g., when a frame with a text entry field opens, or when the user closes the system commands menu). However, keyboard and voice commands can target the input focus to specific characters within the data entry field.

Entering and Editing Data

When entering data into an empty field, characters are inserted at the cursor. As each character is inserted, the cursor moves one space to the right; the cursor always appears immediately to the right of the last inserted character.

[image]

Editing a data entry field is limited to backspacing and retyping. Backspacing when the cursor is at the end of the data string moves the input focus to the preceding character. When input is focused on a character, the character appears in reverse color within the cursor, as shown below.

[image]

Backspacing when the input focus is already over a character deletes that character and again moves the cursor back to the preceding character. Once the incorrect characters have been removed, the user can type the correct characters.

By default, the system provides only visual feedback as each character is typed. As an option, however, the user can invoke an echo mode, in which the system speaks each character as it is typed. The user can toggle echo mode on and off by pressing the “Echo” key on the virtual keyboard or by enabling echo feedback in the system preference settings.

Maximum Length

A maximum length should be specified for every data entry field, although the maximum length may be greater than the field can display simultaneously. For example, a data entry field may have a maximum length of 30 characters, even if only 15 can be displayed at once. If the user types in text that is too long to display in a data entry field, then the text scrolls to allow the user to see each [image] times in a row, then an error message appears, explaining the maximum length for the data entry field.

Submitting and Aborting

When data has been entered to the user's satisfaction, s/he issues a voice or keyboard “Enter” command to submit the data. The data is saved to the field and the next frame is presented to the user.

If the user wishes to abort data entry (i.e., discard any changes made to the data entry field), s/he issues a “Cancel” (voice or mouse) or “Escape” command (virtual or physical keyboard).

The table below summarizes data entry field interactions with the supported input methods.

Table X. Data Entry Field Interactions

[image]

Interaction Details for Specific Input Methods

Virtual Keyboard

Users can invoke the virtual keyboard using the “Keyboard” system command. This causes the virtual keyboard to appear on the screen, as shown below. The pointer changes from an arrow to a hand. As long as the virtual keyboard has the focus, user input is limited to keys on the keyboard. (Plus some non-virtual keyboard way of escaping from the virtual keyboard.) Other interface items and other modes of input are disabled.

[image]

Speech Recognition

Users can invoke speech recognition using the “Voice entry” system command. This causes a “speech keyboard” (not yet designed) to appear, providing a list of the voice commands that are available for data entry. The pointer changes to an ear. As long as the speech keyboard has the focus, user input is limited to voice commands on the speech keyboard and valid alphanumeric characters. (Plus some non-speech way of escaping from the speech keyboard.) Other interface items and other modes of input are disabled.

Speech Error Correction

As a supplement to the standard editing methods shown above, two additional methods are provided to help the user correct speech recognition errors.

The first correction method is to invoke a database of common misinterpretations by saying “Correction.” This command, which indicates to the computer that a correction is needed, causes the system to consult the database and suggest alternatives. The system continues to suggest alternatives until the correct character is displayed or the database alternatives have been exhausted.

For example, imagine that the user says, “three,” which the system misinterprets as “e.” The database might indicate that “e” is a common misinterpretation of “g” and “3.” When the user says, “correction,” the system replaces the “e” with “g.” Since this is still incorrect, the user says, “correction,” again. This time, the system correctly replaces the “g” with “3.” The error is resolved.

In the event that the database does not contain the correct character, the user can invoke the third correction method. In this case the system treats the characters as voice-scrollable list. The user can scroll backward and forward through this list using voice commands (“previous character” and “next character”) until the correct character is displayed.

For this example, imagine that the user says, “d,” which the system misinterprets repeatedly as “z.” The user says, “delete,” which causes the “z” to disappear. Then s/he says, “e,” and the system displays “e.” Finally, s/he says, “previous character,” and the system replaces the “e” with a “d.” Alternatively, s/he could have scrolled back forward from “c” by saying, “next character.”

Handwriting Recognition

Technical Recommendation

The product PenOffice by ParaGraph (http://www.paragraph.com) or the Calligrapher SDK by the same company, are possible technologies for implementation.

Interface

Users can invoke speech recognition by using the “Handwriting” system command. This causes a “handwriting palette” (not yet designed) to appear, providing a list of the gestures that are available for data entry. The pointer changes to a hand with a pen. As long as the handwriting palette has the focus, user input is limited to commands on the handwriting palette. (Plus some non-handwriting way of escaping from the palette.) Other interface items and other modes of input are disabled.

Recognition Style

Recognition will be on a character-by-character basis, utilizing the entire screen area. The recognition will be style independent, recognizing natural letter shapes, and not requiring any new letter writing patterns (in contrast to Palm's Graphitti method). The recognition will be writing style independent, recognizing characters that are drawn as cursive, or print, including variations that occur in modern handwriting, like “all caps”, or “small caps”.

Drawing the Character

The user will be able to “draw” a character on the entire screen surface, with any appropriate 2D input modality. Note that a GlidePoint® could permit finger spelling.

The “digital ink” of the characters drawn by the user will be displayed in real time, in a high contrast color, not otherwise reserved for the UI. The figure below shows how a character might appear while being drawn.

[image]

[image]

Entering and Exiting H/W Recognition Mode

To begin entering characters with handwriting recognition mode, the user will invoke the “handwriting” system command. To exit handwriting recognition mode, the user will either:

Enter the gesture for “Enter” to complete the entry

Cancel the input from the system command menu or equivalent.

Select the next field, from the system command menu or equivalent.

Physical Keyboard

Users can use a physical keyboard to enter characters into data entry fields simply by typing on the keyboard. Visual feedback is limited to the appearance of the typed characters in the data entry field.

Data Validation

The example system supports within-field and cross-field data validation for text entry fields. When a validation error occurs, an error message appears, explaining the problem and recommending a solution.

Masking

The example system will support masking in data entry fields. Some masks are associated with a unique presentation style to help users enter data in the required format. The following table lists the masks supported for data entry fields and shows the presentation style associated with each mask.

Table XXX. Masking and Presentation Styles

[image]

Trees

A command tree is a special type of single selection list that allows commands to be organized and displayed to the user hierarchically. Indentation is used to distinguish the different levels of the hierarchy, which can extend as many as four levels.

The primary purpose of the tree is to provide “table of contents” navigation for online documentation, but it can be used wherever the user would benefit from viewing commands in a hierarchical structure (e.g., users organized into groups).

A tree includes two object types: nodes and leaves. Nodes represent branches of the tree and act as containers for leaves, other nodes, or both. Nodes are never “empty.” Leaves represent the lowest level of a branch, and consist of commands or data entry fields. Leaves are never containers. When a tree is used to make a table of contents, the leaf commands are hypertext links to the documentation.

Selecting a closed node causes that branch to expand, revealing the next level of commands, which could include either nodes or leaves or both. Selecting an open node causes that branch to collapse, hiding all lower levels. Expanding and collapsing an individual node does not affect the state of any other node, so node state is “sticky.”

The user selects a node or leaf by clicking it or speaking it. When a mouse wheel (or other 1D pointing device) is used for navigating a tree, highlighting moves from one item to the next regardless of their relative levels in the hierarchy.

Each item in a tree consists of an icon and a text string. Three icons should be provided for each tree: collapsed node, expanded node, and leaf. Two icon sets will be included in the SDK: “generic tree” and “table of contents.”

As an optional feature, nodes and leaves in a tree can be color-coded (or an additional icon?) to reveal whether they contain incomplete data entry fields. (This feature is linked to data validation.)

Another optional feature is to color code leaves that have been visited. This feature is intended primarily for trees used as tables of contents.

Below is a tree showing only top-level items:

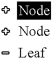

Clicking the highlighted node reveals the next level below that node.

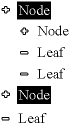

Task Orientation (Bouncing Ball)

The task orientation area provides navigational context to assist in orientation. It is not interactive. The behavior of the task orientation area depends on the current navigational structure.

Linear

When the user is in a linear navigation structure (i.e., a fixed sequence of frames with no branching, AKA “island of linearity”), the task orientation area displays from left to right the following items:

The selection made in the previous frame of the linear sequence (if any—not available when the user is still in the first frame of a sequence)

The prompt for the current frame (highlighted)

Prompts for upcoming frames (as many as will fit on the screen)

Non-linear

When the user is in a non-linear navigation structure, the task orientation area displays from left to right the following items:

The selections made in previous frames (as many as will fit on the screen)

The prompt for the current frame (highlighted)

The user can hide/unhide as a preference setting. If hidden then the screen real estate is available for list and app area.

Note that the transition may be jarring to the user, and some sort of smooth scrolling transition may be preferable. Further feedback to the user to indicate that they are (or are not) now in a linear process may also be preferable.

Application Area

Hypertext Navigation

The example system supports hypertext navigation in the application area by 1) converting a hypertext document's links into the items of a list (i.e., a single selection list interface field) and 2) defining a highlight appearance for hypertext links in the application area. When the user scrolls through the list items, the highlighting updates in both the list and in the application area.

Full-Screen/Partial-Screen Display

By default, the application area occupies only a portion of the total available screen area. However, the user can toggle between partial-screen and full-screen display by using the “minimize” and “maximize” system commands, one or the other of which is always available. These commands are sticky. When the application area is in full-screen mode, all other interface components are hidden except the prompt, which appears in its usual location, superimposed on the content of the application area. To minimize visual obstruction of the underlying content, the prompt is displayed using a transparent or outline font.

System commands are available as usual when the application area is in full-screen view. The “system commands” command causes the list of system commands to appear in its usual area, superimposed on the application area, using a transparent or outline font. Although the frame's interface field is hidden when the application area is in full-screen view, users can still access it through voice or 1D mouse commands. Scrolling the mouse wheel causes the interface field to become visible, superimposed on the content of the application. The interface field disappears again when the user makes a selection or after a brief timeout. If the user makes a selection using a voice command, only the selected item appears.

When the system is in full-screen view, messages (notifications) will appear and behave as usual, except that they are superimposed over the application content.

Navigating the App Area

Users can control what's visible in the application area by invoking the following commands.

Page up/down (similar to list command)

Scroll up/down/left/right

Zoom in/out

Previous/Next (page)

System Components

System Commands

To reduce recognition errors, system commands are preceded by a universal keyword. By default, the keyword is “computer,” but users can change this keyword as part of the preference settings.

Menu

The “Menu” command causes a list of all system commands to appear in a popup menu. This list appears whenever the user says, “Menu,” clicks the right mouse button, or selects the Menu icon in the upper right corner of the frame. The menu closes as soon as the user issues any system command. (Repeating the “Menu” command closes the menu without performing any other action.)

Quit Listening/Start Listening

The “quit listening” and “start listening” commands suspend and resume speech recognition. The “quit listening” command is intended primarily for use when ambient noise is misinterpreted by the system as voice commands. Although “quit listening” can be issued as a voice command, “start listening” obviously cannot.

Previous/Next

The “Previous” command navigates to the most recently viewed frame and undoes any action performed as part of the forward frame transition. Data generated by the user in the preceding frame is preserved and displayed to the user. For example, in a tree or single-selection list, the item selected earlier is highlighted; in a multiple-selection list, items selected earlier are checked; in a data entry field, characters entered earlier are present.

The “Next” command is enabled only when the user has navigated back one or more frames. This command redoes the action(s) performed the last time the user proceeded through the current frame. The application is responsible for determining when the user can go forward and what data is persisted about the frames that have been backed through. As a guideline, data already entered should be preserved for as long as possible.

Cancel

The “cancel” command is passed back to the application, which decides how to respond. The intended functionality is to allow users to escape from some well-defined sub-task without saving any input, but it applies to an application-specific chunk of functionality. The command is enabled/disabled by the application on a frame-by-frame basis. When a cancel command is issued, the system displays a warning message, the text for which is supplied by the application, which also determines the button labels and behaviors. We recommend, minimally, allowing the user to proceed with or halt the cancellation. Once the cancellation has been confirmed, the application determines the next state and functionality.

Undo

The “undo” command reverses the last keystroke-level user action performed within the current frame. It is intended primarily for use with multiple selection lists and data entry fields. If there are no actions within the frame to be undone, this command will be disabled.

List

The “list” command causes the system to speak the items currently visible in a list or tree. If the system is currently in number mode, then the system will also speak the item number.

One, Two, Three . . .

The number commands allow the user to select list items privately by speaking a number rather than a word. For example, if the second list item happens to “Dan Newell,” the user can say “computer two” and select Dan Newell without revealing the content of the interaction to anyone.

Page Up/Page Down

If the list includes more items than can be displayed simultaneously, the “page up” and “page down” meta-commands can be used to scroll additional items into view.

Exit

This command returns the user to the startup frame. Application is notified so it can prompt the user to save data.

Namespace Collisions

The following features are intended to allow developers and users manage namespace collisions between system commands and application commands.

The system will expose a standard set of system commands in the UI in two tiers:

Tier1—require no escape sequence to be accessed: back, cancel, page up, page down.

Tier2—require an escape sequence to be accessed: system commands, quit listening, list, exit, voice coding.

All system commands can be aliased by the developer or the user as part of the system configuration or by the user at runtime.

The UIF will check at runtime to make sure that there are no namespace collisions between application specific input and the un-escaped system commands. If there is a collision, and the user selects the collided action, the system will prompt the user for disambiguation.

System Status

Potentially useful information includes: vu meter, battery, speech recognition status, network connectivity.

System status—these elements will be part of every frame

Battery and network signal strength will surface when outside norm (low)

Clock and VU meter will always be on unless user turns them off

Clock appearance is toggle-able through the configuration settings

Date/time format is also configurable.

System Configuration

User can adjust the following attributes:

Sound Output

Adjust the volume.

Clock

Specify whether it is visible and which date/time format to use.

Microphone

Launch the setup wizard.

Speech Profile

Switch users.

System Command Keyword

By default, the system command keyword is “computer,” but the user can specify a different keyword.

Speech Feedback

Several types of speech feedback are available on the example system. Users can enable or disable each type of speech feedback as part of their system preferences.

Echo Commands

When the user selects an item in a list or tree, the system speaks it.

Echo Characters

As the user enters each character in a data entry field, the system speaks it.

Speak Messages

The system speaks the contents of each system message (notification) that appears.

Pointing

The user can disable 2D pointing.

Messages

Source

The WPC system will manage messages from the following sources:

Current WPC applet

Other WPC applet

WPC system

OS

The WPC system will make no attempt to manage messages from the following sources:

Non-WPC applications

Message Types

The WPC system should distinguish the following types of message and manage each type appropriately:

| | | Possible Dismissal |
|---|---|---|
| Message Type | Description | Methods |
| Error | Reports system and | Automatic, |
| | application errors to users. | Acknowledgement, or |
| | | Decision |
| Warning | Warns users about the | Decision (minimally, |
| | possible destructive | proceed or cancel) |
| | consequences of a user action | |
| | and requires confirmation | |
| | before proceeding. | |
| Query | Requests task-related | Decision |
| | information from users before | |
| | proceeding. | |
| Notification | Provides information | Automatic, |
| | presumed to be of interest to | Acknowledgement |
| | the user but unrelated to the | |
| | current task. | |
| Context- | Provides information useful for | Automatic, |
| appropriate | completing the current task. | Acknowledgement |
| Help | | |

A unique icon for each type of message will be displayed.

Presentation Timing Within the User's Task

Users should be allowed to complete certain tasks (e.g., free-form text entry) without being interrupted by messages unrelated to the current task.

Within the H/C Dialog

Messages should be presented by the WPC at a point in the human/computer dialog when the user expects the computer to have the conversational ‘token.’

Advance Warning

The WPC should be able to provide a cue (auditory and/or visual) before presenting any message unrelated to the user's current task.

Output Modes

The WPC will present all messages in both audio and video.

Modality

All messages presented by the WPC will be modal. Since the WPC application is itself modal, the effect is that all messages will be system modal.

If the message is modal, the sound continues until the user responds or (if it is application modal) switches to another application. If the user says something out of bounds or says nothing for a certain period of time, the system repeats the message and prompts explicitly for a response.

Dismissal

Automatic Dismissal

The WPC should allow appropriate messages (notification messages and error messages that require no decision from the user) to be dismissed automatically through a timeout.

User Actions

Preemptive Abort

The WPC should allow the user to preemptively abort presentation of a notification message unrelated to the current task. (Requires advance warning.)

Acknowledgement

Users should be able to acknowledge messages using an interaction that is fast and intuitive (e.g., say or click “OK”).

Decision

In general, users should be given the opportunity to make a decision any time it would allow them to return immediately to the current task.

Deferral

Users should be able to defer rather than dismiss messages when appropriate. Deferred messages should be re-presented automatically after a specified time. Developers should determine whether deferral is appropriate and specify the re-presentation time. (In other words, it is not a requirement that users be allowed to defer all messages or to specify the re-presentation time for each message.)

Input Modes

The user should be able to acknowledge, respond to, or defer messages using the following input modes:

Voice

Mouse

Keyboard

Touchscreen

Re-grounding

If a message's timing is appropriate (see discussion above), then the WPC will help the user re-ground by presenting the next prompt immediately after the user dismisses a message.

User Preferences

Users should be allowed to

Turn off the advance warning for messages (if any)

Specify whether any messages will timeout

Users should not be allowed to

Preemptively abort messages that require an acknowledgement or decision

Modeling Building Blocks of UIS

Scaling API

User/Computer Dialog Model

This describes a technique for abstracting the functionality of computers in general, and task software in particular, from the methods used to provide the presentation of and interaction with the UI. The functional abstraction is an important part of an ideal system to dynamically scale UI.

The abstraction begins with a description of a minimum set of functional components for at least one embodiment of a practical user/computer dialog. As shown in the following Illustration 1, information takes different forms when flowing between a user and their computing environment. The computer generates and collects information with local I/O devices, including many kinds of sensors. The devices provide or receive this information from the computing environment, which may be local or remote. The user perceives computer-generated information, and controls the computing environment with both explicit indications of intent or implicit commands via unconscious gesture or pattern of behavior over time. As long the information is generated by the user or their associated environment and can be detected by the system, it is part of the dialog.

[image]

The presentation of information to the user can use any of their senses. This is also true for the user's interaction with the computer's input devices. This is a significant consideration for the abstraction because it doesn't matter which sense or body activity is being used. In other words, the abstraction supports the presentation and collection of information without regard the form it is taking.

In Illustration 2, one embodiment of minimum functional elements are shown.

[image]

Computer to User Necessary

Prompts—provides user with information regarding an available choice. Types of choices range from unconstrained to constrained. Constrained choices may be enumerated or un-enumerated.

Choice—an option that the user can select which provides information that the computer can act on

Notifications—provides user with information, but does not provide a choice

Feedback—indicates to user what choice has been made

Desirable

Content—non-interactive

Status—shows progress of system or task related process

Focus

Grouping—relationships between choices

Mode—indication of how system will respond to a choice

User to Computer Necessary

Indications—these are generated by the user to show their intention. Intentions are conveyed by selecting choices. Indications do not require a prompt predicate.

Desirable

Content—this can be any information not designed to indicate a choice to the computer.

Context—Indications and Content that are modeled in the Context Module

Patterns—though not part of explicit user intention, the collection and analysis over time of a user's indications and context can be used to control a computer.

User/Computer/Task Dialog Model

Since most of the dialog between user and compute relates to the execution of a task, the preceding defining of the important elements of a user/computer dialog is insufficient to completely abstract the task functionality from the presentation and interaction. This is due in part to the desire for the computer system to provide prompts and choices that relate to system control, not to the task.

Therefore, as shown in Illustration 3, the abstraction can be broken into two pieces:

[image]

UI Functions

Input—How Choices are Indicated

Devices are manipulated by the user. A computer system could also convert analog signals from devices into digital O/S commands, and interprets them as one of the following:

BIOS or O/S escape sequences

UI Shell commands

Output—How Information is Presented

Devices, preferences

Task Functions

Input—What Choices are Indicated

Explicit choice indication

Implicit choice indication

Output—What Choices are Available

Prompted

Enumerated

Constrained

API: APP→UIPS

1) Element of the Dialog

Schema of dialog

get from building blocks

prompts

feedback

Syntax of Dialog

<dialog element>

content

<content metadataX>

value

</content metadataX>

</dialog element>

2) Content of Element

may not inform UI changes

text of a prompt

3) Task Sequence/Grammar

How do I string the elements together, navigation path, chunking

The following illustration shows chunking on a granular level:

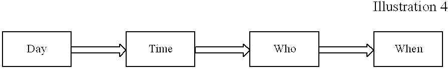

If this were a graphical user interface, there were be a separate dialog box or wizard page for each item in the flow chart. In a graphical user interface, chunking on a not-so-granular level is demonstrated by including all these bits of information about creating an appointment in one dialog box or wizard page.

“navigation state” specifics whether back/next/cancel are appropriate for this step

4) User Requirements While In-task

This step uses both of the user's hands for the duration of the step, therefore physical burdening=no hands, . . .

5) Content Metadata

This is explicit. This data is: sensitive, not urgent, free, from my Mom

Metadata can include the following attributes:

Sensory mode to user

Characterization of its impact on cognition

Security

To

From

Time

Date

API: Application←UIPS

1) & 2) Choices within the Task

Value+application prompt

3) Choices About the Task

Value+system prompt

Back, cancel, next, help, exit,

API: UIPS←→CA

API: UIPS←→UI Templates

API: UIPS←→Custom Run Time UI

API: UIPS←→I/O Devices

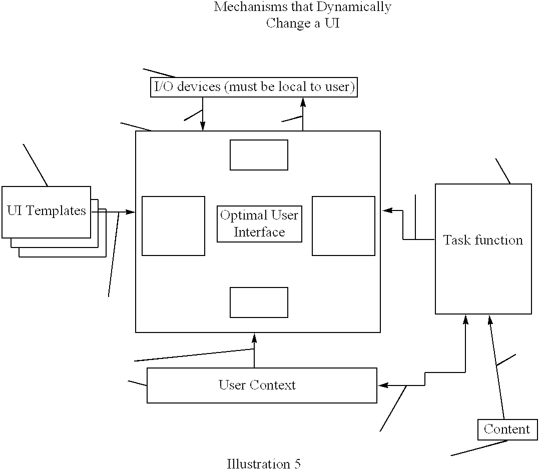

Overview

An arbitrary computer UI can be characterized in the following manner.

What are the UI Building Blocks?—What are the fundamental functions of a computer's UI? The fundamental functions are at a very elemental level, such as prompts, choices, and feedback. A UI element as simple as a command button is a combination of several of these elemental functions, in that it is a prompt (the text label), a command (that is executed when the button is “pressed”), and also provides feedback (the button appears to “depress”).

How are Building Blocks grouped?—What functional structures are created from the building blocks? In Windows these would include dialog boxes, applications, and operating environments, in addition to the basic controls in Windows themselves (scroll bars, command buttons, etc.).

What are General UI Attributes—Ignoring functionality, what are the Gestalt characteristics of a well-designed UI? Some of these attributes include Learnability, Simplicity, Flexibility, and so forth.

What are the UI Building Blocks?

Elemental Functionality (Building Blocks)

In this embodiment, there are only a limited number of types of user/computer interactions:

User Acknowledgement—User is given a single choice for communication with the computer. E.g. clicking okay to acknowledge and error.

User Choices—What is meant here is the expression of a choice (that occurs in the user's mind) to the computer. Moving a cursor, typing a letter, or speaking into a microphone are manifestations of this expression.

PC Notifications—Information presented to the user that is not associated with a choice, such as status reporting.

PC Prompts—The presentation of choice(s) to the user. A command button, by its use of metaphor to imply an obvious interaction, presents a choice to the user (you can click me), and is therefore a kind of prompt.

PC Feedback—presents indications on choices the user has made, or is currently making. When the user clicks on a command button, and the button appears to become “depressed”, the button is providing feedback to the user on their choice.

User Choices

Definition: The user indicates a preference from among a set of alternatives

WIMP Examples: Choice mechanisms can be ordered by how many choices are available. Low to High:

Confirmations

Lists

Commands

Hierarchies

Data Entry

Hidden elements can be revealed in various ways. Examples include:

Scroll bar

Text to speech

Acknowledgement

Definition: INFORMING: The PC is alerting the user that it cannot complete an action, and requiring the user to acknowledge that they have received the alert (in contrast to Confirmation below, user has no choices.)

WIMP Examples

[image]

| Associated | | |
|---|---|---|
| Verbs | Deficits w/WIMP | Alternatives |
| Acknowledge | Requires either tactile | Single choice can be mapped to |
| | control or speech | any utterance. I.e., blowing on |
| | recognition of name of | the Example: Using the |
| | control (e.g. “OK”) | microphone could suffice |
| Ignore | Usually UI is stuck in | Time out w/ reviewable |
| | modality | history |

Confirmation

Definition: SEEKING FEEDBAcK: The PC is seeking permission from the user to complete an action that can be accomplished in more than one way, and allows a choice between the alternatives.

WIMP Examples

The examples above illustrate different presentations of confirmations in the Windows environment. Note that in the example on the right, the confirmation Building Block has been combined with other Building Blocks to provide additional functionality.

[image]

A spin control, which presents elements of an ordered set one by one, is one example of a list.

[image]

| Associated | | |
|---|---|---|
| Verbs | Description | Alternatives |
| Breath Focus | Moving the focus (on an | |
| Manipulation | element in the list) in a | |
| | procedural way | |
| | First/Last/Next/Prev/, | |
| | mouse pointer, | |
| Exclusive | Identifying a single | List is read to user (this is |
| Selection | element of the list, to the | revealing hidden |
| | exclusion of all other | elements), listen for |
| | elements | choice, indicate “yes/now” |
| Highlight/ | | Speak choice |
| Marking | | AutoFill by character |
| | | Grid control |
| | | Apparently clairvoyant |
| | | suggestions |
| | | Keyword navigation |
| | | Labels (e.g. alias “A”, “B”) |
| Inclusive | Identifying multiple | This could be the same as |
| selection | elements of the list | the previous two until a |
| | | certain keyword or action is |
| | | initiated such as saying |
| | | “Done.” |
| Reorder | Changing the sort | |
| | sequence of the list | |
| Create/ | Modifies the set. | |
| Delete | Add a new element to the | |
| | list/ | |
| | Remove an element from | |
| | the list | |
| Copy | | |
| Invoke | Where there is a single or | |
| selection(s) - | primary function to perform | |
| default function | on elements of the list; the | |
| | act of triggering that | |
| | function | |
| Perform Func- | Where there are multiple | |
| tion on | functions to perform on | |
| selection(s) - | elements of the list; the act | |
| alternate | of triggering a specific | |
| associated | function | |
| function | | |
| invocation | | |

COMMANDS

| | | Deficits |
|---|---|---|
| Description | WIMP Examples | w/WIMP |
| Using a command, the user initiates | Toolbar buttons, | Fine motor |
| a new thread of execution. Icons, | program icons | control, screen |
| when used as short-cuts or | | real-estate |
| representations of files, are | | |
| commands. As are toolbar buttons. | | |
| Menus are hierarchical lists, with | | |
| the leafs as commands. <CNTL> | | |
| <I> is a command. | | |

HIERARCHIES

| Description | WIMP Examples | Deficits w/WIMP |
|---|---|---|
| A Hierarchy is a collection of | Tree control | Lack of consistency |
| elements and lists that has two | menus | |
| relationships. That of breadth, | | |
| which lists have, and depth, | | |
| which relates multiple lists. | | |

DATA ENTRY

Description
The choice of any alpha-numeric, or special characters.

PC NOTIFICATIONS

| Description | WIMP Examples | Deficits w/WIMP |
|---|---|---|
| Notifications provide information | Progress bar (no | Cognitive load, |
| to the user that is not associated | ack) | screen real estate |
| with a choice. | | |

PC PROMPTS

| Description | WIMP Examples | Deficits w/WIMP |
|---|---|---|
| Prompts surface | Any onscreen control that can be | Reading requires |
| choices to the | manipulated by the user. | continuous |
| user. | The text part of a dialog box. | attention |
| | Earcon. | Audio is always |
| | Question Mark Icon | foreground |

PC FEEDBACK

| Description | WIMP | |
|---|---|---|
| Description | Examples | Deficits w/WIMP |
| The PC presents indications on choices | Moving the | |
| the user has made, or is currently | mouse | |
| making. | | |

How are Building Blocks Grouped?

Functions

The atomic functional elements of the User Interface, such as those defined in the previous section.

Task

A Task is a specific piece of work to be accomplished.

In some embodiments, tasks are characterized with the following.

Presence—This characterizes the quality of attention that the user should devote to the task. It may be Focus, routine, or awareness. See Divided User Attention.

Complexity—includes breadth and depth of orientation

Urgency/Safety—See . . .

Exclusivity—The property of being difficult to do more than one of this kind of task. Example is phone conversations. See “Modality”

Applications

Tasks grouped by convenience.

Threads

A Thread is a path of choices with a common user goal. The path can be tracked at a variety of levels, especially the Task or Application level.

Environment

The UI shell.

What are General UI Attributes?

General UI Attributes are abstractions belonging to, or characteristics of, a User Interface as a whole. Examples include the following:

LEARNABILITY

EXPLORABILITY

FREEDOM

SAFETY

GROUNDING

CONSISTENCY

INVITATION (PARKS)

FAMILIARITY

MEMORABLE

PREDICTABILITY

SURFACING INFORMATION/CONTROLS

MENTAL MODELS

METAPHOR: SYMBOL SUGGESTING A REAL WORLD

OBJECT, IMPLYING MEANING.

SIMILE: DIFFERENT SYMBOLS TREATED AS HAVING LIKE ATTRIBUTES OR INTERACTIONS.

DIRECT MANIPULATION

By treating certain classes of visual elements as “objects” that have common interactions, used to surface common properties, (simile) we create a mental model of being able to directly manipulate these “objects”, making interaction more learnable and memorable.

TRANSFERENCE

CONSISTENCY/PREDICTABILITY

CONSISTENCY W/UNDERLYING ARCHITECTURE

Surface reality of underlying architecture.

MALLEABILITY: HOW ADAPTABLE A MENTAL MODEL IS TO BEING INTERPRETED AS A DIFFERENT BUT VIABLE MENTAL MODEL.

SINGLE MODEL OF COMMAND

Not a modal User Interface based on I/O modality.

NATURAL/INTUITIVE

SIMPLICITY

AVOIDANCE OF MODES

DIRECTNESS

AVOIDANCE OF ABSTRACTION

AVOIDANCE OF IMPLYING INFORMATION

AVOIDANCE OF SUPERFLUOUS INFORMATION

FLEXIBILITY

ADAPTABILITY

ACCOMMODATION

DEFERABILITY

Back burner/front burner—defer/activate

EXTENDABILITY

EFFECTIVENESS

EFFICIENCY

EFFORT

SAFETY

ABILITY TO WITHDRAW FROM INTERACTION

ERROR PREVENTION/RECOVERY

FORGIVENESS

HELP

Synchronizing Computer Generated Images with Real World Images

In some situations, UIs are dynamically modified so as to display information in accordance with a real-world view without using real-world physical markers. In particular, the system displays virtual information on top of the user's view of the real world, and maintains that presentation while the user moves through the real world.

Some embodiments include a context-aware system that models the user, and uses this model to present virtual information on a display in a way that it corresponds to the user's view of the real world, and enhances that view.

In one embodiment, the system displays information to the user in visual layers. One example of this is a constellation layer that displays constellations in the sky, based on the portion of the real-world sky that the user is viewing. As the user's view of the night sky changes, the system shifts the displayed virtual constellation information with the visible stars. This embodiment is also able to calculate & display the constellation layer during the day, based on the user's location and view of the sky. This constellation information can be organized in a virtual layer that provides the user ease of use controls, including the ability to activate or deactivate the display of constellation information as a layer of information.

In a further embodiment, the system groups various categories of computer-presented information related to the commonality of the information. In some embodiments, the user chooses the groups. These groups are presented to the user as visual layers. These layers of grouped information can be visually controlled (e.g., turned off, or visually enhanced, reduced) by controlling the transparency of the layer.

Another embodiment presents information about nearby objects to the user, synchronized with the real world surroundings. This information can be displayed in a variety of ways using this layering technique of mapping virtual information with the real-world view. One example involves enhancing the display of ATMs to a user searching for ATMs. Such a layer could be displayed in a layer showing streets and ATM locations, or such a layer could display the ATM's location near the user. Once the user has found the ATM being desired, the system could turn off the layer automatically, or based on the user's configuration of the behavior, simply allow the user to turn off the layer.

Another embodiment displays a layer of information, on top of the real-world view, that shows information represents the path the user traveled between different points of interest. Possible visual clues (bread crumbs) could be any kind of visual image, like a dashed line, or dots, to represent the route, or path, the user traveled. One example involves a user searching a parking garage for a lost car. If the user cannot remember where the car is parked, and the user is searching the parking garage, the system can trace the search-route and help the user avoid searching the same locations by displaying that route. In a related situation, if the bread-crumb trail was activated when the user parked the car, the user could turn on that layer of information and follow the virtual trail as it displays to the user in real-time, adjusting to the user's view, thus leading the user directly back to the parked vehicle. This information could also be displayed as a bird's-eye view, showing the path of the user relative to a map of the garage.

Another embodiment displays route information as a bird's-eye view showing a path relative to a map. This information is presented in overlaid, transparent, layers of information and can include streets, hotels and other similar information related to a trip.

The labeling and selection of a particular layer can be provided to the user in a variety of methods. One example provides labeled tabs, like on hanging folders that can be selected by the user.

The system accomplishes the task of presenting virtual information on top of real-world information by various means. Three main embodiments are tracking head positions, tracking eye positions, and real world pattern recognition. The system can also use a combination of these aspects to obtain enough information.

The head positions can be tracked by a variety of means. Three of these are inertial sensors mounted on the user's head, strain gauges, and environmental tracking of the person. Inertial sensors worn by the user can provide information to the system and help it determine the real-world view of the user. An example of inertial sensors is some kind of jewelry to detect the turns of a user's head. Strain gauges, for example, embedded in a hat, or the neck of clothing, measure two axes: left and right, along with up and down. The environment can also provide information to the system regarding the user's head and focus. The environment can provide pattern-matching information of the user's head to help indicate the visual interest of the user. This can occur from a camera watching head movements, like in a kiosk or other such booth, or any camera that can provide information about the user. Environmental sensors can perform triangulation based on a single beacon, or multiple beacons, transmitting information about the user, and the user's head & eyes. The sensors of a room, or say a car, can triangulate information about the user and present that information to the system for further use by the system for determining the user's view of the real-world. Also, the reverse works, where the environment broadcasts information about location, or distance from one the sensors in the environment, such that the system can perform the calculations without needing to broadcast information about the user.

The user's system can track the eye positions of the user for use in determining the user's view of the real world, which can be used by the system to integrate the presentation of virtual information with the user's view of the real world.

Another embodiment involves the system performing pattern recognition of the real world. The system's software dynamically detects the user's view of the real world and incorporates that information when the system determines where to display the virtual objects such that they remain integrated while the user moves about the real world.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, those skilled in the art will appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied. Accordingly, the inventors reserve the right to add additional claims after filing the application to pursue such additional claim forms for other aspects of the invention.

What is claimed is:

1. A method for dynamically determining an appropriate user interface to be presented to a user of a computing device based on a current context, the method comprising:
for each of multiple predefined user interfaces, characterizing multiple properties of the predefined user interface;
dynamically determining one or more current needs for a user interface to be presented to the user; and
selecting for presentation to the user one of the predefined user interfaces whose characterized properties correspond to the dynamically determined current needs.

2. The method of claim 1 including presenting the selected predefined user interface to the user.

3. The method of claim 1 wherein the computing device is a wearable personal computer.

4. The method of claim 1 wherein the current context is represented by a plurality of context attributes that each model an aspect of the context.

5. The method of claim 1 wherein the current context is a context of the user.

6. The method of claim 1 wherein the selecting is performed at execution time.

7. The method of claim 1 wherein the dynamic determining and the selecting are performed repeatedly so that the user interface that is presented to the user is appropriate to the current needs.

8. The method of claim 1 wherein the dynamic determining and the selecting are performed repeatedly so that the user interface that is presented to the user is optimal with respect to the current needs.

9. The method of claim 1 wherein the determining of the current needs includes at least one of characterizing UI needs corresponding to a current task being performed, characterizing UI needs corresponding to a current situation of the user, and characterizing UI needs corresponding to current I/O devices that are available.

10. The method of claim 1 wherein the determining of the current needs includes characterizing UI needs corresponding to a current task being performed, characterizing UI needs corresponding to a current situation of the user, and characterizing UI needs corresponding to current I/O devices that are available.

11. The method of claim 1 wherein the determining of the current needs includes characterizing a current cognitive availability of the user and identifying the current needs based at least in part on the characterized current cognitive availability.

12 The method of claim 1 wherein the determining and the selecting are performed without user intervention.

13. The method of claim 1 wherein the selected user interface includes information to be presented to the user and interaction controls that can be manipulated by the user.

14. The method of claim 1 including monitoring the user and/or a surrounding environment of the user in order to produce information about the current context.

15. The method of claim 1 wherein the determined current needs are based at least in part on the current context.

16. The method of claim 1 including customizing the selected user interface based on the user before presenting of the customized user interface to the user.

17. The method of claim 1 including adapting the selected user interface to a type of the computing device before presenting of the adapted user interface to the user.

18. The method of claim 1 including adapting the selected user interface to a current activity of the user before presenting of the adapted user interface to the user.

19. The method of claim 1 wherein the determining of the current needs is based at least in part on the user being mobile.

20. A computer-readable medium whose contents cause a computing device to dynamically determine an appropriate user interface to be presented to a user of a computing device, by performing a method comprising:
for each of multiple predefined user interfaces, characterizing properties of the predefined user interface;
dynamically determining one or more current needs for a user interface to be presented to the user;
selecting for presentation to the user one of the predefined user interfaces whose characterized properties correspond to the dynamically determined current needs; and
presenting the selected user interface to the user.

21. The computer-readable medium of claim 20 wherein the computer-readable medium is a memory of a computing device.

22. The computer-readable medium of claim 20 wherein the computer-readable medium is a data transmission medium transmitting a generated data signal containing the contents.

23. The computer-readable medium of claim 20 wherein the contents are instructions that when executed cause the computing device to perform the method.

24. A computing device for dynamically determining an appropriate user interface to be presented to a user of a computing device, comprising:
a first component capable of, for each of multiple defined user interfaces, characterizing properties of the defined user interface;
a second component capable of determining during execution one or more current needs for a user interface to be presented to the user; and
a third component capable of selecting during execution one of the defined user interfaces whose characterized properties correspond to the dynamically determined current needs, the selected user interface for presentation to the user.

25. The computing device of claim 24 wherein the first, second and third components are executing in memory of the computing device.

26. A computer system for dynamically determining an appropriate user interface to be presented to a user of a computing device, comprising:
means for, for each of multiple defined user interfaces, characterizing properties of the defined user interface;
means for determining during execution one or more current needs for a user interface to be presented to the user; and
means for selecting during execution one of the defined user interfaces whose characterized properties correspond to the dynamically determined current needs, the selected user interface for presentation to the user.

27. A method for dynamically determining an appropriate user interface to be presented to a user of a computing device based on a current context, the method comprising:
determining multiple user interface elements that are available for presentation on the computing device;
characterizing properties of the determined user interface elements;
dynamically determining one or more current needs for a user interface to be presented to the user; and
generating a user interface for presentation to the user, the generated user interface having user interface elements whose characterized properties correspond to the dynamically determined current needs.

28. The method of claim 27 including presenting the generated user interface to the user.

29. The method of claim 27 wherein the dynamic determining and the generating are performed repeatedly so that the user interface that is presented to the user is optimal with respect to the current needs.

30. The method of claim 27 wherein the determining and the generating are performed without user intervention.

31. The method of claim 27 including retrieving one or more definitions for combining available user interface elements in an appropriate manner so as to satisfy current needs, and wherein the generating of the user interface uses at least one of the retrieved definitions to combine the user interface elements of the generated user interface in a manner that is appropriate to the determined current needs.

32. The method of claim 27 including retrieving one or more definitions for adapting available user interface elements to a type of computing device, and wherein the generating of the user interface uses at least one of the retrieved definitions to combine the user interface elements of the generated user interface in a manner specific to the type of the computing device.

33. A method for dynamically presenting an appropriate user interface to a user of a computing device based on a current context, the method comprising:
presenting a first user interface to the user;
without user intervention, determining that the current context has changed in such a manner that the first user interface is not appropriate for the user;
selecting a second user interface that is appropriate for the user based at least in part on the current context; and
presenting the second user interface to the user.

34. The method of claim 33 wherein the determining that the current context has changed in such a manner that the first user interface is not appropriate for the user includes automatically detecting the changes.

35. The method of claim 33 wherein the selecting of the second user interface is performed without user intervention.

36. The method of claim 33 wherein the second user interface is one of multiple predefined user interfaces.

37. The method of claim 33 wherein the second user interface is dynamically generated after the determining of the changes in the current context.

38. The method of claim 33 wherein the second user interface is a modification of the first user interface.

39. The method of claim 38 wherein the modifying of the first user interface (“UI”) includes modifying prominence of one or more UI elements of the first user interface, modifying associations between the UI elements, modifying a metaphor associated with the first user interface, modifying a sensory analogy associated with the first user interface, modifying a degree of background awareness associated with the first user interface, modifying a degree of invitation associated with the first user interface, and/or modifying a degree of safety of the user based on one or more indications presented as part of the second user interface that were not part of the first user interface.

40. A method for characterizing predefined user interfaces to allow a user interface that is currently appropriate to be presented to a user of a computing device to be dynamically selected, the method comprising:
for each of multiple predefined user interfaces, characterizing the user interface by,
determining an intended use of the predefined user interface;
determining one or more user tasks with which the predefined user interface is compatible; and
determining one or more computing device configurations with which the predefined user interface is compatible,
so that one of the predefined user interfaces can be dynamically selected for presentation to a user based on the selected user interface being currently appropriate.

41. The method of claim 40 including determining information about a current context and selecting one of the predefined user interfaces that is appropriate for the current context.

42. The method of claim 40 wherein the characterizing of each of the predefined user interfaces includes at least one of characterizing content of the user interface, characterizing a cost of using the user interface, characterizing a relevant date for the user interface, characterizing a design of elements of the user interface, characterizing functions of the elements of the user interface, characterizing hardware affinity of the user interface, characterizing an identification of the user interface, characterizing an importance of the user interface, characterizing input and output devices that are compatible with the user interface, characterizing languages to which the user interface corresponds, characterizing a learning profile of the user interface, characterizing task lengths for which the user interface is compatible, characterizing a name of the user interface, characterizing physical availability of the user interface, characterizing a power supply of the user interface, characterizing a priority of the user interface, characterizing privacy supported by the user interface, characterizing processing capabilities used for the user interface, characterizing safety capabilities of the user interface, characterizing security capabilities of the user interface, characterizing a source of the user interface, characterizing storage capabilities used for the user interface, characterizing audio capabilities of the user interface, characterizing task complexities compatible with the user interface, characterizing themes corresponding to the user interface, characterizing an urgency level for the user interface, characterizing a user attention level for the user interface, characterizing user characteristics compatible with the user interface, characterizing user expertise levels compatible with the user interface, characterizing user preference accommodation capabilities of the user interface, characterizing a version of the user interface, and characterizing video capabilities of the user interface.

43. The method of claim 40 wherein the characterizing of each of the predefined user interfaces is performed without user intervention.

44. A method for dynamically determining requirements for a user interface that is currently appropriate to be presented to a user of a computing device based on a current context, the method comprising:
dynamically determining one or more current characteristics of a user interface that is currently appropriate to be presented to the user, the determining based at least in part on the current context; and
identifying at least some of the determined characteristics as requirements for a user interface that is currently appropriate to be presented to the user.

45. The method of claim 44 including determining a user interface that satisfies the determined requirements and presenting the determined user interface to the user.

46. The method of claim 44 wherein the determining of the current characteristics includes determining characteristics corresponding to a current task being performed, determining characteristics corresponding to a current situation of the user, and/or determining characteristics corresponding to current I/O devices that are available.

47. The method of claim 44 wherein the determining of the current characteristics is performed without user intervention.

48. A method for dynamically determining requirements for a user interface that is currently appropriate to be presented to a user of a computing device, the method comprising:
dynamically determining one or more current characteristics of a user interface that is currently appropriate to be presented to the user, the determining based at least in part on a current task being performed by the user; and
identifying at least some of the determined characteristics as requirements for a user interface that is currently appropriate to be presented to the user.

49. The method of claim 48 including determining a user interface that satisfies the determined requirements and presenting the determined user interface to the user.

50. The method of claim 48 wherein the determining of the current characteristics is performed without user intervention.

51. A method for dynamically determining requirements for a user interface that is currently appropriate to be presented to a user of a computing device, the method comprising:
dynamically determining one or more current characteristics of a user interface that is currently appropriate to be presented to the user, the determining based at least in part on a current I/O devices that are available to the computing device; and
identifying at least some of the determined characteristics as requirements for a user interface that is currently appropriate to be presented to the user.

52. The method of claim 51 including determining a user interface that satisfies the determined requirements and presenting the determined user interface to the user.

53. The method of claim 51 wherein the determining of the current characteristics is performed without user intervention.

54. A method for dynamically determining requirements for a user interface that is currently appropriate to be presented to a user of a computing device, the method comprising:
dynamically determining one or more current characteristics of a user interface that is currently appropriate to be presented to the user, the determining based at least in part on a current context of the user; and
identifying at least some of the determined characteristics as requirements for a user interface that is currently appropriate to be presented to the user.

55. The method of claim 54 including determining a user interface that satisfies the determined requirements and presenting the determined user interface to the user.

56. The method of claim 54 wherein the determining of the current characteristics is performed without user intervention.

57. A method for dynamically determining characteristics of a user interface that is currently appropriate to be presented to a user of a computing device, the method comprising:
dynamically determining a level of attention which the user can currently give to the user interface; and
dynamically determining one or more current characteristics of a user interface that is currently appropriate to be presented to the user based at least in part on the determined level of attention.

58. The method of claim 57 including determining a user interface that includes the determined characteristics and presenting the determined user interface to the user.

59. The method of claim 57 wherein the determined level of attention is based on a determined current cognitive load of the user.

60. The method of claim 57 wherein the determining of the current characteristics is performed without user intervention.

61. The method of claim 57 wherein the determining of the level of attention is performed without user intervention.

62. A method for determining techniques for dynamically generating an appropriate user interface to be presented to a user of a computing device, the method comprising:
retrieving one or more definitions for dynamically combining available user interface elements in an appropriate manner so as to satisfy current needs; and
selecting one of the retrieved definitions based on current conditions so that available user interface elements can be combined in an appropriate manner to generate a user interface that is appropriate to be presented to the user.

63. The method of claim 62 including using the selected definition to generate a user interface that is appropriate to be presented to the user and presenting the generated user interface to the user.

64. The method of claim 62 wherein the selecting of the retrieved definition is performed without user intervention.

65. A method for determining techniques for dynamically generating an appropriate user interface to be presented to a user of a computing device, the method comprising:
retrieving one or more definitions for dynamically adapting available user interface elements to a type of computing device; and
selecting one of the retrieved definitions based on current conditions so that available user interface elements can be adapted to the type of the computing device so as to generate a user interface that is appropriate to be presented to the user.

66. The method of claim 65 including using the selected definition to generate a user interface that is appropriate to be presented to the user and presenting the generated user interface to the user.

67. The method of claim 65 wherein the selecting of the retrieved definition is performed without user intervention.

68. A method for dynamically determining an appropriate user interface to be presented to a user of a computing device based on a current context, the method comprising:
determining multiple user interface elements that are available for presentation on the computing device; and
characterizing properties of the determined user interface elements, so that available user interface elements whose characterized properties are appropriate for a current context can be selected and combined in an appropriate manner to generate a user interface that is appropriate to be presented to the user

69. The method of claim 68 including combining available user interface elements whose characterized properties are appropriate for a current context in order to generate a user interface that is appropriate to be presented to the user and presenting the generated user interface to the user.

70. The method of claim 68 wherein the characterizing of the properties is performed without user intervention.
